(19) United States
(12) Patent Application Publication
(10) Pub. No.: US 2015/0025953 A1
(43) Pub. Date: Jan. 22, 2015

(54) REWARDING INFLUENCERS

(71) Applicant: SEARETE LLC, Bellevue, WA (US)

(72) Inventors: Gary W. Flake, Bellevue, WA (US); William H. Gates, III, Medina, WA (US); Alexander G. Gounares, Kirkland, WA (US); W. Daniel Hillis, Encino, CA (US); Royce A. Levien, Lexington, MA (US); Robert W. Lord, Seattle, WA (US); Mark A. Malamud, Seattle, WA (US); Craig J. Mundie, Seattle, WA (US); Christopher D. Payne, Seattle, WA (US); Richard F. Rashid, Redmond, WA (US); Clarence T. Tegreene, Mercer Island, WA (US); Charles Whitmer, North Bend, WA (US); Lowell L. Wood, JR., Bellevue, WA (US)

(21) Appl. No.: 14/447,470

(22) Filed: Jul. 30, 2014

Related U.S. Application Data
(63) Continuation-in-part of application No. 12/660,752, filed on Mar. 2, 2010, now abandoned.

(51) Int. Cl. G06Q 30/02; H04L 29/08

(52) U.S. Cl. CPC G06Q 30/0214; H04L 67/10
USPC 705/14.16

(57) ABSTRACT

A method embodiment includes receiving data indicative of a person accessing at least one of a first network-available electronic content or a second network-available electronic content, perhaps in a Web 2.0 environment. Also, receiving data indicative of an involvement between the person and a third party. The involvement being independent of the person activating a link to a site owned by the third party that is included in the first network-available electronic content or in the second network available electronic content. Further, assessing a behavioral influence by the first network-available electronic content and/or the second network-available electronic content on the indicated involvement with respect to the possible matters of interest between the person and a third party. Also, facilitating delivery of a benefit to an owner of the first network-available electronic content and/or an owner of the second network-available electronic content in response to the assessed behavioral influence.

If an Application Data Sheet (ADS) has been filed on the filing date of this application, it is incorporated by reference herein. Any applications claimed on the ADS for priority under 35 U.S.C. §§119, 120, 121 or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications(s),” if any, listed below:

### PRIORITY APPLICATIONS

For purposes of the USPTO extra-statutory requirements, the present application constitutes a continuation-in-part of U.S. patent application Ser. No. 11/799,460, entitled REWARDING INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Apr. 30, 2007, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 11/799,461, entitled DETERMINING INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Apr. 30, 2007, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 11/811,349, entitled REWARDING INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Jun. 7, 2007, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 11/811,402, entitled DETERMINING INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Jun. 8, 2007, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 11/824,551, entitled REPORTING INFLUENCE ON A PERSON BY NETWORK-AVAILABLE CONTENT naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Jun. 29, 2007, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 11/824,580, entitled DETERMINING AN INFLUENCE ON A PERSON BY WEB PAGES naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Jun. 29, 2007, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 11/824,582, entitled COLLECTING INFLUENCE INFORMATION naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Jun. 29, 2007, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 11/881,800, entitled REWARDING INDEPENDENT INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Jul. 27, 2007, now issued as U.S. Pat. No. 8,712,837 on Apr. 29, 2014, which is an application of which a currently co-pending application is entitled to the benefit of the filing date;

For purposes of the USPTO extra-statutory requirements, the present application constitutes a continuation-in-part of U.S. patent application Ser. No. 11/906,537, entitled COLLECTING INFLUENCE INFORMATION naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Oct. 1, 2007, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 11/906,780, entitled REWARDING INDEPENDENT INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Oct. 2, 2007, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 12/290,310, entitled REWARDING INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Oct. 28, 2008, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 12/290,675, entitled SYSTEMS FOR REWARDING INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Oct. 31, 2008, which is currently co-pending, or is an application of which a currently co-pending application is entitled to the benefit of the filing date;

For purposes of the USPTO extra-statutory requirements, the present application constitutes a continuation-in-part of U.S. patent application Ser. No. 12/660,752, entitled DETERMINING INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Mar. 2, 2010, which is currently co-pending, or is an application of which a currently co-pending application is entitled to the benefit of the filing date; and

For purposes of the USPTO extra-statutory requirements, the present application constitutes a continuation-in-part of U.S. patent application Ser. No. 12/660,799, entitled DETERMINING INFLUENCERS naming Gary W. Flake; William H. Gates, III; Alexander G. Gounares; W. Daniel Hillis; Royce A. Levien; Robert W. Lord; Mark A. Malamud; Craig J. Mundie; Christopher D. Payne; Richard F. Rashid; Clarence T. Tegreene; Charles Whitmer; and Lowell L. Wood, Jr. as inventors, filed Mar. 3, 2010, now issued as U.S. Pat. No. 8,290,973 on Oct. 16, 2012, which is an application of which a currently co-pending application is entitled to the benefit of the filing date.

### RELATED APPLICATIONS

None.

The United States Patent Office (USPTO) has published a notice to the effect that the USPTO's computer programs require that patent applicants both reference a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listing of applications provided above is inconsistent with the listing provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

The present disclosure relates generally to determining and/or rewarding influencers, and more specifically, to assessing an influence of an electronically accessed content on an involvement between an accessor and a third party. In some implementations, the assessment of the influence may be performed in a Web 2.0 environment, and a provider of the electronically accessed content may be rewarded based on the assessed influence.

### BRIEF DESCRIPTION OF THE DRAWINGS

FIG. 1 illustrates an exemplary embodiment of a thin computing device in which embodiments may be implemented;

FIG. 2 illustrates an exemplary embodiment of a general-purpose computing system in which embodiments may be implemented;

FIG. 3 illustrates an exemplary system in which embodiments may be implemented;

FIG. 4 illustrates an exemplary network environment in which embodiments may be implemented;

FIG. 5 illustrates an exemplary operational flow;

FIG. 6 illustrates an embodiment of the exemplary operational flow of FIG. 5;

FIG. 7 illustrates another embodiment of the exemplary operational flow of FIG. 5;

FIG. 8 illustrates a further embodiment of the exemplary operational flow of FIG. 5;

FIG. 9 illustrates an embodiment of the exemplary operational flow of FIG. 5;

FIG. 10 illustrates another embodiment of the exemplary operational flow of FIG. 5;

FIG. 11 illustrates an embodiment of the exemplary operational flow of FIG. 5;

FIG. 12 illustrates another embodiment of the exemplary operational flow of FIG. 5;

FIG. 13 illustrates a further embodiment of the exemplary operational flow of FIG. 5;

FIG. 14 illustrates an embodiment of the exemplary operational flow of FIG. 5;

FIG. 15 illustrates another embodiment of the exemplary operational flow of FIG. 5;

FIG. 16 illustrates a further embodiment of the exemplary operational flow of FIG. 5;

FIG. 17 illustrates a further embodiment of the exemplary operational flow of FIG. 5;

FIG. 18 illustrates a further embodiment of the exemplary operational flow of FIG. 5;

FIG. 19 illustrates an embodiment of the exemplary operational flow of FIG. 5;

FIG. 20 illustrates an embodiment of the exemplary operational flow of FIG. 5;

FIG. 21 illustrates another embodiment of the exemplary operational flow of FIG. 5;

FIG. 22 illustrates a further embodiment of the exemplary operational flow of FIG. 5;

FIG. 23 illustrates an exemplary computer program product;

FIG. 24 illustrates an exemplary system;

FIG. 25 illustrates a device;

FIG. 26 illustrates an example of a system that may serve as a context for introducing one or more processes, systems or other articles;

FIG. 27 illustrates an exemplary operational flow;

FIG. 28 illustrates an alternative embodiment of the exemplary operational flow of FIG. 27;

FIG. 29 illustrates another alternative embodiment of the exemplary operational flow of FIG. 27;

FIG. 30 illustrates a further alternative embodiment of the exemplary operational flow of FIG. 27;

FIG. 31 illustrates a further alternative embodiment of the exemplary operational flow of FIG. 27;

FIG. 32 illustrates an alternative embodiment of the exemplary operational flow of FIG. 27;

FIG. 33 illustrates another alternative embodiment of the exemplary operational flow of FIG. 27;

FIG. 34 illustrates an alternative embodiment of the exemplary operational flow of FIG. 27;

FIG. 35 illustrates another alternative embodiment of the exemplary operational flow of FIG. 27;

FIG. 36 illustrates a further alternative embodiment of the exemplary operational flow of FIG. 27;

FIG. 37 illustrates an alternative embodiment of the exemplary operational flow of FIG. 27;

FIG. 38 illustrates another alternative embodiment of the exemplary operational flow of FIG. 27;

FIG. 39 illustrates a further alternative embodiment of the exemplary operational flow of FIG. 27;

FIG. 40 illustrates an exemplary computing device operable to communicate over a network;

FIG. 41 illustrates an exemplary computer program product;

FIG. 42 illustrates an exemplary device;

FIG. 43 illustrates another system that may serve as a context for introducing one or more processes, systems or other articles described herein;

FIG. 44 illustrates a system;

FIG. 45 illustrates an example operational flow for reporting influence;

FIG. 46 illustrates an alternative embodiment of the operational flow described in FIG. 45;

FIG. 47 illustrates another embodiment of the operational flow described in FIG. 45;

FIG. 48 illustrates a further embodiment of the operational flow described in FIG. 45;

FIG. 49 illustrates an alternative embodiment of the operational flow described in FIG. 45;

FIG. 50 illustrates a further embodiment of the operational flow described in FIG. 45;

FIG. 51 illustrates another embodiment of the operational flow described in FIG. 45;

FIG. 52 illustrates an alternative embodiment of the operational flow described in FIG. 45;

FIG. 53 illustrates an operational flow of reporting influence on a person;

FIG. 54 illustrates an operational flow for reporting an influence of electronic content;

FIG. 55 illustrates a system;

FIG. 56 illustrates an example computer program product;

FIG. 57 illustrates an example apparatus;

FIG. 58 illustrates an example system;

FIG. 59 illustrates an example operational flow for reporting a possible influential electronic content;

FIG. 60 illustrates an alternative embodiment of the operational flow of FIG. 59;

FIG. 61 illustrates another embodiment of the operational flow of FIG. 59;

FIG. 62 illustrates a further embodiment of the operational flow of FIG. 55;

FIG. 63 illustrates an operational flow for reporting influence on a person;

FIG. 64 illustrates an alternative embodiment of the operational flow of FIG. 63;

FIG. 65 illustrates another embodiment of the operational flow of FIG. 63;

FIG. 66 illustrates a further embodiment of the operational flow of FIG. 63;

FIG. 67 illustrates an alternative embodiment of the operational flow of FIG. 63;

FIG. 68 illustrates another alternative embodiment of the operational flow of FIG. 59;

FIG. 69 illustrates an example system in which embodiments may be implemented;

FIG. 70 illustrates an example computer program product;

FIG. 71 illustrates an influence reporting apparatus;

FIG. 72 illustrates an example operational flow for assessing an influence of an electronic content on a person;

FIG. 73 illustrates an alternative embodiment of the operational flow of FIG. 68;

FIG. 74 illustrates another alternative embodiment of the operational flow of FIG. 68;

FIG. 75 illustrates an example system;

FIG. 76 illustrates an example operational flow for influence reporting;

FIG. 77 illustrates an alternative embodiment of the operational flow of FIG. 76;

FIG. 78 illustrates another alternative embodiment of the operational flow of FIG. 76;

FIG. 79 illustrates a further alternative embodiment of the operational flow of FIG. 76;

FIG. 80 illustrates an alternative embodiment of the operational flow of FIG. 76;

FIG. 81 illustrates another alternative embodiment of the operational flow of FIG. 71;

FIG. 82 illustrates a further alternative embodiment of the operational flow of FIG. 71;

FIG. 83 illustrates an alternative embodiment of the operational flow of FIG. 71;

FIG. 84 illustrates an example system;

FIG. 85 illustrates an example computer program product; and

FIG. 86 illustrates an example of an apparatus.

FIG. 87 illustrates an example of a system 4000;

FIG. 88 illustrates an example of an operational flow representing operations related to influence evaluation;

FIG. 89 illustrates an alternative embodiment of the activity monitoring operation 4110 of the operational flow of FIG. 88;

FIG. 90 illustrates another alternative embodiment of the activity monitoring operation 4110 of the operational flow of FIG. 88;

FIG. 91 illustrates an alternative embodiment of the interaction monitoring operation 4140 of the operational flow of FIG. 88;

FIG. 92 illustrates another alternative embodiment of the operational flow of FIG. 88;

FIG. 93 illustrates a further alternative embodiment of the operational flow of FIG. 88;

FIG. 94 illustrates an alternative embodiment of the operational flow of FIG. 88;

FIG. 95 illustrates another alternative embodiment of the operational flow of FIG. 88;

FIG. 96 illustrates a further embodiment of the operational flow of FIG. 88;

FIG. 97 illustrates an embodiment of the operational flow of FIG. 88;

FIG. 98 illustrates an example computer program product;

FIG. 99 illustrates an example system;

FIG. 100 illustrates an example device;

FIG. 101 illustrates an exemplary embodiment of a thin computing device in which embodiments may be implemented;

FIG. 102 illustrates an exemplary embodiment of a general-purpose computing system in which embodiments may be implemented;

FIG. 103 illustrates another exemplary system in which embodiments may be implemented;

FIG. 104 illustrates an exemplary network environment in which embodiments may be implemented;

FIGS. 105 through 140 are flowcharts of various embodiments of methods of assessing an influence of an electronically accessed content in accordance with various implementations of the present disclosure;

FIGS. 141-147 illustrate exemplary embodiments of alternate computing systems and environments in which embodiments may be implemented; and

FIGS. 148-157 are flowcharts of various embodiments of methods of determining an influence of an electronically accessed content in accordance with various implementations of the present disclosure.

### DETAILED DESCRIPTION

In the following detailed description, reference is made to the accompanying drawings, which form a part hereof. In the drawings, similar symbols typically identify similar components, unless context dictates otherwise. The illustrated embodiments described in the detailed description, drawings, and claims are not meant to be limiting. Other embodiments may be utilized, and other changes may be made, without departing from the spirit or scope of the subject matter presented here.

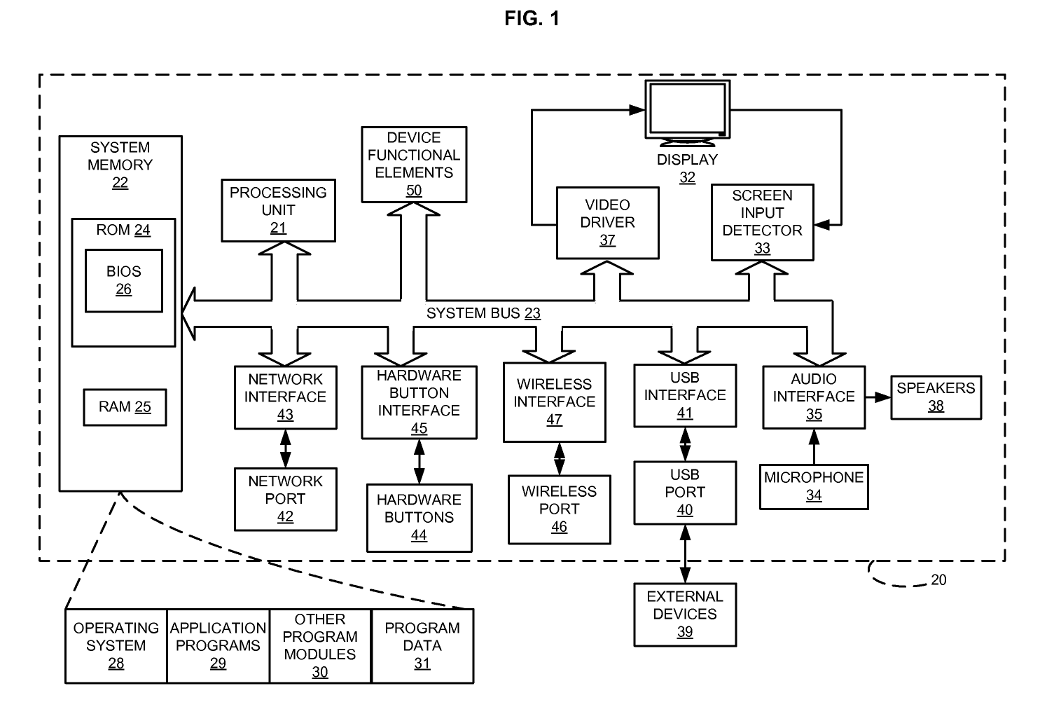

FIG. 1 and the following discussion are intended to provide a brief, general description of an environment in which embodiments may be implemented. FIG. 1 illustrates an exemplary system that includes a thin computing device 20, which may be included in an electronic device that also includes a device functional element 50. For example, the electronic device may include any item having electrical and/or electronic components playing a role in a functionality of the item, such as a limited resource computing device, an electronic pen, a handheld electronic writing device, a digital camera, a scanner, an ultrasound device, an x-ray machine, a non-invasive imaging device, a cell phone, a printer, a refrigerator, a car, and an airplane. The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 and/or RAM 25, including an operating system 28, one or more application programs 29, other program modules 30 and program data 31.

A user may enter commands and information into the computing device 20 through input devices, such as a number of switches and buttons, illustrated as hardware buttons 44, connected to the system via a suitable interface 45. Input devices may further include a touch-sensitive display screen 32 with suitable input detection circuitry 33. The output circuitry of the touch-sensitive display 32 is connected to the system bus 23 via a video driver 37. Other input devices may include a microphone 34 connected through a suitable audio interface 35, and a physical hardware keyboard (not shown). In addition to the display 32, the computing device 20 may include other peripheral output devices, such as at least one speaker 38.

Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are exemplary and other components and means of establishing communications links may be used.

The computing device 20 may be primarily designed to include a user interface. The user interface may include a character, a key-based, and/or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and is coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, and a camera capturing and saving an image.

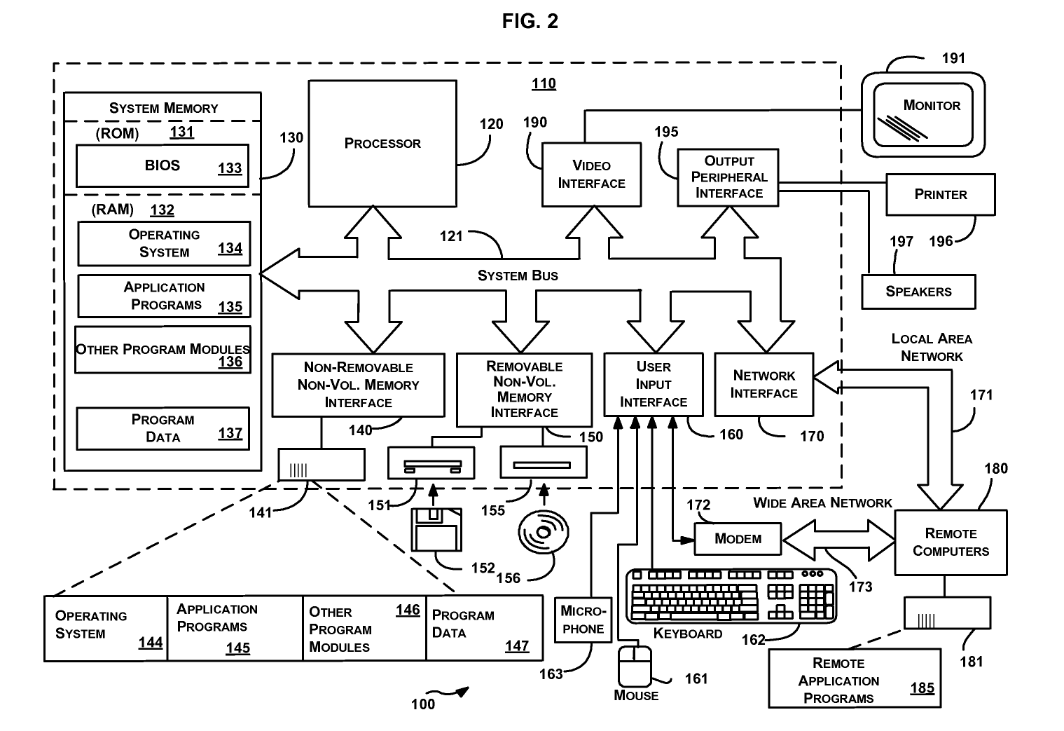

FIG. 2 illustrates an exemplary embodiment of a general-purpose computing system in which embodiments may be implemented, shown as a computing system environment 100. Components of the computing system environment 100 may include, but are not limited to, a computing device 110 having a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, and/or atomic quantum memory. Combinations of any of the above may also be included within the scope of computer-readable media.

Communications media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media such as a wired network and a direct-wired connection and wireless media such as acoustic, RF, optical, and infrared media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, and/or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by processing unit 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, and/or is coupled to an optical disk drive 155 that reads from and writes to a removable, non-volatile optical disk 156, such as a CD ROM. Other removable/nonremovable, volatile/non-volatile computer storage media that can be used in the exemplary operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies. A user may enter commands and information into the computing device 110 through input devices such as a microphone 163, keyboard 162, and pointing device 161, commonly referred to as a mouse, trackball, or touch pad. Other input devices (not shown) may include a joystick, game pad, satellite dish, and scanner. These and other input devices are often connected to the processing unit 120 through a user input interface 160 that is coupled to the system bus, but may be connected by other interface and bus structures, such as a parallel port, game port, or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The logical connections depicted in FIG. 2 include a local area network (LAN) 171 and a wide area network (WAN) 173, but may also include other networks such as a personal area network (PAN) (not shown). Such networking environments are commonplace in offices, enterprise-wide computer networks, intranets, and the Internet.

When used in a LAN networking environment, the computing system environment 100 is connected to the LAN 171 through a network interface or adapter 170. When used in a WAN networking environment, the computing device 110 typically includes a modem 172 or other means for establishing communications over the WAN 173, such as the Internet. The modem 172, which may be internal or external, may be connected to the system bus 121 via the user input interface 160, or via another appropriate mechanism. In a networked environment, program modules depicted relative to the computing device 110, or portions thereof, may be stored in a remote memory storage device. By way of example, and not limitation, FIG. 2 illustrates remote application programs 185 as residing on computer storage medium 181. It will be appreciated that the network connections shown are exemplary and other means of establishing communications link between the computers may be used.

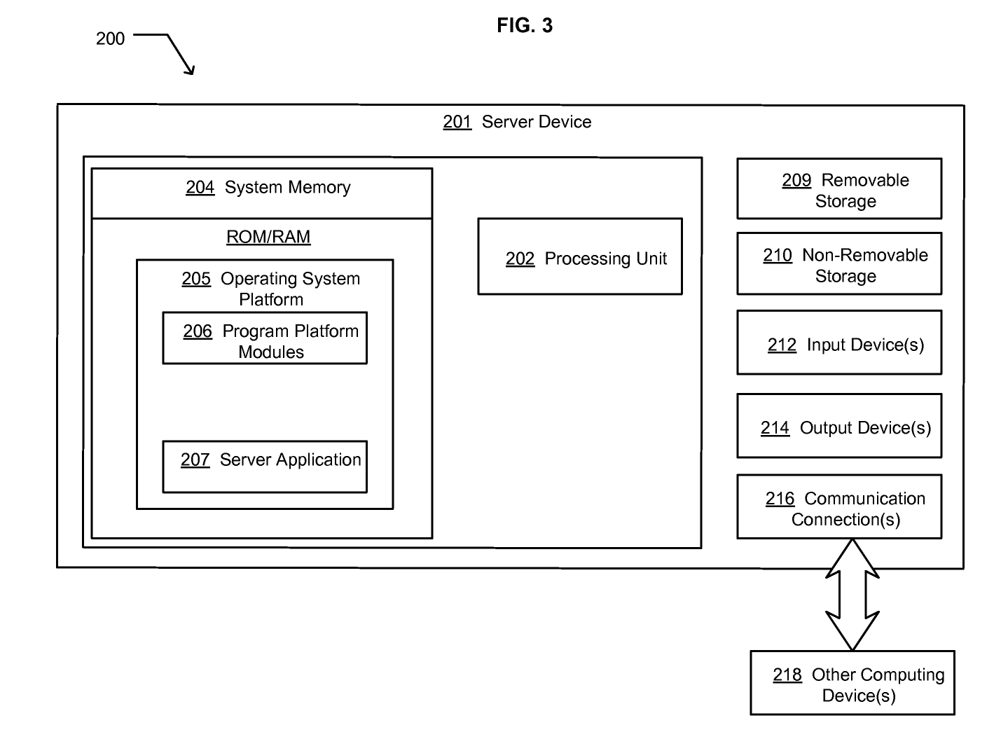

FIG. 3 illustrates an exemplary system 200 in which embodiments may be implemented. The exemplary system includes a computing system couplable to a network and operable to provide electronic content, such as a server 201. In an embodiment, the server may include an application server, audio server, database server, fax server, file server, intranet server, mail server, merchant server, modem server, network access server, network server, print server, proxy server, remote access server, telephony server, terminal server, video server, and/or Web server. In another embodiment, the server may include a network intermediary, a network switch, and/or a router. Server functionality may be implemented in software, hardware, firmware, and/or a combination thereof. Server functionality may be provided by a computing device that also provides other functionality. The network may include an electronic network, an optical network, and/or a combination of optical and electronic networks.

In a configuration, the server 201 typically includes at least one processing unit 202 and system memory 204. System memory 204 typically includes operating system platform 205 and one or more program modules 206 running on operating system. In addition to the program modules 206, a server application 207 may also be running on the operating system. The server application 207 may be operable to deliver electronic content and/or files to applications via a protocol, and may include and/or interact with other computing devices, application servers, applications, and application interfaces (APIs) residing in other applications. For example, the server application may include a Web server operable to deliver Web pages and/or electronic content to Web browser applications via HTTP protocols.

The server 201 may have additional features or functionality. For example, server may also include additional data storage devices (removable and/or non-removable), as illustrated in FIG. 3 by removable storage 209 and non-removable storage 210. System memory 204, removable storage 209 and non-removable storage 210 are all examples of computer storage media. The server may include input device(s) 212 and output device(s) 214. The server also contains communication connections 216 that allow the device to communicate with and perform a service associated with a network, including communicating with other servers and/or with other computing device, illustrated as other computing device(s) 218. Communication connections 216 are one example of communication media.

FIGS. 1-3 are intended to provide a brief, general description of an illustrative and/or suitable exemplary environments in which embodiments may be implemented. An exemplary system may include the thin computing device 20 of FIG. 1, the computing system environment 100 of FIG. 2, and/or the server of FIG. 3. FIGS. 1-3 are examples of a suitable environment and is not intended to suggest any limitation as to the structure, scope of use, or functionality of an embodiment. A particular environment should not be interpreted as having any dependency or requirement relating to any one or combination of components illustrated in an exemplary environment. For example, in certain instances, one or more elements of an environment may be deemed not necessary and omitted. In other instances, one or more other elements may be deemed necessary and added. Further, it will be appreciated that device(s) and/or environment(s) described herein may include numerous electrical, optical, mechanical, and/or digital components that may necessary to operate the device, but are not needed to illustrate the subject matter described herein. As such, some of these electrical, optical, mechanical, and/or digital components may be omitted from the specification for clarity.

In the description that follows, certain embodiments may be described with reference to acts and symbolic representations of operations that are performed by one or more computing devices, such as the computing device 110 of FIG. 2. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

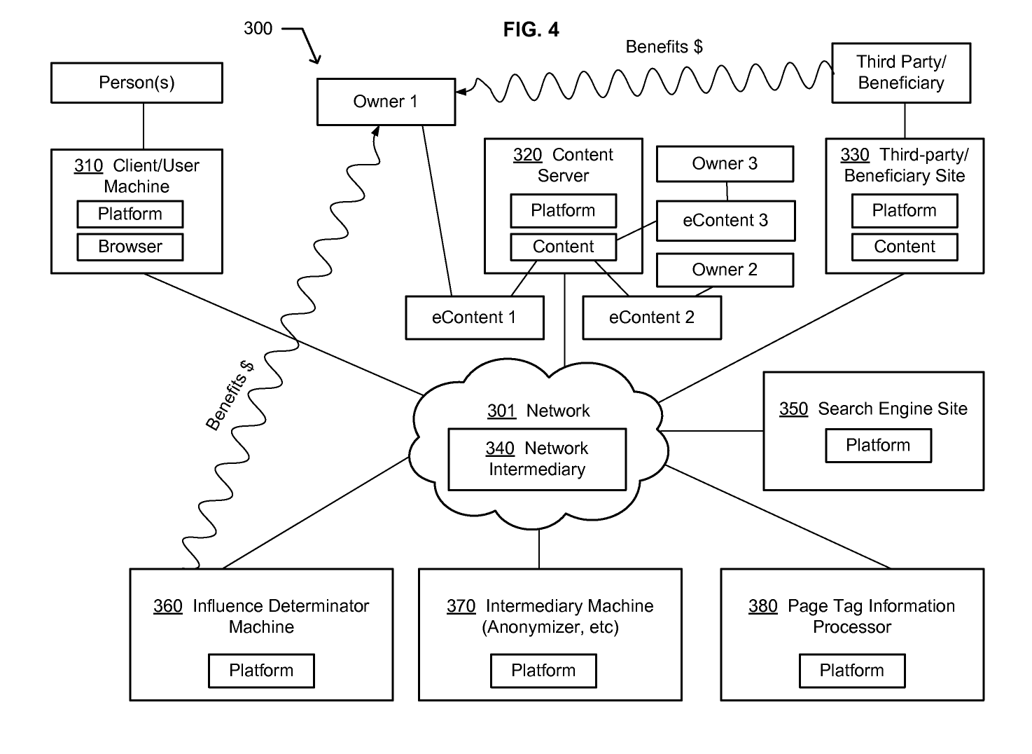

FIG. 4 illustrates an exemplary network environment 300 in which embodiments may be implemented. The exemplary environment includes networks, illustrated as a network 301, and client machines, illustrated as client machine 310. A fabric of the network may include network intermediaries, illustrated as a network intermediary 340 running on a platform (not shown). In an embodiment, the client machine includes a computing device used by a human user. In another embodiment, the client machine includes a computing device used by a human user to communicate in a peer-to-peer environment (P2P), and/or to communicate in a cloud-to-cloud environment (C2C). In a further embodiment, the client machine includes a computing device used by a human user to communicate with a server. The client machine may include the thin computing device 20 illustrated in FIG. 1, and/or the computing device 110 illustrated in FIG. 2.

The exemplary environment 300 also includes servers, illustrated as a content server 320. In an embodiment, the content server is operable to provide electronic content (illustrated as eContent 1 and/or eContent 2 to one or more client machines. In another embodiment, the content server includes the server 201 illustrated in FIG. 3. In a further embodiment, the content server(s) includes a node in P2P and/or a C2C network. The node may include the thin computing device 20 illustrated in FIG. 1, and/or the computing device 110 illustrated in FIG. 2. The exemplary environment also includes a third party sites, illustrated as a third party site 330. The third party site may include a merchant site, such as amazon.com for books, a manufacturer site, such as subaru.com for automobiles, a religious institution, such as catholic.org and/or hinduism.com, and/or a political site, such as mc.org and/or democrats.org. The exemplary environment also includes search engine sites, illustrated as a search engine site 350. The search engine site may include a general search engine site, such as google.com and/or live.com. In another embodiment, the search engine site may include a topical search site, such as HONMedhunt and/or FindLaw.com.

The exemplary environment 300 may also include an influence determinator machine 360, an intermediary machine 370, and/or a page tag information processor 380. Each of these machines may be operable to receive data and/or information gathered by at least one of the client machine 310, the content server 320, the third party site 330, and/or the network intermediary 340, and to produce an output useable in assessing an influence on a person using the client machine by a content of the content server.

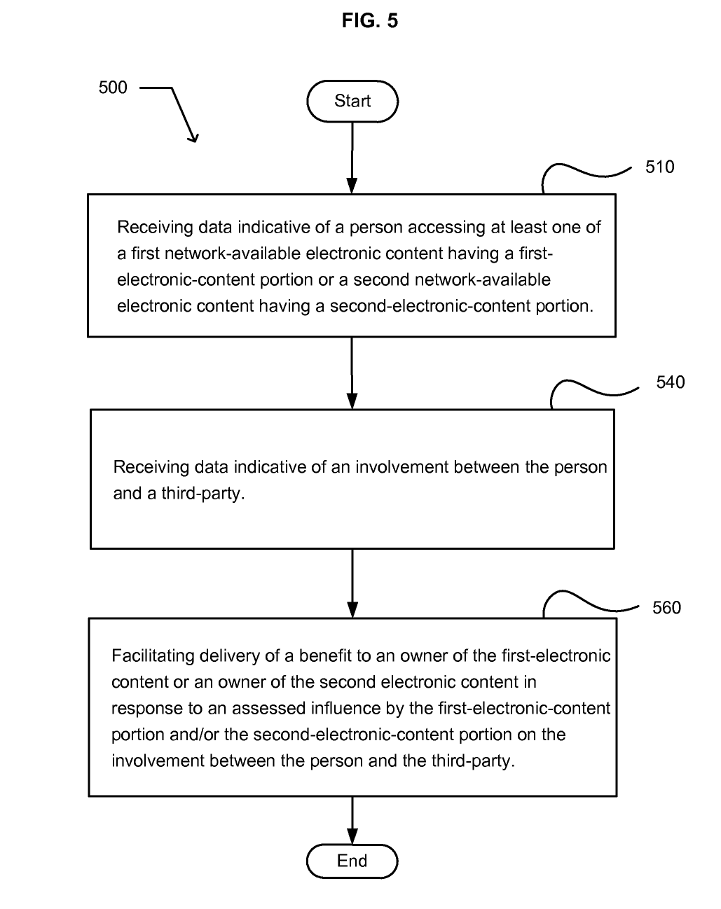

FIG. 5 illustrates an exemplary operational flow 500. After a start operation, the operational flow moves to a navigation content operation 510. The navigation content operation receives data indicative of a person accessing at least one of a first network-available electronic content having a first electronic content portion or a second network-available electronic content having a second electronic content portion. An engagement data operation 540 receives data indicative of an involvement between the person and a third party. A recognition operation 560 facilitates delivery of a benefit to an owner of the first electronic content or an owner of the second electronic content in response to an assessed influence by the first electronic content portion and/or the second electronic content portion on the involvement between the person and the third party. The operational flow then moves to an end operation.

In an embodiment, the exemplary operational flow 500 may be performed at a computing device. For example, the exemplary operational flow may be performed by at least one of the client machine 310, the content server 320, the third party site 330, the search engine site 350, the influence determinator machine 360, the intermediary machine 370, and/or the page tag information processor 380 of FIG. 4. In an embodiment, at least a portion of the data may be received from a platform or an application running on the platform of the device performing the operational flow 500. In an embodiment, the operational flow may be performed by the content server using data received from the client machine and received from an application running on a platform of the content server. In another embodiment, the operational flow may be performed by the content server using data from both the client machine and the third party site. In a further embodiment, the operational flow may be performed by the influence determinator machine using data received from at least one of the client machine, the content server, the search engine site, and/or the third party site. In another embodiment, the operational flow may be performed by the search engine platform using data received from at least one of the client machine, the content server, and/or the third party site.

FIG. 4 may be used to illustrate a use of an embodiment of the exemplary operational flow 500. For example, a person may use their computing device, illustrated as the client machine 310, to access over the Internet and browse blog pages hosted by a content server, illustrated as the content server 320 and eContent 1 and eContent 2 respectively created by owner 1 and owner 2. By way of further example, in a situation where the person is looking to buy a new truck, they may access eContent 1 and eContent 2 looking for recommendations and reviews of trucks. The person may spend five minutes accessing eContent 1 because they like the content or find it helpful, and only ten seconds accessing eContent 2 because they do not find the content helpful. The navigation content operation 510 in FIG. 5 may receive data indicative of the person accessing eContent 1 having a first electronic content portion pertaining to Ford and GM trucks and eContent 2 having a second electronic content portion pertaining to Ford and Toyota trucks. The navigation operation may receive data indicative of respective access times and other aspects of the person's access. The person may use their computing device to become involved over the Internet with a third party, such as a Ford sales site. They may order delivery of printed promotional materials, a quote on a new truck, arrange a test drive, seek an address of a Ford dealer, and/or order a truck. Alternatively, they may become involved by visiting a dealer showroom, taking a test drive, and/or purchasing a truck. The engagement data operation 540 may receive data indicative of an involvement between the person and a third party, such as Ford. The data may be received from any number of sources, for example, such as the client machine 310, the third party site 330, the network intermediary 340, the search engine site 350, and/or the page tag information processor 380. Alternatively, the data indicative of an involvement between the person and Ford may be manually gathered by a sales person at a dealership visited by the person. The recognition operation 560 facilitates delivery of a benefit to an owner of the first electronic content or an owner of the second electronic content in response to an assessed influence by the first electronic content portion and/or the second electronic content portion on the involvement between the person and the third party. For example, an assessed influence by the first electronic content portion and/or the second electronic content portion on the involvement between the person and the third party may indicate that the first electronic content portion likely influenced the involvement between the person and the third party, which in this example, is Ford. The recognition operation may facilitate a benefit to the owner of the first electronic content portion in response to the assessed influence.

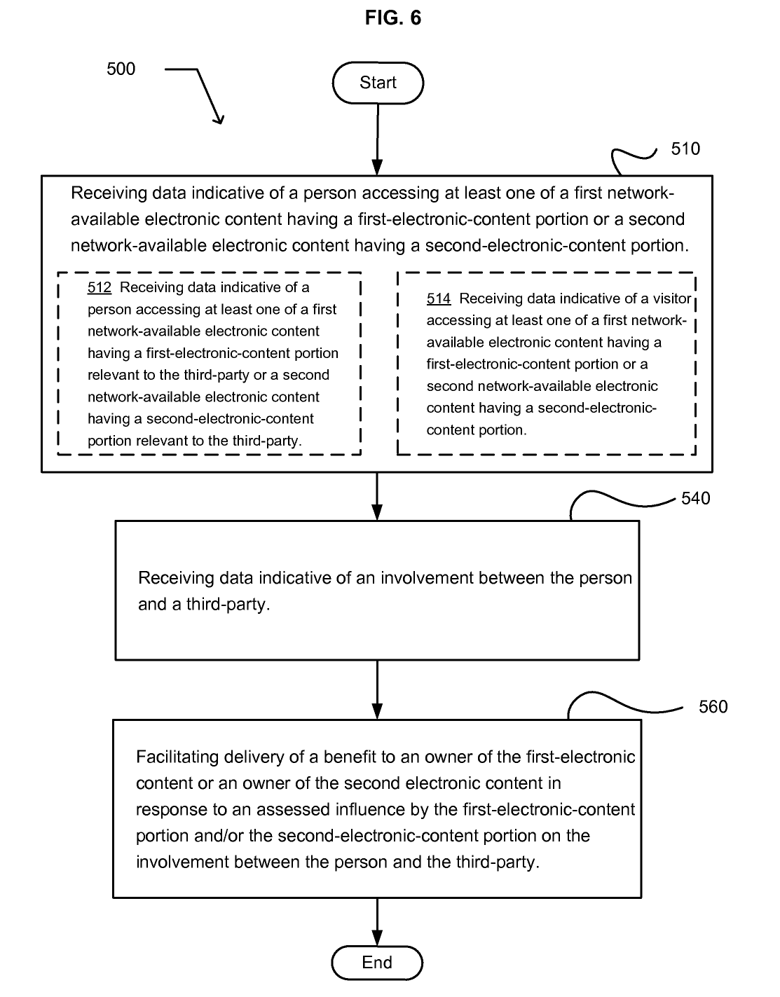

FIG. 6 illustrates an embodiment of the exemplary operational flow 500 of FIG. 5. The navigation content operation 510 may include at least one additional operation. The at least one additional operation may include an operation 512, and/or an operation 514. The operation 512 receives data indicative of a person accessing at least one of a first network-available electronic content having a first electronic content portion relevant to the third party or a second network-available electronic content having a second electronic content portion relevant to the third party. The operation 514 receives data indicative of a visitor accessing at least one of a first network-available electronic content having a first electronic content portion or a second network-available electronic content having a second electronic content portion.

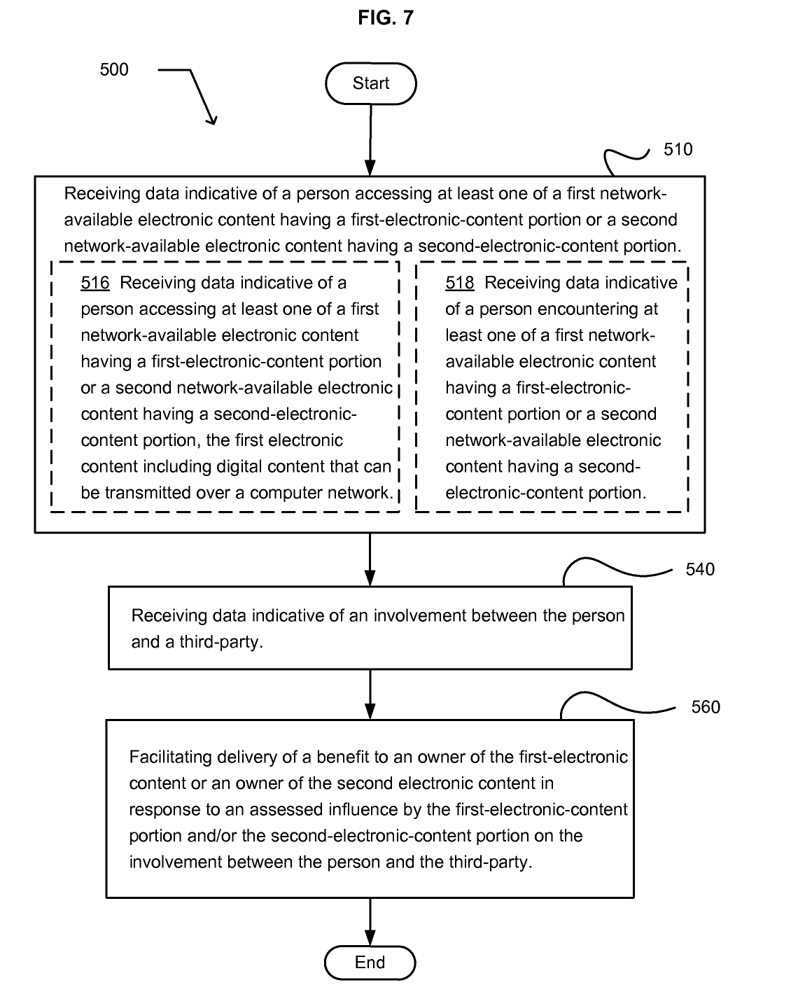

FIG. 7 illustrates another embodiment of the exemplary operational flow 500 of FIG. 5. The navigation content operation 510 may include at least one additional operation. The at least one additional operation may include an operation 516, and/or an operation 518. The operation 516 receives data indicative of a person accessing at least one of a first network-available electronic content having a first electronic content portion or a second network-available electronic content having a second electronic content portion. The first electronic content including digital content that can be transmitted over a computer network. The operational flow 518 receives data indicative of a person encountering at least one of a first network-available electronic content having a first electronic content portion or a second network-available electronic content having a second electronic content portion. The encountering may include indirectly accessing at least one of a first network-available electronic content having a first electronic content portion or a second network-available electronic content having a second electronic content portion. For example, indirectly accessing may include viewing a summary, a précis, and/or an aggregation of content that includes at least one of a first network-available electronic content or a second network-available electronic content.

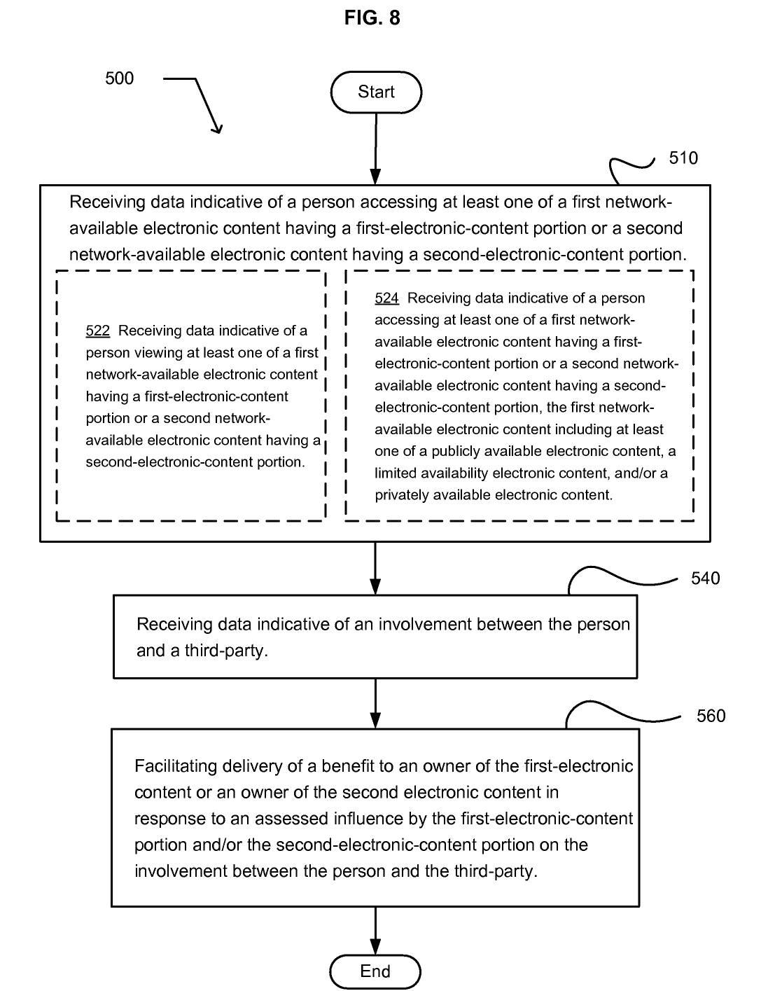

FIG. 8 illustrates a further embodiment of the exemplary operational flow 500 of FIG. 5. The navigation content operation 510 may include at least one additional operation. The at least one additional operation may include an operation 522, and/or an operation 524. The operation 522 receives data indicative of a person viewing at least one of a first network-available electronic content having a first electronic content portion or a second network-available electronic content having a second electronic content portion. The operation 524 receives data indicative of a person accessing at least one of a first network-available electronic content having a first electronic content portion or a second network-available electronic content having a second electronic content portion. The first network-available electronic content including at least one of a publicly available electronic content, a limited availability electronic content, and/or a privately available electronic content.

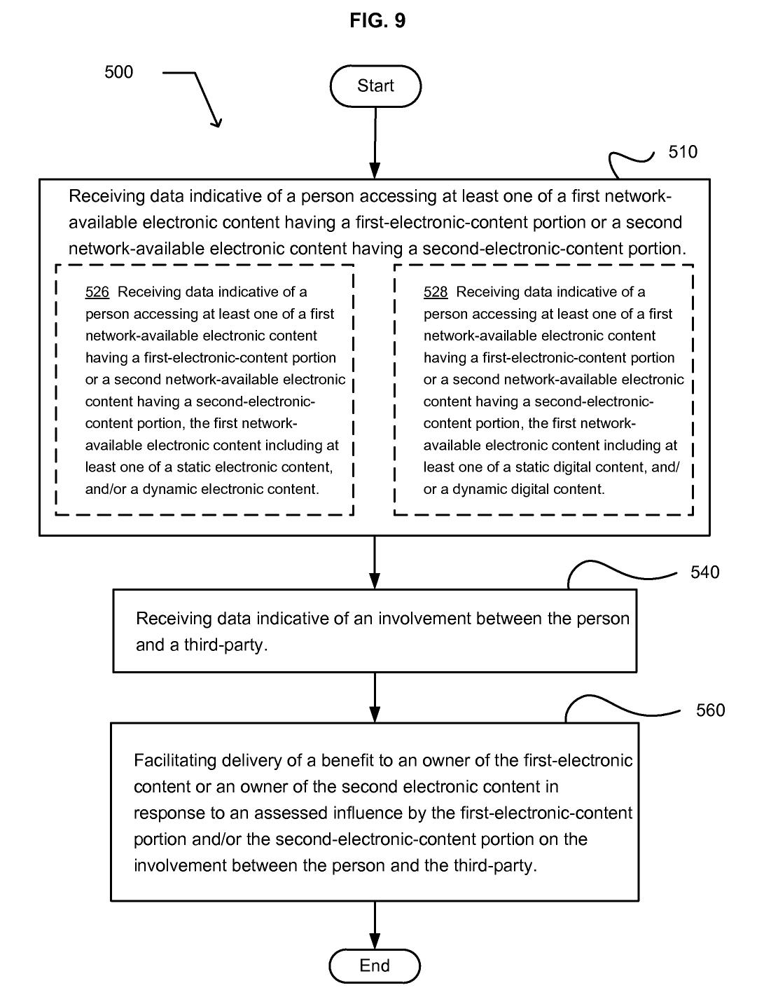

FIG. 9 illustrates an embodiment of the exemplary operational flow 500 of FIG. 5. The navigation content operation 510 may include at least one additional operation. The at least one additional operation may include an operation 526, and/or an operation 528. The operation 526 receives data indicative of a person accessing at least one of a first network-available electronic content having a first electronic content portion or a second network-available electronic content having a second electronic content portion. The first network-available electronic content including at least one of a static electronic content, and/or a dynamic electronic content. The operation 528 receives data indicative of a person accessing at least one of a first network-available electronic content having a first electronic content portion or a second network-available electronic content having a second electronic content portion. The first network-available electronic content including at least one of a static digital content, and/or a dynamic digital content.

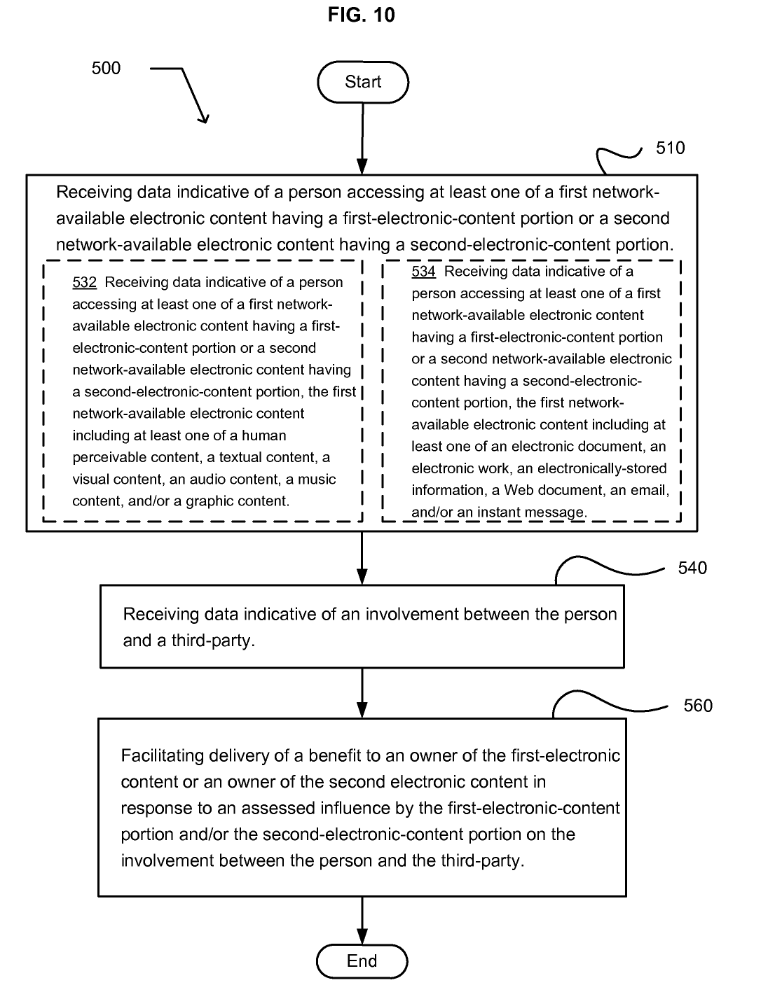

FIG. 10 illustrates another embodiment of the exemplary operational flow 500 of FIG. 5. The navigation content operation 510 may include at least one additional operation. The at least one additional operation may include an operation 532, and/or an operation 534. The operation 532 receives data indicative of a person accessing at least one of a first network-available electronic content having a first electronic content portion or a second network-available electronic content having a second electronic content portion. The first network-available electronic content including at least one of a human perceivable content, a textual content, a visual content, an audio content, a music content, and/or a graphic content. The operation 534 receives data indicative of a person accessing at least one of a first network-available electronic content having a first electronic content portion or a second network-available electronic content having a second electronic content portion. The first network-available electronic content including at least one of an electronic document, an electronic work, an electronically-stored information, music, video, a Web document, an email, and/or an instant message. In an embodiment, the Web document may include at least one of a Web site, a Web page, a Weblog, a blog, a blog entry, and/or a web element.

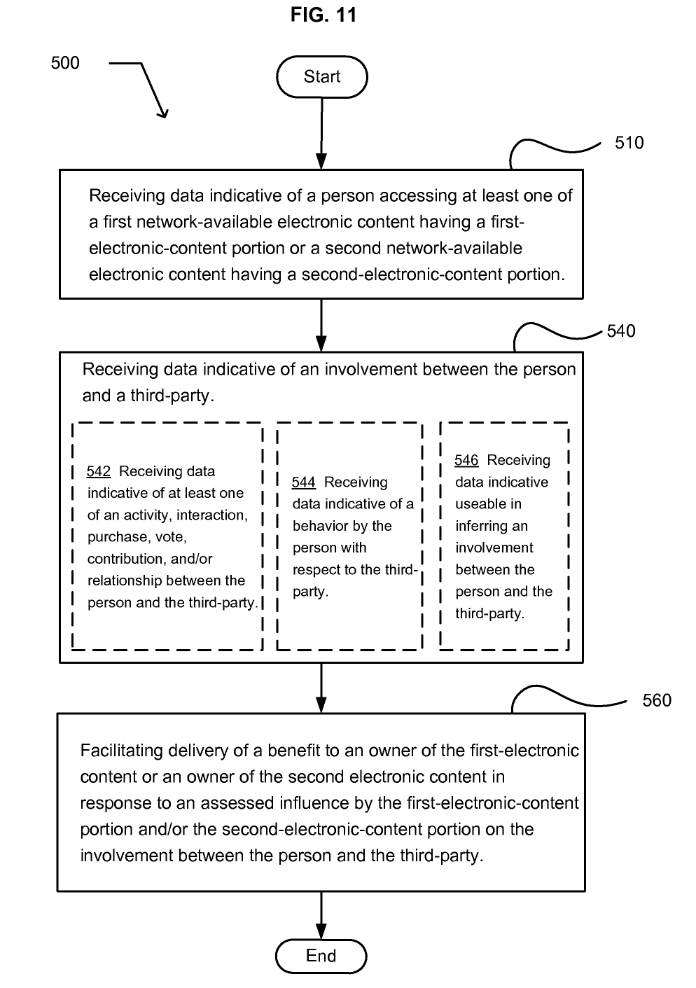

FIG. 11 illustrates an embodiment of the exemplary operational flow 500 of FIG. 5. The engagement data operation 540 may include at least one additional operation. The at least one additional operation may include an operation 542, an operation 544, and/or an operation 546. The operation 542 receives data indicative of at least one of an activity, interaction, purchase, vote, contribution, performance, and/or relationship between the person and the third party. The operation 544 receives data indicative of a behavior by the person with respect to the third party. In another embodiment, data indicative of a behavior by the person with respect to the third party includes hits, page views, visits, sessions, generating requests, viewing, time between visits, and/or impressions. The operation 546 receives data indicative useable in inferring an involvement between the person and the third party.

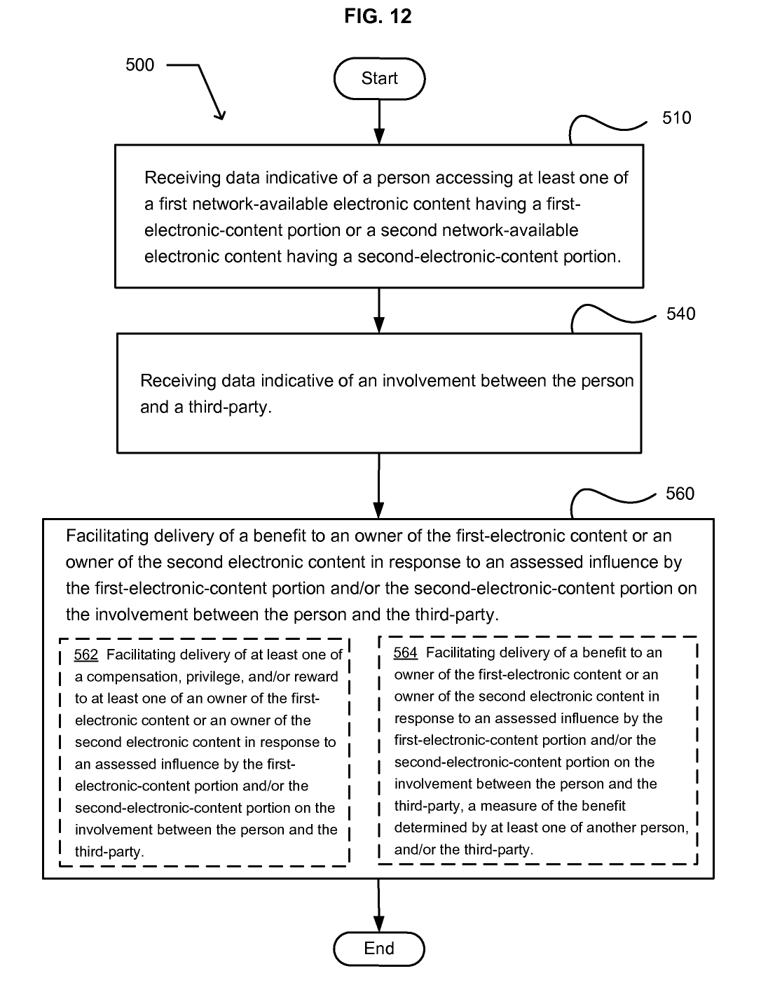

FIG. 12 illustrates another embodiment of the exemplary operational flow 500 of FIG. 5. The recognition operation 560 may include at least one additional operation. The at least one additional operation may include an operation 562, and/or an operation 564. The operation 562 facilitates delivery of at least one of a compensation, privilege, and/or reward to at least one of an owner of the first electronic content or an owner of the second electronic content in response to an assessed influence by the first electronic content portion and/or the second electronic content portion on the involvement between the person and the third party. The operation 564 facilitates delivery of a benefit to an owner of the first electronic content or an owner of the second electronic content in response to an assessed influence by the first electronic content portion and/or the second electronic content portion on the involvement between the person and the third party. A measure of the benefit is determined by at least one of another person, and/or the third party. In an embodiment, the measure of a benefit may include at least one of an amount, degree, and/or quantity.

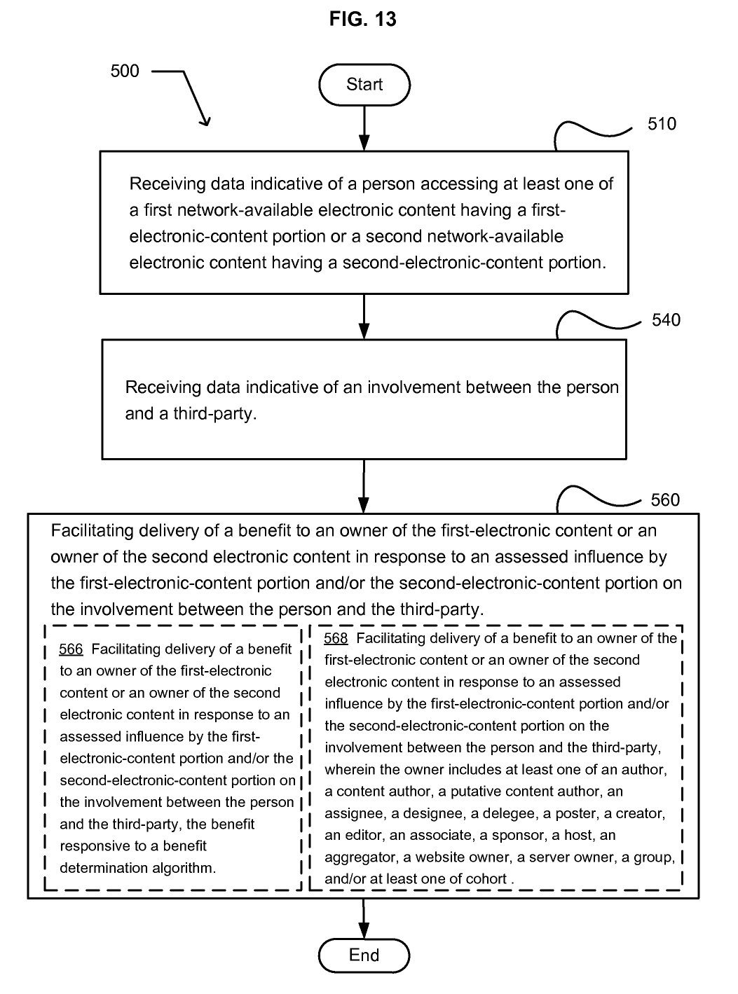

FIG. 13 illustrates a further embodiment of the exemplary operational flow 500 of FIG. 5. The recognition operation 560 may include at least one additional operation. The at least one additional operation may include an operation 566, and/or an operation 568. The operation 566 facilitates delivery of a benefit to an owner of the first electronic content or an owner of the second electronic content in response to an assessed influence by the first electronic content portion and/or the second electronic content portion on the involvement between the person and the third party, the benefit responsive to a benefit determination algorithm. In an alternative embodiment, the benefit determination algorithm includes a benefit contribution determination algorithm. The operation 568 facilitates delivery of a benefit to an owner of the first electronic content or an owner of the second electronic content in response to an assessed influence by the first electronic content portion and/or the second electronic content portion on the involvement between the person and the third party. The owner includes at least one of an author, a content author, a putative content author, an assignee, a designee, a delegee, a poster, a creator, an editor, an associate, a sponsor, a host, an aggregator, a website owner, a server owner, a group, and/or at least one of cohort. In an alternative embodiment, a cohort may include a social networking site, for example Facebook, MySpace, Classmates, YouTube, and/or Friendster.

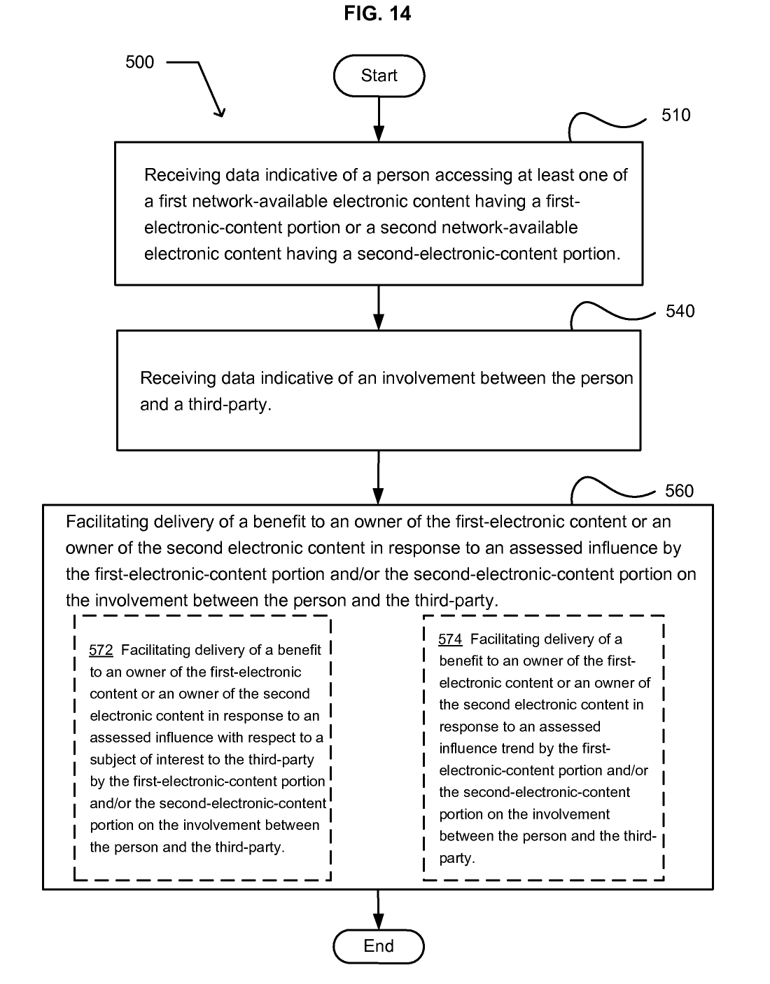

FIG. 14 illustrates an embodiment of the exemplary operational flow 500 of FIG. 5. The recognition operation 560 may include at least one additional operation. The at least one additional operation may include an operation 572, and/or an operation 574. The operation 572 facilitates delivery of a benefit to an owner of the first electronic content or an owner of the second electronic content in response to an assessed influence with respect to a subject of interest to the third party by the first electronic content portion and/or the second electronic content portion on the involvement between the person and the third party. The operation 574 facilitates delivery of a benefit to an owner of the first electronic content or an owner of the second electronic content in response to an assessed influence trend by the first electronic content portion and/or the second electronic content portion on the involvement between the person and the third party.

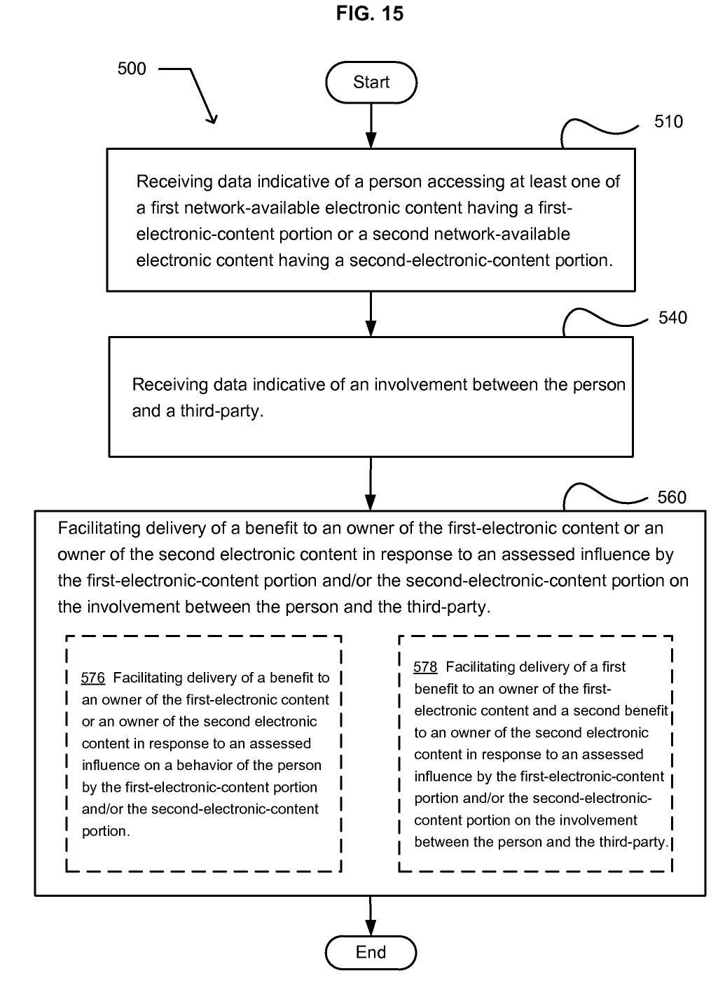

FIG. 15 illustrates another embodiment of the exemplary operational flow 500 of FIG. 5. The recognition operation 560 may include at least one additional operation. The at least one additional operation may include an operation 576, and/or an operation 578. The operation 576 facilitates delivery of a benefit to an owner of the first electronic content or an owner of the second electronic content in response to an assessed influence on a behavior of the person by the first electronic content portion and/or the second electronic content portion. In an embodiment, an assessed influence may include generalized sales figures, election votes, and/or enrollment. In another embodiment, an assessed influence may include sales figures, election votes, and/or enrollment related to the person. The operation 578 facilitates delivery of a first benefit to an owner of the first electronic content and a second benefit to an owner of the second electronic content in response to an assessed influence by the first electronic content portion and/or the second electronic content portion on the involvement between the person and the third party.

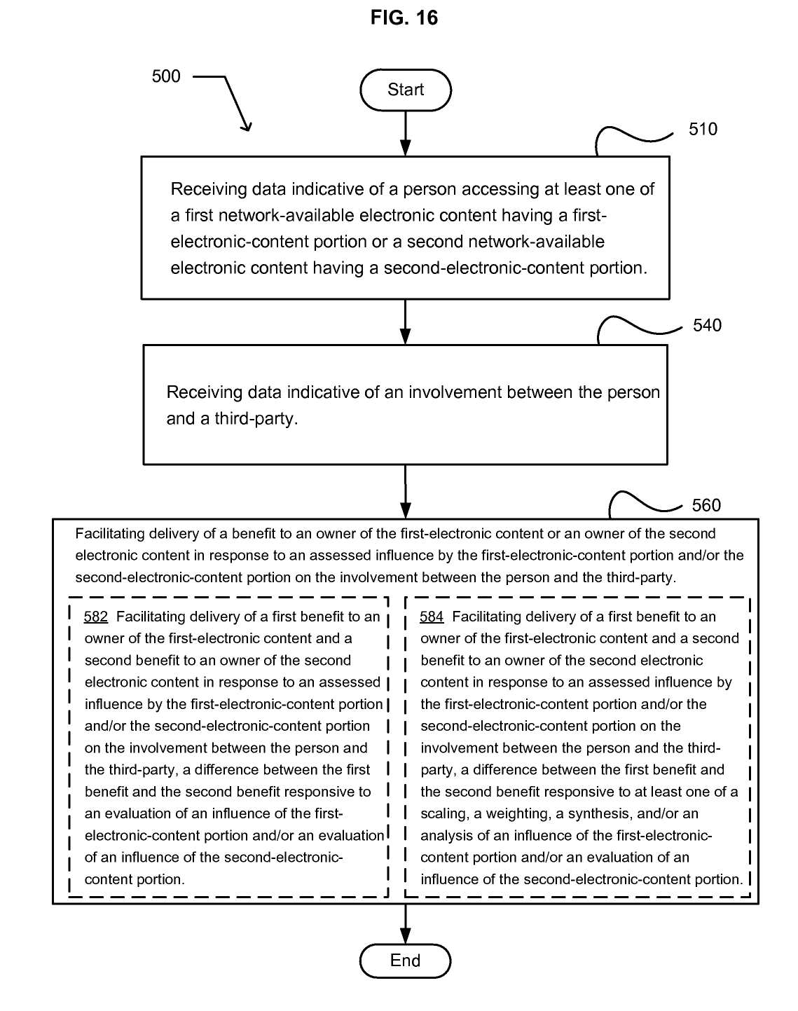

FIG. 16 illustrates a further embodiment of the exemplary operational flow 500 of FIG. 5. The recognition operation 560 may include at least one additional operation. The at least one additional operation may include an operation 582, and/or an operation 584. The operation 582 facilitates delivery of a first benefit to an owner of the first electronic content and a second benefit to an owner of the second electronic content. The first benefit and the second benefit are in response to an assessed influence by the first electronic content portion and/or the second electronic content portion on the involvement between the person and the third party. A difference between the first benefit and the second benefit being responsive to an evaluation of an influence of the first electronic content portion and/or an evaluation of an influence of the second electronic content portion. In an embodiment, the influence evaluation may include an algorithmically implemented influence evaluation. In another embodiment, the influence evaluation may include an artificial intelligence implemented influence evaluation. The operation 584 facilitates delivery of a first benefit to an owner of the first electronic content and a second benefit to an owner of the second electronic content. The first benefit and the second benefit are in response to an assessed influence by the first electronic content portion and/or the second electronic content portion on the involvement between the person and the third party. A difference between the first benefit and the second benefit is responsive to at least one of a scaling, a weighting, a synthesis, and/or an analysis of an influence of the first electronic content portion and/or an evaluation of an influence of the second electronic content portion.

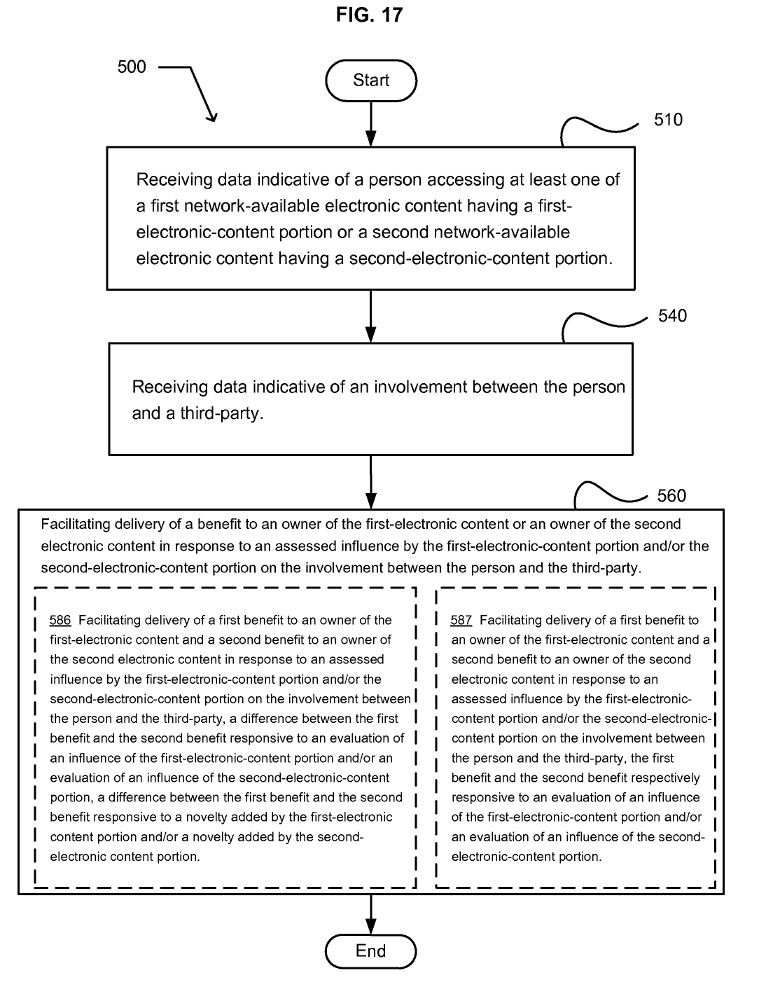

FIG. 17 illustrates a further embodiment of the exemplary operational flow 500 of FIG. 5. The recognition operation 560 may include at least one additional operation. The at least one additional operation may include an operation 586, and/or an operation 587. The operation 586 facilitates delivery of a first benefit to an owner of the first electronic content and a second benefit to an owner of the second electronic content. The first benefit and the second benefit are in response to an assessed influence by the first electronic content portion and/or the second electronic content portion on the involvement between the person and the third party. A difference between the first benefit and the second benefit is responsive to an evaluation of an influence of the first electronic content portion and/or an evaluation of an influence of the second electronic content portion, a difference between the first benefit and the second benefit responsive to a novelty added by the first electronic content portion and/or a novelty added by the second electronic content portion. The operation 587 facilitates delivery of a first benefit to an owner of the first electronic content and a second benefit to an owner of the second electronic content in response to an assessed influence by the first electronic content portion and/or the second electronic content portion on the involvement between the person and the third party. The first benefit and the second benefit respectively are responsive to an evaluation of an influence of the first electronic content portion and/or an evaluation of an influence of the second electronic content portion. In an embodiment, the first benefit and the second benefit are respectively responsive to at least one of an algorithm implemented evaluation, and/or an artificial intelligence implemented evaluation. In another embodiment, the first and second benefit are respectively responsive to at least one of at least one of a comparison, a relative allocation, a difference, and/or distribution of an influence of the first electronic content portion and/or an evaluation of an influence of the second electronic content portion.

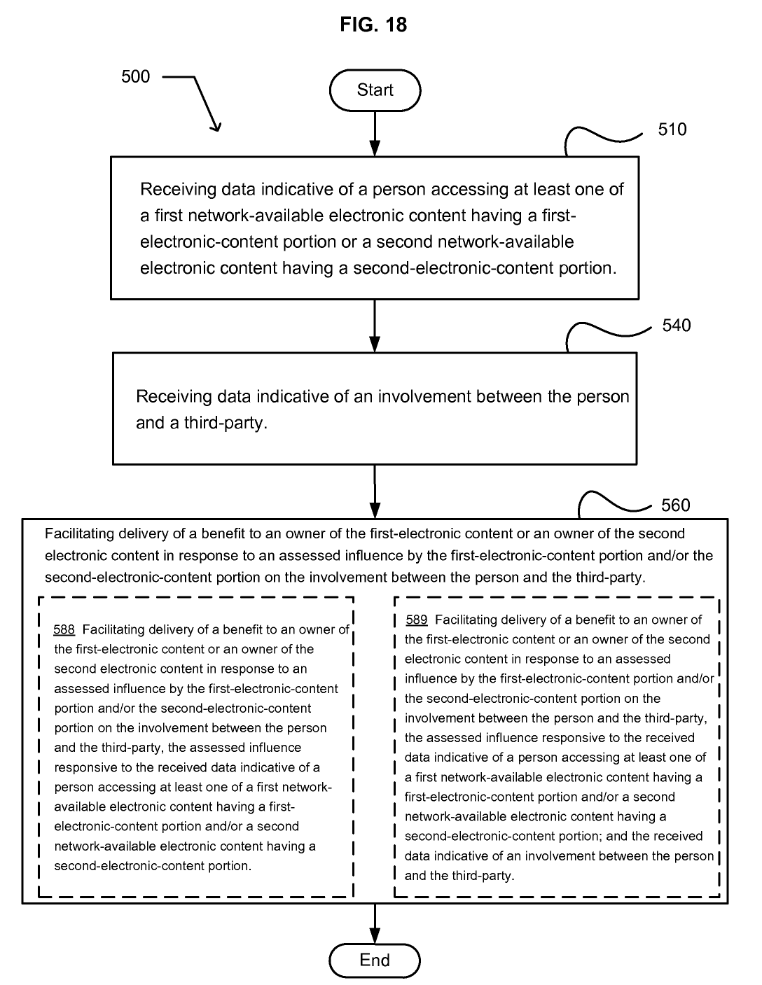

FIG. 18 illustrates a further embodiment of the exemplary operational flow 500 of FIG. 5. The recognition operation 560 may include at least one additional operation. The at least one additional operation may include an operation 588, and/or an operation 589. The operation 588 facilitates delivery of a benefit to an owner of the first electronic content or an owner of the second electronic content. The benefit is in response to an assessed influence by the first electronic content portion and/or the second electronic content portion on the involvement between the person and the third party. The assessed influence is responsive to the received data indicative of a person accessing a first network-available electronic content having a first electronic content portion and/or a second network-available electronic content having a second electronic content portion. The operation 589 facilitates delivery of a benefit to an owner of the first electronic content or an owner of the second electronic content in response to an assessed influence by the first electronic content portion and/or the second electronic content portion on the involvement between the person and the third party. The assessed influence is responsive to the received data indicative of a person accessing at least one of a first network-available electronic content having a first electronic content portion and/or a second network-available electronic content having a second electronic content portion; and the received data indicative of an involvement between the person and the third party. The assessed influence may be responsive to one or more other factors.

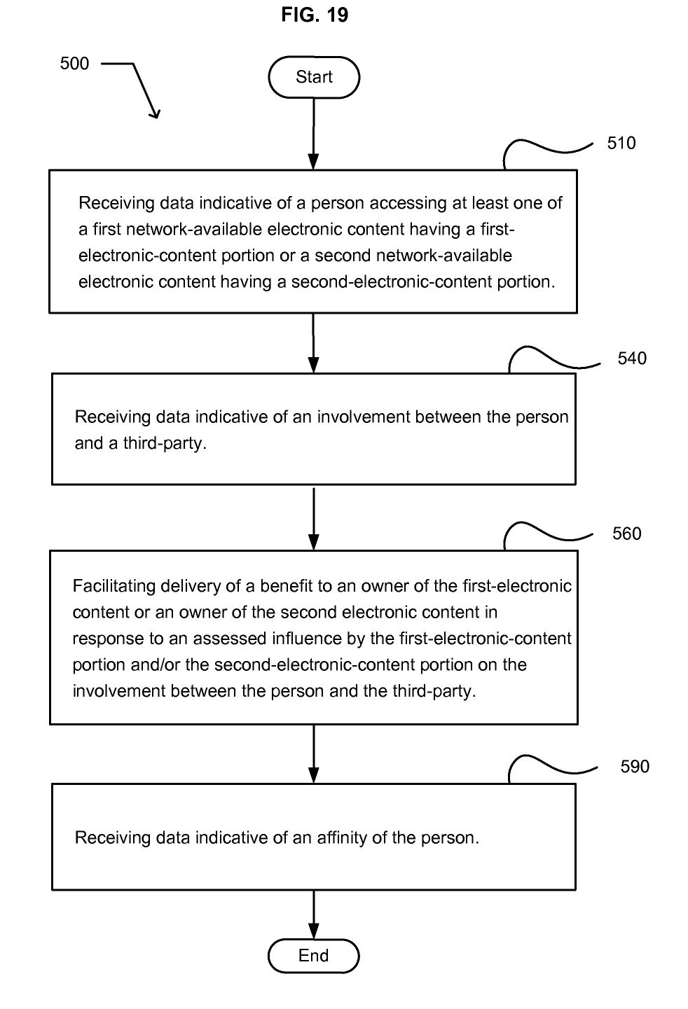

FIG. 19 illustrates an embodiment of the exemplary operational flow 500 of FIG. 5. The operational flow may include at least one additional operation, such as a kinship operation 590. The kinship operation receives data indicative of an affinity of the person. In an alternative embodiment, the data indicative of an affinity of the person is useable at the recognition operation 560 in assessing an influence by the first electronic content portion and/or the second electronic content portion on the involvement between the person and the third party.

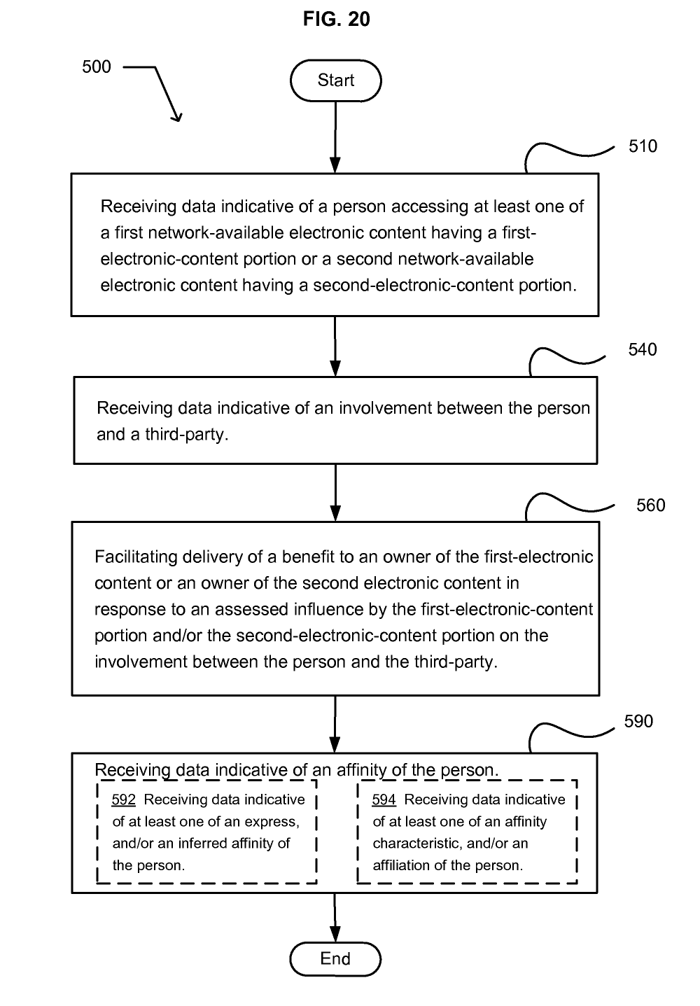

FIG. 20 illustrates an embodiment of the exemplary operational flow 500 of FIG. 5. The kinship operation 590 may include at least one additional operation. The at least one additional operation may include an operation 592 and/or an operation 594. The operation 592 receives data indicative of at least one of an express, and/or an inferred affinity of the person. The operation 594 receives data indicative of at least one of an affinity characteristic, and/or an affiliation of the person, such as the person's age category (young, middle age, senior), and/or the person's income (low income, median income, high income).

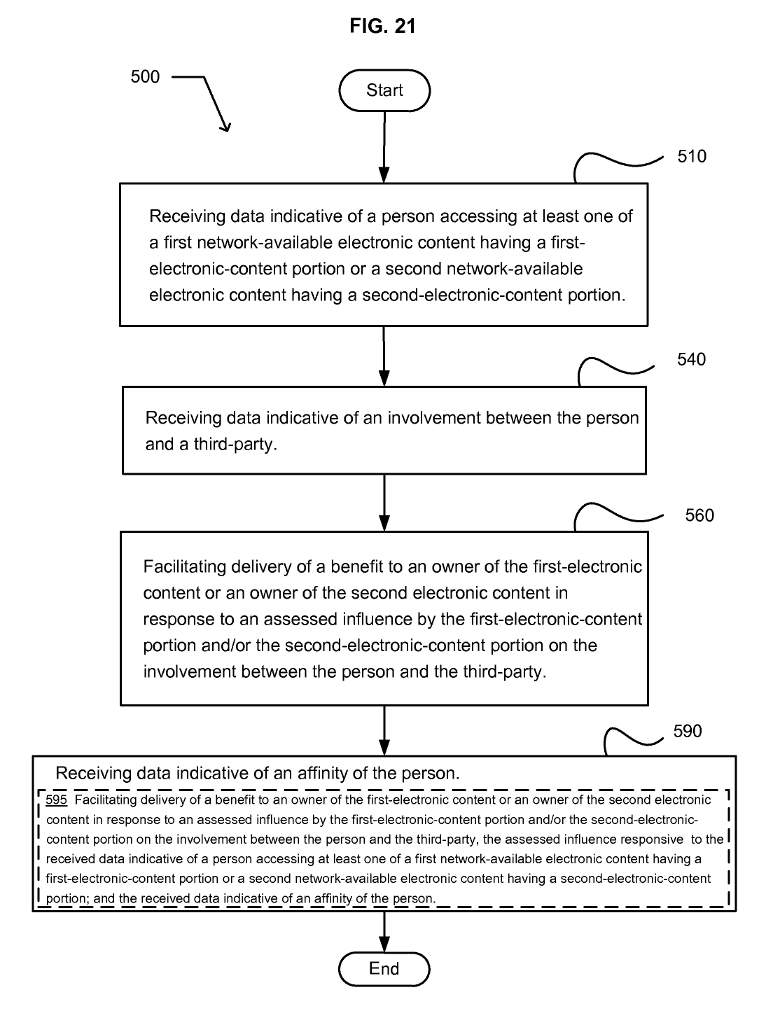

FIG. 21 illustrates another embodiment of the exemplary operational flow 500 of FIG. 5. The kinship operation 590 may include at least one additional operation, such as the operation 595. The operation 595 facilitates delivery of a benefit to an owner of the first electronic content or an owner of the second electronic content in response to an assessed influence by the first electronic content portion and/or the second electronic content portion on the involvement between the person and the third party. The assessed influence is responsive to the received data indicative of a person accessing at least one of a first network-available electronic content having a first electronic content portion or a second network-available electronic content having a second electronic content portion. The assessed influence is also responsive to the received data indicative of an affinity of the person.

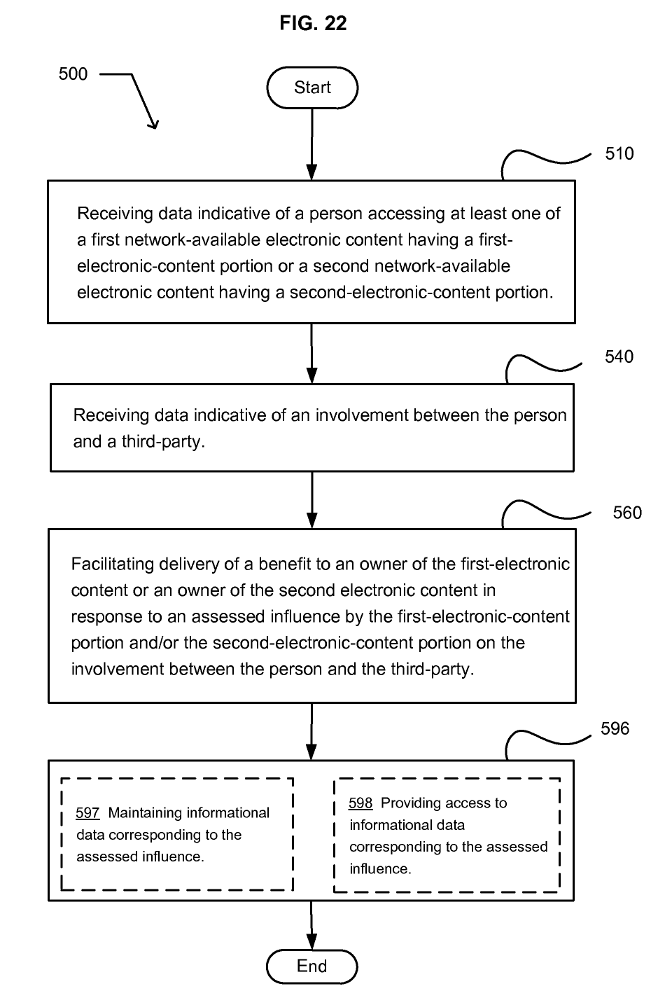

FIG. 22 illustrates a further embodiment of the exemplary operational flow 500 of FIG. 5. The operational flow 500 may include may include at least one additional operation 596. The at least one additional operation 596 may include an operation 597 and/or an operation 598. The operation 597 maintains informational data corresponding to the assessed influence. The operation 598 provides access to informational data corresponding to the assessed influence.

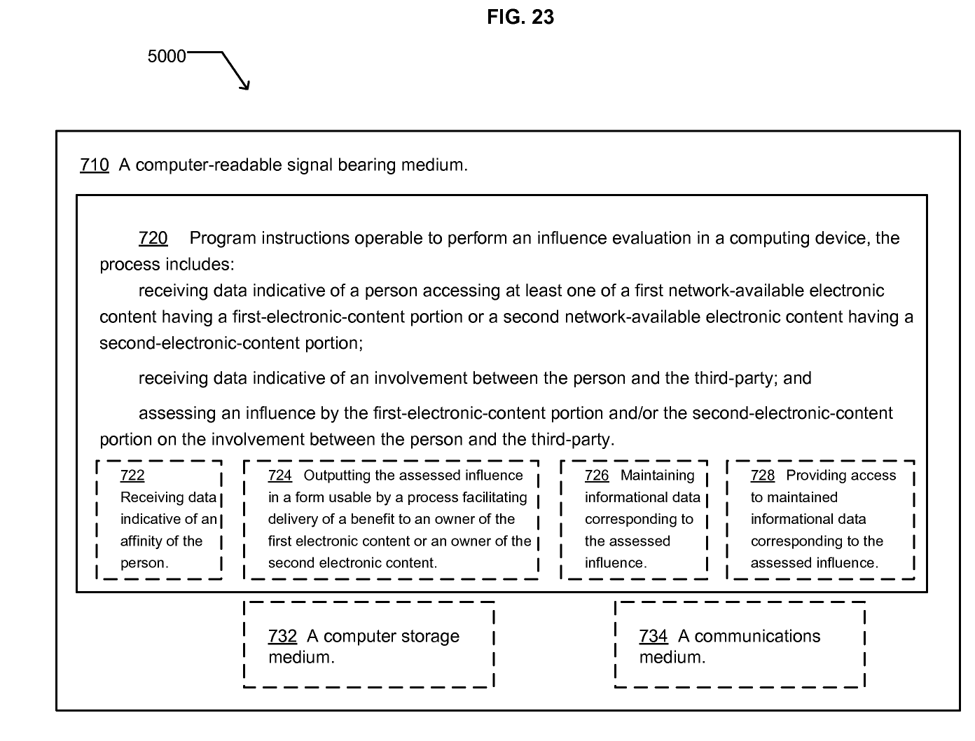

FIG. 23 illustrates an exemplary computer program product 700. The program product includes a computer-readable signal-bearing medium 710 bearing program instructions 720 operable to perform an influence evaluation process in a computing device. The process includes receiving data indicative of a person accessing at least one of a first network-available electronic content having a first electronic content portion or a second network-available electronic content having a second electronic content portion. The process also includes receiving data indicative of an involvement between the person and the third party, and assessing an influence by the first electronic content portion and/or the second electronic content portion on the involvement between the person and the third party.

In an alternative embodiment, the process of the program instructions 720 further includes receiving data indicative of an affinity of the person 722. In another embodiment, the process of the program instructions further includes outputting the assessed influence in a form usable by a process facilitating delivery of a benefit to an owner of the first electronic content or an owner of the second electronic content 724. In a further embodiment, the process of the program instructions further includes maintaining informational data corresponding to the assessed influence 726. In another embodiment, the process of the program instructions further includes providing access to maintained informational data corresponding to the assessed influence 728.

In another embodiment, the computer-readable signal-bearing medium includes computer storage medium 732. In a further embodiment, the computer-readable signal-bearing medium includes communication medium 734.

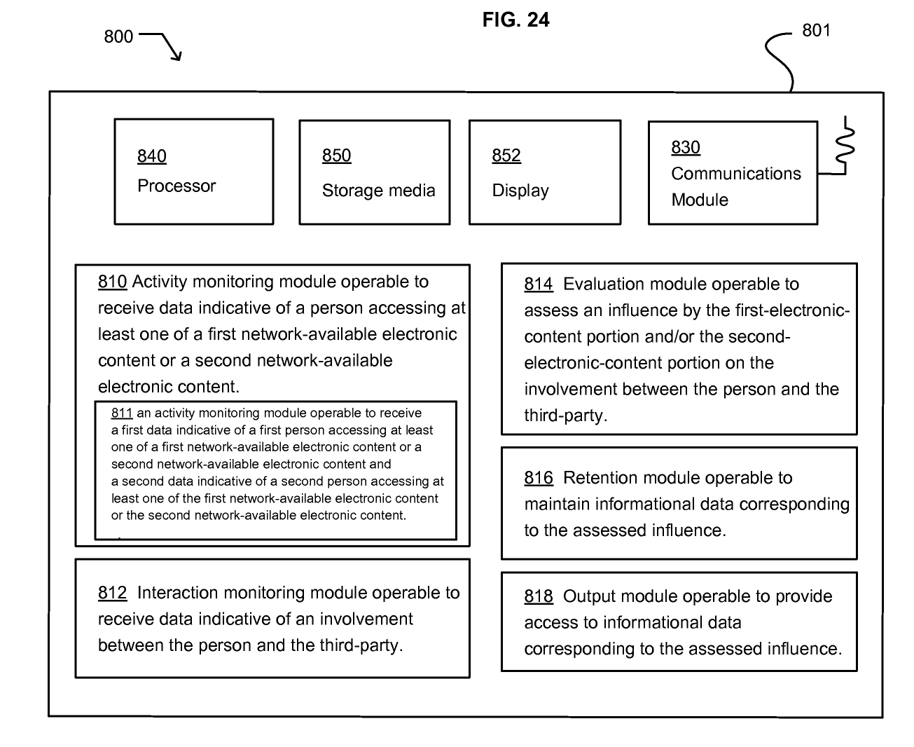

FIG. 24 illustrates an exemplary system 800. The system includes a computing device 801 operable to communicate with a network (not shown). In an embodiment, the computing device may include the computing device 20 described in conjunction with FIG. 1, and/or the computing device 110 described in conjunction with FIG. 2. Communication by the computing device with a network may be implemented using a communications module 830. The communications module may include a wired, wireless, and/or optical communication capability. The computing device also includes an activity monitoring module 810, an interaction monitoring module 812, and an evaluation module 814. The activity monitoring module is operable to receive data indicative of a person accessing at least one of a first network-available electronic content or a second network-available electronic content. The interaction monitoring module is operable to receive data indicative of an involvement between the person and the third party. The evaluation module is operable to assess an influence by the first electronic content and/or the second electronic content on the involvement between the person and the third party.

In another embodiment, the computing device 801 includes a processor 840, a storage media 850, and/or a display 852. In a further embodiment, the computing device further includes a retention module 816 operable to maintain informational data corresponding to the assessed influence. In another embodiment, the computing device further includes an output module 818 operable to provide access to informational data corresponding to the assessed influence.

In an embodiment, the computing device 801 operable to communicate with a network further includes a computing device responsive to human input, and operable to display human perceivable content and communicate with a network. In another embodiment, the computing device operable to communicate with a network includes a computing device operable to provide electronic content to a network. In a further embodiment, the computing device operable to communicate with a network further includes an intermediate computing device operable to communicate with a network.

In an embodiment, the activity monitoring module 810 further includes an activity monitoring module 811 operable to receive a first data indicative of a first person accessing at least one of a first network-available electronic content or a second network-available electronic content. The activity monitoring module is further operable to receive a second data indicative of a second person accessing at least one of the first network-available electronic content or the second network-available electronic content. In another embodiment, the interaction monitoring module 812 further includes an interaction monitoring module (not shown) operable to operable to receive data indicative of an involvement between the first person and the third party and/or the second person and the third party. In another embodiment, the evaluation module 814 further includes an evaluation module (not shown) operable to assess an influence by the first electronic content and/or the second electronic content on the involvement between the first person and the third party, and/or on the involvement between the second person and the third party.

In an embodiment, the computing device 801 operable to communicate with a network further includes a network intermediary device operable to communicate with a network. In another embodiment, the computing device operable to communicate with a network further includes a computing device under a control of the third party and operable to communicate with a network.

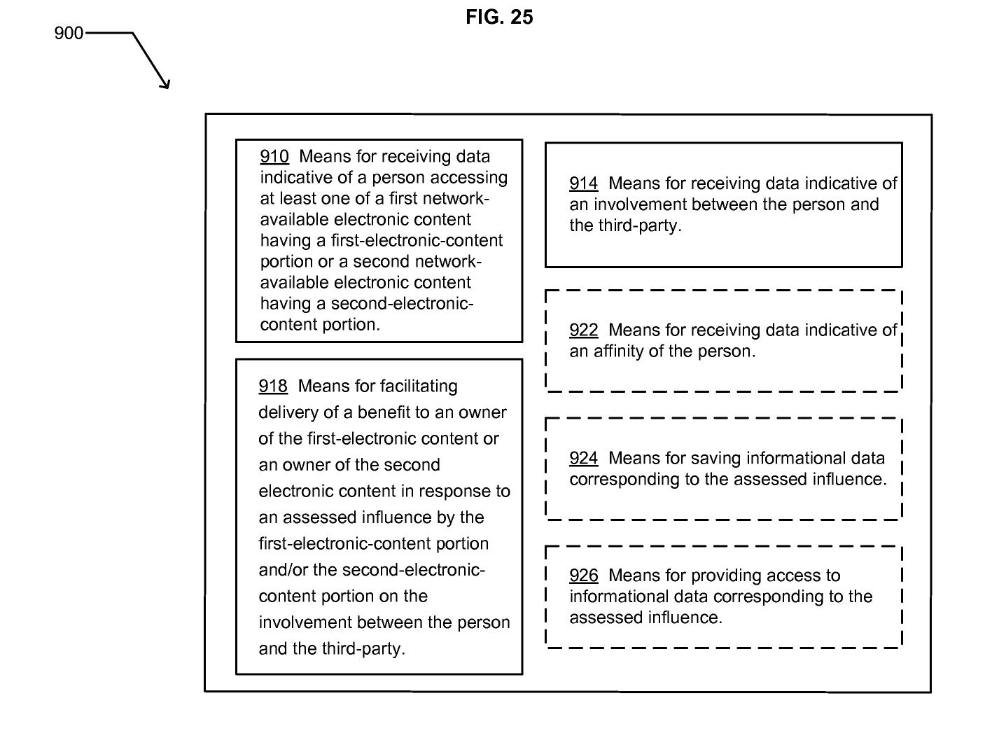

FIG. 25 illustrates a device 900. The device includes means 910 for receiving data indicative of a person accessing at least one of a first network-available electronic content having a first electronic content portion or a second network-available electronic content having a second electronic content portion. The device also includes means 914 for receiving data indicative of an involvement between the person and the third party. The device further includes means 918 for facilitating delivery of a benefit to an owner of the first electronic content or an owner of the second electronic content in response to an assessed influence by the first electronic content portion and/or the second electronic content portion on the involvement between the person and the third party.

In an embodiment, the device 900 further includes means 922 for receiving data indicative of an affinity of the person. In another embodiment, the device further includes means 924 for saving informational data corresponding to the assessed influence. In a further embodiment, the device includes means 926 for providing access to informational data corresponding to the assessed influence.

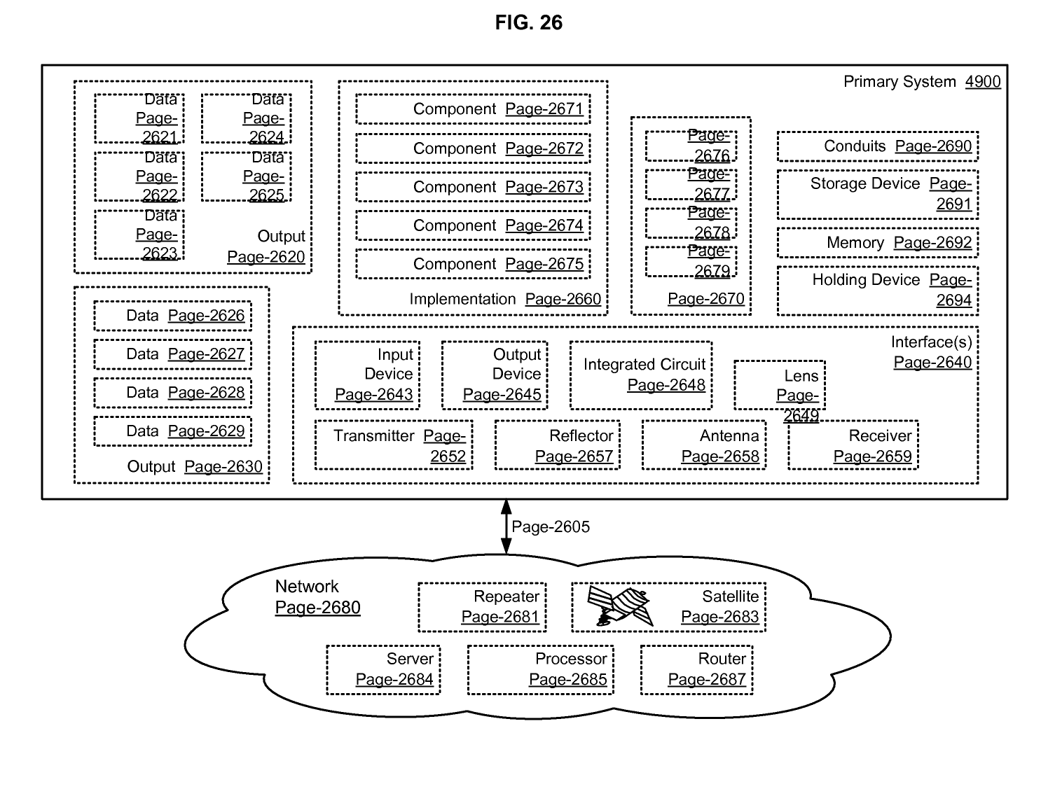

FIG. 26 illustrates an example of a system that may serve as a context for introducing one or more processes, systems or other articles. Primary system 1000 may include one or more instances of outputs 1020, 1030 or implementations 1060, 1070 that may be held or transmitted by interfaces 1040, conduits 1090, storage devices 1091, memories 1092, holding devices 1094, or the like. In various embodiments as described herein, for example, one or more instances of implementation output data 1021, 1022, 1023, 1024, 1025, 1026, 1027, 1028, 1029 or implementation components 1071, 1072, 1073, 1074, 1075, 1076, 1077, 1078, 1079 may each be expressed in any aspect or combination of software, firmware, or hardware as signals, data, designs, functional expressions, instructions, or the like. The interface(s) 1040 may include one or more instances of input devices 1043, output devices 1045, integrated circuits 1048, lenses 1049, transmitters 1052, reflectors 1057, antennas 1058, receivers 1059, or the like for handling data or communicating with local users or with network 1080 via linkage 1005, for example. Several variants of primary system 1000 are described below with reference to one or more instances of repeaters 1081, communication satellites 1083, servers 1084, processors 1085, routers 1087, or other elements of network 1080.

Those skilled in the art will recognize that some list items may also function as other list items. In the above-listed types of media, for example, some instances of interface(s) 1040 may include conduits 1090, or may also function as storage devices that are also holding devices 1094. Transmitters 1052 may likewise include input devices or bidirectional user interfaces, in many implementations of interface(s) 1040. Each such listed term should not be narrowed by any implication from other terms in the same list but should instead be understood in its broadest reasonable interpretation as understood by those skilled in the art.

Several variants described herein refer to device-detectable “implementations” such as one or more instances of computer-readable code, transistor or latch connectivity layouts or other geometric expressions of logical elements, firmware or software expressions of transfer functions implementing computational specifications, digital expressions of truth tables, or the like. Such instances can, in some implementations, include source code or other human-readable portions. Alternatively or additionally, functions of implementations described herein may constitute one or more device-detectable “implementation outputs” such as decisions, manifestations, side effects, results, coding or other expressions, displayable images, data files, data associations, statistical correlations, streaming signals, intensity levels, frequencies or other measurable attributes, packets or other encoded expressions, or the like from invoking or monitoring the implementation as described herein.

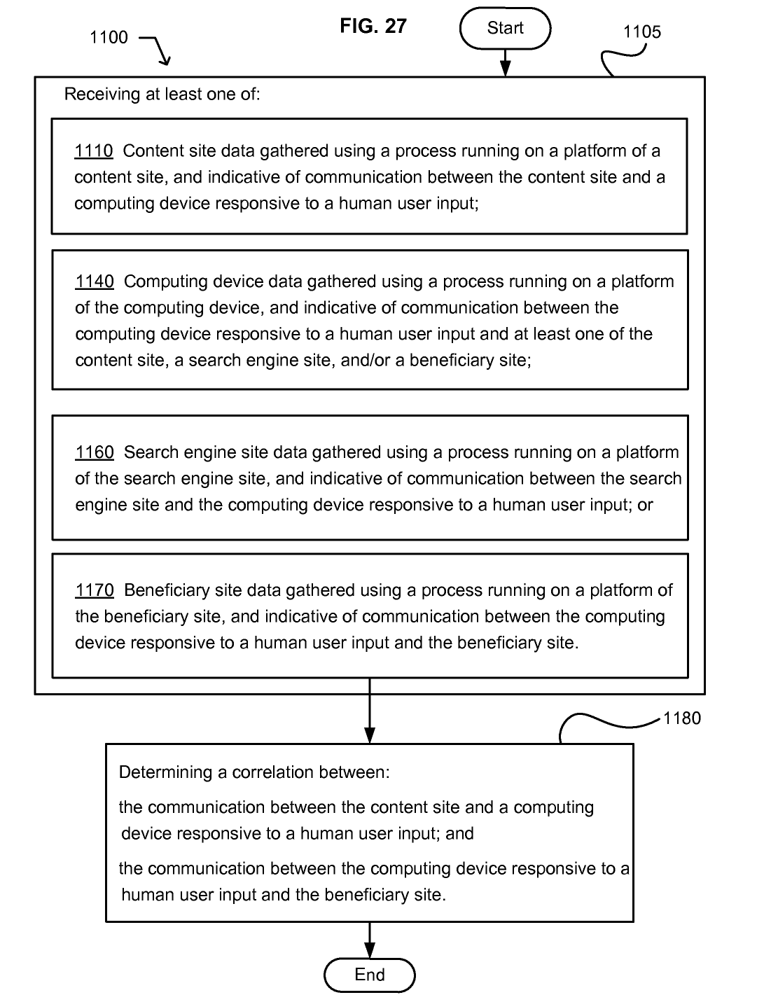

FIG. 27 illustrates an exemplary operational flow 1100. After a start operation, the operational flow moves to data gathering operation 1105. In an embodiment, the data gathering operation includes an operational flow that receives data from at least one of a content site data operation 1110, a computing device data operation 1140, a search engine site data operation 1160, or a beneficiary site data operation 1170. The receiving content site data operation includes receiving content site data gathered through a process running on a platform of a content site, and indicative of communication between the content site and a computing device responsive to a human user input. The computing device data operation includes receiving computing device data gathered through a process running on a platform of the computing device, and indicative of communication between the computing device responsive to a human user input and at least one of the content site, a search engine site, and/or a beneficiary site. In an embodiment, the beneficiary site and the content site are independent of each other. The search engine site data operation includes receiving search engine site data gathered through a process running on a platform of the search engine site, and indicative of communication between the search engine site and the computing device responsive to a human user input. The beneficiary site data operation includes receiving beneficiary site data gathered through a process running on a platform of the beneficiary site, and indicative of communication between the computing device responsive to a human user input and the beneficiary site.

In an embodiment, the data gathering operation 1105 described above includes receiving at least one class of data. This text describes the data gathering operation by using the word “or” in accord with a convention analogous to when “at least one of A, B, or C, etc.” is used. In general, such a convention is intended in the sense one having skill in the art would understand the convention—(e.g., “an operational flow receiving at least one of A, B, or C” would include but not be limited to an operational flow receiving A alone; receiving B alone; receiving C alone; receiving both A and B; receiving both A and C; receiving both B and C; receiving A, B, and C; and so on). For example, in another embodiment, the data gathering operation receives a single instance of content site data. In a further embodiment, the data gathering operation receives content site data and beneficiary site data. In another operation, the data gathering operation receives two instances of computing device data and one instance of search engine site data.

The operational flow 1100 includes an influence evaluation operation 1180. The influence evaluation operation determines a correlation between (a) the communication between the content site and a computing device responsive to a human user input and (b) the communication between the computing device responsive to a human user input and the beneficiary site. The operational flow then moves to an end operation.

In an embodiment, the exemplary operational flow 1100 may be performed at a computing device. In another embodiment, FIG. 4 may be used to illustrate an environment in which the exemplary operational flow may be implemented. For example, the exemplary operational flow may be performed by at least one of the client machine 310, a content site illustrated as the content server 320, a beneficiary site illustrated as the third party site 330, the search engine site 350, the influence determinator machine 360, the intermediary machine 370, and/or the page tag information processor 380 of FIG. 4. In yet another embodiment, at least a portion of the data may be outputted by a platform and/or an application running on the platform of the device performing the operational flow 1100. In a further embodiment, the operational flow may be performed by the content server using data outputted by the client machine and outputted by an application running on a platform of the content server. In another embodiment, the operational flow may be performed by the content server using data from both the client machine and the third party site. In a further embodiment, the operational flow may be performed by the influence determinator machine using data outputted by at least one of the client machine, the content server, the search engine site, and/or the third party site. In another embodiment, the operational flow may be performed by the search engine platform using data outputted by at least one of the client machine, the content server, and/or the third party site. In an embodiment, an instance of data may be received directly or indirectly from a machine that gathered it. For example, if the operational flow is being performed at the influence determinator machine, the computing device data 1110 may be received by the content server, which then provides the computing device data to the influence determinator machine.

In an embodiment of the operational flow 1100, the platform of the content site and the platform of the computing device include an at least substantially common platform. For example, a platform may include an operating system architecture, such as Microsoft Windows, UNIX, LINUX, Solaris, and/or Mac OS X. By way further example, a platform may include an application and/or a family of applications. A family of applications may include Word, Excel, Outlook, Internet Explorer, Live Search, and/or Visio. Another family of applications may include the Google search engine, Gmail, Google Calendar, and/or Google Docs & Spreadsheets. A further family of applications may include a general family of applications, and/or a specialized family of applications. In another example, a platform may include a hardware platform. In a further example, a hardware platform may include a gaming platform and/or a particular chip architecture. In another example, a hardware platform may include a platform of combination of a switch, a router, and/or a sniffer.

In another embodiment of the operational flow 1100, the platform of the content site and the platform of the computing device include an at least substantially common platform. In a further embodiment, the platform of the content site and the platform of the computing device include an at least substantially common platform family.

In an embodiment of the operational flow 1100, the platform of the content site and the platform of the search engine site include an at least substantially common platform. In another embodiment, the platform of the content site and the platform of the search engine site include an at least substantially common platform family. In a further embodiment, the platform of the content site and the platform of the beneficiary site include an at least substantially common platform. In another embodiment, the platform of the content site and the platform of the beneficiary site include an at least substantially common platform family. In a further embodiment, the platform of the computing device and the platform of the search engine site include an at least substantially common platform. In another embodiment, the platform of the computing device and the platform of the search engine site include an at least substantially common platform family. In a further embodiment, the platform of the computing device and the platform of the beneficiary site include an at least substantially common platform.

In an embodiment of the operational flow 1100, the platform of the computing device and the platform of the beneficiary site include an at least substantially common platform family. In another embodiment, the platform of the search engine site and the platform of the beneficiary site include an at least substantially common platform. In a further embodiment, the platform of the search engine site and the platform of the beneficiary site include an at least substantially common platform family. In another embodiment, the process running on a platform of the content site and the process running on a platform of the computing device include an at least substantially common process. In a further embodiment, the process running on a platform of the content site and the process running on a platform of the computing device include at least substantially coordinating processes. In another embodiment, the process running on a platform of the content site and the process running on a platform of the search engine site include an at least substantially common process. In a further embodiment, the process running on a platform of the content site and the process running on a platform of the search engine site include at least substantially coordinating processes. In another embodiment, the process running on a platform of the content site and the process running on a platform of the beneficiary site include an at least substantially common process.

In an embodiment of the operational flow 1100, the process running on a platform of the content site and the process running on a platform of the beneficiary site include at least substantially coordinating processes. In another embodiment, the process running on a platform of the computing device and the process running on a platform of the search engine site include an at least substantially common process. In a further embodiment, the process running on a platform of the computing device and the process running on a platform of the search engine site include at least substantially coordinating processes. In another embodiment, the process running on a platform of the computing device and the process running on a platform of the beneficiary site include an at least substantially common process. In a further embodiment, the process running on a platform of the computing device and the process running on a platform of the beneficiary site include at least substantially coordinating processes.

In an embodiment of the operational flow 1100, the process running on a platform of the search engine site and the process running on a platform of the beneficiary site include an at least substantially common process. In another embodiment, the process running on a platform of the search engine site and the process running on a platform of the beneficiary site include at least substantially coordinating processes.

Referring now also to the context of FIG. 26, in some embodiments, flow 1100 may be performed by one or more instances of server 1084 remote from primary system 1000 but operable to cause output device(s) 1045 to receive and present results via linkage 1005. Alternatively or additionally, any included instances of device-detectable data 1021-1025 may be borne by one or more conduits 1090, holding devices 1094, integrated circuits 1048, or the like as described herein. Such data may optionally be configured for transmission by a semiconductor chip or other embodiment of integrated circuit 1048 that contains or is otherwise operatively coupled with one or more antennas 1058 (in a radio-frequency identification tag, for example).

In some variants, flow 1100 may be implemented entirely within primary system 1000, optionally as a stand-alone system. Operation 1105 may be implemented by configuring component 1071 as logic for receiving content site data gathered through a process running on a platform of a content site, and indicative of communication between the content site and a computing device responsive to a human user input, for example, such as by including special-purpose instruction sequences or special-purpose-circuit designs for this function. Output data 1021 from such a component in primary system 1000 or network 1080 may be recorded by configuring available portions of storage device(s) 1091. Alternatively or additionally, such specific output data may be transmitted by configuring transistors, relays, or other conduits 1090 of primary system 1000 to transfer it to component 1075, for example.

Alternatively or additionally, one or more instances of component 1072 may perform operation 1105 via implementation as logic for receiving computing device data gathered through a process running on a platform of the computing device, and indicative of communication between the computing device responsive to a human user input and at least one of the content site, a search engine site, and/or a beneficiary site, for example. Implementation output data 1022 from such a component in primary system 1000 or network 1080 may be sent in some form to component 1075, for example.

Alternatively or additionally, one or more instances of component 1073 may perform operation 1105 via implementation as logic for receiving beneficiary site data gathered through a process running on a platform of the beneficiary site, and indicative of communication between the computing device responsive to a human user input and the beneficiary site, for example. Implementation output data 1023 from such a component in primary system 1000 or network 1080 may be routed to component 1075, for example.

Alternatively or additionally, one or more instances of component 1074 may perform operation 1105 via implementation as logic for receiving search engine site data gathered through a process running on a platform of the search engine site, and indicative of communication between the search engine site and the computing device responsive to a human user input, for example. Implementation output data 1024 from such a component in primary system 1000 or network 1080 may be routed (directly or indirectly) to component 1075, for example.

At some time after such data is received as described above to one or more of whichever components 1071-1074 may have been included in implementation 1060, one or more instances of component 1075 may act upon it. In some variants, one or more of optional components 1071-1074 may be omitted or ignored, for example, even in a context in which an included one or more of components 1071-1074 can respectively detect one or more of items 1110, 1140, 1160, 1170. Component 1075 may respond by performing operation 1180, for example, if configured as logic for determining a correlation between (a) the communication between the content site and the computing device responsive to a human user input; and (b) the communication between the computing device responsive to a human user input and the beneficiary site. Output 1020 from flow 1100 may (optionally) include other implementation output data 1021-1025 as described herein. Such output 1020 may, for example, be processed as described herein, recorded into available portions of storage device(s) 1091, or routed (directly or indirectly) through linkage 1005. Each portion of implementation 1060 may likewise include one or more instances of software, hardware, or the like implementing logic that may be expressed in several respective forms as described herein or otherwise understood by those skilled in the art.

Referring again now to FIG. 5, also in reference to the context of FIG. 26, some instance of flow 500 may likewise be implemented entirely within primary system 1000 in some variants. Operation 510 may be implemented by configuring component 1076 as logic for receiving data indicative of a person accessing at least one of a first network-available electronic content having a first electronic content portion or a second network-available electronic content having a second electronic content portion, for example, such as by including special-purpose instruction sequences or special-purpose-circuit designs for this function. Output data 1026 from such a component in primary system 1000 or network 1080 may be recorded into available portions of storage device(s) 1091 or sent to component 1078, for example. Component 1077 may perform operation 540 via implementation as logic for receiving data indicative of an involvement between the person and a third party, for example. Implementation output data 1027 from such a component in primary system 1000 or network 1080 may be recorded into available portions of storage device(s) 1091 or sent to component 1078, for example. Component 1077 may perform operation 560 via implementation as logic for facilitating delivery of a benefit to an owner of the first electronic content or an owner of the second electronic content in response to an assessed influence by the first electronic content portion and/or the second electronic content portion on the involvement between the person and the third party. Output 1030 from flow 500 may likewise include other data 1028, 1029 as described herein. Each portion of implementation 1060 may likewise include one or more instances of software, circuitry, or the like implementing logic that may be expressed in several respective forms as described herein or otherwise understood by those skilled in the art.

In some embodiments, output device 1045 may indicate an occurrence of flow 1100 concisely as a decision, an evaluation, an effect, an hypothesis, a probability, a notification, or some other useful technical result. For example, such “indicating” may comprise such modes as showing, signifying, acknowledging, updating, explaining, associating, or the like in relation to any past or ongoing performance of such actions upon the common item(s) as recited. Such indicating may also indicate one or more specifics about the occurrence: the parties or device(s) involved, a description of the method or performance modes used, any sequencing or other temporal aspects involved, indications of resources used, location(s) of the occurrence, implementation version indications or other update-indicative information, or any other such contextual information that may be worthwhile to provide at potential output destinations.

Concise indication may occur, for example, in a context in which at least some items of data 1021-1029 are unavailable or unimportant, or in which a recipient may understand or access portions of data 1021-1029 without receiving a preemptive explanation of how it was obtained. By distilling output 1020 at an “upstream” stage (which may comprise integrated circuit 1048, for example, in some arrangements), downstream-stage media (such as other elements of network 1080, for example) may indicate occurrences of various methods described herein more effectively. Variants of flow 1100, for example, may be enhanced by distillations described herein, especially in bandwidth-limited transmissions, security-encoded messages, long-distance transmissions, complex images, or compositions of matter bearing other such expressions.

In some variants, a local implementation comprises a service operable for accessing a remote system running a remote implementation. In some embodiments, such “accessing” may include one or more instances of establishing or permitting an interaction between the server and a local embodiment such that the local embodiment causes or uses another implementation or output of one or more herein-described functions at the server. Functioning as a web browser, remote terminal session, or other remote activation or control device, for example, interface(s) 1040 may interact with one or more primary system users via input and output devices 1043, 1045 so as to manifest an implementation in primary system 1000 via an interaction with server 1084, for example, running a secondary implementation of flow 1100. Such local implementations may comprise a visual display supporting a local internet service to the remote server, for example. Such a remote server may control or otherwise enable one or more instances of hardware or software operating the secondary implementation outside a system, network, or physical proximity of primary system 1000. For a building implementing primary system 1000, for example, “remote” devices may include those in other countries, in orbit, or in adjacent buildings. In some embodiments, “running an implementation” may include invoking one or more instances of software, hardware, firmware, or the like atypically constituted or adapted to facilitate methods or functions as described herein. For example, primary system 1000 running an implementation of flow 1100 may be a remote activation of a special-purpose computer program resident on server 1084 via an internet browser session interaction through linkage 1005, mediated by input device 1043 and output device 1045.

In some variants, some or all of components 1071-1079 may be borne in various data-handling elements—e.g., in one or more instances of storage devices 1091, in memories 1092 or volatile media, passing through linkage 1005 with network 1080 or other conduits 1090, in one or more registers or data-holding devices 1094, or the like. For example, such processing or configuration may occur in response to user data or the like received at input device 1043 or may be presented at output device 1045. Instances of input devices 1043 may (optionally) include one or more instances of cameras or other optical devices, hand-held systems or other portable systems, keypads, sensors, or the like as described herein. Output device(s) 1045 may likewise include one or more instances of image projection modules, touch screens, wrist-wearable systems or the like adapted to be worn while in use, headphones and speakers, eyewear, liquid crystal displays (LCDs), actuators, lasers, organic or other light-emitting diodes, phosphorescent elements, portions of (hybrid) input devices 1043, or the like.

A device-detectable implementation of variants described herein with reference to flow 1100, for example, may be divided into several components 1071-1079 carried by one or more instances of active modules such as signal repeaters 1081, communication satellites 1083, servers 1084, processors 1085, routers 1087, or the like. For example, in some embodiments, component 1072 may be borne by an “upstream” module (e.g., repeater 1081 or the like) while or after component 1071 is borne in a “downstream” module (e.g., another instance of repeater 1081, communication satellite 1083, server 1084, or the like). Such downstream modules may “accept” such bits or other portions of implementation 1060 or implementation 1070 sequentially, for example, such as by amplifying, relaying, storing, checking, or otherwise processing what was received actively. Sensors and other “upstream” modules may likewise “accept” raw data, such as by measuring physical phenomena or accessing one or more databases.

In some embodiments, a medium bearing data (or other such event) may be “caused” (directly or indirectly) by one or more instances of prior or contemporaneous measurements, decisions, transitions, circumstances, or other causal determinants. Any such event may likewise depend upon one or more other prior, contemporaneous, or potential determinants, in various implementations as taught herein. In other words, such events may occur “in response” to both preparatory (earlier) events and triggering (contemporaneous) events in some contexts. Output 1020 may result from more than one component of implementations 1060, 1070 or more than one operation of flow 1100, for example.

In some embodiments, such integrated circuits 1048 may comprise transistors, capacitors, amplifiers, latches, converters, or the like on a common substrate of a semiconductor material, operable to perform computational tasks or other transformations. An integrated circuit may be application-specific (“ASIC”) in that it is designed for a particular use rather than for general purpose use. An integrated circuit may likewise include one or more instances of memory circuits, processors, field-programmable gate arrays (FPGA's), antennas, or other components, and may be referred to as a system-on-a-chip (“SoC”).

In some embodiments, one or more instances of integrated circuits or other processors may be configured to perform auditory pattern recognition. In FIG. 26, for example, instances of the one or more input devices 1043 may include a microphone or the like operable to provide auditory samples in data 1021-1029. Some form or portion of such output may be provided remotely, for example, to one or more instances of neural networks or other configurations of remote processors 1085 operable to perform automatic or supervised speech recognition, selective auditory data retention or transmission, or other auditory pattern recognition, upon the samples. Alternatively or additionally such sound-related data may include annotative information relating thereto such as a capture time or other temporal indications, capture location or other source information, language or other content indications, decibels or other measured quantities, pointers to related data items or other associative indications, or other data aggregations or distillations as described herein.

In some embodiments, one or more instances of integrated circuits or other processors may be configured for optical image pattern recognition. In FIG. 26, for example, instances of lenses 1049 or other input devices 1043 may include optical sensors or the like operable to provide one or more of geometric, hue, or optical intensity information in data 1021-1029. Some form or portion of such output may be provided locally, for example, to one or more instances of optical character recognition software, pattern recognition processing resources, or other configurations of integrated circuits 1048 operable to perform automatic or supervised image recognition, selective optical data retention or transmission, or the like. Alternatively or additionally such image-related data may include annotative information relating thereto such as a capture time or other temporal indications, capture location or other source information, language or other content indications, pointers to related data items or other associative indications, or other data aggregations or distillations as described herein.

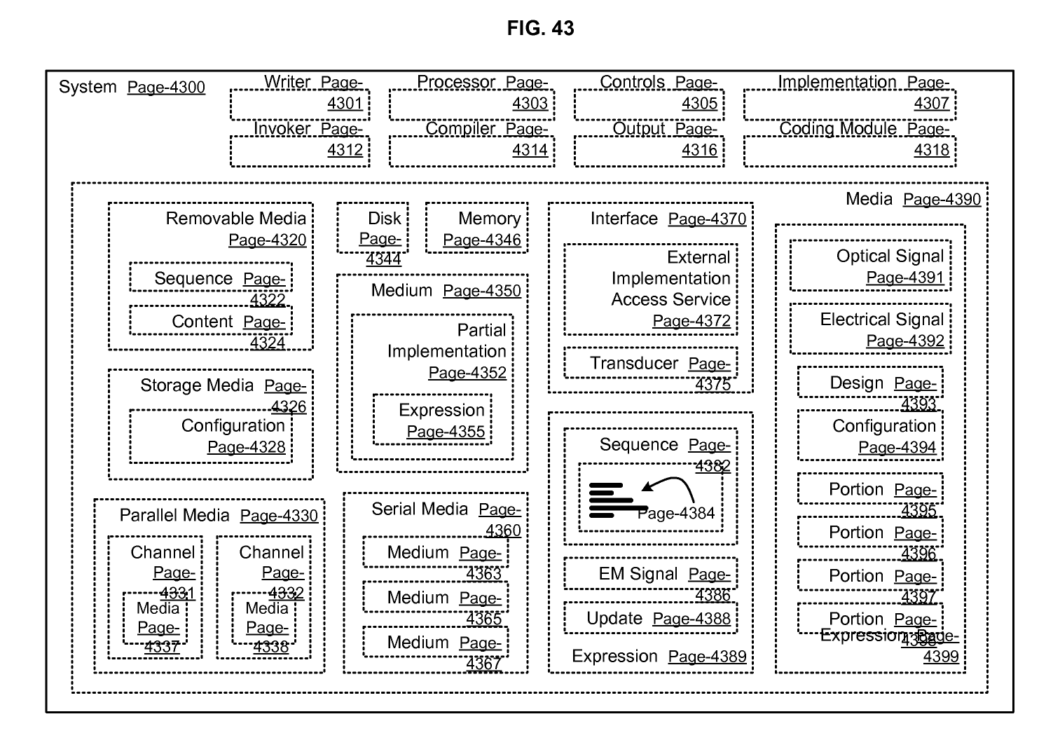

In some embodiments, one or more instances of integrated circuits or other processors may be configured to perform linguistic pattern recognition. In FIG. 43, for example, instances of input devices 1043 may include keys, pointing devices, microphones, sensors, reference data, or the like operable to provide spoken, written, or other symbolic expressions in data 1021-1029. Some form or portion of such output may be provided locally, for example, to one or more instances of translation utilities, compilers, or other configurations of integrated circuits 1048 operable to perform automatic or supervised programming or other language recognition, selective linguistic data retention or transmission, or the like. Alternatively or additionally such language-related data may include annotative information relating thereto such as a capture time or other temporal indications, capture location or other source information, language or other content indications, pointers to related data items or other associative indications, or other data classifications, aggregations, or distillations as described herein.

In some embodiments, antennas 1058 or receivers 1059 may include a device that is the receiving end of a communication channel as described herein. For example, such a receiver may gather a signal from a dedicated conduit or from the environment for subsequent processing and/or retransmission. As a further example, such antennas or other receivers may include one or more instances of wireless antennas, radio antennas, satellite antennas, broadband receivers, digital subscriber line (DSL) receivers, modem receivers, transceivers, or configurations of two or more such devices for data reception as described herein or otherwise known.

In one variant, two or more respective portions of output data 1021-1029 may be sent from server 1084 through respective channels at various times, one portion passing through repeater 1081 and another through router 1087. Such channels may each bear a respective portion of a data aggregation or extraction, a publication, a comparative analysis or decision, a record selection, digital subscriber content, statistics or other research information, a resource status or potential allocation, an evaluation, an opportunity indication, a test or computational result, or another output 1020, 1030 of interest. Such distributed media may be implemented as an expedient or efficient mode of bearing such portions of output data to a common destination such as interface 1040 or holding device 1094. Alternatively or additionally, some such data may be transported by moving a medium (carried on storage device 1091, for example) so that only a small portion (a purchase or other access authorization, for example, or a contingent or supplemental module) is transferred via linkage 1005.

In some embodiments, one or more instances of signal repeaters 1081 may include a device or functional implementation that receives a signal and transmits some or all of the signal with one or more of an altered strength or frequency, or with other modulation (e.g., an optical-electrical-optical amplification device, a radio signal amplifier or format converter, a wireless signal amplifier, or the like). A repeater may convert analog to digital signals or digital to analog signals, for example, or perform no conversion. Alternatively or additionally, a repeater may reshape, retime or otherwise reorder an output for transmission. A repeater may likewise introduce a frequency offset to an output signal such that the received and transmitted frequencies are different. A repeater also may include one or more instances of a relay, a translator, a transponder, a transceiver, an active hub, a booster, a noise-attenuating filter, or the like.

In some embodiments, such communication satellite(s) 1083 may be configured to facilitate telecommunications while in a geosynchronous orbit, a Molniya orbit, a low earth orbit, or the like. Alternatively or additionally, a communication satellite may receive or transmit, for example, telephony signals, television signals, radio signals, broadband telecommunications signals, or the like.

In some variants, processor 1085 or any components 1071-1079 of implementations 1060, 1070 may (optionally) be configured to perform flow variants as described herein with reference to any of FIGS. 6-22. An occurrence of such a variant can be expressed as a computation, a transition, or as any other items of data 1021-1029 described herein, for example. Such output 1020, 1030 can be generated, for example, by depicted components of primary system 1000 or network 1080 including one or more features as described with reference to any of FIG. 1-4, 23, 24, or 41.

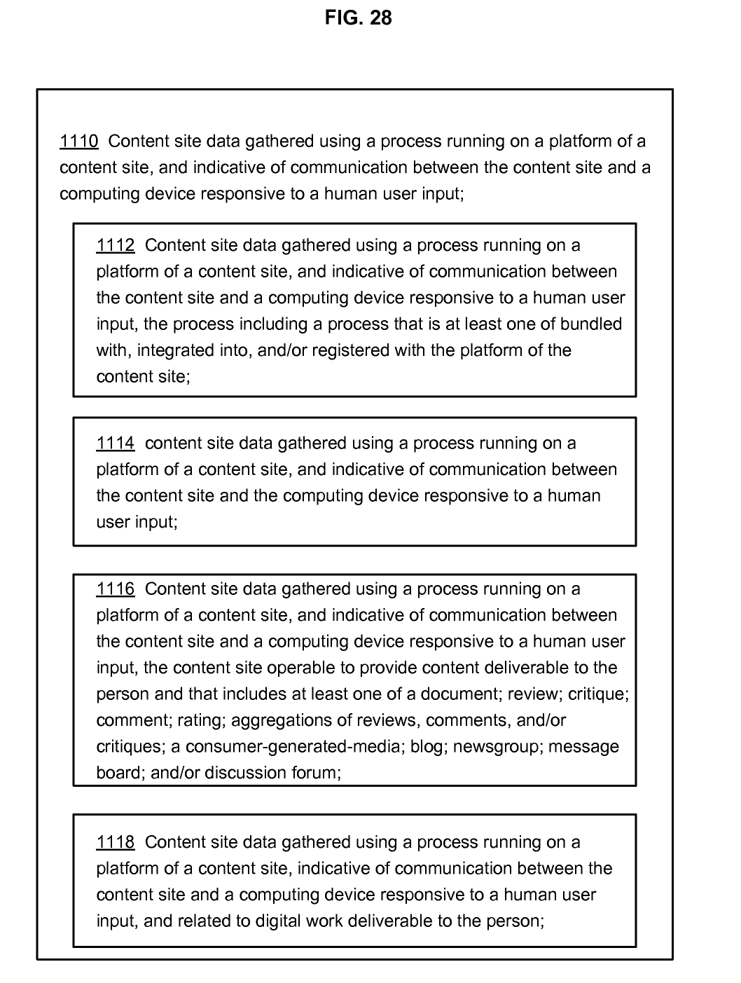

FIG. 28 illustrates an alternative embodiment of the exemplary operational flow 1100 of FIG. 27. The receiving content site data operation 1110 may include at least one additional operation. The at least one additional operation may include an operation 1112, an operation 1114, an operation 1116, and/or an operation 1118. At the operation 1112, the receiving content site data operation includes receiving content site data gathered through a process running on a platform of a content site. The content site data is indicative of communication between the content site and a computing device responsive to a human user input. The process includes a process that is at least one of bundled with, integrated into, and/or registered with the platform of the content site. At the operation 1114, the receiving content site data operation includes receiving content site data gathered through a process running on a platform of a content site. The content site data is indicative of communication between the content site and the computing device responsive to a human user input. At the operation 1116, the receiving content site data operation includes receiving content site data gathered through a process running on a platform of a content site. The content site data is indicative of communication between the content site and a computing device responsive to a human user input. The content site is operable to provide content deliverable to the person. The deliverable content including at least one of a: document; review; critique; comment; rating; aggregations of reviews, comments, and/or critiques; consumer-generated-media; blog; newsgroup; message board; and/or discussion forum. At the operation 1118, the receiving content site data operation includes receiving content site data gathered through a process running on a platform of a content site. The content data is indicative of communication between the content site and a computing device responsive to a human user input, and related to digital work deliverable to the person.

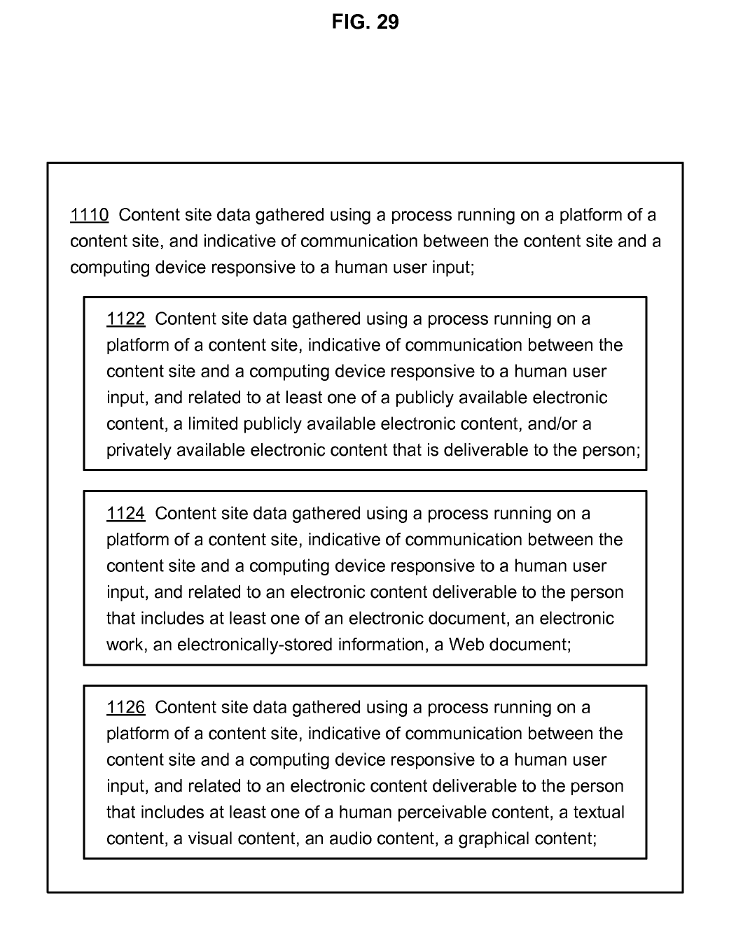

FIG. 29 illustrates another alternative embodiment of the exemplary operational flow 1100 of FIG. 27. The receiving content site data operation 1110 may include at least one additional operation. The at least one additional operation may include an operation 1122, an operation 1124, and/or an operation 1126. At the operation 1122, the receiving content site data operation includes receiving content site data gathered through a process running on a platform of a content site. The content site data is indicative of communication between the content site and a computing device responsive to a human user input, and related to at least one of a publicly available electronic content, a limited publicly available electronic content, and/or a privately available electronic content that is deliverable to the person. At the operation 1124, the receiving content site data operation includes receiving content site data gathered through a process running on a platform of a content site. The content site data is indicative of communication between the content site and a computing device responsive to a human user input, and related to an electronic content deliverable to the person that includes at least one of an electronic document, an electronic work, an electronically-stored information, a Web document an email, and/or an instant message. In another embodiment, the Web document includes a Web site content, a Web page, a Weblog, and/or a blog. At the operation 1126, the receiving content site data operation includes receiving content site data gathered through a process running on a platform of a content site. The content site data indicative of communication between the content site and a computing device responsive to a human user input, and related to an electronic content deliverable to the person that includes at least one of a human perceivable content, a textual content, a visual content, an audio content, and/or a graphical content.

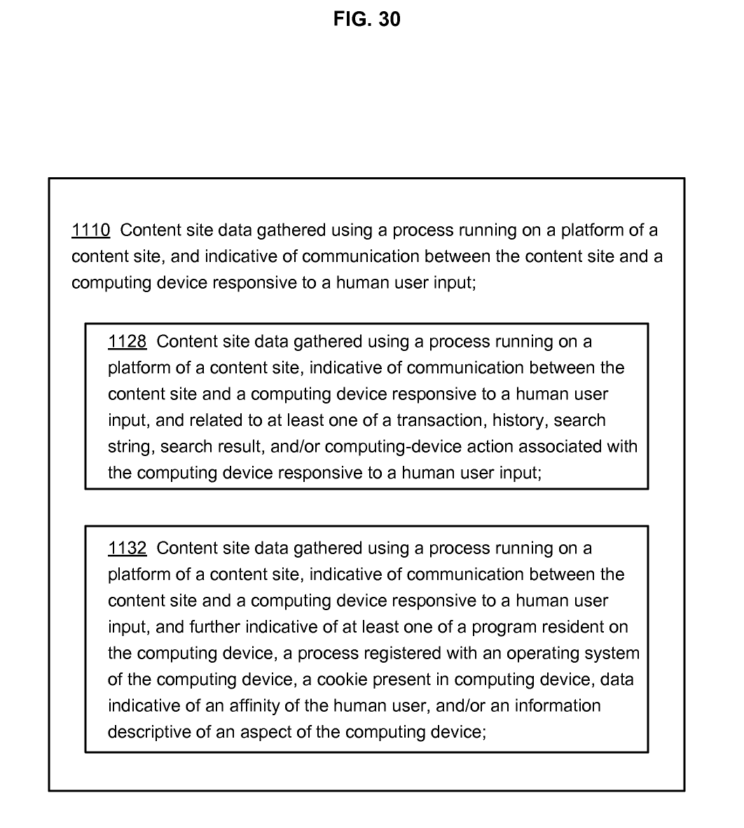

FIG. 30 illustrates a further alternative embodiment of the exemplary operational flow 1100 of FIG. 27. The receiving content site data operation 1110 may include at least one additional operation. The at least one additional operation may include an operation 1128, and/or an operation 1132. At the operation 1128, the receiving content site data operation includes receiving content site data gathered through a process running on a platform of a content site. The content site data indicative of communication between the content site and a computing device responsive to a human user input. The content site data is related to at least one of a transaction, history, search string, search result, and/or computing-device action associated with the computing device responsive to a human user input. At the operation 1132, the receiving content site data operation includes receiving content site data gathered through a process running on a platform of a content site, indicative of communication between the content site and a computing device responsive to a human user input. The content site data is further indicative of at least one of a program resident on the computing device, a process registered with an operating system of the computing device, a cookie present in computing device, data indicative of an affinity of the human user, and/or an information descriptive of an aspect of the computing device.

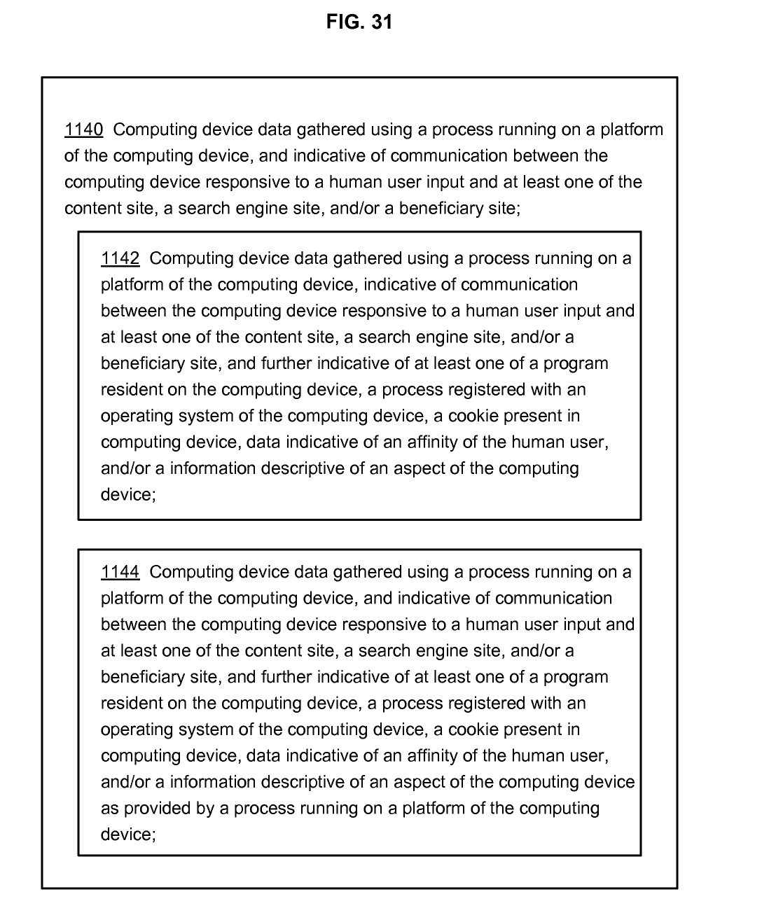

FIG. 31 illustrates a further alternative embodiment of the exemplary operational flow 1100 of FIG. 27. The receiving computing device data operation 1140 may include at least one additional operation. The at least one additional operation may include an operation 1142, and/or an operation 1144. At the operation 1142, the receiving computing device data operation includes receiving computing device data gathered through a process running on a platform of the computing device. The computing device data indicative of communication between the computing device responsive to a human user input and at least one of the content site, a search engine site, and/or a beneficiary site. The computing device data further indicative of at least one of a program resident on the computing device, a process registered with an operating system of the computing device, a cookie present in computing device, data indicative of an affinity of the human user, and/or an information descriptive of an aspect of the computing device. At the operation 1144, the receiving computing device data operation includes receiving computing device data gathered through a process running on a platform of the computing device. The computing device data indicative of communication between the computing device responsive to a human user input and at least one of the content site, a search engine site, and/or a beneficiary site. The computing device data further indicative of at least one of a program resident on the computing device, a process registered with an operating system of the computing device, a cookie present in computing device, data indicative of an affinity of the human user, and/or an information descriptive of an aspect of the computing device as provided by a process running on a platform of the computing device.

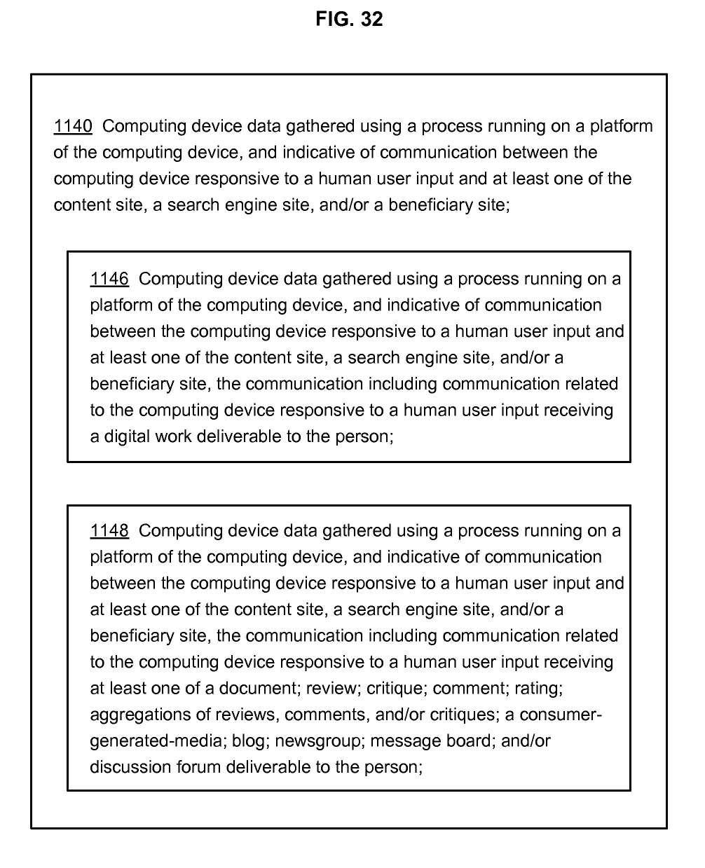

FIG. 32 illustrates an alternative embodiment of the exemplary operational flow 1100 of FIG. 27. The receiving computing device data operation 1140 may include at least one additional operation. The at least one additional operation may include an operation 1146, and/or an operation 1148. At the operation 1146, the receiving computing device data operation includes receiving computing device data gathered through a process running on a platform of the computing device, and indicative of communication between the computing device responsive to a human user input and at least one of the content site, a search engine site, and/or a beneficiary site. The communication includes communication related to the computing device responsive to a human user input receiving a digital work deliverable to the person. At the operation 1148, the receiving computing device data operation includes receiving computing device data gathered through a process running on a platform of the computing device. The computing device data indicative of communication between the computing device responsive to a human user input and at least one of the content site, a search engine site, and/or a beneficiary site. The communication includes communication related to the computing device responsive to a human user input receiving at least one of a document; review; critique; comment; rating; aggregations of reviews, comments, and/or critiques; a consumer-generated-media; blog; newsgroup; message board; and/or discussion forum deliverable to the person.

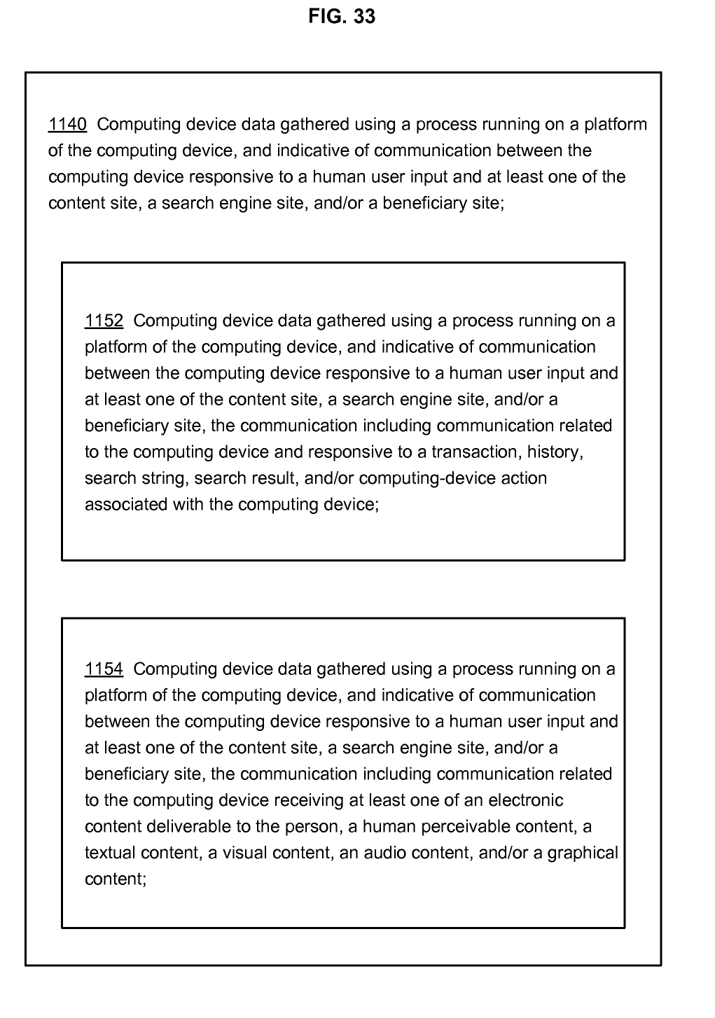

FIG. 33 illustrates another alternative embodiment of the exemplary operational flow 1100 of FIG. 27. The receiving computing device data operation 1140 may include at least one additional operation. The at least one additional operation may include an operation 1152, and/or an operation 1154. At the operation 1152, the receiving computing device data operation includes receiving computing device data gathered through a process running on a platform of the computing device. The computing device data indicative of communication between the computing device responsive to a human user input and at least one of the content site, a search engine site, and/or a beneficiary site. The communication includes communication related to the computing device and responsive to a transaction, history, search string, search result, and/or computing-device action associated with the computing device. In an alternative embodiment, the communication related to the computing device includes communication related to the computing device receiving at least one of an electronic content deliverable to the person, which includes at least one of an electronic document, an electronic work, an electronically-stored information, a Web document, an email, and/or an instant message. At the operation 1154, the receiving computing device data operation includes receiving computing device data gathered through a process running on a platform of the computing device. The computing device data indicative of communication between the computing device responsive to a human user input and at least one of the content site, a search engine site, and/or a beneficiary site. The communication includes communication related to the computing device receiving at least one of an electronic content deliverable to the person, a human perceivable content, a textual content, a visual content, an audio content, and/or a graphical content.

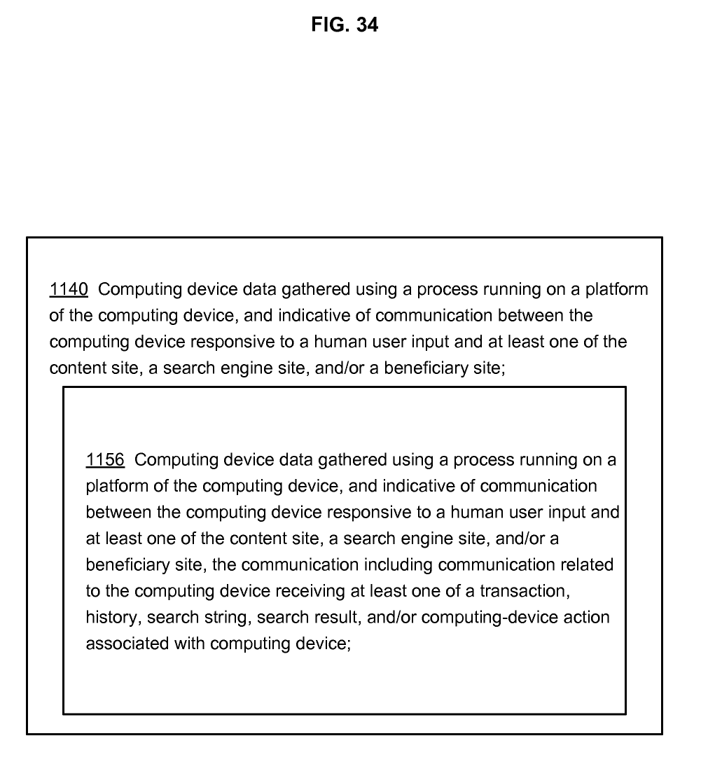

FIG. 34 illustrates an alternative embodiment of the exemplary operational flow 1100 of FIG. 27. The receiving computing device data operation 1140 may include at least one additional operation, such as the operation 1156. At the operation 1156, the receiving computing device data operation includes receiving computing device data gathered through a process running on a platform of the computing device. The computing device data indicative of communication between the computing device responsive to a human user input and at least one of the content site, a search engine site, and/or a beneficiary site. The communication includes communication related to the computing device receiving at least one of a transaction, history, search string, search result, and/or computing-device action associated with computing device.

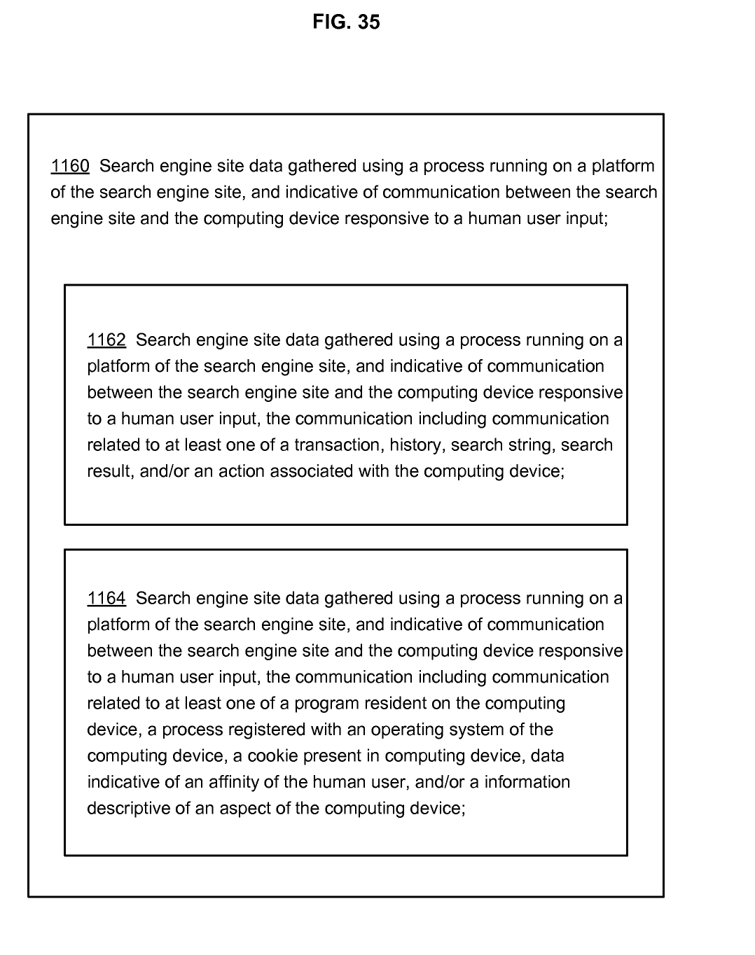

FIG. 35 illustrates another alternative embodiment of the exemplary operational flow 1100 of FIG. 27. The receiving search engine site data operation 1160 may include at least one additional operation. The at least one additional operation may include an operation 1162, and/or an operation 1164. At the operation 1162, the receiving search engine site data operation includes receiving search engine site data gathered through a process running on a platform of the search engine site. The search engine site data indicative of communication between the search engine site and the computing device responsive to a human user input. The communication includes communication related to at least one of a transaction, history, search string, search result, and/or an action associated with the computing device. At the operation 1164, the receiving search engine site data operation includes receiving search engine site data gathered through a process running on a platform of the search engine site. The search engine site data indicative of communication between the search engine site and the computing device responsive to a human user input. The communication includes communication related to at least one of a program resident on the computing device, a process registered with an operating system of the computing device, a cookie present in computing device, data indicative of an affinity of the human user, and/or an information descriptive of an aspect of the computing device.

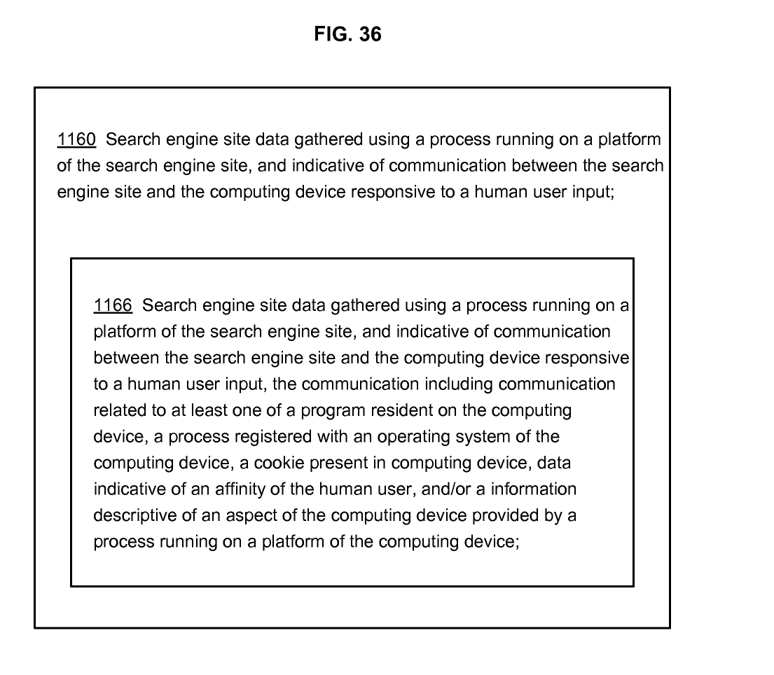

FIG. 36 illustrates a further alternative embodiment of the exemplary operational flow 1100 of FIG. 27. The receiving search engine site data operation 1160 may include at least one additional operation. The at least one additional operation may include an operation 1166. At the operation 1166, the receiving search engine site data operation includes receiving search engine site data gathered through a process running on a platform of the search engine site. The search engine site data indicative of communication between the search engine site and the computing device responsive to a human user input. The communication includes communication related to at least one of a program resident on the computing device, a process registered with an operating system of the computing device, a cookie present in computing device, data indicative of an affinity of the human user, and/or an information descriptive of an aspect of the computing device provided by a process running on a platform of the computing device.

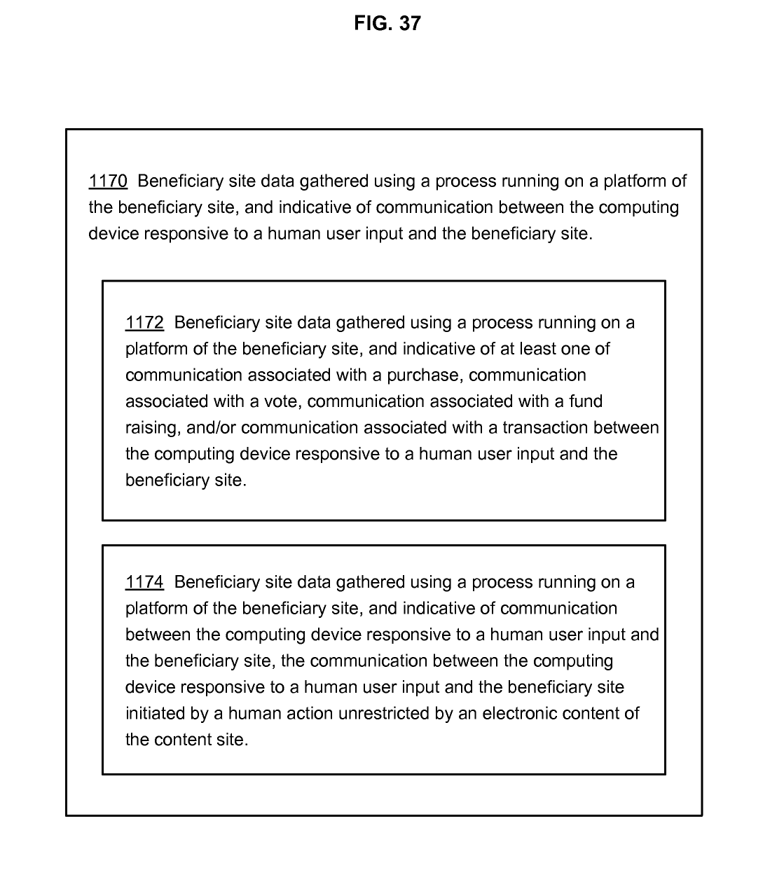

FIG. 37 illustrates an alternative embodiment of the exemplary operational flow 1100 of FIG. 27. The receiving beneficiary site data operation 1170 may include at least one additional operation. The at least one additional operation may include an operation 1172, and/or an operation 1174. At the operation 1172, the receiving beneficiary site data operation includes receiving beneficiary site data gathered through a process running on a platform of the beneficiary site. The beneficiary site data indicative of at least one of communication associated with a purchase, communication associated with a vote, communication associated with a fund raising, and/or communication associated with a transaction between the computing device responsive to a human user input and the beneficiary site. At the operation 1174, the receiving beneficiary site data operation includes receiving beneficiary site data gathered through a process running on a platform of the beneficiary site. The beneficiary site data indicative of communication between the computing device responsive to a human user input and the beneficiary site. The communication between the computing device and the beneficiary site is initiated by a human action unrestricted by an electronic content of the content site. For example, the communication between the computing device and the beneficiary site is not responsive to or initiated by a clickthrough or other executable link provided by the content site.

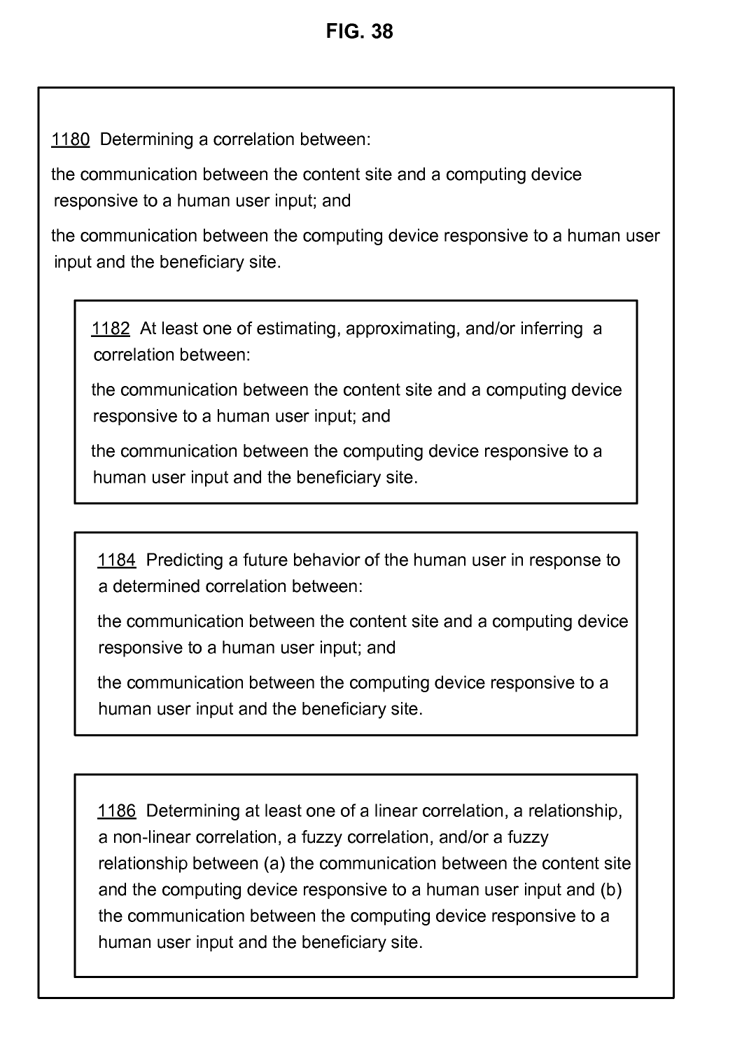

FIG. 38 illustrates another alternative embodiment of the exemplary operational flow 1100 of FIG. 27. The influence evaluation operation 1180 may include at least one additional operation. The at least one additional operation may include an operation 1182, an operation 1184, and/or an operation 1186. At the operation 1182, the influence evaluation operation includes at least one of estimating, approximating, and/or inferring a correlation between (a) the communication between the content site and a computing device responsive to a human user input and (b) the communication between the computing device responsive to a human user input and the beneficiary site. At the operation 1184, the influence evaluation operation includes predicting a future behavior of a person in response to a determined correlation between (a) the communication between the content site and a computing device responsive to a human user input and (b) the communication between the computing device responsive to a human user input and the beneficiary site. In an embodiment, the person includes the human user, a plurality of persons in an affinity group that includes the human user, and/or a hypothetical human. At the operation 1186, the influence evaluation operation includes determining at least one of a linear correlation, a relationship, a non-linear correlation, a fuzzy correlation, and/or a fuzzy relationship between (a) the communication between the content site and a computing device responsive to a human user input and (b) the communication between the computing device responsive to a human user input and the beneficiary site.

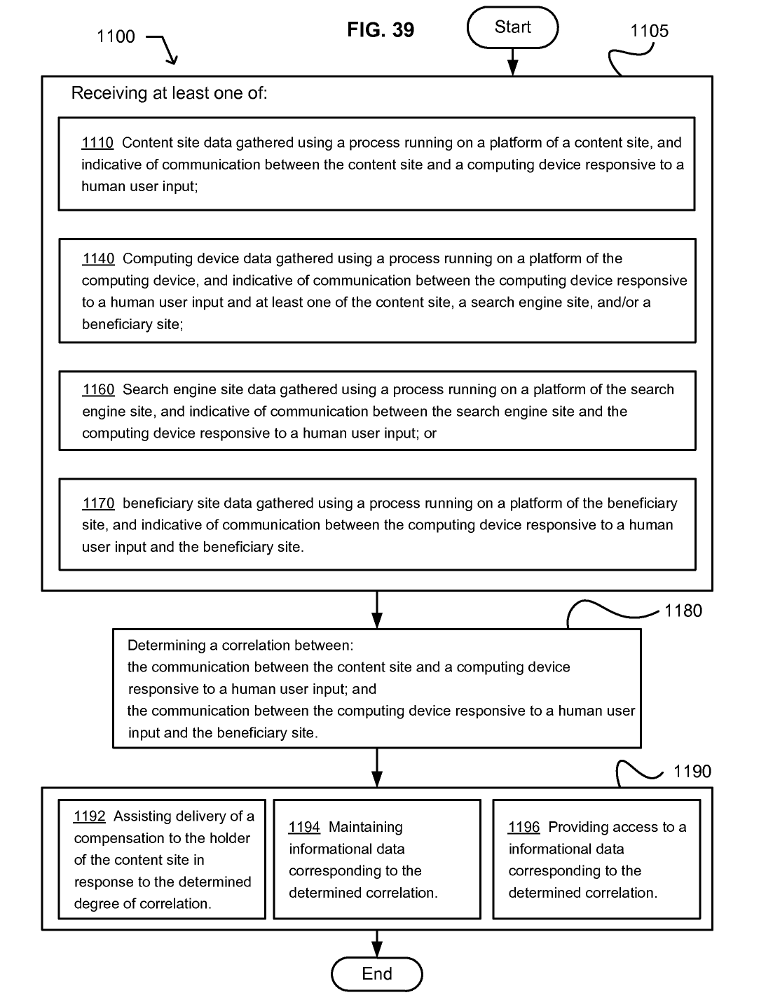

FIG. 39 illustrates a further alternative embodiment of the exemplary operational flow 1100 of FIG. 27. The exemplary operational flow 1100 may include at least one additional operation 1190. The at least one additional operation may include an operation 1192, an operation 1194, and/or an operation 1196. The operation 1192 assists delivery of a compensation to the holder of the content site in response to the determined degree of correlation. In an alternative embodiment, the compensation to the holder may be determined in response to the determined degree of correlation. In an embodiment, the holder of the content site may include at least one of an owner, developer, operator, proprietor, blogger, and/or designated recipient of any benefit. The operation 1194 maintains informational data corresponding to the determined correlation. The operation 1196 provides access to an informational data corresponding to the determined correlation.

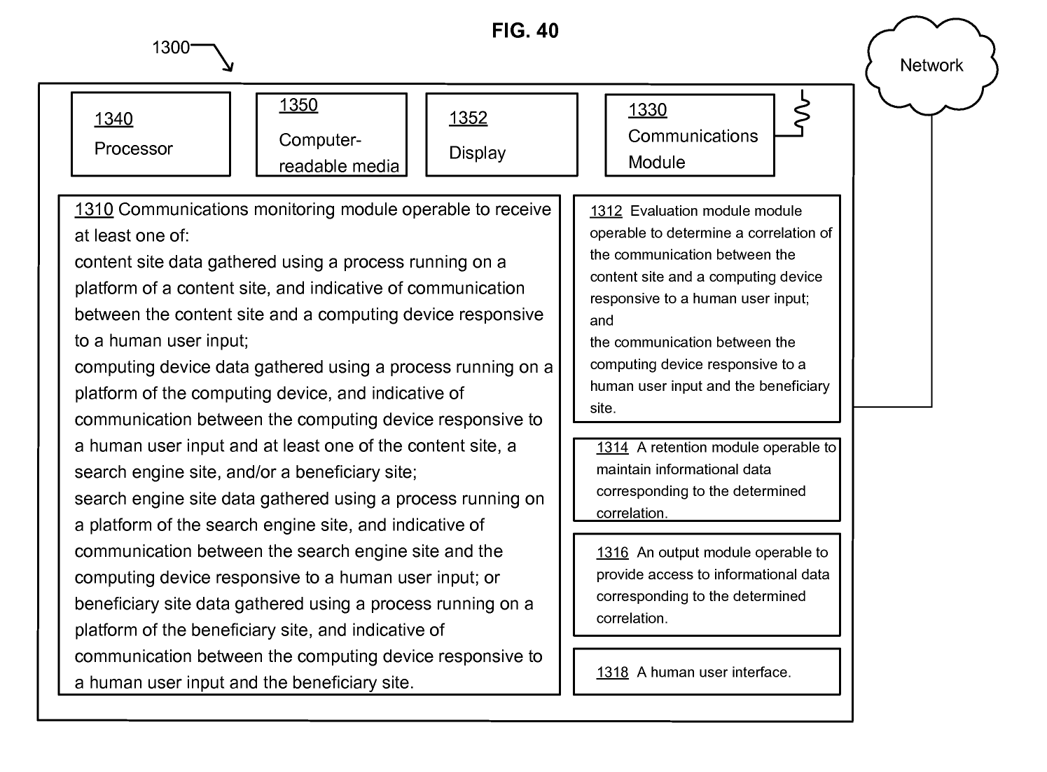

FIG. 40 illustrates an exemplary 1300 computing device 1300 operable to communicate over a network. The computing device includes a communications monitoring module 1310 and an evaluation module 1312. The communications monitoring module is operable to receive at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human input and the beneficiary site. The evaluation module 1312 is operable to determine a correlation of (a) the communication between the content site and a computing device responsive to a human user input; and (b) the communication between the computing device responsive to a human user input and the beneficiary site.

In an alternative embodiment, the computing device 1300 further a computer-readable media configurable by data outputted by at least one of the communications monitoring module and/or the evaluation module. The computer-readable media is illustrated as a storage media 1350. In another embodiment, the computing device further includes a retention module 1314 operable to maintain informational data corresponding to the determined correlation. In a further embodiment, the computing device includes an output module 1316 operable to provide access to informational data corresponding to the determined correlation. In another embodiment, the computing device further includes a computing device responsive to human input, and operable to display human perceivable content and communicate with a network. In yet another embodiment, the computing device further includes a computing device operable to provide electronic content via a network. In a further embodiment, the computing device further includes a network intermediary device operable to communicate with a network. In another embodiment, the computing device further includes a computing device under a control of the third party.

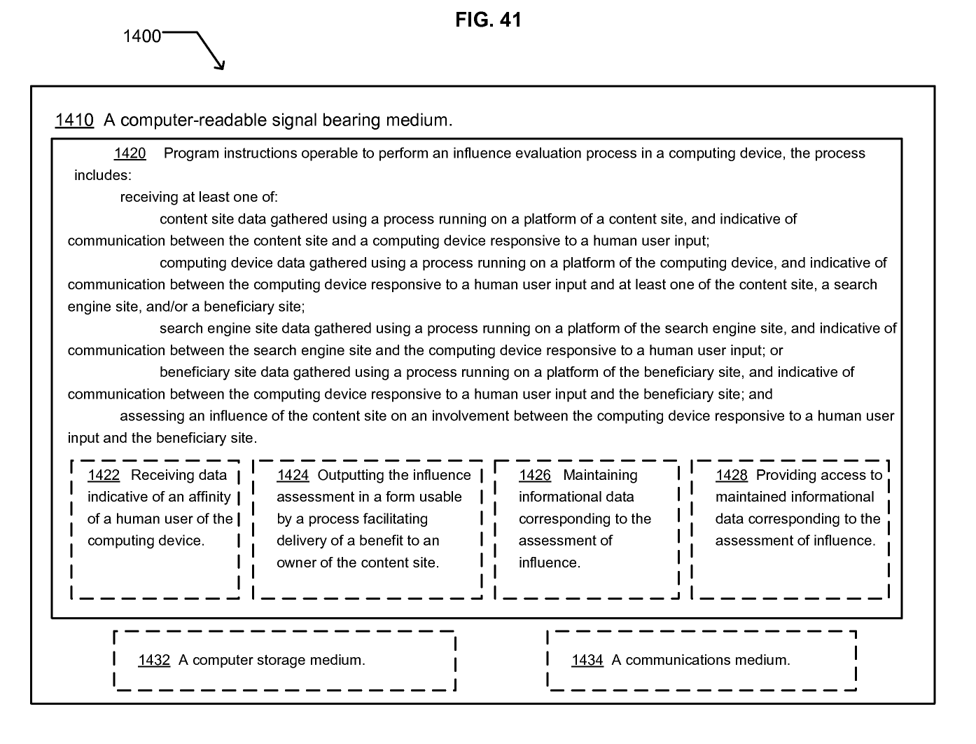

FIG. 41 illustrates an exemplary computer program product 1400. The computer program product includes a signal bearing medium 1410 bearing program instructions 1420 operable to perform an influence evaluation process in a computing device. The process of the program instructions includes receiving at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human input and the beneficiary site. The process of the program instructions 1420 also includes assessing an influence of the content site on an involvement between the computing device responsive to a human user input and the beneficiary site. In an alternative embodiment, the process of the program instructions 1420 further includes receiving data indicative of an affinity of a human user of the computing device 1422. In another embodiment, the process of the program instructions further includes outputting the influence assessment in a form usable by a process facilitating delivery of a benefit to an owner of the content site 1424. In further embodiment, the process of the program instructions further includes maintaining informational data corresponding to the assessment of influence 1426. In yet another embodiment, the process of the program instructions further includes providing access to maintained informational data corresponding to the assessment of influence 1428.

In another embodiment, the computer-readable signal-bearing medium 1410 includes a computer storage medium 1432. In a further embodiment, the computer-readable signal-bearing medium includes a communication medium 1434.

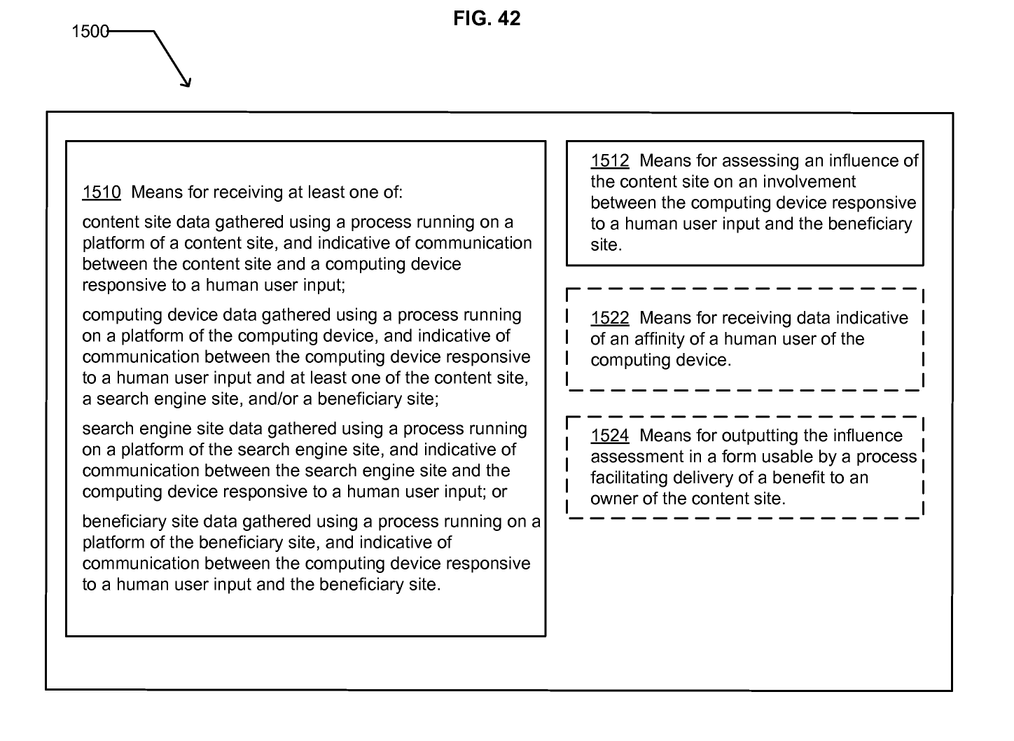

FIG. 42 illustrates an exemplary device 1500. The device includes means 1510 for receiving at least one of content site data, computing device data, search engine site data, or beneficiary site data. The content site data gathered through a process running on a platform of a content site, and indicative of communication between the content site and a computing device responsive to a human user input. The computing device data gathered through a process running on a platform of the computing device, and indicative of communication between the computing device responsive to a human user input and at least one of the content site, a search engine site, and/or a beneficiary site. The search engine site data gathered through a process running on a platform of the search engine site, and indicative of communication between the search engine site and the computing device responsive to a human user input. The beneficiary site data gathered through a process running on a platform of the beneficiary site, and indicative of communication between the computing device responsive to a human input and the beneficiary site.

The device 1510 also includes means 1512 for assessing an influence of the content site on an involvement between the computing device responsive to a human user input and the beneficiary site. In an alternative embodiment, the device further includes means 1522 for receiving data indicative of an affinity of a human user of the computing device. In another embodiment, the device further includes means 1524 for outputting the influence assessment in a form usable by a process facilitating delivery of a benefit to an owner of the content site.

With reference now to FIG. 43, shown is an example of another system that may serve as a context for introducing one or more processes, systems or other articles described herein. As shown system 1800 comprises one or more instances of writers 1801, processors 1803, controls 1805, software or other implementations 1807, invokers 1812, compilers 1814, outputs 1816, coding modules 1818, or the like with one or more media 1890 bearing expressions or outputs thereof. In some embodiments, such media may include distributed media bearing a divided or otherwise distributed implementation or output. For example, in some embodiments, such media may include two or more physically distinct solid-state memories, two or more transmission media, a combination of such transmission media with one or more data-holding media configured as a data source or destination, or the like.

In some embodiments, transmission media may be “configured” to bear an output or implementation (a) by causing a channel in a medium to convey a portion thereof or (b) by constituting, adapting, addressing, or otherwise linking to such media in some other mode that depends upon one or more atypical traits of the partial or whole output or implementation. Data-holding elements of media may likewise be “configured” to bear an output or implementation portion (a) by holding the portion in a storage or memory location or (b) by constituting, adapting, addressing, or otherwise linking to such media in some other mode that depends upon one or more atypical traits of the partial or whole output or implementation. Such atypical traits may include a name, address, portion identifier, functional description, or the like sufficient to distinguish the output, implementation, or portion from a generic object.

In some embodiments described herein, “logic” and similar implementations can include software or other control structures operable to guide device operation. Electronic circuitry, for example, can manifest one or more paths of electrical current constructed and arranged to implement various logic functions as described herein. In some embodiments, one or more media are “configured to bear” a device-detectable implementation if such media hold or transmit a special-purpose device instruction set operable to perform a novel method as described herein. Alternatively or additionally, in some variants, an implementation may include special-purpose hardware or firmware components or general-purpose components executing or otherwise invoking special-purpose components. Specifications or other implementations may be transmitted by one or more instances of transmission media as described herein, optionally by packet transmission or otherwise by passing through distributed media at various times.

In some embodiments, one or more of the coding modules 1818 may be configured with circuitry for applying, imposing, or otherwise using a syntactic or other encoding constraint in forming, extracting, or otherwise handling respective portions of the device-detectable implementation or output. In encoding a software module or other message content, for example, compiler 1814 or coding module 1818 may implement one or more such constraints pursuant to public key or other encryption, applying error correction modes, certifying or otherwise annotating the message content, or implementing other security practices described herein or known by those skilled in the art. Alternatively or additionally, another instance of coding module 1818 may be configured to receive data (via receiver 1059, e.g.) and decode or otherwise distill the received data using one or more such encoding constraints. Compiler 1814 may, in some variants, convert one or more of components 1071-1079 from a corresponding source code form before the component(s) are transmitted across linkage 1005.

System 1800 may be implemented, for example, as one or more instances of stand-alone workstations, servers, vehicles, portable devices, removable media 1820, as components of primary system 1000 or network 1080 (of FIG. 26), or the like. Alternatively or additionally, media 1890 may include one or more instances of signal repeaters 1081, communication satellites 1083, servers 1084, processors 1085, routers 1087, portions of primary system 1000 as shown, or the like.

Media 1890 may include one or more instances of removable media 1820, tapes or other storage media 1826; parallel (transmission) media 1830; disks 1844; memories 1846; other data-handling media 1850; serial media 1860; interfaces 1870; or expressions 1889, 1899. Removable media 1820 can bear one or more device-detectable instances of instruction sequences 1822 or other implementations of flow 1100 or flow 500, for example. Alternatively or additionally, in some embodiments, removable media 1820 can bear alphanumeric data, audio data, image data, structure-descriptive values, or other content 1824 in a context that indicates an occurrence of flow 1100 or flow 500. In some circumstances, transmission media may bear respective portions of implementations as described herein serially or otherwise non-simultaneously. In some variants in which two portions 1897, 1898 constitute a partial or complete software implementation or product of a novel method described herein, portion 1897 may follow portion 1898 successively through serial media 1863, 1865, 1867 (with transmission of portion 1897 partly overlapping in time with transmission of portion 1898 passing through medium 1863, for example).

As shown, parallel channels 1831, 1832 are respectively implemented at least in media 1837, 1838 of a bus or otherwise effectively in isolation from one another. In some embodiments, a bus may be a system of two or more signal paths—not unified by a nominally ideal conduction path between them—configured to transfer data between or among internal or external computer components. For example, one data channel may include a power line (e.g., as medium 1865) operable for transmitting content of the device-detectable implementation as described herein between two taps or other terminals (e.g., as media 1863, 1867 comprising a source and destination).

In another such configuration, one or more media 1837 of channel 1831 may bear portion 1897 before, while or after one or more other media 1838 of parallel channel 1832 bear portion 1898. In some embodiments, such a process may occur “while” another process occurs if they coincide or otherwise overlap in time substantially (by several clock cycles, for example). In some embodiments, such a process may occur “after” an event if any instance of the process begins after any instance of the event concludes, irrespective of other instances overlapping or the like.

In a variant in which a channel through medium 1850 bears an expression 1855 partially implementing an operational flow described herein, the remainder of the implementation may be borne (earlier or later, in some instances) by the same medium 1850 or by one or more other portions of media 1890 as shown. In some embodiments, moreover, one or more controls 1805 may configure at least some media 1890 by triggering transmissions as described above or transmissions of one or more outputs 1816 thereof.

In some embodiments, the one or more “physical media” may include one or more instances of conduits, layers, networks, static storage compositions, or other homogenous or polymorphic structures or compositions suitable for bearing signals. In some embodiments, such a “communication channel” in physical media may include a signal path between two transceivers or the like. A “remainder” of the media may include other signal paths intersecting the communication channel or other media as described herein. In some variants, another exemplary system comprises one or more physical media 1890 constructed and arranged to receive a special-purpose sequence 1882 of two or more device-detectable instructions 1884 for implementing a flow as described herein or to receive an output of executing such instructions. Physical media 1890 may (optionally) be configured by writer 1801, transmitter 1052, or the like.

In some embodiments, such a “special-purpose” instruction sequence may include any ordered set of two or more instructions directly or indirectly operable for causing multi-purpose hardware or software to perform one or more methods or functions described herein: source code, macro code, controller or other machine code, or the like. In some embodiments, an implementation may include one or more instances of special-purpose sequences 1882 of instructions 1884, patches or other implementation updates 1888, configurations 1894, special-purpose circuit designs 1893, or the like. Such “designs,” for example, may include one or more instances of a mask set definition, a connectivity layout of one or more gates or other logic elements, an application-specific integrated circuit (ASIC), a multivariate transfer function, or the like.

Segments of such implementations or their outputs may (optionally) be manifested one or more information-bearing static attributes comprising the device-detectable implementation. Such attributes may, in some embodiments, comprise a concentration or other layout attribute of magnetic or charge-bearing elements, visible or other optical elements, or other particles in or on a liquid crystal display or other solid-containing medium. Solid state data storage modules or other such static media may further comprise one or more instances of laser markings, barcodes, human-readable identifiers, or the like, such as to indicate one or more attributes of the device-detectable implementation. Alternatively or additionally such solid state or other solid-containing media may include one or more instances of semiconductor devices or other circuitry, magnetic or optical digital storage disks, dynamic or flash random access memories (RAMs), or the like. Magnetoresistive RAMs may bear larger implementation or output portions or aggregations safely and efficiently, moreover, and without any need for motors or the like for positioning the storage medium.

Segments of such implementations or their outputs may likewise be manifested in electromagnetic signals 1886, laser or other optical signals 1891, electrical signals 1892, or the like. In some embodiments, for example, such electrical or electromagnetic signals may include one or more instances of static or variable voltage levels or other analog values, radio frequency transmissions or the like. In some embodiments, the above-mentioned “optical” signals may likewise include one or more instances of time- or position-dependent, device-detectable variations in hue, intensity, or the like. Alternatively or additionally, portions of such implementations or their outputs may manifest as one or more instances of magnetic, magneto-optic, electrostatic, or other physical configurations 1828 of nonvolatile storage media 1826 or as external implementation access services 1872.

In some embodiments, physical media can be configured by being “operated to bear” or “operated upon to bear” a signal. For example, they may include physical media that generate, transmit, conduct, receive, or otherwise convey or store a device-detectable implementation or output as described herein. Such conveyance or storing of a device-detectable implementation or output may be carried out in a distributed fashion at various times or locations, or such conveyance or storing of a device-detectable implementation or output may be done at one location or time. As discussed above, such physical media “operated to bear” or “operated upon to bear” may include physical media that are atypically constituted or adapted to facilitate methods or functions as described herein.

In some configurations, one or more output devices 1045 may present one or more results of computing device data gathered through a process running on a platform of the computing device, and indicative of communication between the computing device responsive to a human user input and at least one of the content site, a search engine site, and/or a beneficiary site in response to interface(s) 1040 receiving one or more invocations or outputs of an implementation of this function via linkage 1005. Such an “invocation” may, in some embodiments, comprise one or more instances of requests, hardware or software activations, user actions, or other determinants as described herein. Alternatively or additionally, in some embodiments, one or more input devices 1043 may later receive one or more invocations or results of search engine site data gathered through a process running on a platform of the search engine site, and indicative of communication between the search engine site and the computing device responsive to a human user input. In contexts like these, processor 1085 or other components of network 1080 may likewise constitute a secondary implementation having access to a primary instance of interface 1040 implementing methods like flow 1100 as described herein.

Serial media 1860 comprises a communication channel of two or more media configured to bear a transition or other output increment successively. In some embodiments, for example, serial media 1860 may include a communication line or wireless medium (e.g., as medium 1865) between two signal-bearing conduits (e.g., terminals or antennas as media 1863, 1867). Alternatively or additionally, one or more lenses 1049 or other light-transmissive media may comprise a serial medium between a light-transmissive medium and a sensor or other light receiver 1059 or transmitter 1052. In some embodiments, such “light-transmissive” media may (optionally) comprise metamaterials or other media operable for bearing one or more instances of microwave signals, radiowave signals, visible light signals, or the like.

In some embodiments, such a lens may be an optical element that causes light to converge or diverge along one or more signal paths. Such a light-transmissive medium may include a signal-bearing conduit, glass, or other physical medium through which an optical signal may travel. More generally, a signal-bearing conduit may be an electrical wire, a telecommunications cable, a fiber-optic cable, or a mechanical coupling or other path for the conveyance of analog or digital signals.

Alternatively or additionally, system 1800 may likewise include one or more instances of media for handling implementations or their outputs: satellite dishes or other reflectors 1057, antennas 1058 or other transducers 1875, arrays of two or more such devices configured to detect or redirect one or more incoming signals, caching elements or other data-holding elements (e.g., disks 1844, memories 1846, or other media 1890), integrated circuits 1048, or the like. In some variants, one or more media may be “configured” to bear a device-detectable implementation as described herein by being constituted or otherwise specially adapted for that type of implementation at one or more respective times, overlapping or otherwise. Such “signal-bearing” media may include those configured to bear one or more such signals at various times as well as those currently bearing them.

In some embodiments, such caching elements may comprise a circuit or device configured to store data that duplicates original values stored elsewhere or computed earlier in time. For example, a caching element may be a temporary storage area where frequently-accessed data may be held for rapid access by a computing system. A caching element likewise may be machine-readable memory (including computer-readable media such as random access memory or data disks). In some embodiments, such caching elements may likewise comprise a latching circuit or device configured to store data that has been modified from original values associated with the data (held elsewhere or computed earlier in time, for example).

In one variant, respective portions 1895, 1896 of an expression 1899 of implementation 1807 may be sent through respective channels at various times. Invoker 1812 may request or otherwise attempt to activate a computer program or streaming media overseas via a telephone cable or other channel 1831. Meanwhile, output 1816 may attempt to trigger a session or other partial implementation 1852, success in which may be indicated by receiving expression 1855 into a visual display or other medium 1850. Such a program or other implementation may be made complete, for example, once both of these attempts succeed.

In some embodiments, transducer(s) 1875 may comprise one or more devices that convert a signal from one form to another form. For example, a transducer may be a cathode ray tube that transforms electrical signals into visual signals. Another example of a transducer comprises a microelectromechanical systems (“MEMS”) device, which may be configured to convert mechanical signals into electrical signals, (or vice versa).

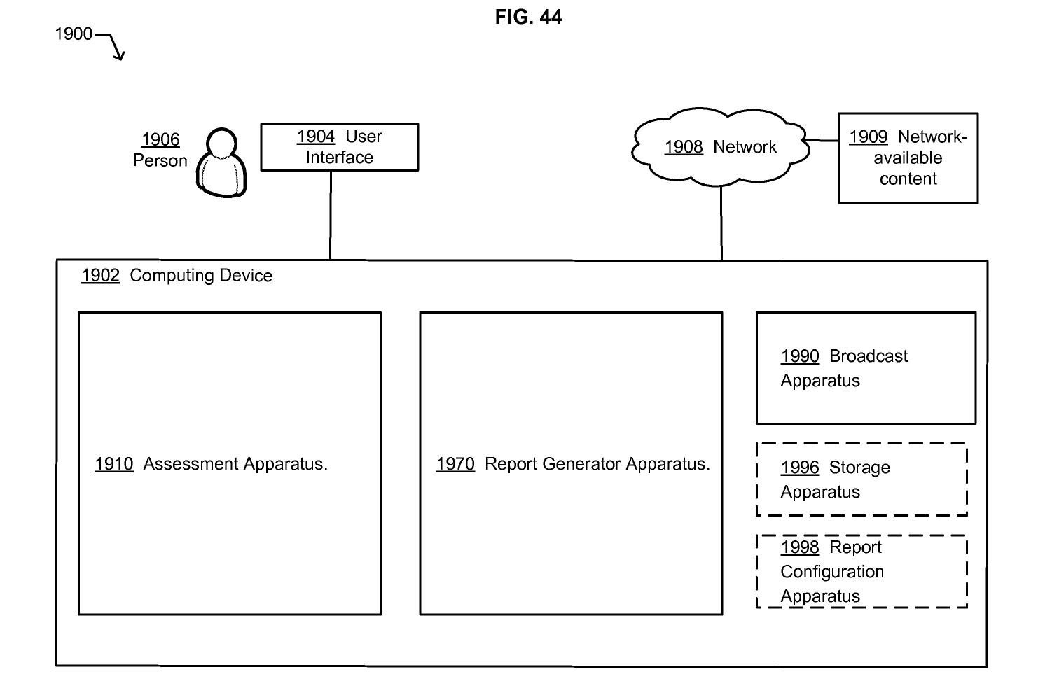

FIG. 44 illustrates a system 1900. The system includes a computing device 1902. In an embodiment, the computing device include a user side computing device. In another embodiment, the computing device may include another computing device, such as a content server computing device, a search engine site, network-intermediary device, a page tag information processor, or other computing device. The computing device contains an assessment apparatus 1910, a report generator apparatus 1970, and a broadcast apparatus 1990. In some embodiments, the broadcast apparatus may be structurally distinct from the assessment apparatus and/or the report generator apparatus. A person 1906 via a user interface 1904 may use the computing device 1902 to access network available content 1909 via a network 1908.

In an alternative embodiment, the computing device 1902 may include at least one additional apparatus. The at least one additional apparatus may include a storage apparatus 1996, and/or a report configuration apparatus 1998. The assessment apparatus 1910 may include one or more sub-apparatus (not shown). The report generator apparatus 1970 may include one or more sub-apparatus (not shown). The broadcast apparatus 1990 may include one or more sub-apparatus (not shown). In an embodiment, one of more of these apparatus may be implemented in hardware, software, and/or firmware.

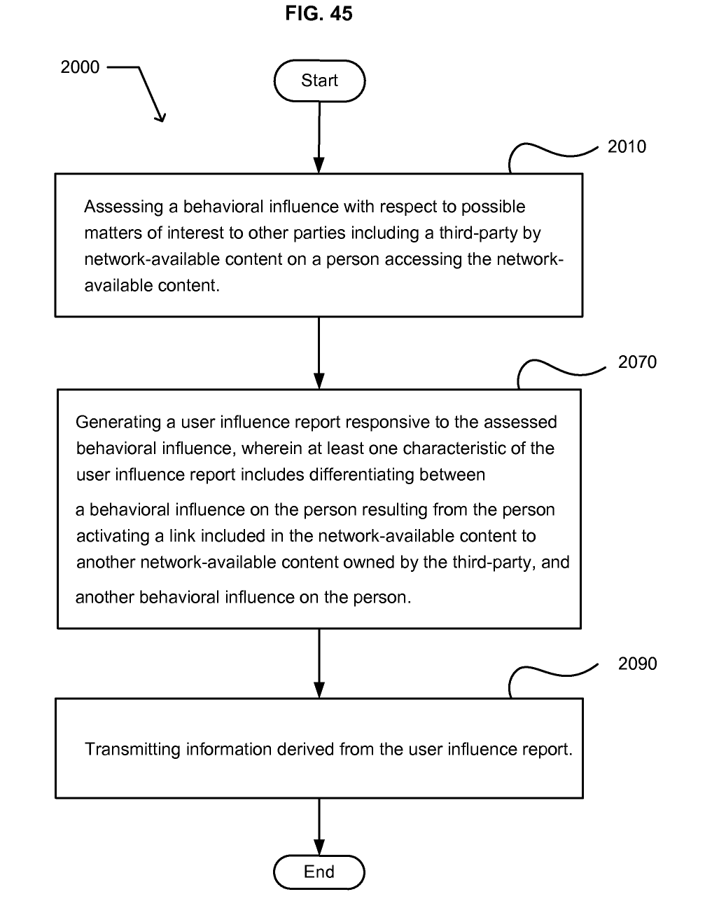

FIG. 45 illustrates an example operational flow 2000 for reporting influence. After a start operation, the operational flow proceeds to an evaluation operation 2010. The evaluation operation assesses a behavioral influence with respect to possible matters of interest to other parties, including a third party, by network-available content on a person accessing the network-available content. In an embodiment, the accessing of the network-available content may occur close in time to a downloading of the network-available content. In another embodiment, the accessing of the network available content may be deferred in time after a downloading of the network-available content. For example, the network-available content may be received on a first day and accessed by the person on a second day. A report preparation operation 2070 generates a user influence report responsive to the assessed behavioral influence. At least one characteristic of the user influence report differentiates between (i) a behavioral influence on the person resulting from the person activating a link included in the network-available content to another network-available content owned by the third party, and (ii) another behavioral influence on the person. For example, in an embodiment, the user influence report may indicate that a behavioral influence resulted in the person clicking on a link included in the network-available content, such as the person clicking on a link to amazon.com included in a book review. In the same example embodiment, the user influence report may also indicate that the person's influenced behavior included looking using a search engine to find other reviews of the same book, and accessing those reviews at identified journalistic websites and blogs before clicking on the link to amazon.com. A broadcast operation 2090 transmits information derived from the user influence report. The operational flow then proceeds to an end operation.

FIG. 45 and several following figures may include various examples of operational flows, discussions, and explanations with respect to the above-described system environment of FIG. 44, and/or with respect to other examples and contexts. However, it should be understood that the operational flows may be executed in a number of other environment and contexts, and/or in modified versions of FIG. 44. Also, although the various operational flows are illustrated in a sequence(s), it should be understood that the various operations may be performed in other orders than those which are illustrated, and/or may be performed concurrently.

The evaluation operation 2010 may be performed by the assessment apparatus 1910 of the computing device 1902 of FIG. 44. The reporting operation 2070 may be performed by the report generator apparatus 1970. The broadcast operation 2090 may be performed by the broadcast apparatus 1990.

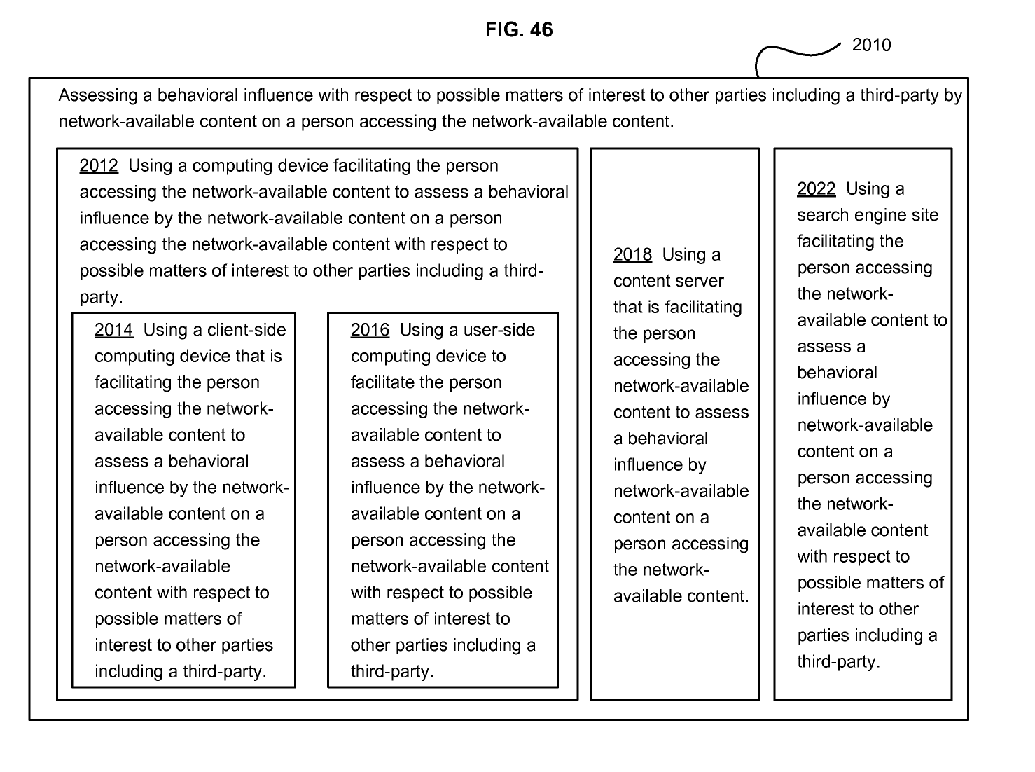

FIG. 46 illustrates an alternative embodiment of the operational flow 2000 described in FIG. 45. The evaluation operation 2010 may include at least one addition embodiment. The at least one additional embodiment may include an operation 2012, an operation 2018, and/or an operation 2022. The operation 2012 uses a computing device facilitating the person accessing the network-available content to assess a behavioral influence by the network-available content on a person accessing the network-available content with respect to possible matters of interest to other parties including a third party. The computing device may include the thin computing device 20 described in conjunction with FIG. 1 and/or the computing device 110 described in conjunction with FIG. 2. The operation 2018 uses a content server that is facilitating the person accessing the network-available content to assess a behavioral influence by network-available content on a person accessing the network-available content. The content server may include the server device 201 described in conjunction with FIG. 3. The operation 2018 may be performed in the content-server based report generator. The operation 2022 uses a search engine site facilitating the person accessing a network-available content to generate a user influence report assessing a behavioral influence by the network-available content on the person accessing the network-available content. The search engine site may include the search engine site 350 described in conjunction with FIG. 4. The operation 2022 may be performed in the search engine site based assessment apparatus 1910. The operation 2012 may include at least one additional embodiment, such as an operation 2014, and/or an operation 2016. The operation 2014 uses a client-side computing device that is facilitating the person accessing the network-available content to assess a behavioral influence by the network-available content on a person accessing the network-available content with respect to possible matters of interest to other parties including a third party. The operation 2016 uses a user-side computing device to facilitate the person accessing the network-available content to assess a behavioral influence by the network-available content on a person accessing the network-available content with respect to possible matters of interest to other parties including a third party.

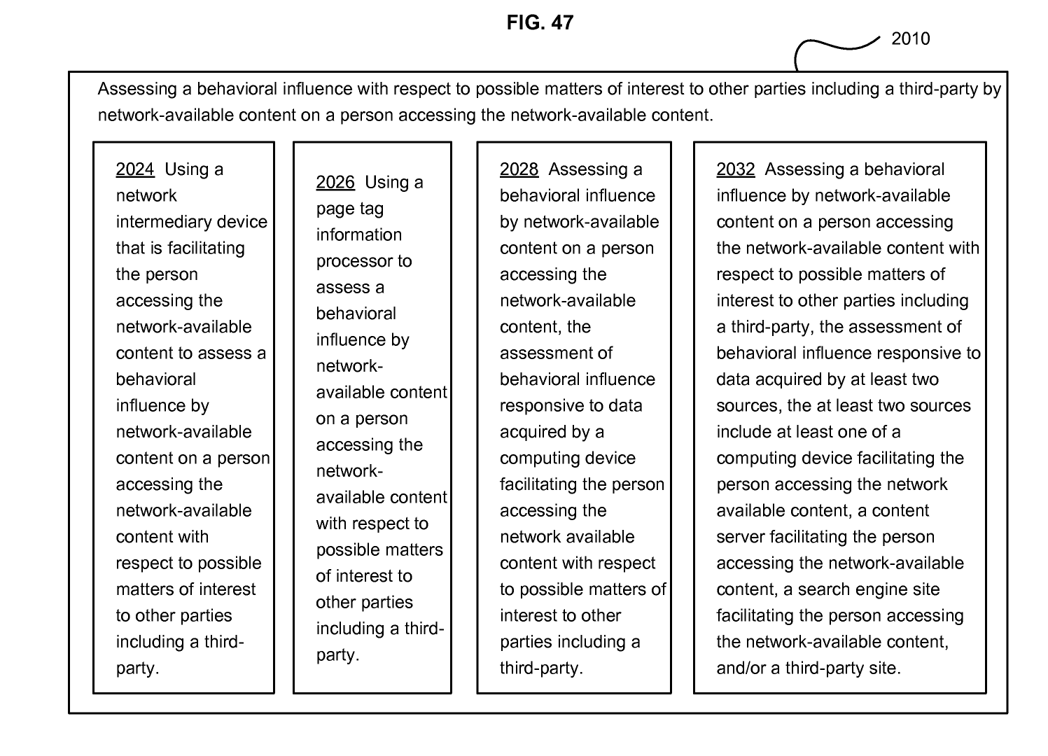

FIG. 47 illustrates another embodiment of the operational flow 2000 described in FIG. 45. The evaluation operation 2010 may include at least one addition embodiment. The at least one additional embodiment may include an operation 2024, an operation 2026, an operation 2028, and/or an operation 2032. The operation 2024 uses a network intermediary device that is facilitating the person accessing the network-available content to assess a behavioral influence by network-available content on a person accessing the network-available content with respect to possible matters of interest to other parties including a third party. The operation 2026 uses a page tag information processor to assess a behavioral influence by network-available content on a person accessing the network-available content with respect to possible matters of interest to other parties including a third party. The operation 2028 assesses a behavioral influence by network-available content on a person accessing the network-available content. The assessment of behavioral influence is responsive to data acquired by a computing device facilitating the person accessing the network available content with respect to possible matters of interest to other parties including a third party. The operation 2032 assesses a behavioral influence by network-available content on a person accessing the network-available content with respect to possible matters of interest to other parties including a third party. The assessment of behavioral influence is responsive to data acquired by at least two sources. The at least two sources include at least one of a computing device facilitating the person accessing the network available content, a content server facilitating the person accessing the network-available content, a search engine site facilitating the person accessing the network-available content, and/or a third party site. For example, the at least two sources may include a computing device facilitating the person accessing the network available content and the content server facilitating the person accessing the network-available content. In a further example, the at least two sources may include two content servers facilitating the person accessing the network-available content.

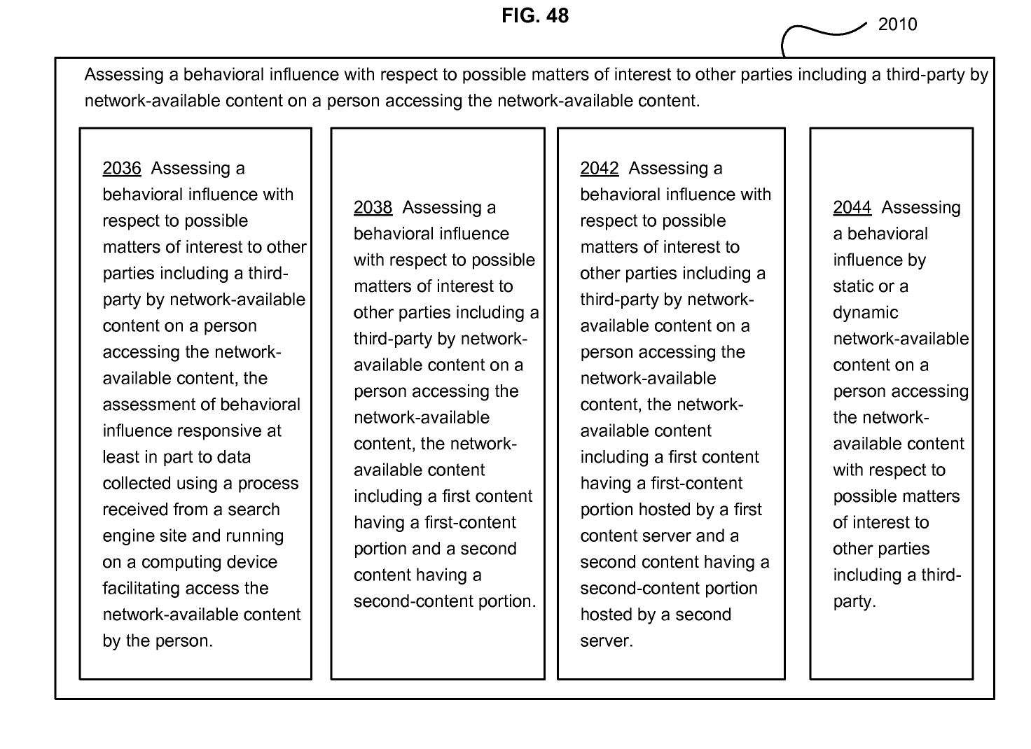

FIG. 48 illustrates a further embodiment of the operational flow 2000 described in FIG. 45. The evaluation operation 2010 may include at least one addition embodiment. The at least one additional embodiment may include an operation 2034, an operation 2036, an operation 2038, an operation 2042, and/or an operation 2044. The operation 2034 (not shown) assesses a behavioral influence by network-available content on a person accessing the network-available content with respect to possible matters of interest to other parties including a third party. The assessment of behavioral influence includes computing device data gathered using a process included in a platform of a computing device facilitating the person accessing the network-available content. The computing device data is indicative of communication between the computing device responsive to a human user input and at least one of a content site, a search engine site, and/or a beneficiary site. The operation 2036 assesses a behavioral influence with respect to possible matters of interest to other parties including a third party by network-available content on a person accessing the network-available content. The assessment of behavioral influence is responsive at least in part to data collected using a process received from a search engine site and running on a computing device facilitating access the network-available content by the person. The operation 2038 assesses a behavioral influence with respect to possible matters of interest to other parties including a third party by network-available content on a person accessing the network-available content. The network-available content includes a first content having a first-content portion and a second content having a second-content portion. For example, the first network available content may include the eContent 1 and the second network available content may include the eContent 2 described in conjunction with FIG. 4. The operation 2042 assesses a behavioral influence with respect to possible matters of interest to other parties including a third party by network-available content on a person accessing the network-available content. The network-available content includes a first content having a first-content portion hosted by a first content server and a second content having a second-content portion hosted by a second server. For example, the first network available content may include the eContent 1 described in conjunction with FIG. 4, and the second network available content may include another eContent hosted by another content server that is not shown. The operation 2044 assesses a behavioral influence by static or a dynamic network-available content on a person accessing the network-available content with respect to possible matters of interest to other parties including a third party.

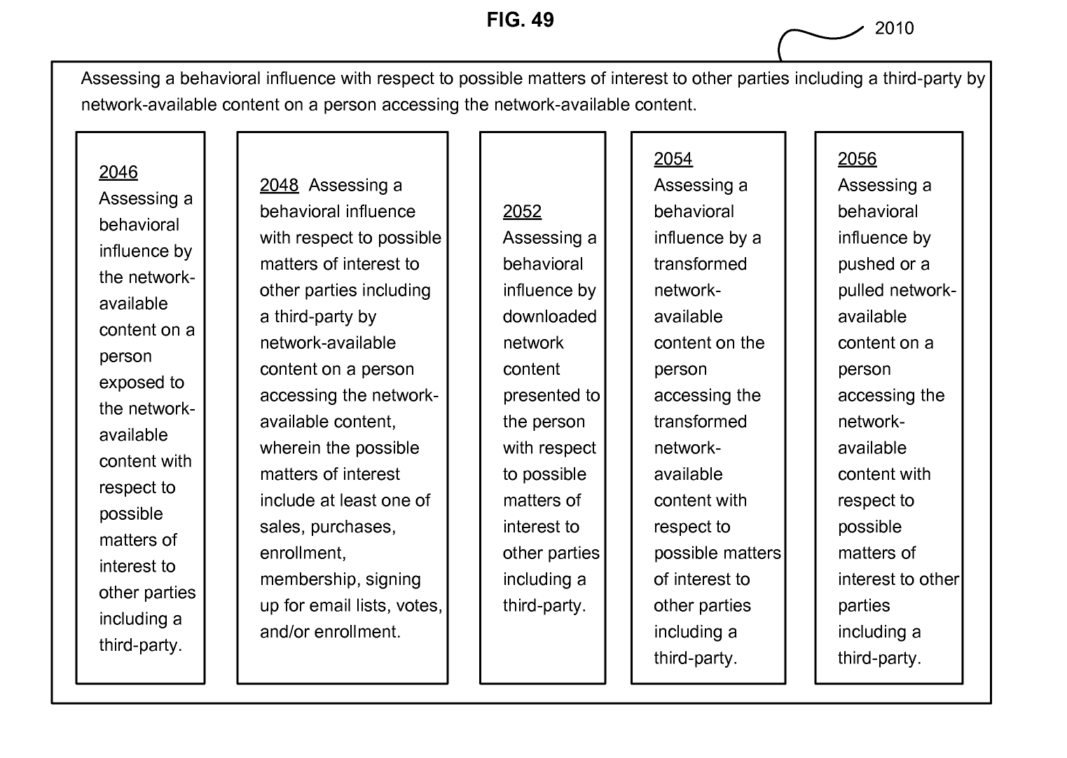

FIG. 49 illustrates an alternative embodiment of the operational flow 2000 described in FIG. 45. The evaluation operation 2010 may include at least one addition embodiment. The at least one additional embodiment may include an operation 2046, an operation 2048, an operation 2052, an operation 2054, and/or an operation 2056. The operation 2046 assesses a behavioral influence by the network-available content on a person exposed to the network-available content with respect to possible matters of interest to other parties, including a third party. The operation 2048 assesses a behavioral influence with respect to possible matters of interest to other parties including a third party by network-available content on a person accessing the network-available content. The possible matters of interest include at least one of sales, purchases, enrollment, membership, signing up for email lists, votes, and/or enrollment. The operation 2052 assesses a behavioral influence by downloaded network content presented to the person with respect to possible matters of interest to other parties including a third party. The operation 2054 assesses a behavioral influence by a transformed network-available content on the person accessing the transformed network-available content with respect to possible matters of interest to other parties, including a third party. The operation 2056 assesses a behavioral influence by pushed or a pulled network-available content on a person accessing the network-available content with respect to possible matters of interest to other parties including a third party.

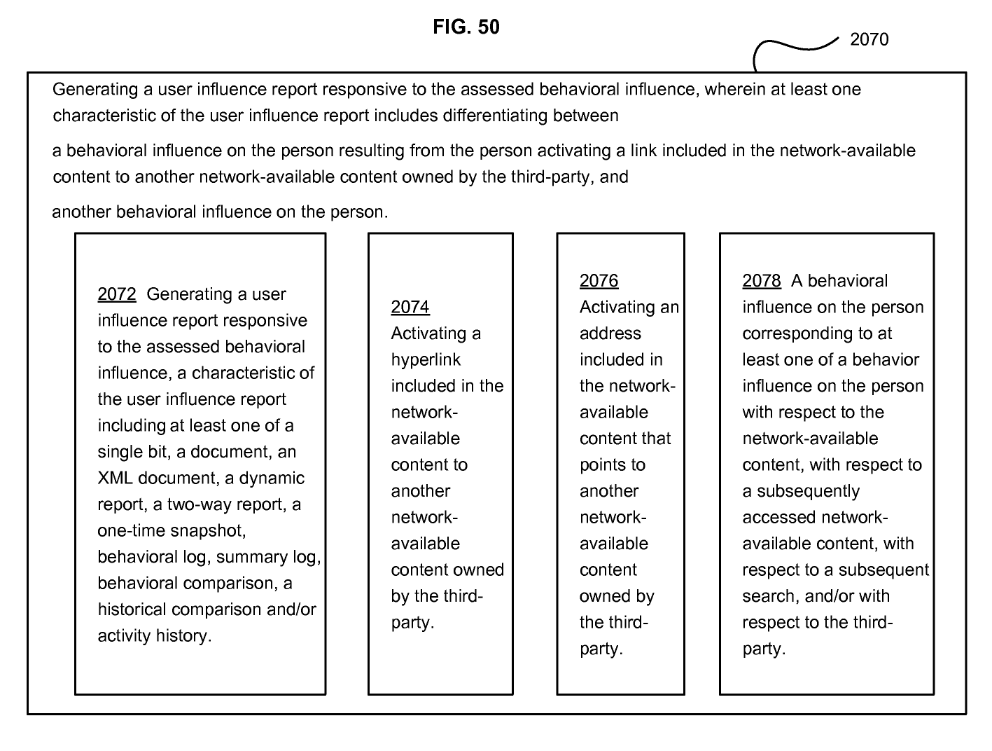

FIG. 50 illustrates a further embodiment of the operational flow 2000 described in FIG. 45. The report preparation operation 2070 may include at least one additional operation. The at least one additional operation may include an operation 2072, an operation 2074, an operation 2076, and/or an operation 2078. The operation 2072 generates a user influence report responsive to the assessed behavioral influence. A characteristic of the user influence report includes at least one of a single bit, a document, an XML document, a dynamic report, a two-way report, a one-time snapshot, behavioral log, summary log, behavioral comparison, a historical comparison and/or activity history. At the operation 2074, the activating a link included in the network-available content to another network-available content owned by the third party further includes activating a hyperlink included in the network-available content to another network-available content owned by the third party. At the operation 2076, the activating a link included in the network-available content to another network-available content owned by the third party further includes activating an address included in the network-available content that points to another network-available content owned by the third party. At the operation 2078, the another behavioral influence on the person further includes a behavioral influence on the person corresponding to at least one of a behavior influence on the person with respect to the network-available content, with respect to a subsequently accessed network-available content, with respect to a subsequent search, and/or with respect to the third party.

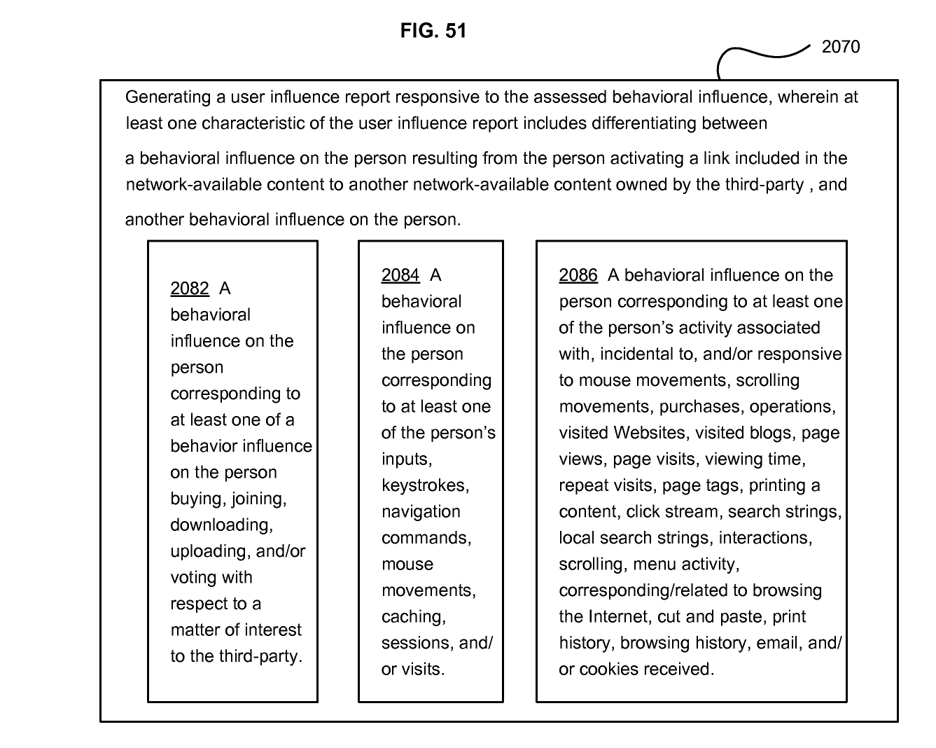

FIG. 51 illustrates another embodiment of the operational flow 2000 described in FIG. 45. The report preparation operation 2070 may include at least one additional operation. The at least one additional operation may include an operation 2082, an operation 2084, and/or an operation 2086. At the operation 2082, the another behavioral influence on the person further includes a behavioral influence on the person corresponding to at least one of a behavior influence on the person buying, joining, downloading, uploading, and/or voting with respect to a matter of interest to the third party. At the operation 2084, the another behavioral influence on the person further includes a behavioral influence on the person corresponding to at least one of the person's inputs, keystrokes, navigation commands, mouse movements, caching, sessions, and/or visits. At the operation 2086, the another behavioral influence on the person further includes a behavioral influence on the person corresponding to at least one of the person's activity associated with, incidental to, and/or responsive to mouse movements, scrolling movements, purchases, operations, visited Websites, visited blogs, page views, page visits, viewing time, repeat visits, page tags, printing a content, click stream, search strings, local search strings, interactions, scrolling, menu activity, corresponding/related to browsing the Internet, cut and paste, print history, browsing history, email, and/or cookies received.

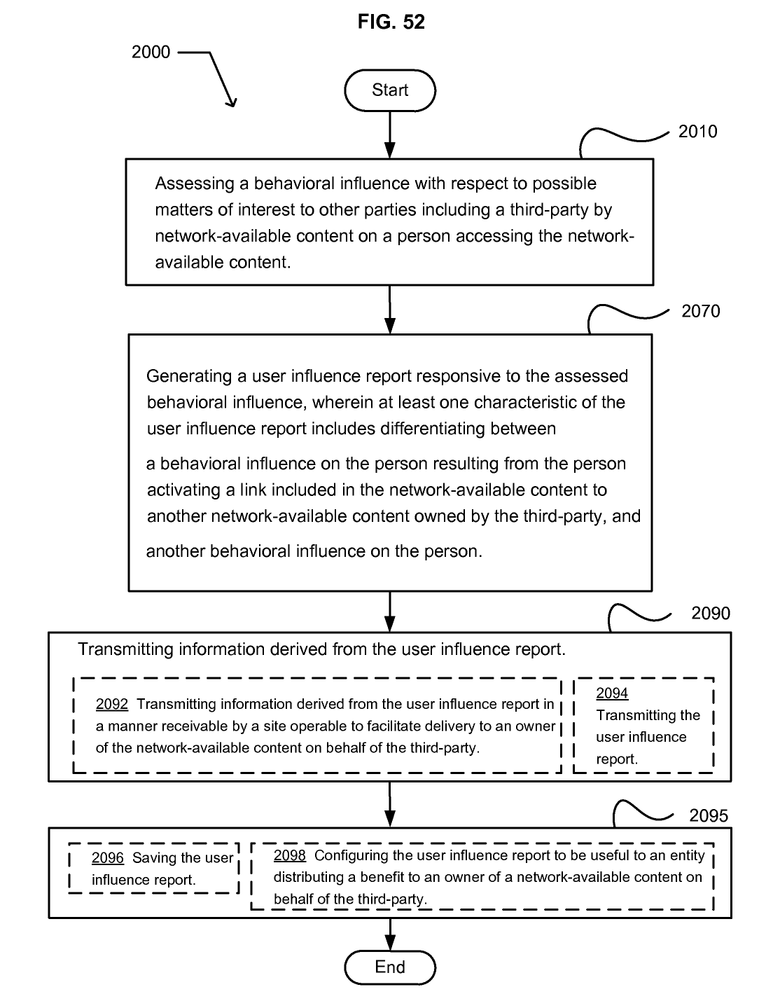

FIG. 52 illustrates an alternative embodiment of the operational flow 2000 described in FIG. 45. The broadcast operation 2090 may include at least one additional operation. The at least one additional operation may include an operation 2092, and/or an operation 2094. The operation 2092 transmits information derived from the user influence report in a manner receivable by a site operable to facilitate delivery to an owner of the network-available content on behalf of the third party. The operation 2094 transmits the user influence report.

The operational flow 2000 may include at least one additional operation 2095. The at least one additional operation may include an operation 2096, and/or an operation 2098. The operation 2096 saves the user influence report. The operation 2098 configures the user influence report to be useful to an entity distributing a benefit to an owner of a network-available content on behalf of the third party.

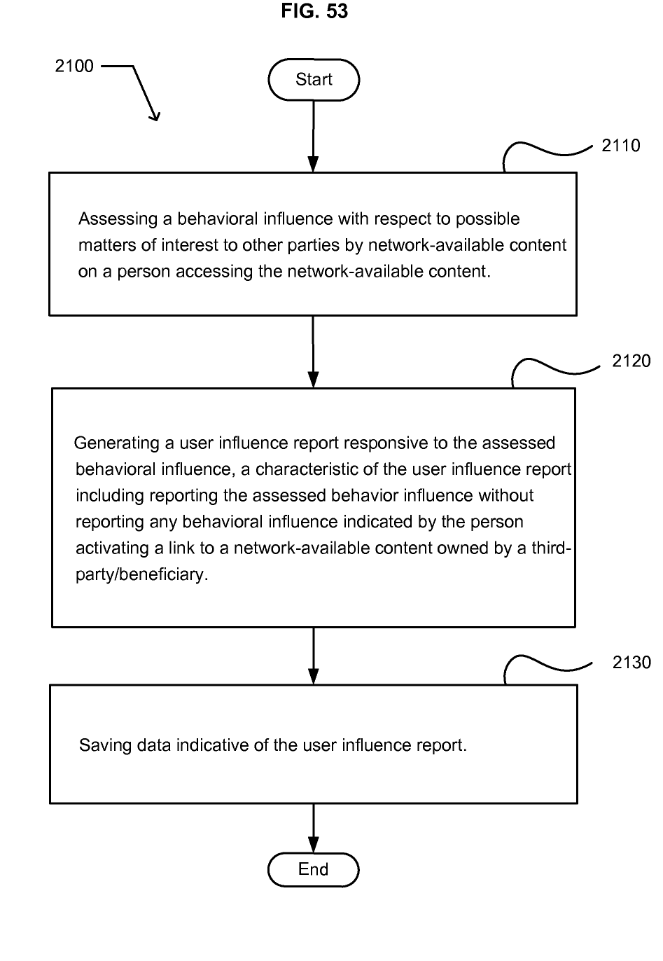

FIG. 53 illustrates an operational flow 2100 of reporting influence on a person. After a start operation, the operational flow includes an evaluation operation 2110. The evaluation operation assesses a behavioral influence with respect to possible matters of interest to other parties by network-available content on a person accessing the network-available content. An analysis operation 2120 generates a user influence report responsive to the assessed behavioral influence. A characteristic of the user influence report includes reporting the assessed behavior influence without reporting any behavioral influence indicated by the person activating a link to a network-available content owned by a third party/beneficiary. A retention operation 2130 saves data indicative of the user influence report. The operational flow then moves to an end operation.

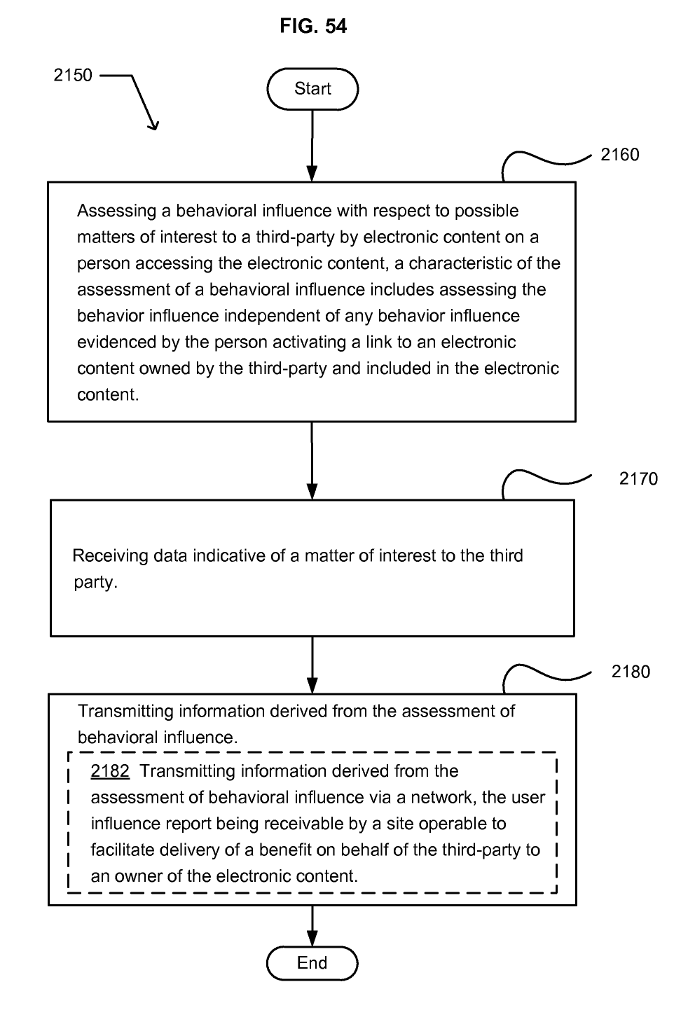

FIG. 54 illustrates an operational flow 2150 for reporting an influence of electronic content. After a start operation, the operational flow moves to an evaluation operation 2160. The evaluation operation assesses a behavioral influence with respect to possible matters of interest to a third party by the electronic content on a person accessing the electronic content. A characteristic of the assessment of a behavioral influence includes assessing the behavior influence independent of any behavior influence evidenced by the person activating a link to an electronic content owned by the third party and included in the electronic content. A data reception operation 2170 receives data indicative of a matter of interest to the third party. For example, the third party/beneficiary of FIG. 4 may be interesting in knowing whether there exists electronic content accessible over the Internet directed to a product they sell, and whether that electronic content is steering people toward the product and/or their Web site, illustrated as third party/beneficiary site 330. Continuing with this example, the data reception operation may in this example receive data indicating that the manufacturer is interested in electronic content related to their product. In an instance, a new car manufacturer may be introducing a new model car, and want to receive an assessment of behavioral influence on the person using the client/user machine 310 of FIG. 4 with respect to their new car. The data reception operation would receive data indicating that manufacturer X is interested in electronic content pertaining to their new model car Y. A dissemination operation 2180 transmits information derived from the assessment of behavioral influence. In an alternative embodiment, the dissemination operation may include at least one additional operation, illustrated as an operation 2182. The operation 2182 transmits information derived from the assessment of behavioral influence via a network. The user influence report is receivable by a site operable to facilitate delivery of a benefit on behalf of the third party to an owner of the electronic content. The operational flow then proceeds to an end operation. Also, although the various operational flows are illustrated in a sequence(s), it should be understood that the various operations may be performed in other orders than those which are illustrated, or may be performed concurrently.

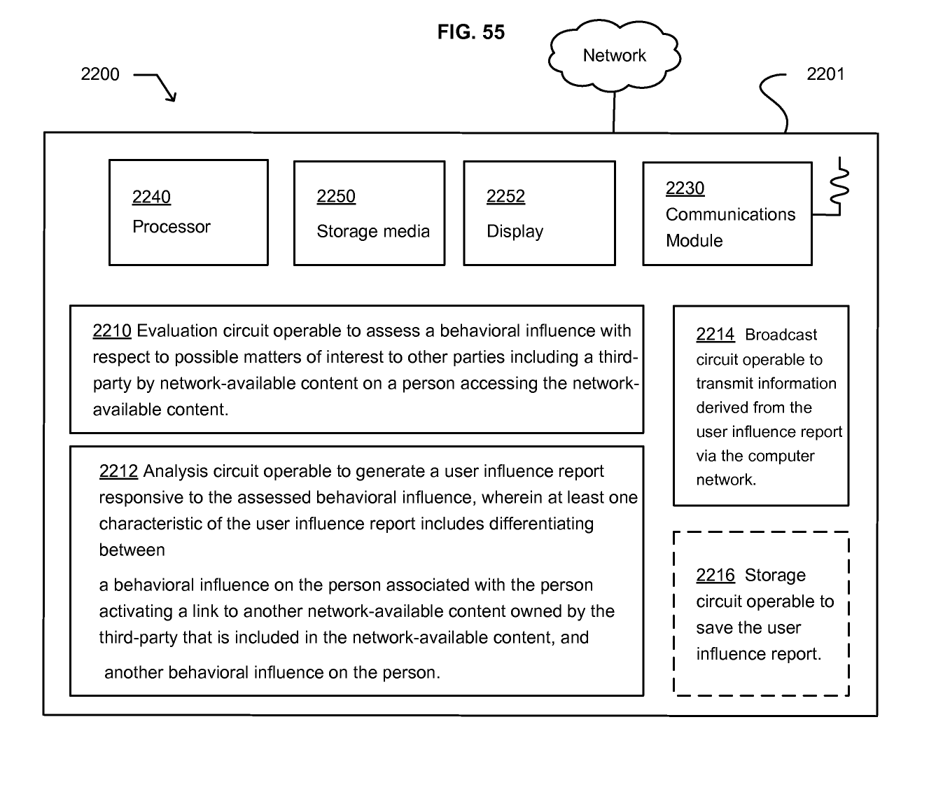

FIG. 55 illustrates a system 2200. The system includes a computing device 2201 couplable with a computer network. The system includes an evaluation circuit 2210, an analysis circuit 2122, and a broadcast circuit 2214. The system may include a storage circuit 2216. These circuits may be structurally incorporated with the computing device. Alternatively, one or more of these circuits may be structurally distinct from the computing device. In such embodiment, the one or more of these circuits may be implemented, for example, in an external device (not shown).

The evaluation circuit 2210 is operable to assess a behavioral influence with respect to possible matters of interest to other parties, including a third party, by network-available content on a person accessing the network-available content. The analysis circuit 2122 is operable to generate a user influence report responsive to the assessed behavioral influence. A characteristic of the user influence report includes differentiating between (i) a behavioral influence on the person associated with the person activating a link to another network-available content owned by the third party that is included in the network-available content, and (ii) another behavioral influence on the person. The broadcast circuit 2214 is operable to transmit information derived from the user influence report via the computer network. The storage circuit 2216 is operable to save the user influence report. For example, the user influence report may be saved in a storage media 2250 of the computing device.

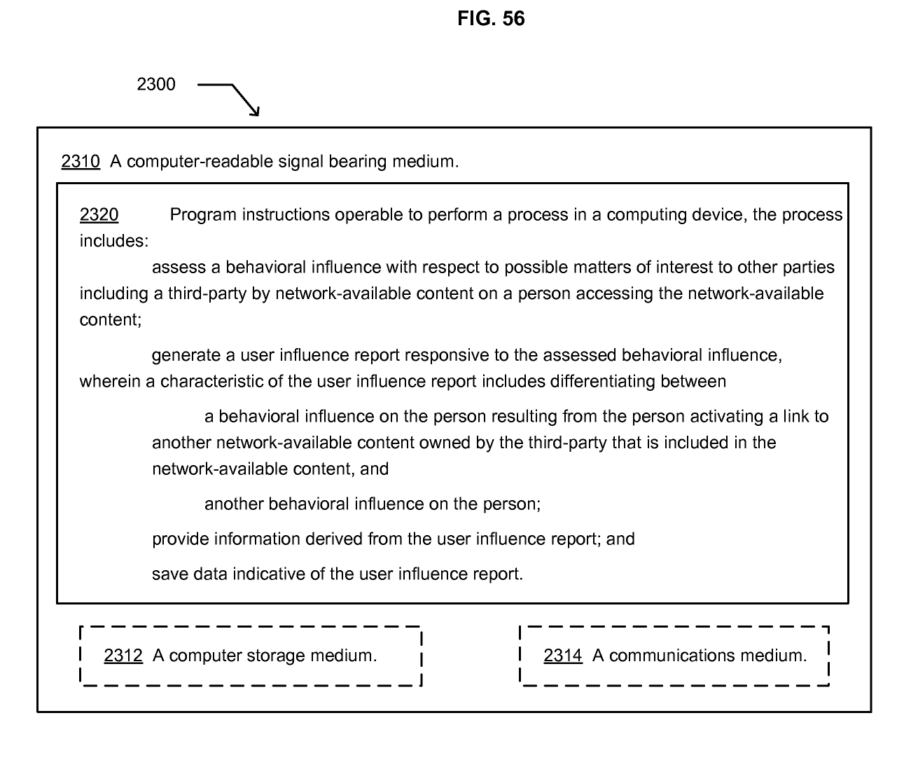

FIG. 56 illustrates an example computer program product 2300. The computer program product includes a computer-readable signal-bearing medium 2310 bearing program instructions 2325. The program instructions are operable to perform a process in a computing device. The process includes assess a behavioral influence with respect to possible matters of interest to other parties including a third party by network-available content on a person accessing the network-available content. The process also includes generate a user influence report responsive to the assessed behavioral influence. A characteristic of the user influence report includes differentiating between (i) a behavioral influence on the person resulting from the person activating a link to another network-available content owned by the third party that is included in the network-available content, and (ii) another behavioral influence on the person. The process further includes provide information derived from the user influence report. The process also includes save data indicative of the user influence report.

In an alternative embodiment, the computer-readable signal-bearing medium 2310 includes a computer storage medium 2312. In another embodiment, the computer-readable signal-bearing medium includes a communication medium 2314.

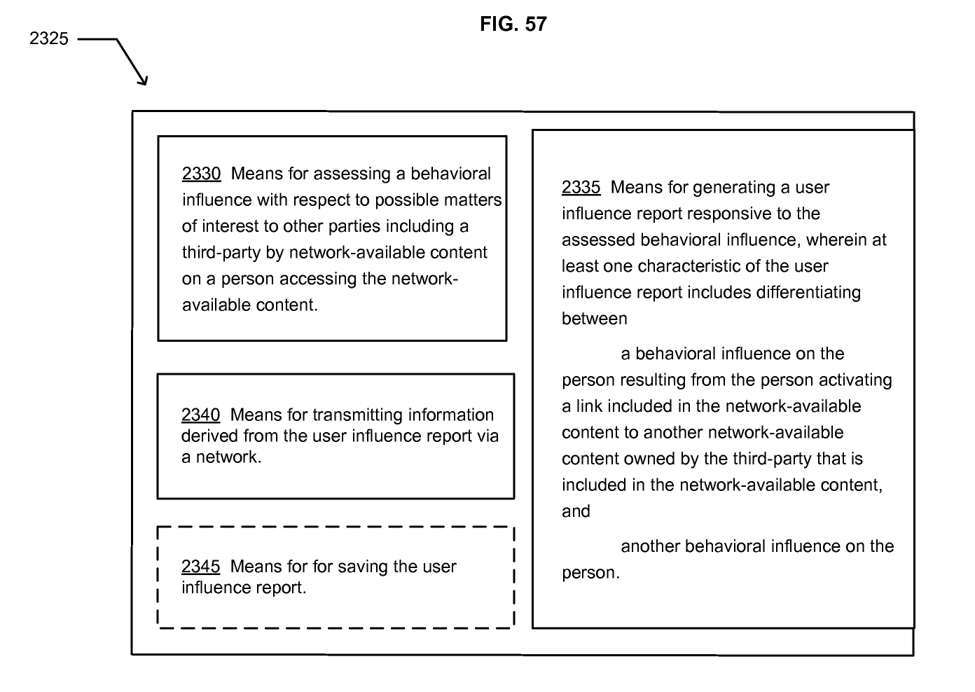

FIG. 57 illustrates an example apparatus 2320. The apparatus includes means 2330 for assessing a behavioral influence with respect to possible matters of interest to other parties including a third party by network-available content on a person accessing the network-available content. The apparatus also includes means 2335 for generating a user influence report responsive to the assessed behavioral influence. A characteristic of the user influence report includes differentiating between (i) a behavioral influence on the person resulting from the person activating a link included in the network-available content to another network-available content owned by the third party that is included in the network-available content, and (ii) another behavioral influence on the person. The apparatus further includes means 2340 for transmitting information derived from the user influence report via a network. In an alternative embodiment, the apparatus may include means 2345 for saving the user influence report.

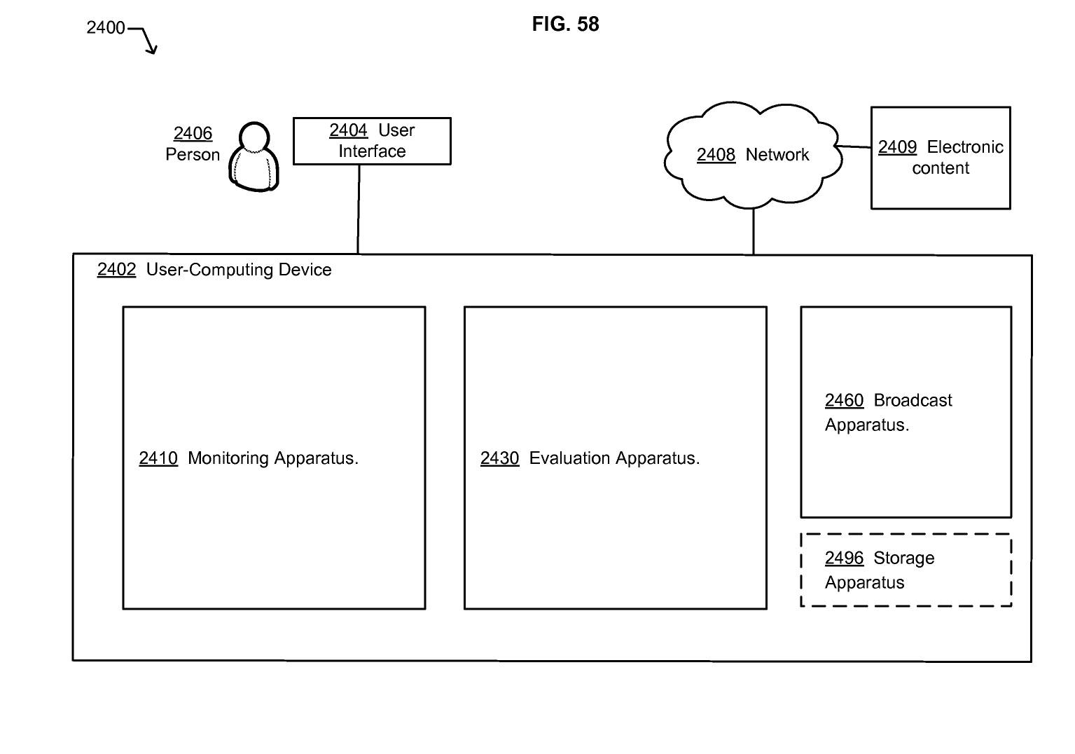

FIG. 58 illustrates an example system 2400. The system includes a computing device 2402. In an embodiment, the computing device includes a user-side computing device. In another embodiment, the computing device may include another computing device, such as a content server computing device, a search engine site, network-intermediary device, a page tag information processor, or other computing device. The computing device contains a monitoring apparatus 2410, an evaluation apparatus 2430, and a broadcast apparatus 2460. In some embodiments, the broadcast apparatus may be structurally distinct from the assessment apparatus and/or the report generator apparatus. A person 2406 via a user interface 2404 may use the user-computing device 2402 to access electronic content 2409 via a network 2408.

In an alternative embodiment, the user-computing device 2402 may include at least one additional apparatus. The at least one additional apparatus may include a storage apparatus 2496. The monitoring apparatus 2410 may include one or more sub-apparatus (not shown). The evaluation apparatus 2430 may include one or more sub-apparatus (not shown). The broadcast apparatus 2460 may include one or more sub-apparatus (not shown). In an embodiment, one of more of these apparatus may be implemented in hardware, software, and/or firmware.

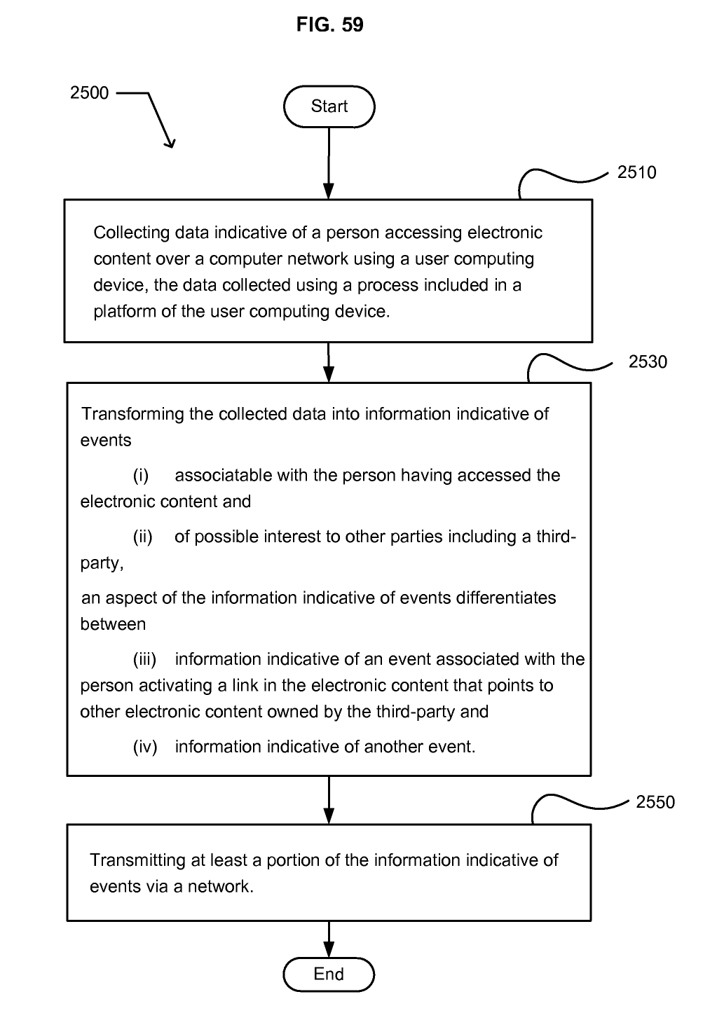

FIG. 59 and several following figures may include various examples of operational flows, discussions, and explanations with respect to the above-described system environment of FIG. 58, and/or with respect to other examples and contexts. However, it should be understood that the operational flows may be executed in a number of other environment and contexts, and/or in modified versions of FIG. 58. Also, although the various operational flows are illustrated in a sequence(s), it should be understood that the various operations may be performed in other orders than those which are illustrated, and/or may be performed concurrently.

FIG. 59 illustrates an example operational flow 2500 for reporting a possible influential electronic content. After a start operation, the operational flow moves to a monitoring operation 2510. The monitoring operation collects data indicative of a person accessing electronic content over a computer network using a user computing device. The data is collected using a process included in a platform of the user computing device. A deriving operation 2530 transforming the collected data into information indicative of events (i) associatable with the person having accessed the electronic content and (ii) of possible interest to other parties including a third party. An aspect of the information indicative of events differentiates between (iii) information indicative of an event associated with the person activating a link in the electronic content that points to other electronic content owned by the third party and (iv) information indicative of another event. A broadcast operation 2550 transmits at least a portion of the information indicative of events via a network. The operational flow then moves to an end operation.

In an embodiment, the operational flow 2500 may be implemented in the system environment illustrated in conjunction with FIG. 58. The monitoring operation 2510 may be performed by the monitoring apparatus 2410 of the computing device 2702 of FIG. 58. The deriving operation 2530 may be performed by the evaluation apparatus 2430. The broadcast operation 2550 may be performed by the broadcast apparatus 2460.

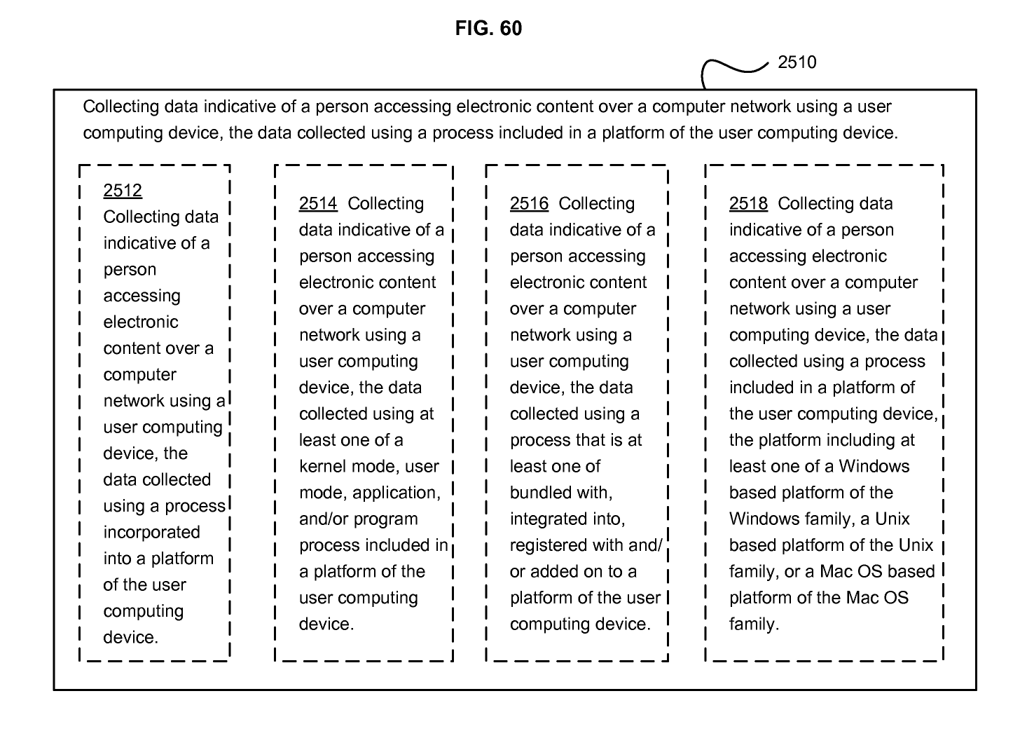

FIG. 60 illustrates an alternative embodiment of the operational flow 2500 of FIG. 59. The monitoring operation 2510 may include at least one additional operation. The at least one additional operation may include an operation 2512, an operation 2514, an operation 2516, and/or an operation 2518. The operation 2512 collects data indicative of a person accessing electronic content over a computer network using a user computing device. The data is collected using a process incorporated into a platform of the user computing device. The operation 2514 collects data indicative of a person accessing electronic content over a computer network using a user computing device. The data is collected using at least one of a kernel mode, user mode, application, and/or program process included in a platform of the user computing device. The operation 2516 collects data indicative of a person accessing electronic content over a computer network using a user computing device. The data is collected using a process that is at least one of bundled with, integrated into, registered with and/or added on to a platform of the user computing device. The operation 2518 collects data indicative of a person accessing electronic content over a computer network using a user computing device, the data collected using a process included in a platform of the user computing device. The platform including at least one of a Windows based platform of the Windows family, a Unix based platform of the Unix family, or a Mac OS based platform of the Mac OS family. The platform may include a Windows based platform of the Windows family, a Unix based platform of the Unix family, or a Mac OS based platform of the Mac OS family. For example, a Windows family may include one or more of a Windows OS for a desktop, such as Vista, a Windows OS for a mobile device, such as Mobile 5, and/or a Microsoft Windows OS for a gaming device, such as Xbox 360 OS. In an another example, a Mac OS family may include one or more of Mac OS for a desktop or a MacBook, such as Mac OS X, an OS for a mobile music device, such as Mac OS X version for an iPod, and/or a Mac OS for mobile device, such as Mac OS X version for iPhone. A platform may span at least two machines. In an embodiment, the platform of the user computing device may include a common OS across at least two user computing devices. The at least two user computing devices may or may not be able to talk with each other. For example, the data may be collected across at least two devices having a Mac OS based platform, such as MacBook, iMac desktop, an iPhone, and/or an iPod.

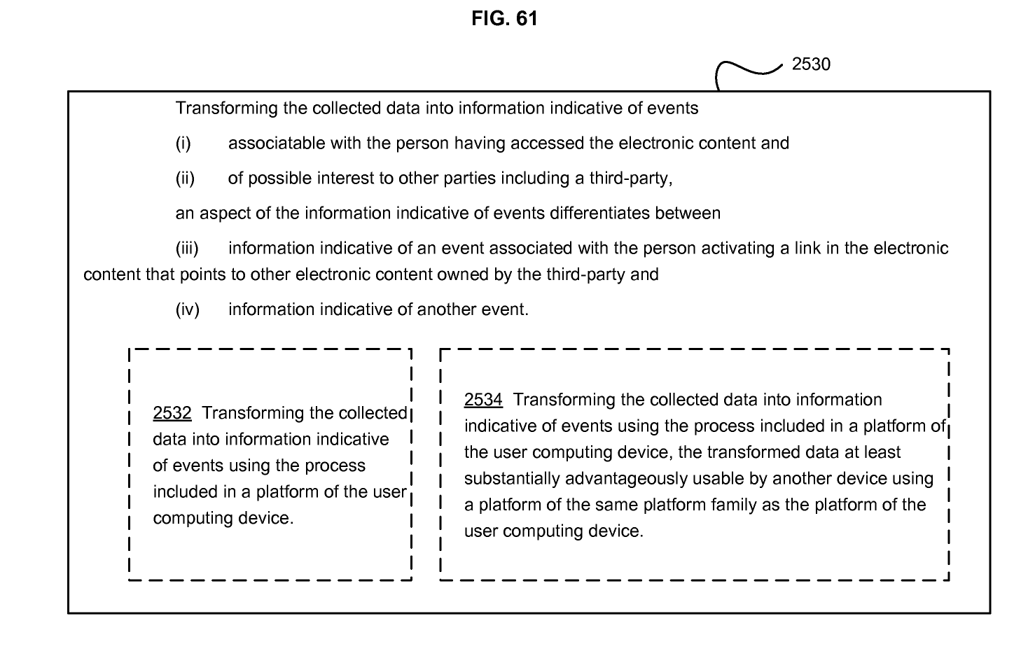

FIG. 61 illustrates another embodiment of the operational flow 2500 of FIG. 59. The deriving operation 2530 may include at least one additional operation. The at least one additional operation may include an operation 2532 and/or an operation 2534. At the operation 2532, the transforming the collected data into information indicative of events further includes transforming the collected data into information indicative of events using the process included in a platform of the user computing device. At the operation 2534, the transforming the collected data into information indicative of events further includes transforming the collected data into information indicative of events using the process included in a platform of the user computing device. The transformed data being at least substantially advantageously usable by another device using a platform of the same platform family as the platform of the user computing device.

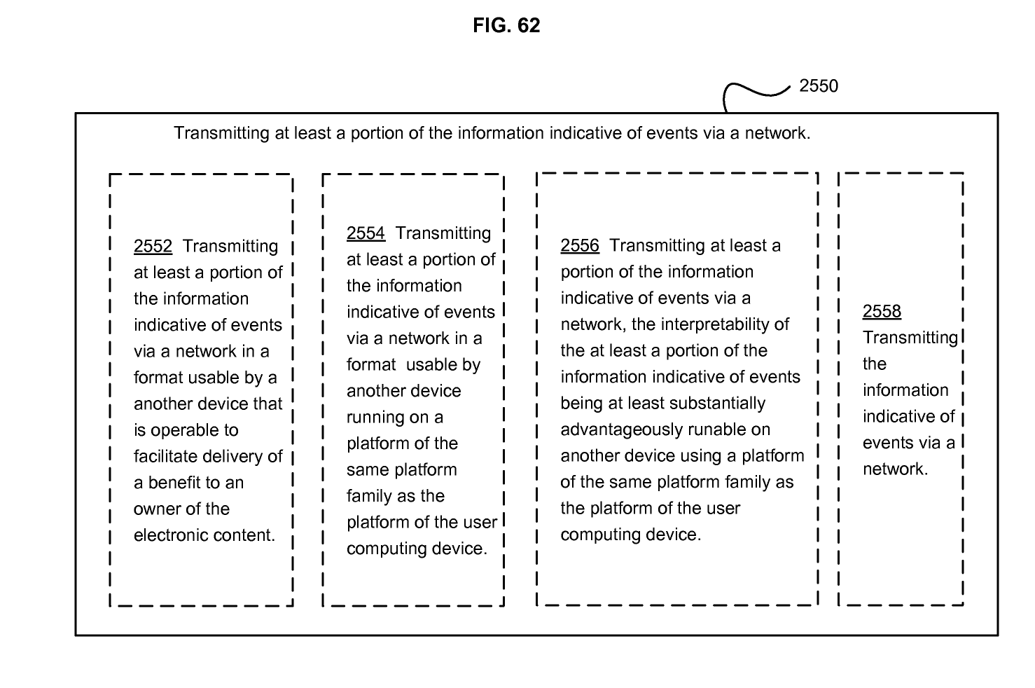

FIG. 62 illustrates a further embodiment of the operational flow 2500 of FIG. 55. The broadcast operation 2550 may include at least one additional operation. The at least one additional operation may include an operation 2552, an operation 2554, an operation 2556, and/or an operation 2558. The operation 2552 transmits at least a portion of the information indicative of events via a network in a format usable by another device that is operable to facilitate delivery of a benefit to an owner of the electronic content. The operation 2554 transmitting at least a portion of the information indicative of events via a network in a format usable by another device running on a platform of the same platform family as the platform of the user computing device. The operation 2556 transmits at least a portion of the information indicative of events via a network. The interpretability of the at least a portion of the information indicative of events being at least substantially advantageously runnable on another device using a platform of the same platform family as the platform of the user computing device. The operation 2558 transmits the information indicative of events via a network.

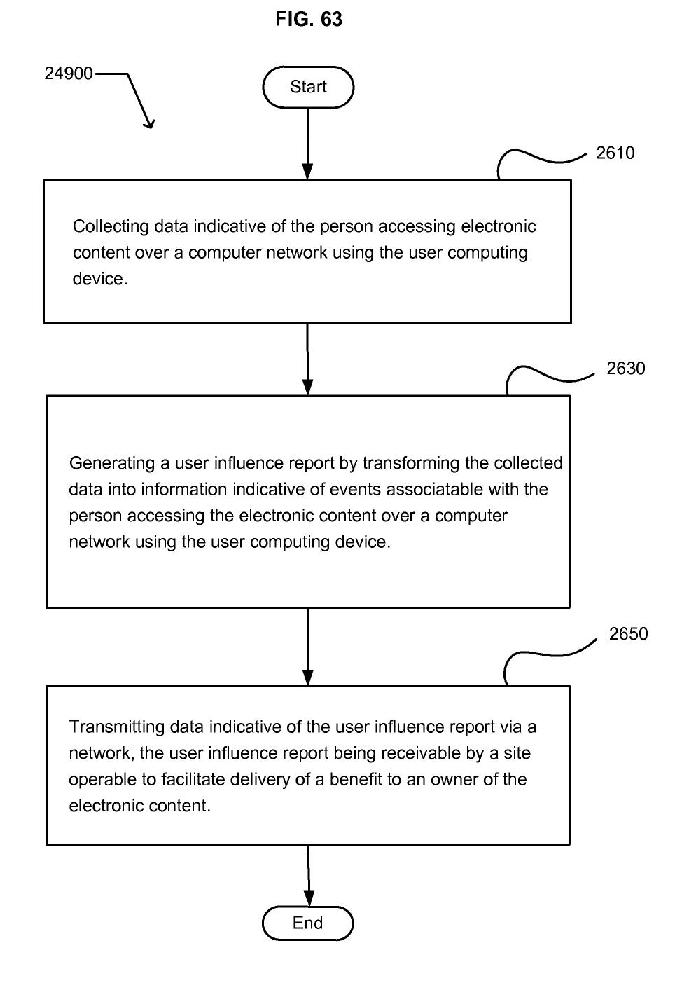

FIG. 63 illustrates an operational flow 2600 for reporting influence on a person. After a start operation, the operational flow moves to a monitoring operation 2610. The monitoring operation collects data indicative of the person accessing electronic content over a computer network using the user computing device. A deriving operation 2630 generates a user influence report by transforming the collected data into information indicative of events associatable with the person accessing the electronic content over a computer network using the user computing device. A broadcasting operation 2650 transmits data indicative of the user influence report via a network. The user influence report is receivable by a site coupled to the network and operable to facilitate delivery of a benefit to an owner of the electronic content. The operational flow then moves to an end operation.

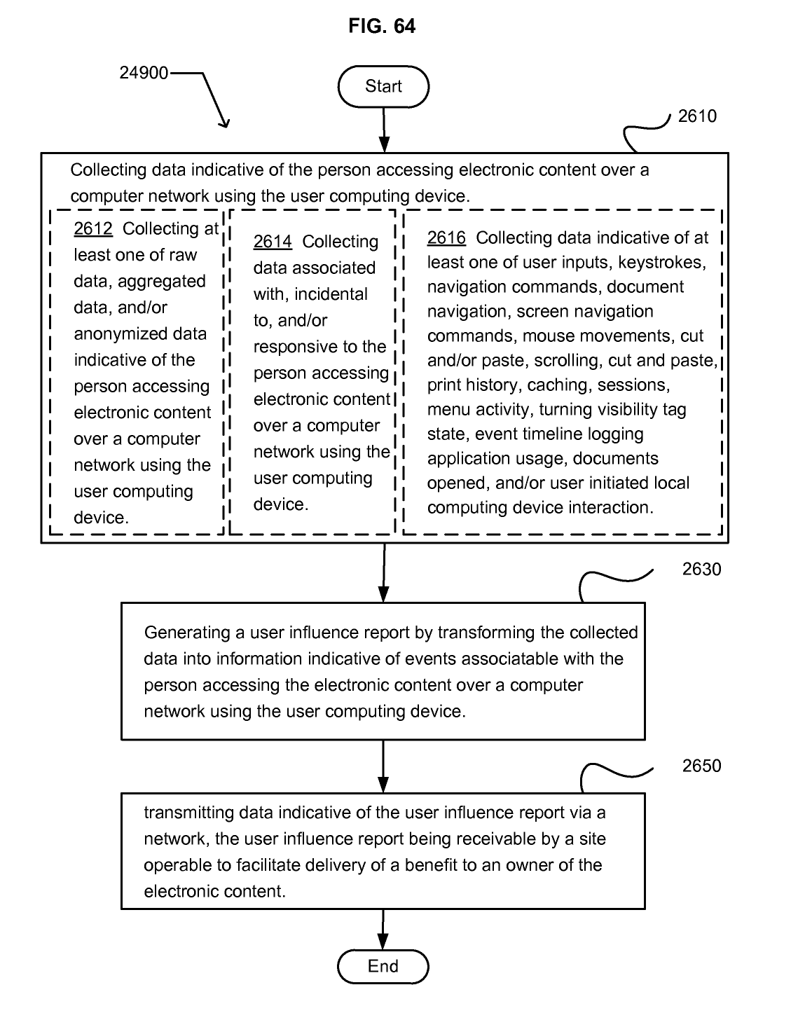

FIG. 64 illustrates an alternative embodiment of the operational flow 2600 of FIG. 63. The monitoring operation 2610 may include at least one additional operation. The at least one additional operation may include an operation 2612, an operation 2614, an operation 2616, and/or an operation 2617. The operation 2612 collects at least one of raw data, aggregated data, and/or anonymized data indicative of the person accessing electronic content over a computer network using the user computing device. The operation 2614 collects data associated with, incidental to, and/or responsive to the person accessing electronic content over a computer network using the user computing device. The operation 2616 collects data indicative of at least one of user inputs, keystrokes, navigation commands, document navigation, screen navigation commands, mouse movements, cut and/or paste, scrolling, cut and paste, print history, caching, sessions, menu activity, visibility tag state, event timeline, logging application usage, documents opened, and/or user initiated computing device interaction. For example, the collect data indicative of keystrokes may include logging all keystrokes along with an indication of the window in which they are typed. By way of further example, the log application usage may include logging events performed, and may additionally include organizing a listing of the logged events. Additionally, log application usage may include monitoring and logging all applications run. Further, collect data indicative of documents opened may include logging documents and/or files opened and/or viewed. The operation 2617 (not shown) collects data indicative of at least one of a user physiological state, tracked user gaze, user dwell time, user pupil dilation, user respiration, and/or user pulse rate.

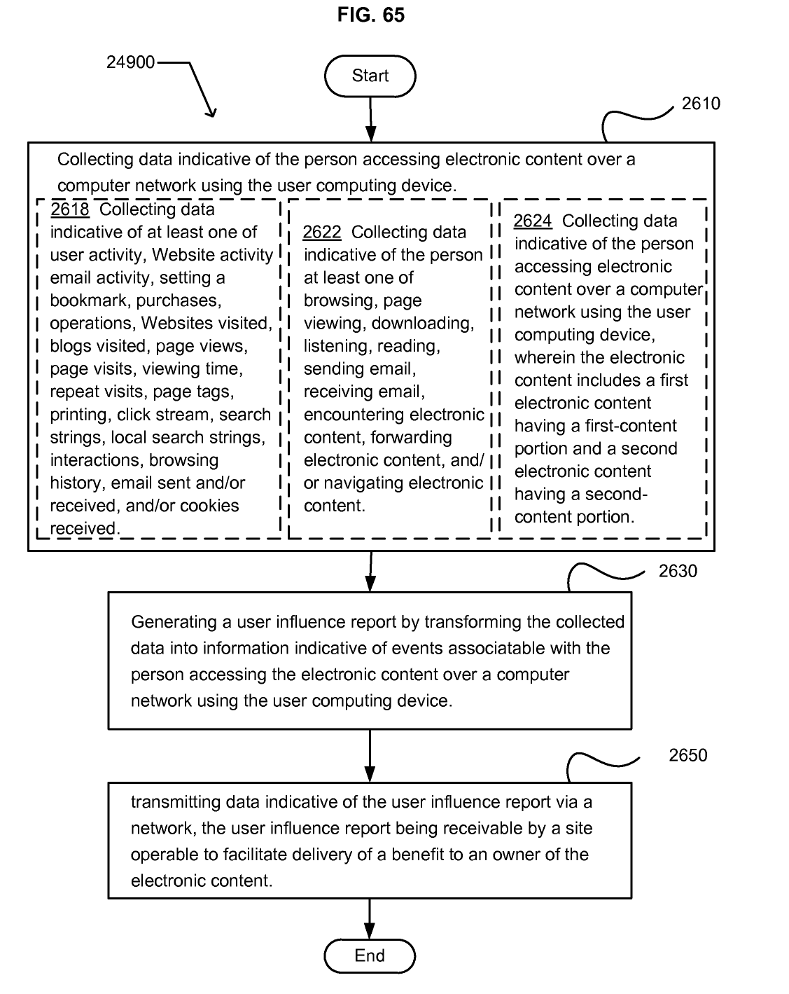

FIG. 65 illustrates another embodiment of the operational flow 2600 of FIG. 63. The monitoring operation 2610 may include at least one additional operation. The at least one additional operation may include an operation 2618, an operation 2619, an operation 2622, and/or an operation 2624. The operation 2618 collects data indicative of at least one of user activity, Website activity email activity, setting a bookmark, purchases, operations, Websites visited, blogs visited, page views, page visits, viewing time, repeat visits, page tags, printing, click stream, search strings, local search strings, interactions, browsing history, email sent and/or received, and/or cookies received. For example, the collect data indicative of Website activity may include logging websites visited by at least one browser. The operation 2619 (not shown) collects data indicative of at least one of Window navigation, tab navigation; window state, tap state, preference changes, and/or state changes. The operation 2622 collects data indicative of the person at least one of browsing, page viewing, downloading, listening, reading, sending email, receiving email, encountering the electronic content, forwarding the electronic content, and/or navigating the electronic content. The operation 2624 collects data indicative of the person accessing the electronic content over a computer network using the user computing device, wherein the electronic content includes a first electronic content having a first-content portion and a second electronic content having a second-content portion. In a further embodiment, the electronic content includes a first electronic content having a first-content portion potentially relevant to a third party and a second electronic content having a second-content portion potentially relevant to the third party.

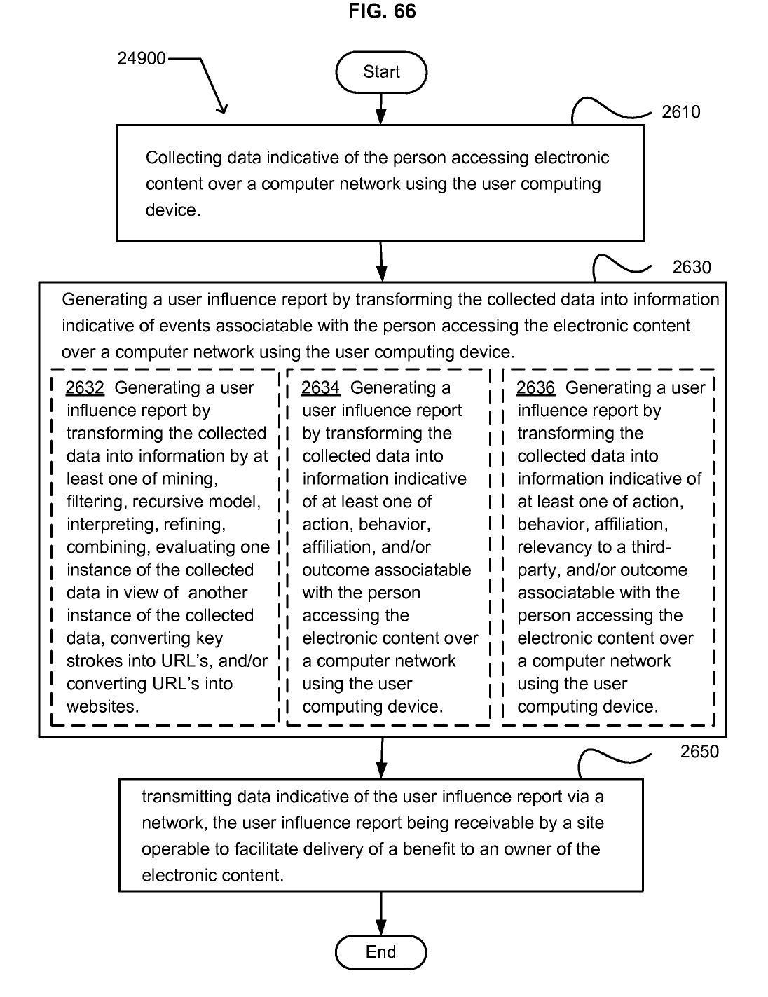

FIG. 66 illustrates a further embodiment of the operational flow 2600 of FIG. 63. The deriving operation 2630 may include at least one additional embodiment. The at least one additional embodiment may include an operation 2632, an operation 2634, and/or an operation 2636. The operation 2632 generates a user influence report by transforming the collected data into information by at least one of mining, filtering, recursive model, interpreting, refining, combining, evaluating one instance of the collected data in view of another instance of the collected data, converting key strokes into URL's, and/or converting URL's into websites. The operation 2634 generates a user influence report by transforming the collected data into information indicative of at least one of action, behavior, affiliation, and/or outcome associatable with the person accessing the electronic content over a computer network using the user computing device. The operation 2636 generates a user influence report by transforming the collected data into information indicative of at least one of action, behavior, affiliation, relevancy to a third party, and/or outcome associatable with the person accessing the electronic content over a computer network using the user computing device.

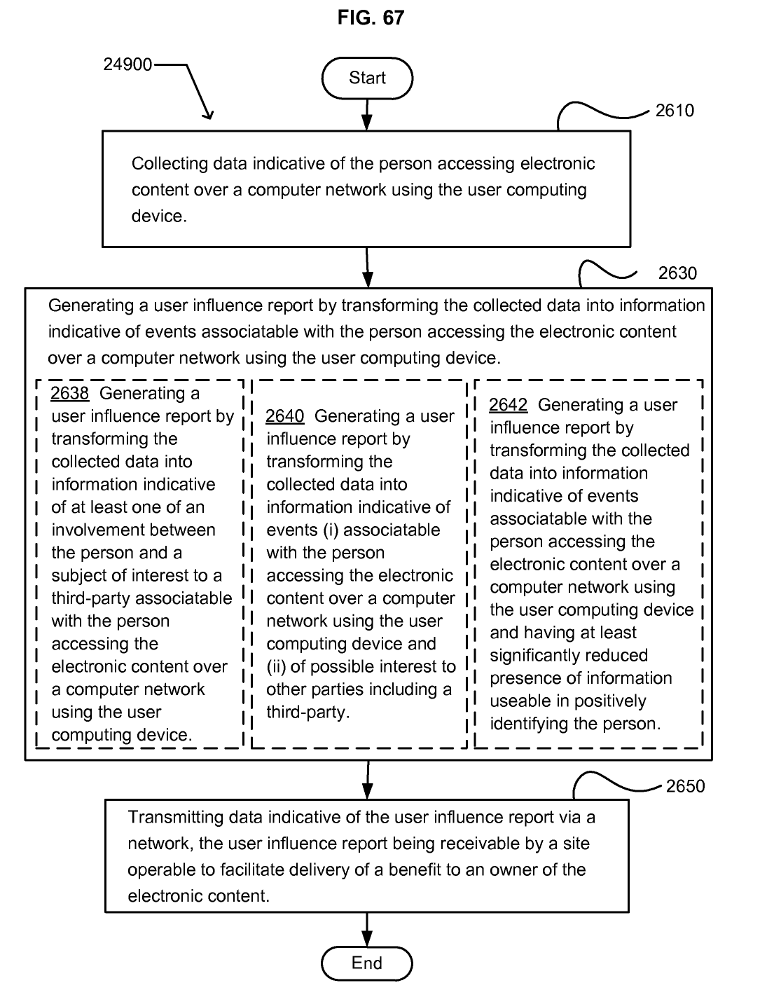

FIG. 67 illustrates an alternative embodiment of the operational flow 2600 of FIG. 63. The deriving operation 2630 may include at least one additional embodiment. The at least one additional embodiment may include an operation 2638, an operation, 2640, and/or an operation 2642. The operation 2638 generates a user influence report by transforming the collected data into information indicative of at least one of an involvement between the person and a subject of interest to a third party associatable with the person accessing the electronic content over a computer network using the user computing device. For example, an involvement may include at least one of a purchase, a donation, a membership, and/or an inquiry. The operation 2640 generates a user influence report by transforming the collected data into information indicative of events (i) associatable with the person accessing the electronic content over a computer network using the user computing device and (ii) of possible interest to other parties including a third party. The operation 2642 generates a user influence report by transforming the collected data into information indicative of events associatable with the person accessing the electronic content over a computer network using the user computing device and having at least significantly reduced presence of information useable in positively identifying the person.

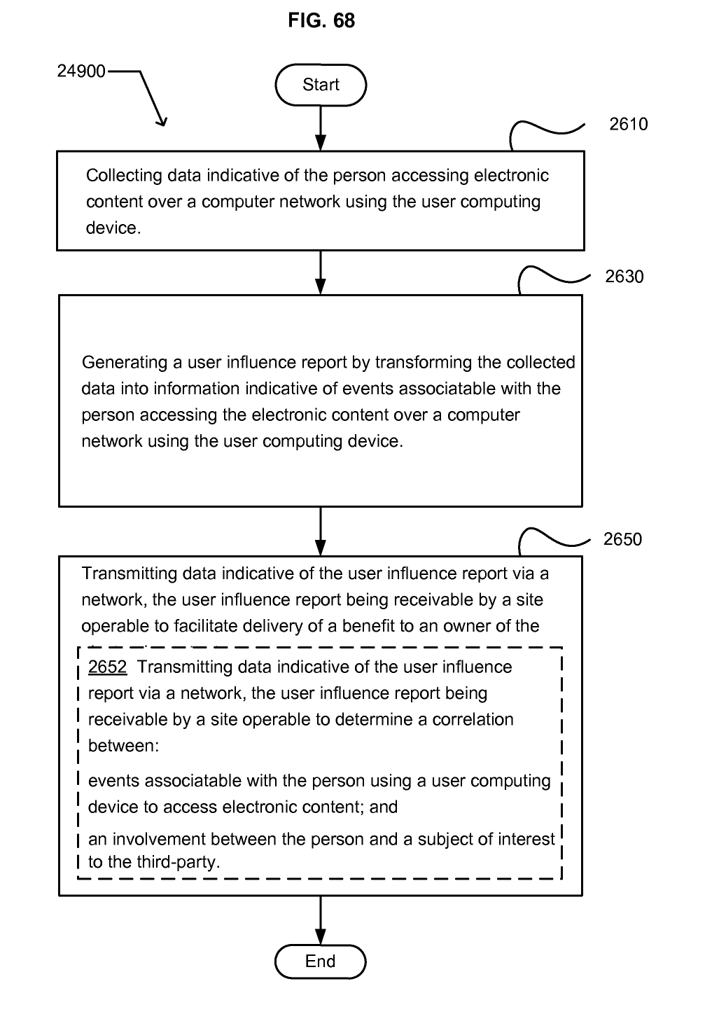

FIG. 68 illustrates another alternative embodiment of the operational flow 2600 of FIG. 59. The broadcast operation 2650 may include at least one additional embodiment, such as an operation 2652. The operation 2652 transmits data indicative of the user influence report via a network, the user influence report being receivable by a site operable to determine a correlation between (i) events associatable with the person using a user computing device to access electronic content; and (ii) an involvement between the person and a subject of interest to a third party.

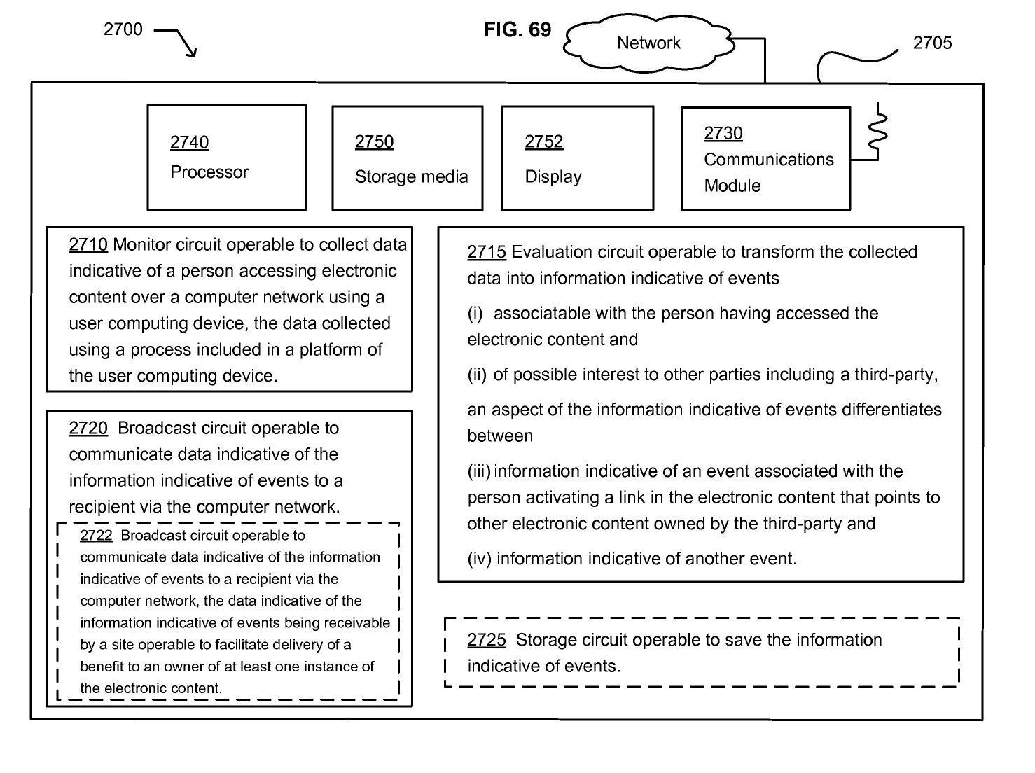

FIG. 69 illustrates an example system 2700 in which embodiments may be implemented. The system includes a computing device 2705 couplable with a computer network. The system also includes a monitor circuit 2710, an evaluation circuit 2715, and a broadcast circuit 2720. An alternative embodiment may include a storage circuit 2725. These circuits may be structurally incorporated with the computing device. Alternatively, one or more of these circuits may be structurally distinct from the computing device. In such embodiment, the one or more of these circuits may be implemented, for example, in an external device (not shown).

The monitor circuit 2710 is operable to collect data indicative of a person accessing electronic content over a computer network using a user computing device. The data is collected using a process included in a platform of the user computing device. The evaluation circuit 2715 is operable to transform the collected data into information indicative of events (i) associatable with the person having accessed the electronic content and (ii) of possible interest to other parties including a third party. An aspect of the information indicative of events differentiates between (iii) information indicative of an event associated with the person activating a link in the electronic content that points to other electronic content owned by the third party and (iv) information indicative of another event. The broadcast circuit 2720 is operable to communicate data indicative of the information indicative of events to a recipient via the computer network. The storage circuit 2725 is operable to save the information indicative of events.

In an alternative embodiment, the broadcast circuit 2720 includes a broadcast circuit 2722 operable to communicate data indicative of the information indicative of events to a recipient via the computer network. The data indicative of the information indicative of events is receivable by a site operable to facilitate delivery of a benefit to an owner of at least one instance of the electronic content.

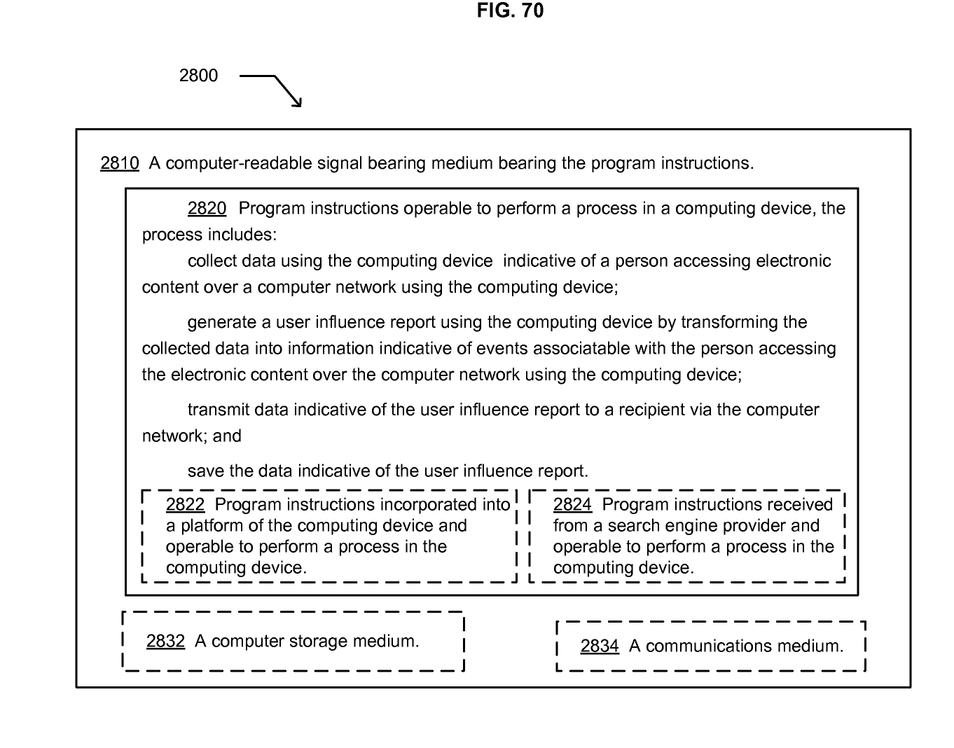

FIG. 70 illustrates an example computer program product 2800. The computer program product includes a computer-readable signal-bearing medium 2810 bearing program instructions 2820. The program instructions are operable to perform a process in a computing device. The process includes collect data using the computing device indicative of a person accessing electronic content over a computer network using the computing device. The process also includes generate a user influence report using the computing device by transforming the collected data into information indicative of events associatable with the person accessing the electronic content over the computer network using the computing device. The process further includes transmit data indicative of the user influence report to a recipient via the computer network. The process includes save data indicative of the user influence report.

In an alternative embodiment, the program instructions 2820 further include program instructions 2822 incorporated into a platform of the computing device and operable to perform a process in the computing device. In another embodiment, the program instructions further include program instructions 2824 received from a search engine provider and operable to perform a process in the computing device. In a further embodiment, the computer-readable signal-bearing medium includes a computer storage medium 2832. In another embodiment, the computer-readable signal-bearing medium includes a communication medium 2834.

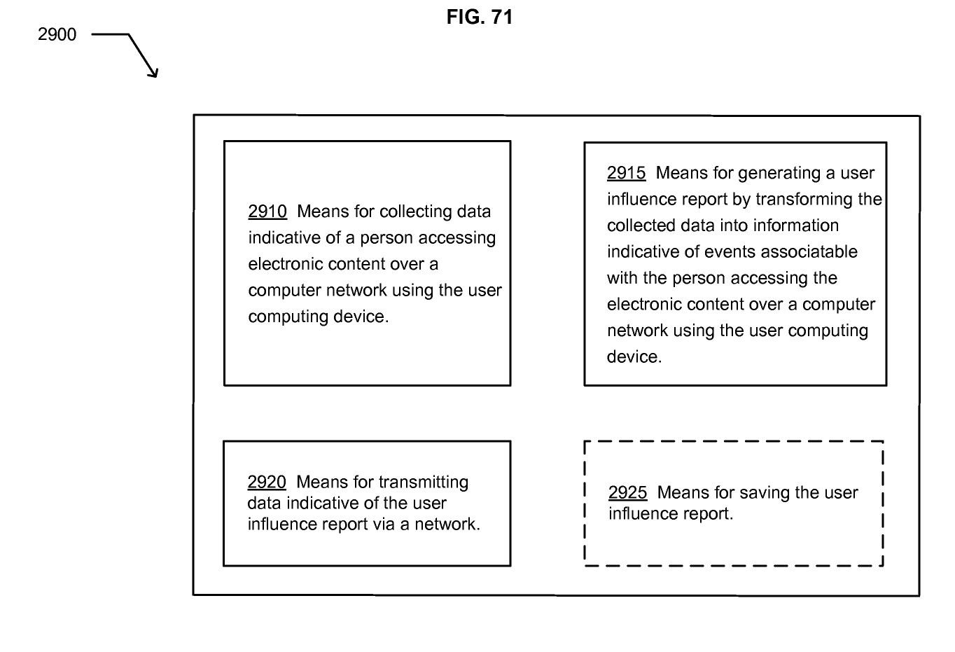

FIG. 71 illustrates an influence reporting apparatus 2900. The apparatus includes means 2910 for collecting data indicative of a person accessing electronic content over a computer network using the user computing device. The apparatus also includes means 2915 for generating a user influence report by transforming the collected data into information indicative of events associatable with the person accessing the electronic content over a computer network using the user computing device. The apparatus also includes means 2920 for transmitting data indicative of the user influence report via a network. In an alternative embodiment, the apparatus includes means 2920 for saving the user influence report.

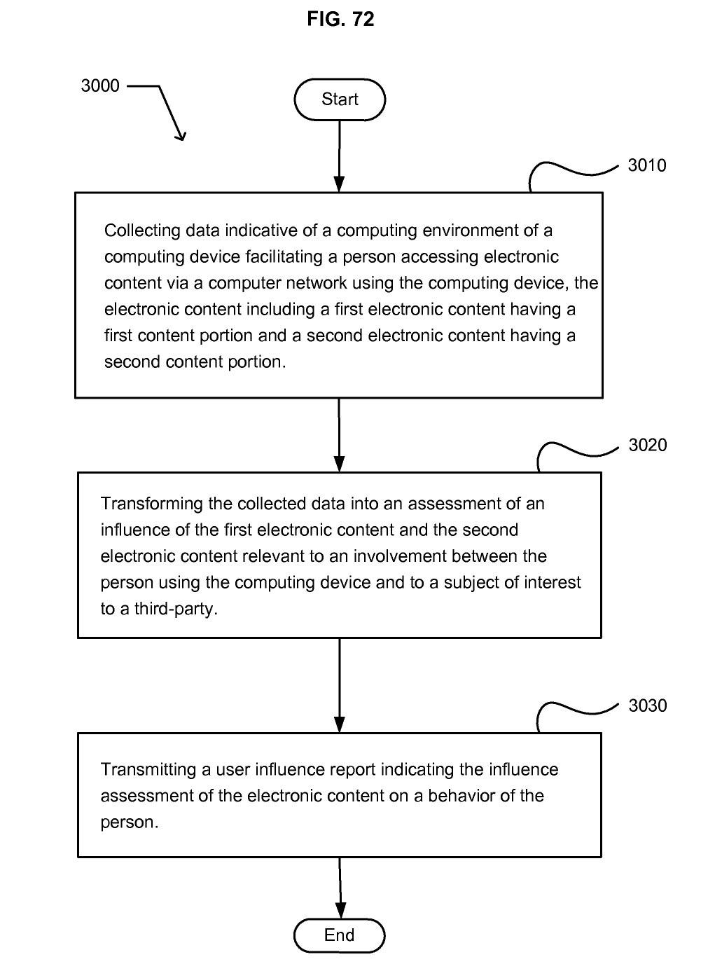

FIG. 72 illustrates an example operational flow 3000 for assessing an influence of an electronic content on a person. After a start operation, the operational flow moves to a monitoring operation 3010. The monitoring operation collects data indicative of a computing environment of a computing device facilitating a person accessing electronic content via a computer network using the computing device. The electronic content including a first electronic content having a first content portion and a second electronic content having a second content portion.

In an embodiment, the computing environment includes a particular configuration of hardware and/or software of the computing device. For example, the computing environment may include a state of the hardware and/or software of the computing device, or a series of states of the hardware and/or software. A state of a software of the computing device may include a URL of a Website electronic content displayed by a browser of the computing device, key words in the Website content, navigation commands implemented with respect to the Website, a Website owner, elapsed time in the state, and/or identification of a prior and/or subsequent Website content displayed. In another embodiment, the computing environment refers to a hardware platform and an operating system running in the computing device. In a further embodiment, a computing environment is used to express a type of configuration, such as a networking environment, database environment, transaction processing environment, batch environment, interactive environment, and so on.

The operational flow 3000 includes an evaluation operation 3020 transforming the collected data into an assessment of an influence of the first electronic content and the second electronic content relevant to an involvement between the person using the computing device and to a subject of interest to a third party. The operational flow also includes a broadcast operation 3030 transmitting a user influence report indicating the influence assessment of the electronic content on a behavior of the person. The operational flow then moves to an end operation.

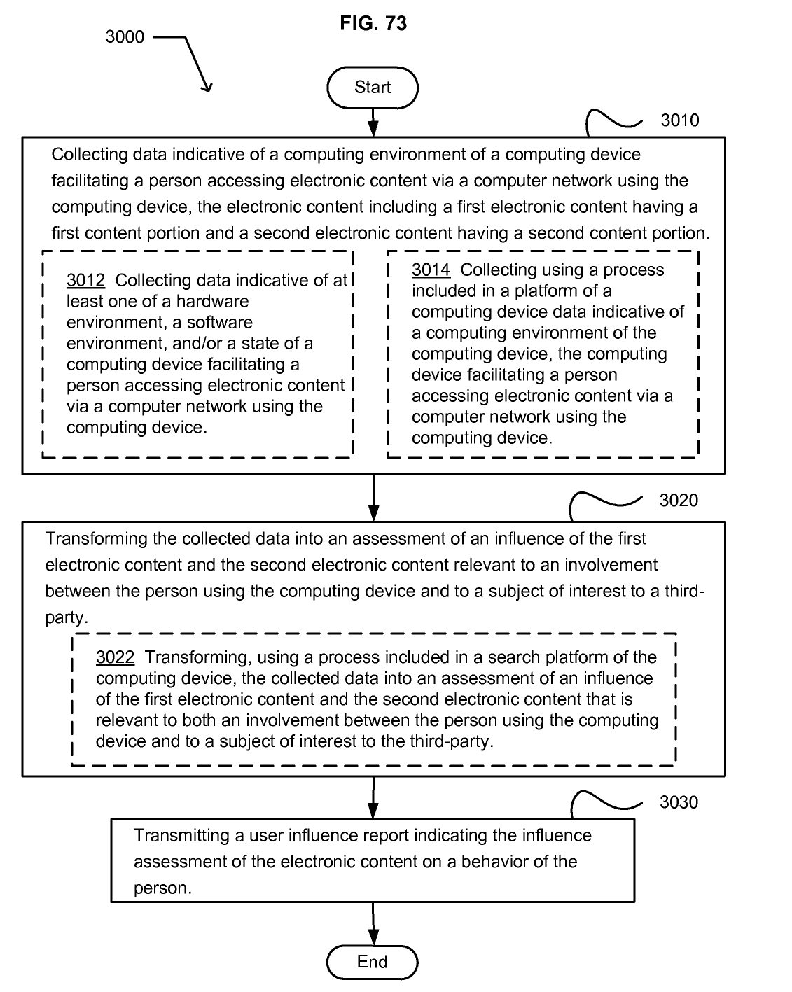

FIG. 73 illustrates an alternative embodiment of the operational flow 3000 of FIG. 68. The monitoring operation 3010 may include at least one additional operation. The at least one additional operation may include an operation 3012, and/or an operation 3014. The operation 3012 collects data indicative of at least one of a hardware environment, a software environment, and/or a state of a computing device facilitating a person accessing electronic content via a computer network using the computing device. The operation 3014 collects using a process included in a platform of a computing device data indicative of a computing environment of the computing device, the computing device facilitating a person accessing electronic content via a computer network using the computing device. The evaluation operation 3020 may include at least one additional operation, such as an operation 3022. The operation 3022 assesses using a process included in a search platform of the computing device an influence of the first electronic content and the second electronic content on an involvement between the person using the computing device and a subject of interest to the third party.

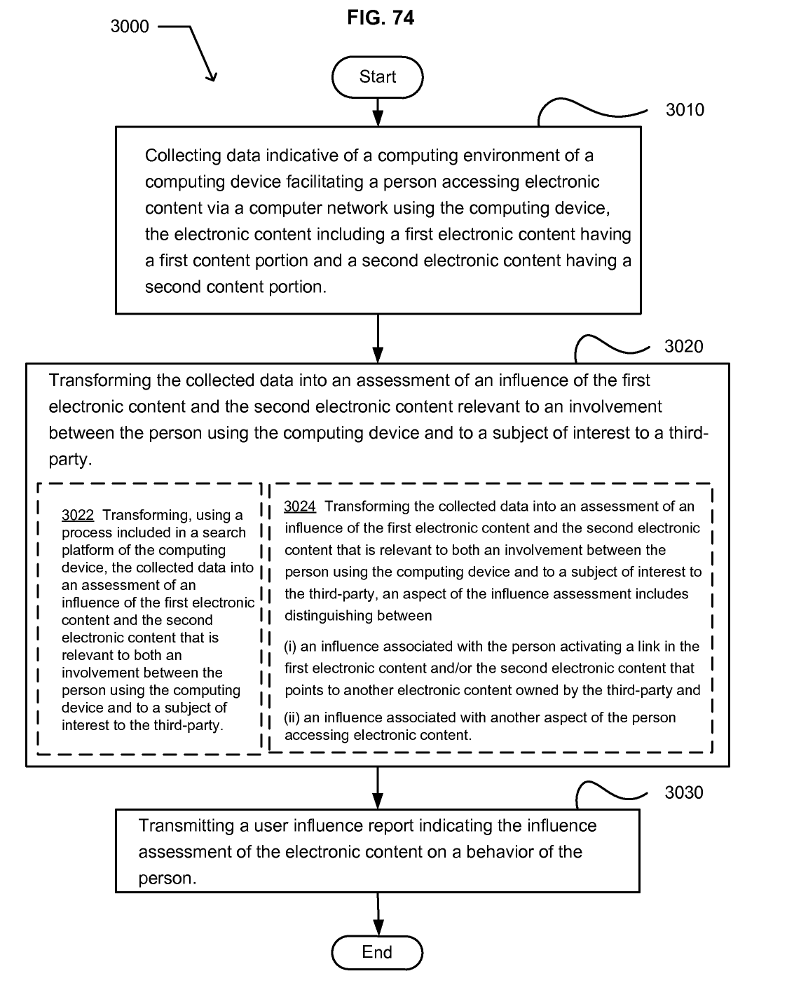

FIG. 74 illustrates another alternative embodiment of the operational flow 3000 of FIG. 68. The evaluation operation 3020 may include at least one additional operation. The at least one additional operation may include an operation 3022, and/or an operation 3024. The operation 3022 transforms, using a process included in a search platform of the computing device, the collected data into an assessment of an influence of the first electronic content and the second electronic content that is relevant to both an involvement between the person using the computing device and to a subject of interest to the third party. The operation 3024 transforms the collected data into an assessment of an influence of the first electronic content and the second electronic content that is relevant to both an involvement between the person using the computing device and to a subject of interest to the third party. An aspect of the influence assessment includes distinguishing between (i) an influence associated with the person activating a link in the first electronic content and/or the second electronic content that points to another electronic content owned by the third party and (ii) an influence associated with another aspect of the person accessing electronic content.

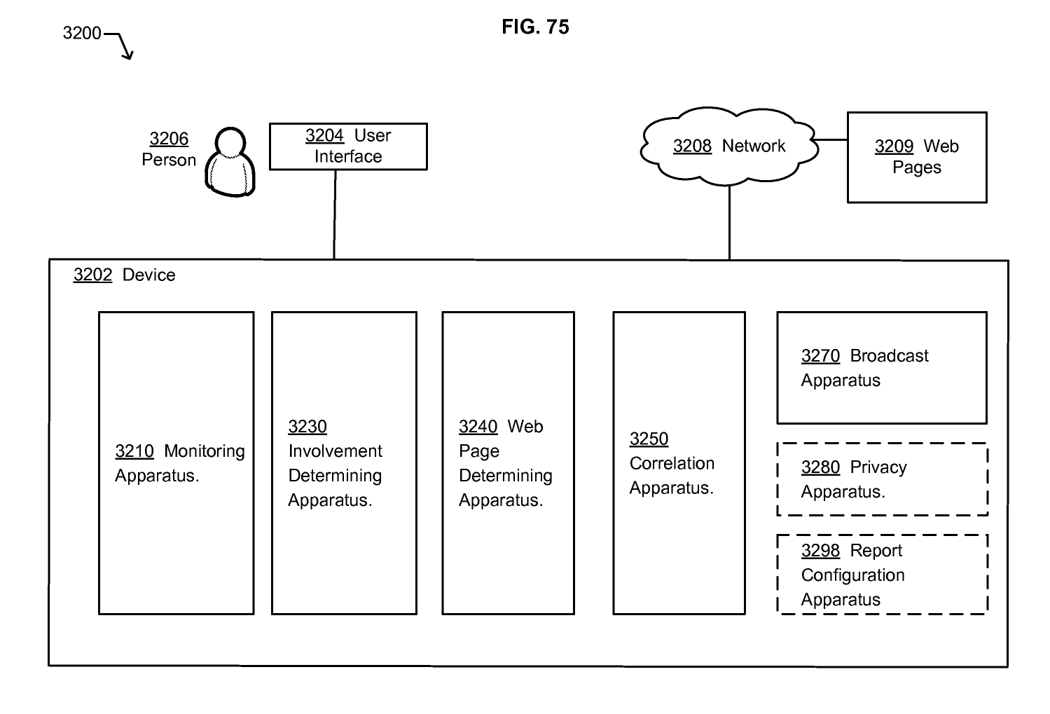

FIG. 75 illustrates an example system 3200. The system includes a computing device 3202. In an embodiment, the computing device include a user side computing device. In another embodiment, the computing device may include another computing device, such as a content server computing device, a search engine site, network-intermediary device, a page tag information processor, or other computing device. The computing device contains a monitoring apparatus 3210, an involvement determining apparatus 3230, a Web page determining apparatus 3240, a correlation apparatus 3250, and a broadcast apparatus 3270. In some embodiments, the broadcast apparatus may be structurally distinct from the monitoring apparatus and/or the correlation apparatus. A person 3206 via a user interface 3204 may use the computing device 3202 to access Web pages 3209 via a network 3208.

In an alternative embodiment, the computing device 3202 may include at least one additional apparatus. The at least one additional apparatus may include a privacy apparatus 3280, and/or a report configuration apparatus 3298. The monitoring apparatus 3210 may include one or more sub-apparatus (not shown). The involvement determining apparatus 3230 may include one or more sub-apparatus (not shown). The Web page determining apparatus 3240 may include one or more sub-apparatus (not shown). The correlation apparatus 3250 may include one or more sub-apparatus (not shown). The broadcast apparatus 3270 may include one or more sub-apparatus (not shown). In an embodiment, one of more of these apparatus may be implemented in hardware, software, and/or firmware.

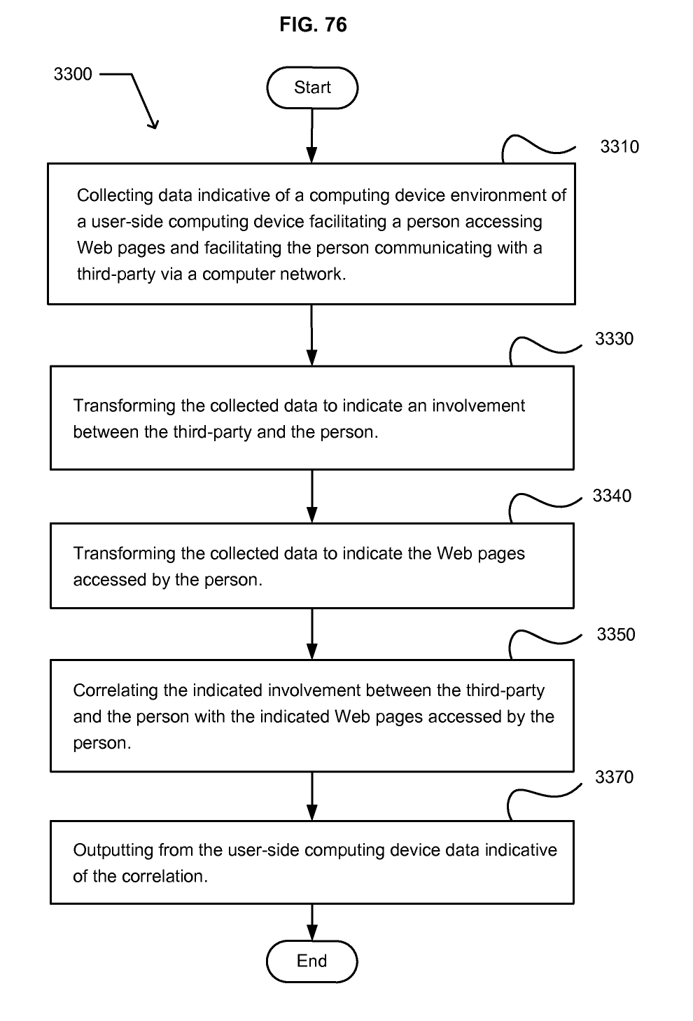

FIG. 76 illustrates an example operational flow 3300 for influence reporting. After a start operation, the operation moves to an accumulation operation 3310. The accumulation operation collects data indicative of a computing device environment of a user-side computing device facilitating a person accessing Web pages and facilitating the person communicating with a third party via a computer network. In an embodiment, a Web page includes a document connected to the World Wide Web and viewable by person connected to the Internet who has a web browser. A first processing operation 3330 transforms the collected data to indicate an involvement between the third party and the person. A second processing operation 3340 transforms the collected data to indicate the Web pages accessed by the person. An evaluation operation 3350 correlates the indicated involvement between the third party and the person with the indicated Web pages accessed by the person. A broadcast operation 3370 outputs from the user-side computing device data indicative of the correlation. In an alternative embodiment, the broadcast operation may push from the user-side computing device data indicative of the correlation. In another embodiment, the broadcast operation may respond to a pull by outputting from the user-side computing device data indicative of the correlation. In a further embodiment, the broadcast operation reports the correlation to a networked recipient.

FIG. 76 and several following figures may include various examples of operational flows, discussions, and explanations with respect to the above-described system environment of FIG. 75, and/or with respect to other examples and contexts. However, it should be understood that the operational flows may be executed in a number of other environment and contexts, and/or in modified versions of FIG. 75. Also, although the various operational flows are illustrated in a sequence(s), it should be understood that the various operations may be performed in other orders than those which are illustrated, and/or may be performed concurrently.

In an embodiment, the accumulation operation 2010 may be performed by the monitoring apparatus 3210 of the computing device 3202 of FIG. 44. The first processing operation 3330 may be performed by the involvement determining apparatus 3230. The second processing operation 3340 may be performed by the Web page determination apparatus 3240. The broadcast operation 3370 may be performed by the broadcast apparatus 3270.

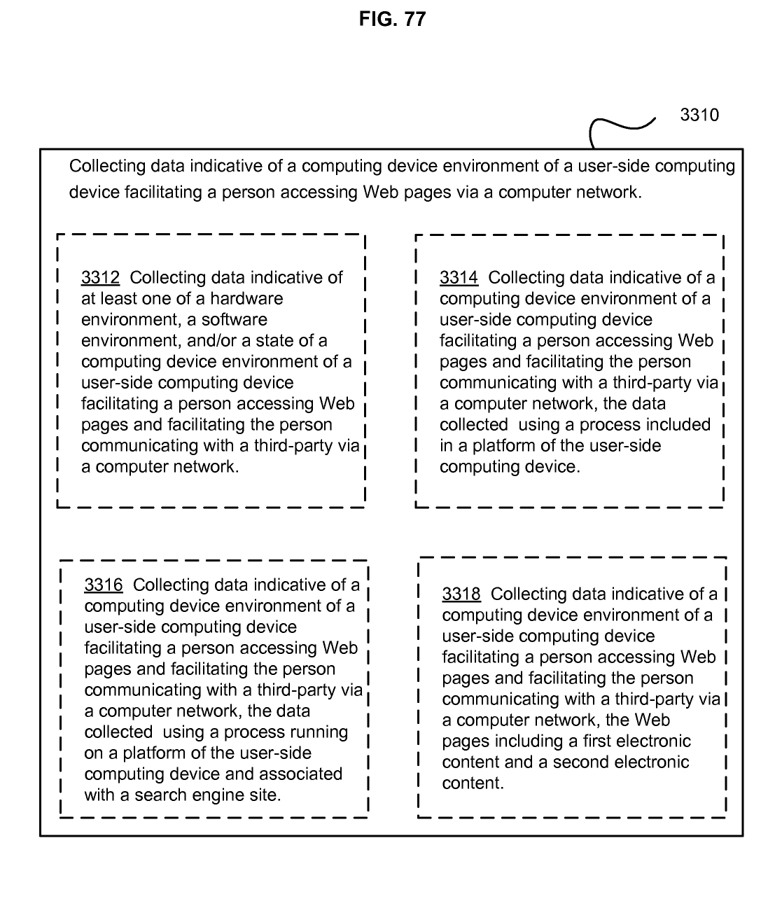

FIG. 77 illustrates an alternative embodiment of the operational flow 3300 of FIG. 76. The accumulation operation 3310 may include at least one additional operation. The at least one additional operation may include an operation 3312, an operation 3314, an operation 3316, and/or an operation 3318. The operation 3312 collects data indicative of at least one of a hardware environment, a software environment, and/or a state of a computing device environment of a user-side computing device facilitating a person accessing Web pages and facilitating the person communicating with a third party via a computer network. The operation 3314 collects data indicative of a computing device environment of a user-side computing device facilitating a person accessing Web pages and facilitating the person communicating with a third party via a computer network. The data is collected using a process included in a platform of the user-side computing device. The operation 3316 collects data indicative of a computing device environment of a user-side computing device facilitating a person accessing Web pages and facilitating the person communicating with a third party via a computer network. The data is collected using a process running on a platform of the user-side computing device and associated with a search engine site. For example, a search engine site, such as Google, Yahoo, or Live Search, may provide an application runnable on a platform of the user-side computing device that performs the operational flow 3300 and transmits the data indicative of the correlation to the search engine site at the operation 3370, or to another designated site. The operation 3318 collects data indicative of a computing device environment of a user-side computing device facilitating a person accessing Web pages and facilitating the person communicating with a third party via a computer network. The Web pages include a first electronic content and a second electronic content.

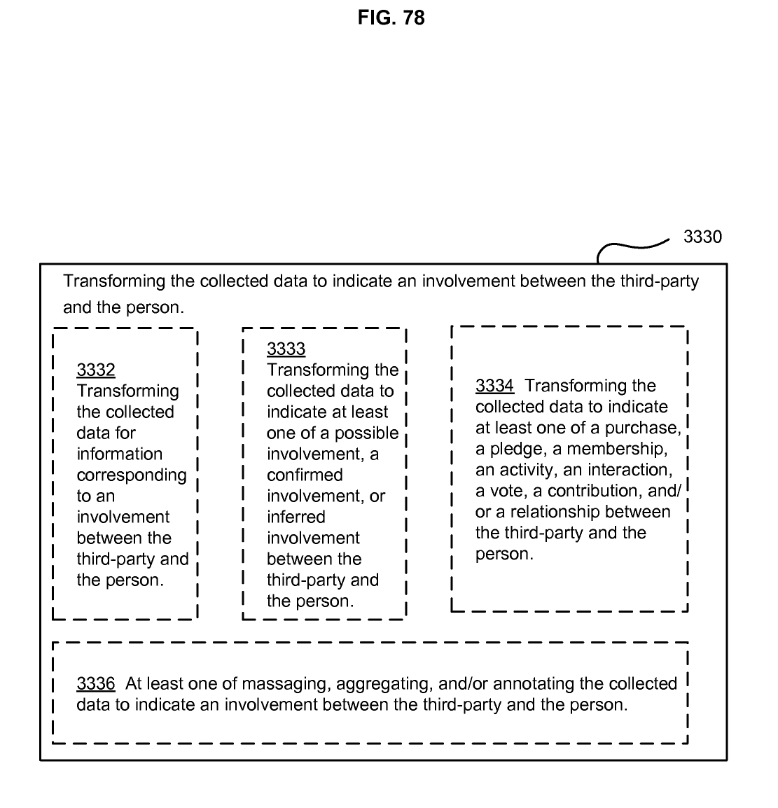

FIG. 78 illustrates another alternative embodiment of the operational flow 3300 of FIG. 76. The first processing operation 3330 may include at least one additional operation. The at least one additional operation may include an operation 3332, an operation 3333, an operation 3333, and/or an operation 3336. The operation 3332 transforms the collected data for information corresponding to an involvement between the third party and the person. The operation 3333 transforms the collected data to indicate at least one of a possible involvement, a confirmed involvement, or inferred involvement between the third party and the person. The operation 3334 transforming the collected data to indicate at least one of a purchase, a pledge, a membership, an activity, an interaction, a vote, a contribution, and/or a relationship between the third party and the person. The operation 3336 at least one of massages, aggregates, and/or annotates the collected data to indicate an involvement between the third party and the person.

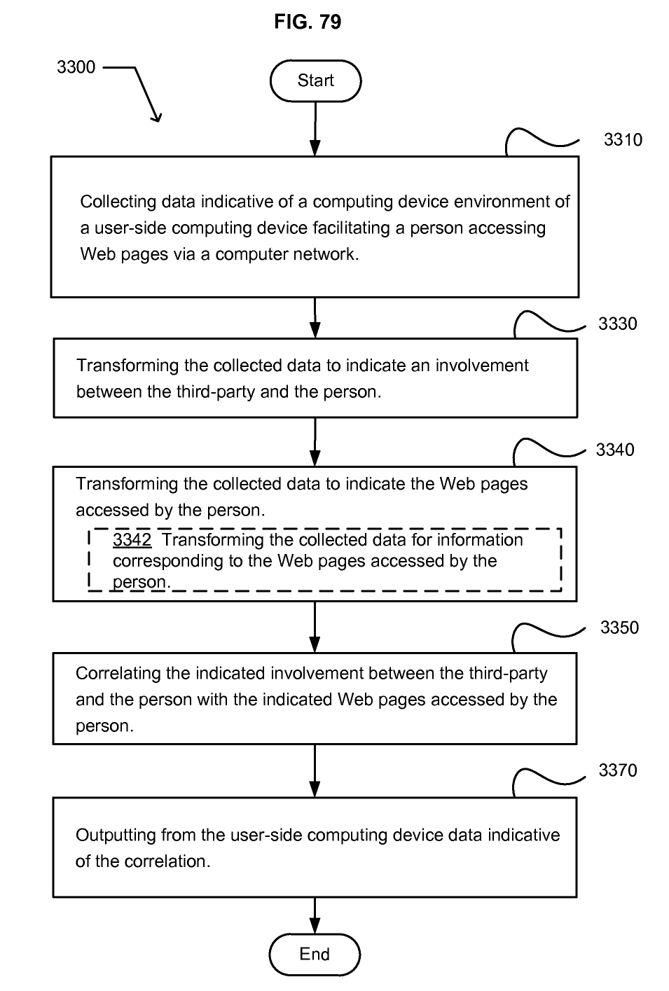

FIG. 79 illustrates a further alternative embodiment of the operational flow 3300 of FIG. 76. The second processing operation 3340 may include at least one additional operation, such as the operation 3342. The operation 3342 transforms the collected data for information corresponding to the Web pages accessed by the person.

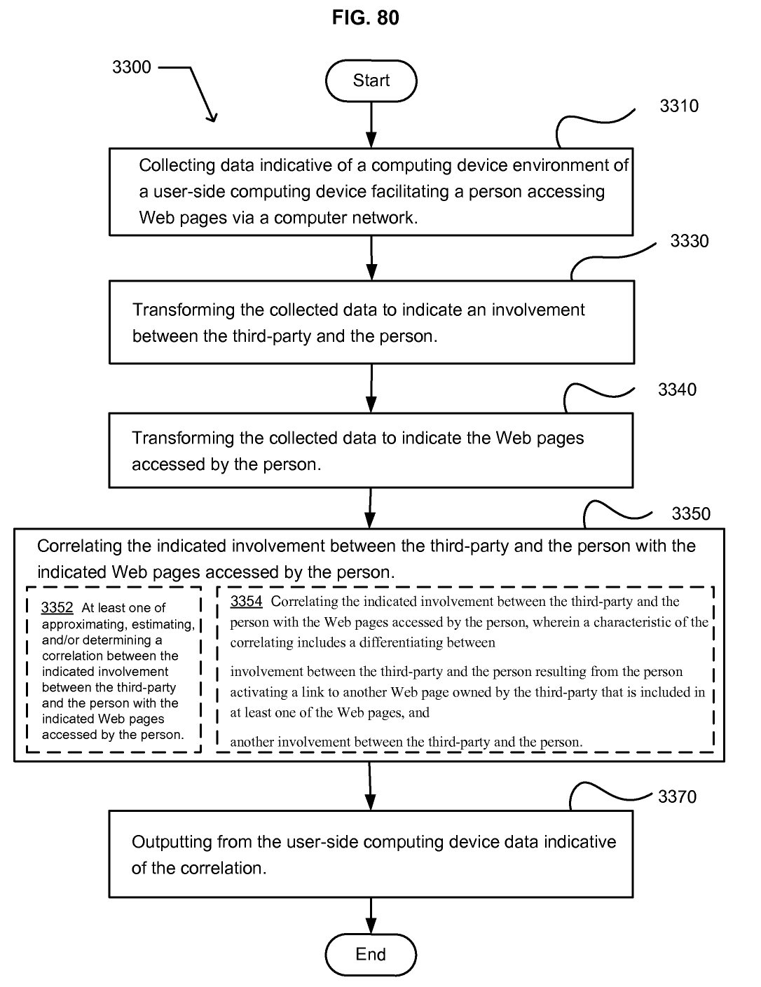

FIG. 80 illustrates an alternative embodiment of the operational flow 3300 of FIG. 76. The evaluation operation 3350 may include at least one additional operation. The at least one additional operation may include an operation 3352, and/or an operation 3354. The operation 3352 at least one of approximates, estimates, and/or determines a correlation of the indicated involvement between the third party and the person with the indicated Web pages accessed by the person. The operation 3354 correlating the indicated involvement between the third party and the person with the Web pages accessed by the person. A characteristic of the correlating includes a differentiating between (i) an involvement between the third party and the person resulting from the person activating a link to another Web page owned by the third party that is included in at least one of the Web pages, and (ii) another involvement between the third party and the person.

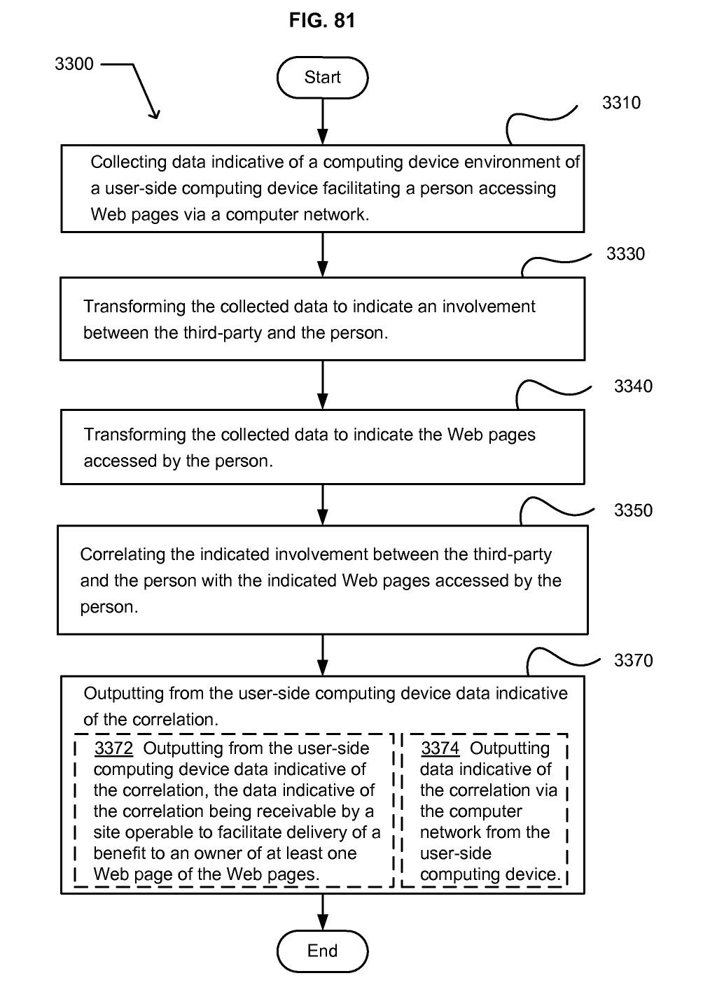

FIG. 81 illustrates another alternative embodiment of the operational flow 3300 of FIG. 71. The broadcast operation 3370 may include at least one additional operation. The at least one additional operation may include an operation 3372, and/or an operation 3374. The operation 3372 outputs from the user-side computing device data indicative of the correlation. The data indicative of the correlation is receivable by a site operable to facilitate delivery of a benefit to an owner of at least one Web page of the Web pages. The operation 3374 outputs data indicative of the correlation via the computer network from the user-side computing device.

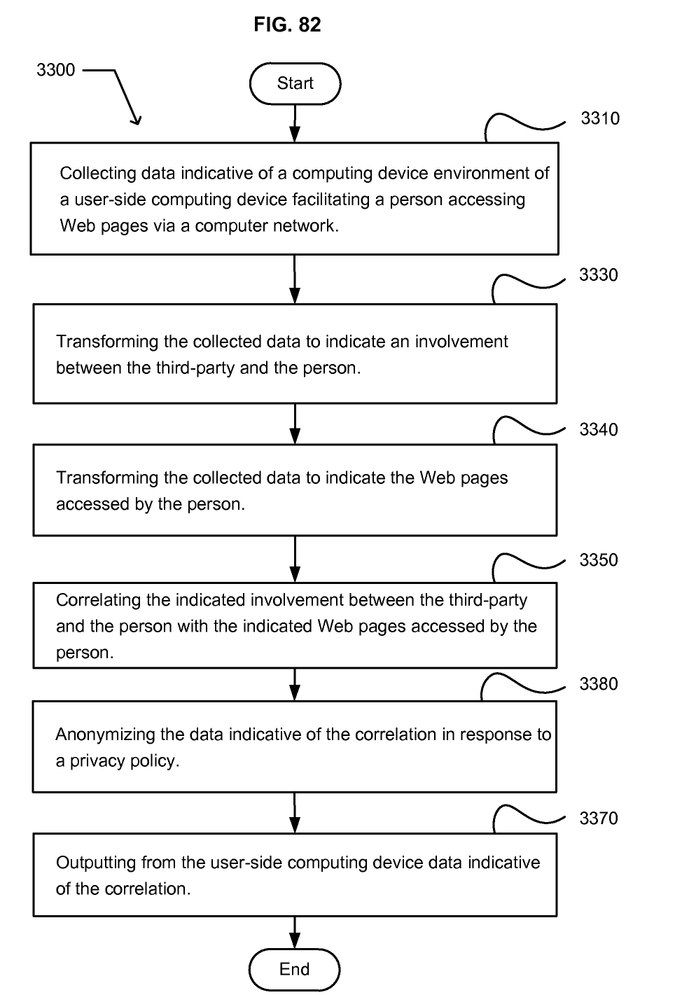

FIG. 82 illustrates a further alternative embodiment of the operational flow 3300 of FIG. 71. The operational flow may include at least one additional operation, such as a confidentiality operation 3380. The confidentiality operation anonymizes the data indicative of the correlation in response to a privacy policy. In an embodiment, the confidentiality operation may be performed by the privacy apparatus 3280.

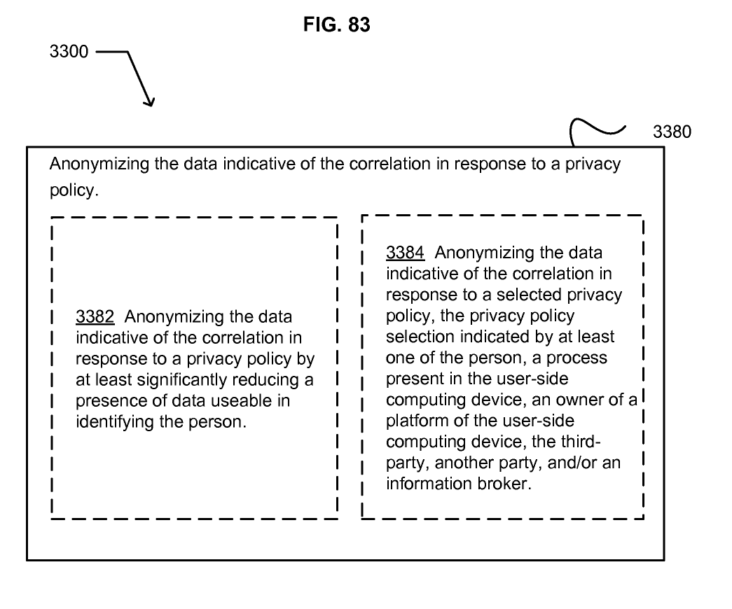

FIG. 83 illustrates an alternative embodiment of the operational flow 3300 of FIG. 71. The confidentiality operation 3380 may include at least one additional operation. The at least one additional operation may include an operation 3382, and/or an operation 3384. The operation 3382 anonymizes the data indicative of the correlation in response to a privacy policy by at least significantly reducing a presence of data useable in identifying the person. In an embodiment, the reducing a presence of data useable in identifying the person includes reducing a presence of an attribute of the person, such as for example by reducing a presence of passwords, credit card data, and/or personal information. The operation 3384 anonymizes the data indicative of the correlation in response to a selected privacy policy. The privacy policy selection is indicated by at least one of the person, a process present in the user-side computing device, an owner of a platform of the user-side computing device, the third party, another party, and/or an information broker.

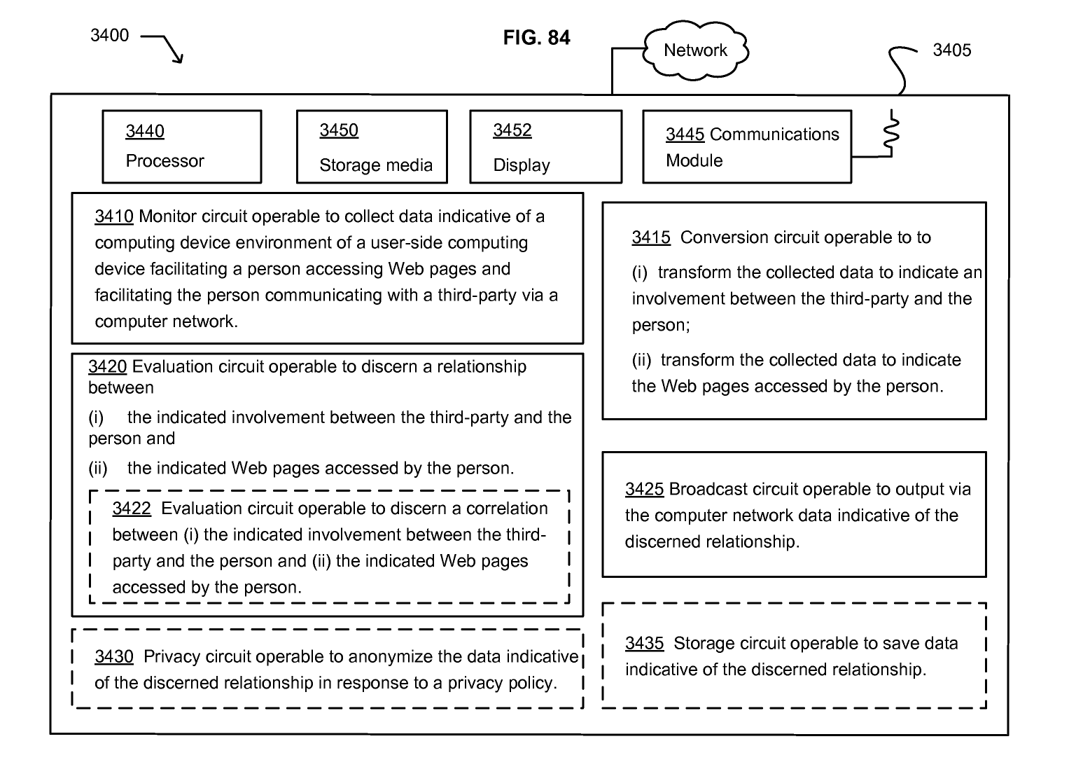

FIG. 84 illustrates an example system 3400. The system includes a computing device 3405 couplable with a computer network. The system also includes a monitor circuit 3410, a conversion circuit 3415, an evaluation circuit 3420, and a broadcast circuit 3425. In an alternative embodiment, the system includes a privacy circuit 3430, and/or a storage circuit 3435. These circuits may be structurally incorporated with the computing device. Alternatively, one or more of these circuits may be structurally distinct from the computing device. In such embodiment, the one or more of these circuits may be implemented, for example, in an external device (not shown).

The monitor circuit 3410 is operable to collect data indicative of a computing device environment of a user-side computing device facilitating a person accessing Web pages and facilitating the person communicating with a third party via a computer network. In another embodiment, the user-side computing device may include the system 3400. The conversion circuit 3415 is operable to (i) transform the collected data to indicate an involvement between the third party and the person, and to (ii) transform the collected data to indicate the Web pages accessed by the person. The evaluation circuit 3420 is operable to discern a relationship between (i) the indicated involvement between the third party and the person and (ii) the indicated Web pages accessed by the person. In an alternative embodiment, the evaluation circuit includes an evaluation circuit 3422 operable to discern a correlation between (i) the indicated involvement between the third party and the person and (ii) the indicated Web pages accessed by the person. In another alternative embodiment, the evaluation circuit includes an evaluation circuit (not shown) operable to provide a probability of a relationship between (i) the indicated involvement between the third party and the person and (ii) the indicated Web pages accessed by the person. The broadcast circuit 3425 is operable to output via the computer network data indicative of the discerned relationship. The privacy circuit 3430 is operable to anonymize the data indicative of the discerned relationship in response to a privacy policy. The storage circuit 3435 is operable to save data indicative of the discerned relationship.

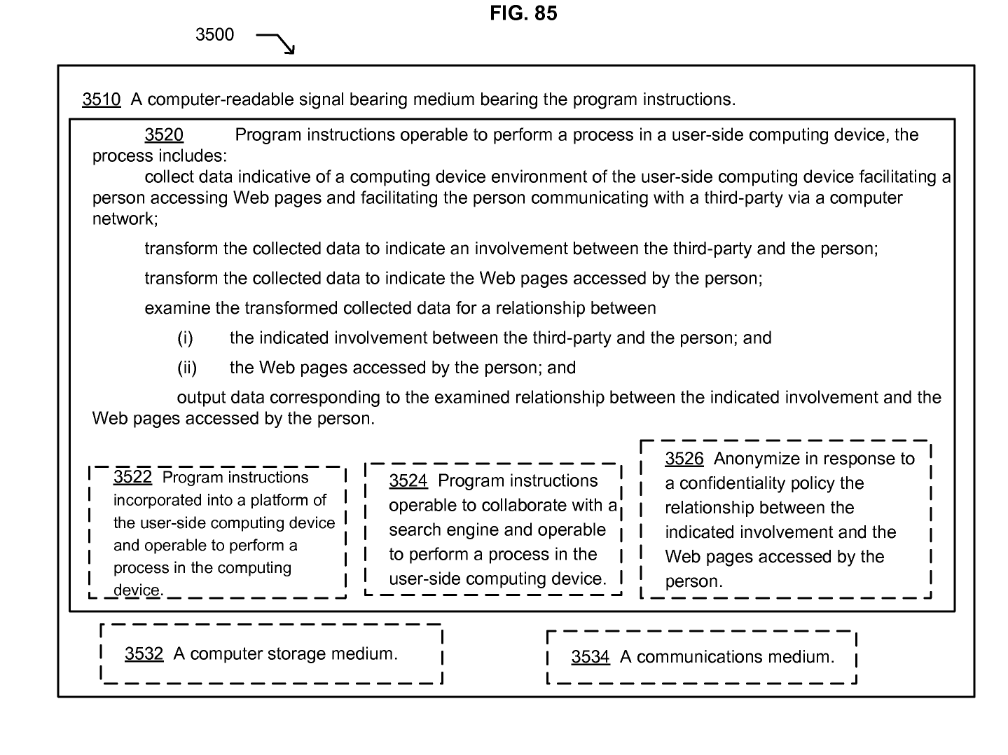

FIG. 85 illustrates an example computer program product 3500. The computer program product includes a computer-readable signal-bearing medium 3510 bearing program instructions 3520. The program instructions include program instructions operable to perform a process in a user-side computing device. The process includes collect data indicative of a computing device environment of the user-side computing device facilitating a person accessing Web pages and facilitating the person communicating with a third party via a computer network. The process also includes transform the collected data to indicate an involvement between the third party and the person. The process additionally includes transform the collected data to indicate the Web pages accessed by the person. The process further includes examine the transformed collected data for a relationship between (i) the indicated involvement between the third party and the person; and (ii) the Web pages accessed by the person. The process further includes output data corresponding to the examined relationship between the indicated involvement and the Web pages accessed by the person.

In an alternative embodiment, the program instructions 3520 further include program instructions 3522 incorporated into a platform of the user-side computing device and operable to perform a process in the computing device. In another embodiment, the program instructions further include program instructions 3524 operable to collaborate with a search engine and operable to perform a process in the user-side computing device. In a further embodiment, the program instructions operable to perform a process in a computing device further include anonymize 3526 in response to a confidentiality policy the relationship between the indicated involvement and the Web pages accessed by the person. In an alternative embodiment, the computer-readable signal-bearing medium includes a computer storage medium 3532. In a further embodiment, the computer-readable signal-bearing medium includes a communication medium 3534.

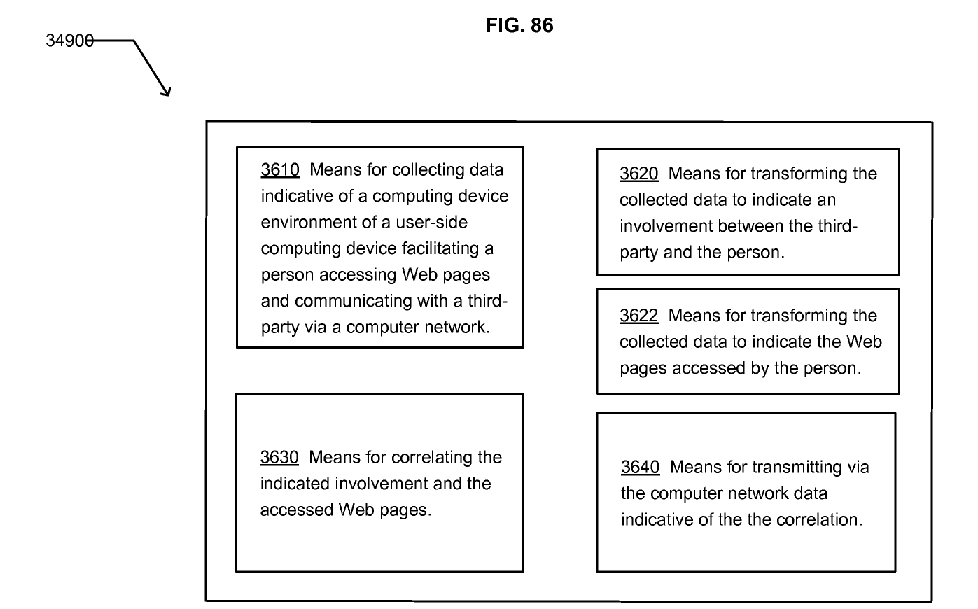

FIG. 86 illustrates an example of an apparatus. The apparatus includes means 3610 for collecting data indicative of a computing device environment of a user-side computing device facilitating a person accessing Web pages and communicating with a third party via a computer network. The apparatus also includes means 3620 for transforming the collected data to indicate an involvement between the third party and the person. The apparatus further includes means 3622 for transforming the collected data to indicate the Web pages accessed by the person. The apparatus includes means 3630 for correlating the indicated involvement and the accessed Web pages. The apparatus also includes means 3640 for transmitting via the computer network data indicative of the correlation.

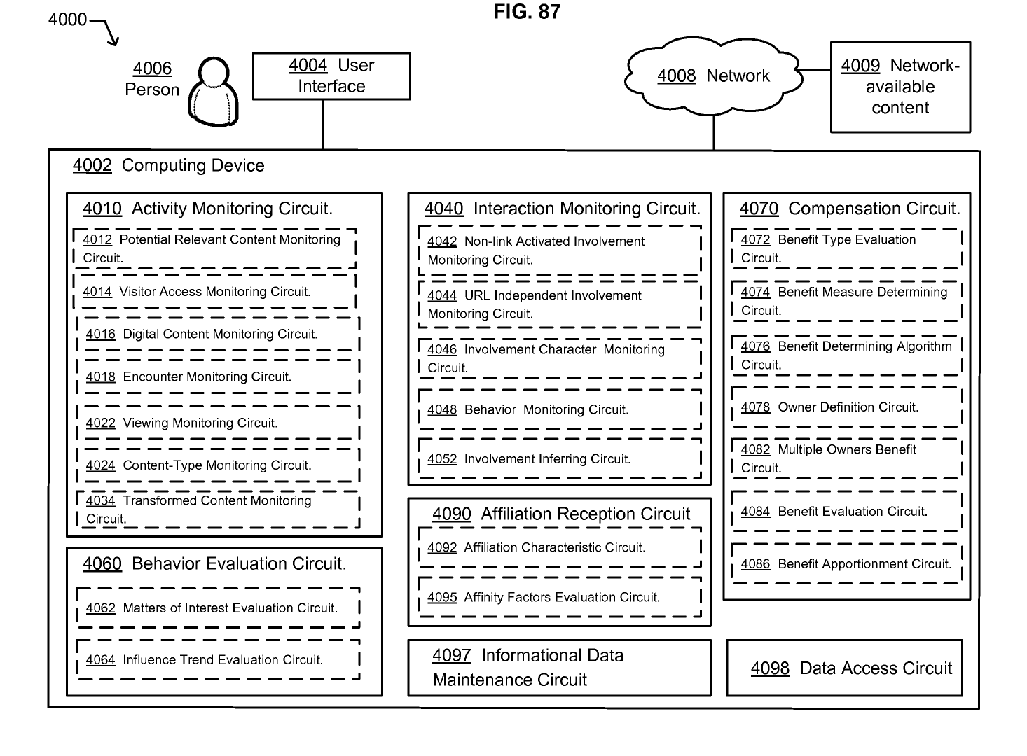

FIG. 87 illustrates an example of a system 4000. The system includes a computing device 4002. In an embodiment, the computing device includes a user-side computing device. The user-side computing device may include the thin computing device 20 described in conjunction with FIG. 1 and/or the computing device 110 described in conjunction with FIG. 2. In another embodiment, the computing device may include another computing device, such as a content-server computing device, a search engine site, network-intermediary device, a page tag information processor, or other computing device. The content server may include the server device 201 described in conjunction with FIG. 3. The search engine site may include the search engine site 350 described in conjunction with FIG. 4. The computing device includes an activity monitoring circuit 4010, an interaction monitoring circuit 4040, a behavior evaluation circuit 4060, and a compensation circuit 4070. In some embodiments, one or more of the circuits 4010, 4040, 4060, and 4070 may be structurally distinct from the remaining circuits. A person 4006 via a user interface 4004 may use the computing device 4002 to access a network available content 4009 via a network 4008. In an embodiment, one of more of these circuits may be implemented in hardware, software, and/or firmware.

In an embodiment, the activity monitoring circuit 4010 may include at least one additional circuit. The at least one additional circuit may include a potential relevant content monitoring circuit 4012, a visitor access monitoring circuit 4014, a digital content monitoring circuit 4016, an encounter monitoring circuit 4018, a viewing monitoring circuit 4022, content-type monitoring circuit 4024, and/or transformed content monitoring circuit 4034.

In another embodiment, the interaction monitoring circuit 4040 may include at least one additional circuit. The at least one additional circuit may include a non-link activated involvement monitoring circuit 4042, a URL-independent involvement monitoring circuit 4044, an involvement character monitoring circuit 4046, a behavior monitoring circuit 4048, and/or an involvement inferring circuit 4052.

In a further embodiment, the behavior evaluation circuit 4060 may include at least one additional circuit. The at least one additional circuit may include a matters of interest evaluation circuit 4062, and/or an influence trend evaluation circuit 4064. In an embodiment, the compensation circuit 4070 may include at least one additional circuit. The at least one additional circuit may include a benefit type evaluation circuit 4072, a benefit measure determining circuit 4074, a benefit determining algorithm circuit 4076, an owner characterization circuit 4078, a multiple owners benefit circuit 4082, a benefit evaluation circuit 4084, and/or a benefit apportionment circuit 4086.

In an alternative embodiment, the computing device 4002 may include at least one additional circuit. The at least one additional apparatus may include an affiliation reception circuit 4090, an information data maintenance circuit 4097, and/or a data access circuit 4098. The affiliation reception circuit may include at least one additional circuit. The at least one additional circuit may include an affiliation characteristic circuit 4092, and/or an affinity factors evaluation circuit 4096.

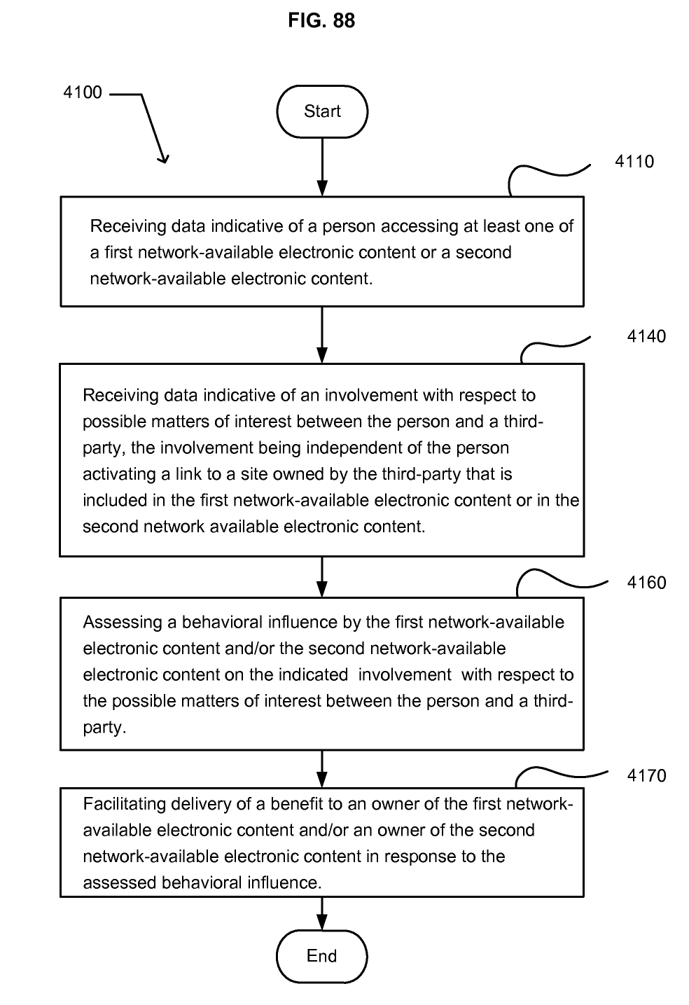

FIG. 88 illustrates an example of an operational flow 4100 representing operations related to influence evaluation. FIG. 88 and several following figures may include various examples of operational flows, discussions, and explanations with respect to the above-described system 4000 of FIG. 87, and/or with respect to other examples and contexts. However, it should be understood that the operational flows may be executed in a number of other environment and contexts, and/or in modified versions of FIG. 87. Also, although the various operational flows are illustrated in a sequence(s), it should be understood that the various operations may be performed in other orders than those which are illustrated, and/or may be performed concurrently.

After a start operation, the operational flow 4100 includes an activity monitoring operation 4110. The activity monitoring operation receives data indicative of a person accessing at least one of a first network-available electronic content or a second network-available electronic content. The activity monitoring operation may be implemented using the activity monitoring circuit 4010 described in conjunction with FIG. 87.

An interaction monitoring operation 4140 receives data indicative of an involvement with respect to possible matters of interest between the person and a third party. The involvement is independent of the person activating a link to a site owned by the third party that is included in the first network-available electronic content or in the second network available electronic content. For example, a link to a site owned by the third party that is included in an electronic content may include amazon.com link to Web site, page, or file owned by Amazon.com. Another example of a link to a site owned by the third party that is included in an electronic content may include a link to a Web site, page, or file owned by a product manufacturer, or a political candidate. A further example of a link to a site owned by the third party that is included in an electronic content may include a linked icon, a Google-cost-per-action link, an AdSense link; and/or a ValueClick link. An example of an involvement independent of the person activating a link to a site owned by the third party includes the person clicking on a link in a blog to another to blog or site. This may include the person activation a youtube.com link in a blog page to see a YouTube video clip of their favorite artist. Another example of an involvement independent of the person activating a link to a site owned by the third party includes the person keyboarding in an address to a site owned by the third party. This may include a person seeing an item of interest in a blog page, and then keyboarding in ebay.com to access eBay's site to search for that item of interest. The interaction monitoring operation may be implemented using the interaction monitoring circuit 4040 described in conjunction with FIG. 87.

A behavior evaluation operation 4160 assesses a behavioral influence by the first network-available electronic content and/or the second network-available electronic content on the indicated involvement with respect to the possible matters of interest between the person and a third party. The behavior evaluation operation may be implemented using the behavior evaluation circuit 4060 described in conjunction with FIG. 87. A compensation operation 4170 facilitates delivery of a benefit to an owner of the first network-available electronic content and/or an owner of the second network-available electronic content in response to the assessed behavioral influence. The compensation operation may be implemented using the compensation circuit 4070 described in conjunction with FIG. 87. The operational flow 4100 then proceeds to an end operation.

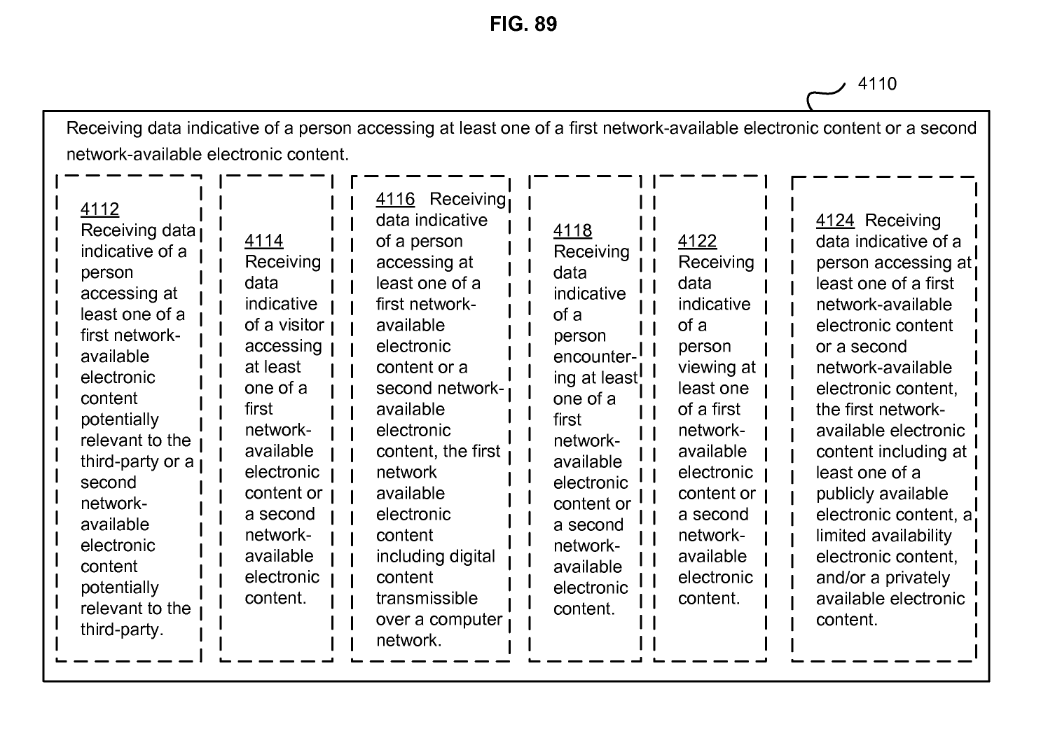

FIG. 89 illustrates an alternative embodiment of the activity monitoring operation 4110 of the operational flow 4100 of FIG. 88. The activity monitoring operation may include at least one additional operation. The at least one additional operation may include an operation 4112, an operation 4114, an operation 4116, an operation 4118, an operation 4122, and/or an operation 4124. The operation 4112 receives data indicative of a person accessing at least one of a first network-available electronic content potentially relevant to the third party or a second network-available electronic content potentially relevant to the third party. The operation 4112 may be implemented using the potentially relevant content monitoring circuit 4012 described in conjunction with FIG. 87. The operation 4114 receives data indicative of a visitor accessing at least one of a first network-available electronic content or a second network-available electronic content. The operation 4114 may be implemented using the visitor access monitoring circuit 4014 described in conjunction with FIG. 87. The operation 4116 receives data indicative of a person accessing at least one of a first network-available electronic content or a second network-available electronic content. The first network available electronic content including digital content transmissible over a computer network. The operation 4116 may be implemented using the digital content monitoring circuit 4016 described in conjunction with FIG. 87. The operation 4118 receives data indicative of a person encountering at least one of a first network-available electronic content or a second network-available electronic content. The operation 4118 may be implemented using the encounter monitoring circuit 4018 described in conjunction with FIG. 87. The operation 4122 receives data indicative of a person viewing at least one of a first network-available electronic content or a second network-available electronic content. The operation 4122 may be implemented using the viewing monitoring circuit 4022 described in conjunction with FIG. 87.

The operation 4124 receives data indicative of a person accessing at least one of a first network-available electronic content or a second network-available electronic content. The first network-available electronic content including at least one of a publicly available electronic content, a limited availability electronic content, and/or a privately available electronic content. The operation 4124 may be implemented using the content type monitoring circuit 4024 described in conjunction with FIG. 87.

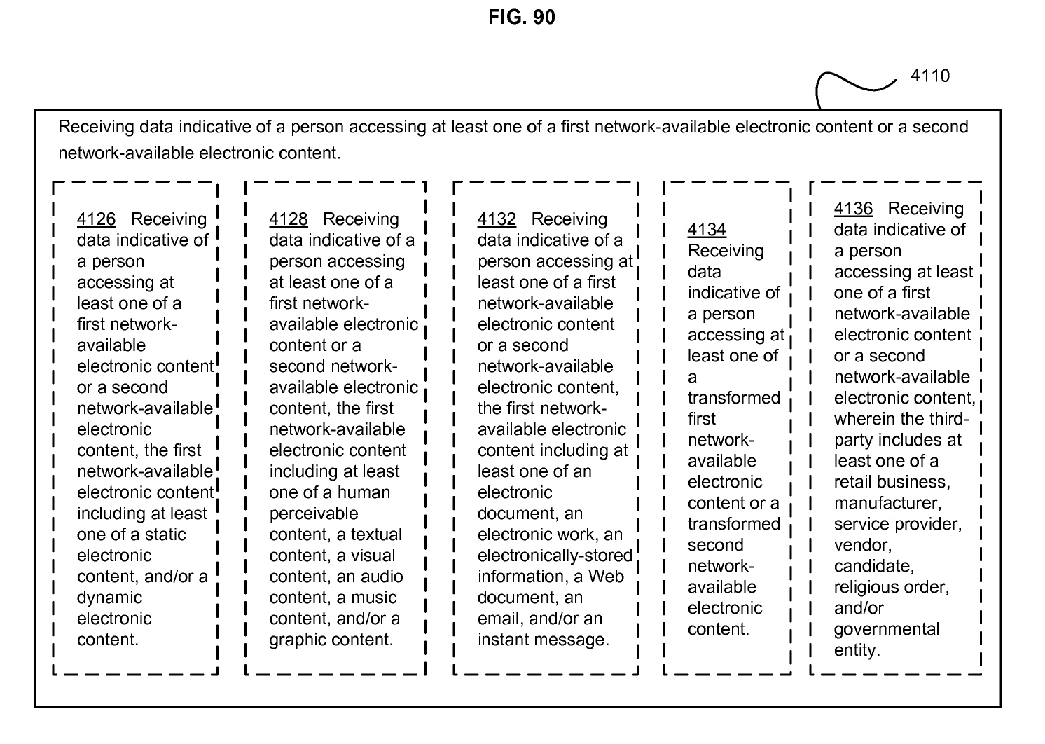

FIG. 90 illustrates another alternative embodiment of the activity monitoring operation 4110 of the operational flow 4100 of FIG. 88. The activity monitoring operation may include at least one additional operation. The at least one additional operation may include an operation 4126, an operation 4128, an operation 4132, an operation 4134, and/or an operation 4136. The operation 4126 receives data indicative of a person accessing at least one of a first network-available electronic content or a second network-available electronic content. The first network-available electronic content including at least one of a static electronic content, and/or a dynamic electronic content. The operation 4128 receives data indicative of a person accessing at least one of a first network-available electronic content or a second network-available electronic content. The first network-available electronic content including at least one of a human perceivable content, a textual content, a visual content, an audio content, a music content, and/or a graphic content. The operation 1432 receives data indicative of a person accessing at least one of a first network-available electronic content or a second network-available electronic content. The first network-available electronic content including at least one of an electronic document, an electronic work, an electronically-stored information, a Web document, an email, and/or an instant message. The operations 4126, 4128, and/or 4132 may be implemented using the content type monitoring circuit 4024 described in conjunction with FIG. 87. The operation 4134 receives data indicative of a person accessing at least one of a transformed first network-available electronic content or a transformed second network-available electronic content. The operation 4134 may be implemented using the transformed content monitoring circuit 4034 described in conjunction with FIG. 87. The operation 4136 receives data indicative of a person accessing at least one of a first network-available electronic content or a second network-available electronic content. The third party including at least one of a retail business, manufacturer, service provider, vendor, candidate, religious order, and/or governmental entity.

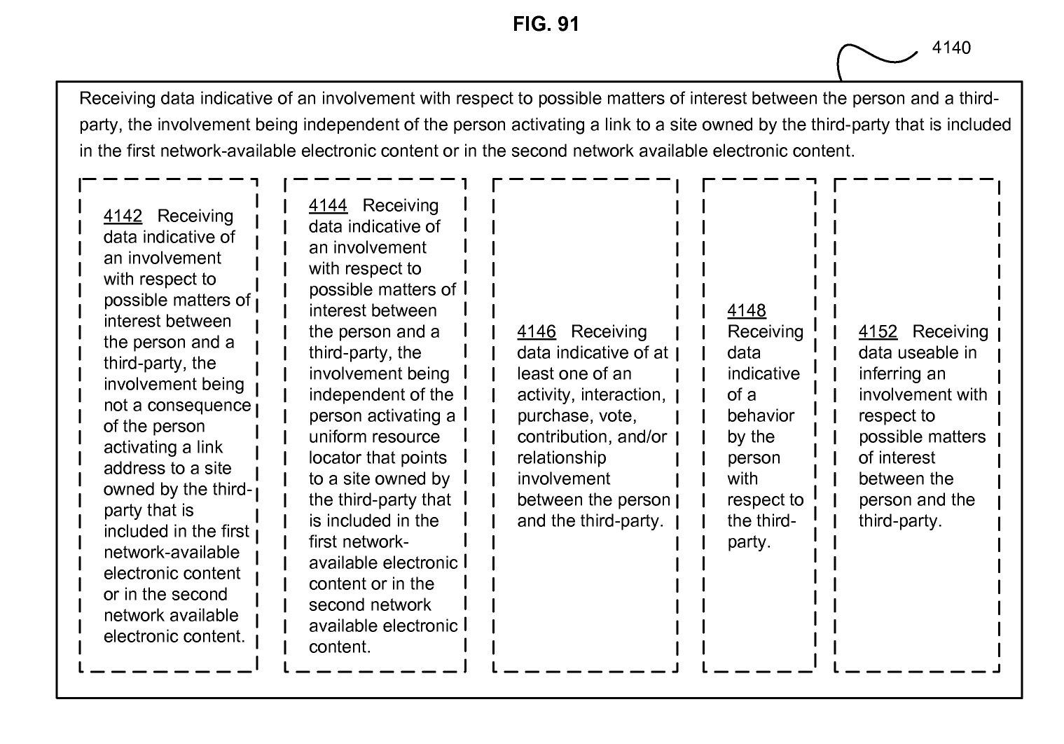

FIG. 91 illustrates an alternative embodiment of the interaction monitoring operation 4140 of the operational flow 4100 of FIG. 88. The interaction monitoring operation may include at least one additional operation. The at least one additional operation may include an operation 4142, an operation 4144, an operation 4146, an operation 4148, and/or an operation 4152. The operation 4142 receives data indicative of an involvement with respect to possible matters of interest between the person and a third party. The involvement is not a consequence of the person activating a link address to a site owned by the third party that is included in the first network-available electronic content or in the second network available electronic content. The operation 4142 may be implemented using the non-link activated-involvement monitoring circuit 4042 described in conjunction with FIG. 87. The operation 4144 receives data indicative of an involvement with respect to possible matters of interest between the person and a third party. The involvement is independent of the person activating a uniform resource locator that points to a site owned by the third party that is included in the first network-available electronic content or in the second network available electronic content. The operation 4144 may be implemented using the URL-independent involvement monitoring circuit 4044. The operation 4146 receives data indicative of at least one of an activity, interaction, purchase, vote, contribution, and/or relationship involvement between the person and the third party. The operation 4146 may be implemented using the involvement-character monitoring circuit 4046. The operation 4148 receives data indicative of a behavior by the person with respect to the third party. The operation 4148 may be implemented using the behavior monitoring circuit 4048. The operation 4152 receives data useable in inferring an involvement with respect to possible matters of interest between the person and the third party. The operation 4152 may be implemented using the involvement inferring circuit 4052.

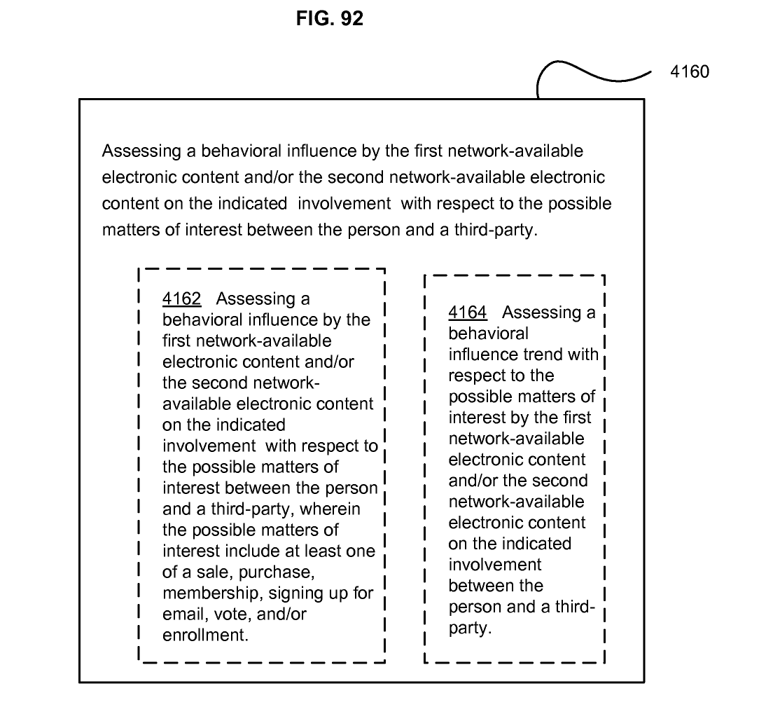

FIG. 92 illustrates another alternative embodiment of the operational flow 4100 of FIG. 88. The behavior evaluation operation 4160 may include at least one additional operation. The at least one additional operation may include an operation 4162, and/or an operation 4164. The operation 4162 assesses a behavioral influence by the first network-available electronic content and/or the second network-available electronic content on the indicated involvement with respect to the possible matters of interest between the person and a third party. The possible matters of interest include at least one of a sale, purchase, membership, signing up for email, vote, and/or enrollment. The operation 4162 may be implemented using the matters-of-interest evaluation circuit 4062 of FIG. 88. The operation 4164 assesses a behavioral influence trend with respect to the possible matters of interest by the first network-available electronic content and/or the second network-available electronic content on the indicated involvement between the person and a third party. The operation 4164 may be implemented using the influence trend evaluation circuit 4064.

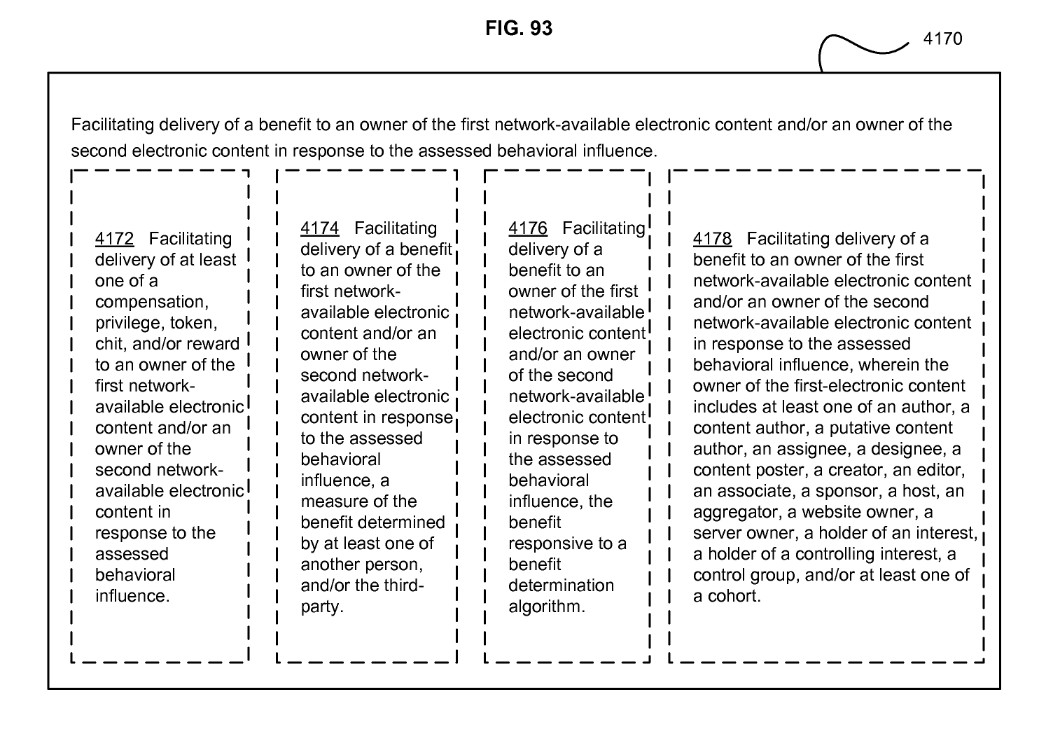

FIG. 93 illustrates a further alternative embodiment of the operational flow 4100 of FIG. 88. The compensation operation 4170 may include at least one additional operation. The at least one additional operation may include an operation 4172, an operation 4174, an operation 4176, and/or an operation 4178. The operation 4172 facilitates delivery of at least one of a compensation, privilege, token, chit, and/or reward to an owner of the first network-available electronic content and/or an owner of the second network-available electronic content in response to the assessed behavioral influence. The operation 4172 may be implemented using the benefit type evaluation circuit 4072 of FIG. 88. The operation 4174 facilitates delivery of a benefit to an owner of the first network-available electronic content and/or an owner of the second network-available electronic content in response to the assessed behavioral influence. A measure of the benefit determined by at least one of another person, and/or the third party. The operation 4174 may be implemented using the benefit measure determining circuit 4074. The operation 4176 facilitates delivery of a benefit to an owner of the first network-available electronic content and/or an owner of the second network-available electronic content in response to the assessed behavioral influence. The benefit is responsive to a benefit determination algorithm. The operation 4176 may be implemented using the benefit determining algorithm circuit 4076. The operation 4178 facilitates delivery of a benefit to an owner of the first network-available electronic content and/or an owner of the second network-available electronic content in response to the assessed behavioral influence. The owner of the first electronic content including at least one of an author, a content author, a putative content author, an assignee, a designee, a content poster, a creator, an editor, an associate, a sponsor, a host, an aggregator, a website owner, a server owner, a holder of an interest, a holder of a controlling interest, a control group, and/or at least one of a cohort. The operation 4178 may be implemented using the owner definition circuit 4078.

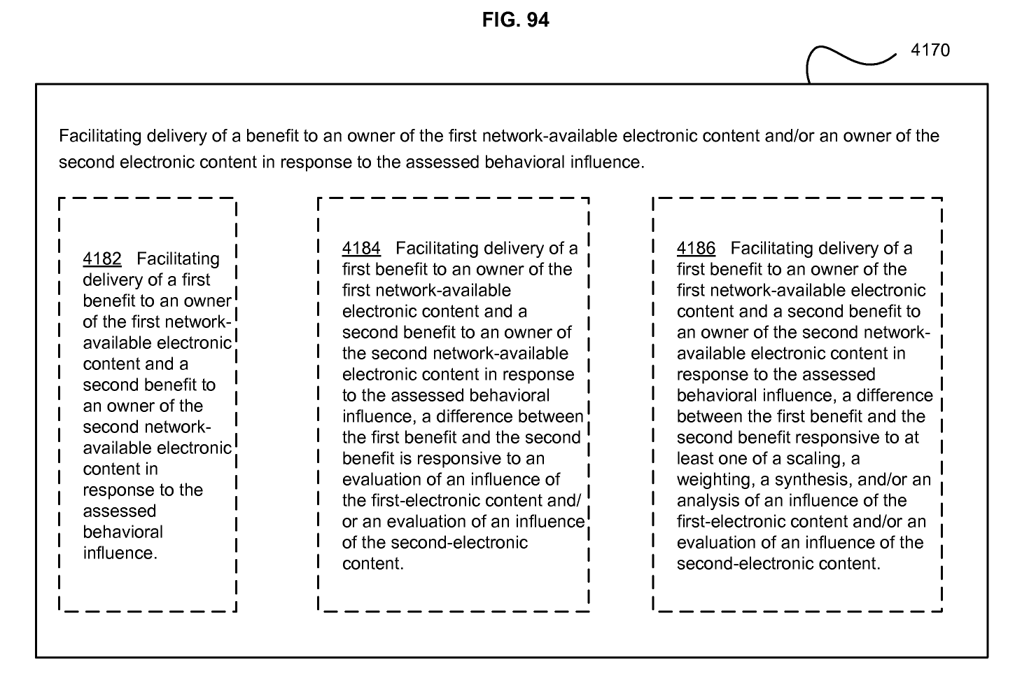

FIG. 94 illustrates an alternative embodiment of the operational flow 4100 of FIG. 88. The compensation operation 4170 may include at least one additional operation. The at least one additional operation may include an operation 4182, an operation 4184, and/or operation 4186. The operation 4182 facilitates delivery of a first benefit to an owner of the first network-available electronic content and a second benefit to an owner of the second network-available electronic content in response to the assessed behavioral influence. The operation 4182 may be implemented using the multiple owners benefit circuit 4082 of FIG. 88. The operation 4184 facilitates delivery of a first benefit to an owner of the first network-available electronic content and a second benefit to an owner of the second network-available electronic content in response to the assessed behavioral influence. A difference between the first benefit and the second benefit is responsive to an evaluation of an influence of the first electronic content and/or an evaluation of an influence of the second electronic content. The operation 4184 may be implemented using the benefit evaluation circuit 4084. The operation 4186 facilitates delivery of a first benefit to an owner of the first network-available electronic content and a second benefit to an owner of the second network-available electronic content in response to the assessed behavioral influence. A difference between the first benefit and the second benefit responsive to at least one of a scaling, a weighting, a synthesis, and/or an analysis of an influence of the first electronic content and/or an evaluation of an influence of the second electronic content. The operation 4186 may be implemented using the benefit apportionment circuit 4086.

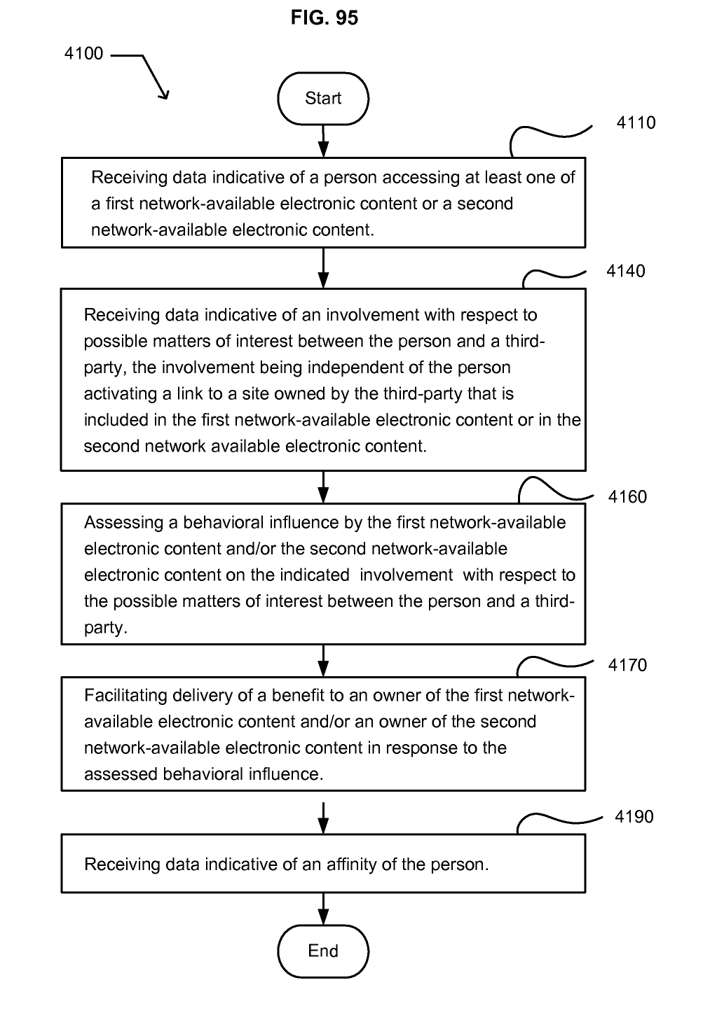

FIG. 95 illustrates another alternative embodiment of the operational flow 4100 of FIG. 88. The operational flow may include at least one additional operation, such as an affiliation reception operation 4190. The affiliation reception operation receives data indicative of an affinity of the person. The affiliation reception operation may be implemented using the affiliation reception circuit 4090 of FIG. 88.

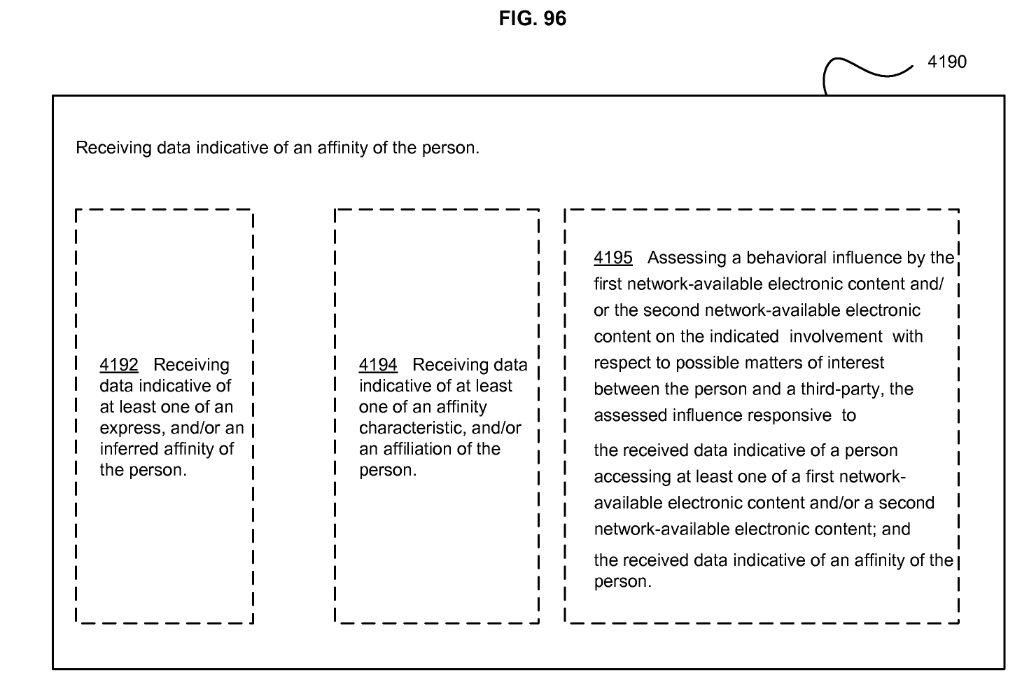

FIG. 96 illustrates a further embodiment of the operational flow 4100 of FIG. 88. The affiliation reception operation 4190 may include at least one additional operation. The at least one additional operation may include an operation 4192, an operation 4194, and/or an operation 4195. The operation 4192 receiving data indicative of at least one of an express, and/or an inferred affinity of the person. The operation 4194 receives data indicative of at least one of an affinity characteristic, and/or an affiliation of the person. The operation 4192 and/or the operation 4194 may be implemented using the affiliation characteristic circuit 4092 of FIG. 88. The operation 4195 assessing a behavioral influence by the first network-available electronic content and/or the second network-available electronic content on the indicated involvement with respect to possible matters of interest between the person and a third party. The assessed influence responsive to the received data indicative of a person accessing at least one of a first network-available electronic content and/or a second network-available electronic content; and to the received data indicative of an affinity of the person. The operation 4195 may be implemented using the affiliation characteristic circuit 4095.

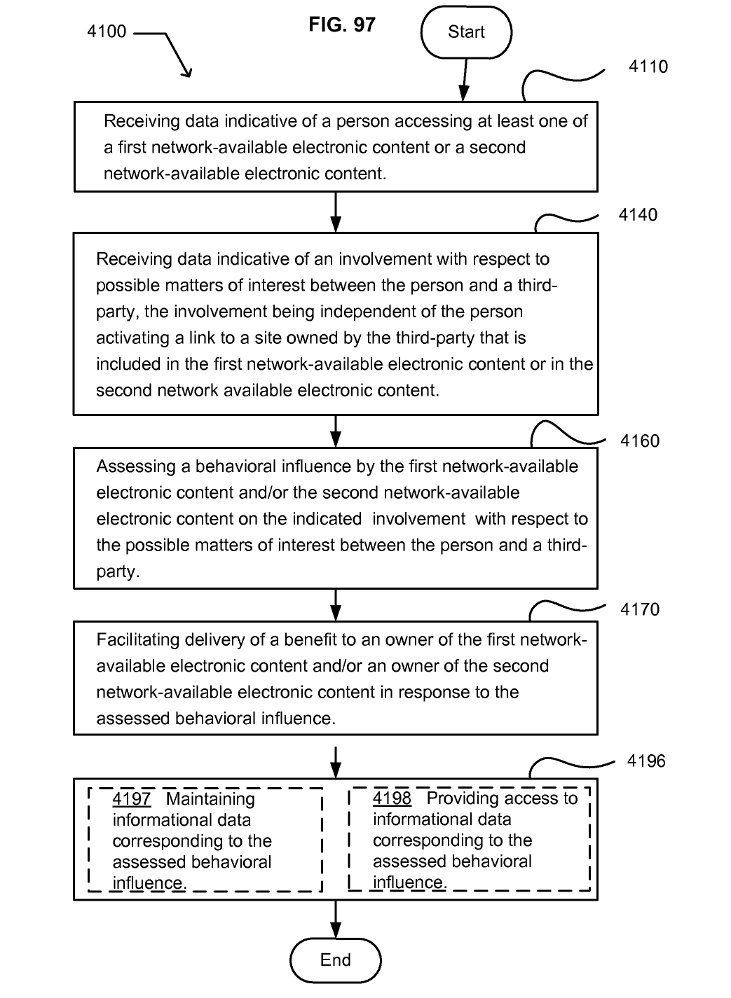

FIG. 97 illustrates an embodiment of the operational flow 4100 of FIG. 88. The embodiment may include at least one additional operation, such as an operation 4196. The at least one additional operation 4196 may include an operation 4197, and or an operation 4198. The operation 4197 maintains informational data corresponding to the assessed behavioral influence. The operation 4197 may be implemented using the information data maintenance circuit 4097 of FIG. 87. The operation 4198 provides access to informational data corresponding to the assessed behavioral influence. The operation 4198 may be implemented using the data access circuit 4098.

Another embodiment provides an operational flow for reporting influence. After a start operation, the operational flow includes receiving data indicative of a person accessing at least one of a first network-available electronic content or a second network-available electronic content. The operational flow also includes receiving data indicative of an involvement with respect to possible matters of interest between the person and a third party. The data indicative of an involvement includes a first data indicative of an involvement independent of the person activating a link to a site owned by the third party that is included in the first network-available electronic content or in the second network available electronic content; and a second data indicative of an involvement caused by the person activating a link to a site owned by the third party that is included in the first network-available electronic content or in the second network available electronic content. The operational flow further includes assessing in response to the first data indicative of an involvement a behavioral influence by the first network-available electronic content and/or the second network-available electronic content. The operational flow also includes facilitating delivery of a benefit to an owner of the first network-available electronic content and/or an owner of the second network-available electronic content in response to the assessed behavioral influence. The operational flow then proceeds to an end operation.

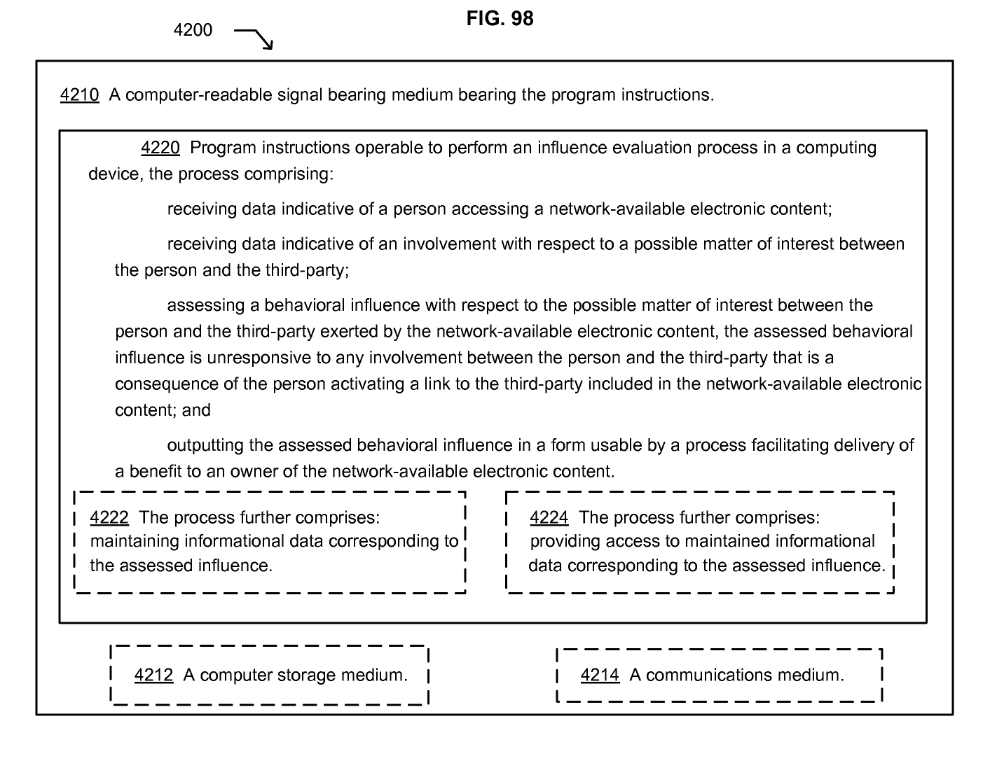

FIG. 98 illustrates an example computer program product 4200. The computer program product includes a computer-readable signal-bearing medium 4210 bearing program instructions 4220. The program instructions are operable to perform an influence evaluation process in a computing device.

The process includes receiving data indicative of a person accessing a network-available electronic content. The process also includes receiving data indicative of an involvement with respect to a possible matter of interest between the person and the third party. The process further includes assessing a behavioral influence with respect to the possible matter of interest between the person and the third party exerted by the network-available electronic content. The assessed behavioral influence is unresponsive to any involvement between the person and the third party that is a consequence of the person activating a link to the third party included in the network-available electronic content. In an embodiment, for example, the data indicative of an involvement may include (i) data indicative a first involvement between the person and the third party that not a consequence of the person activating any link embedded in the network-available electronic content to a site owned by the third party, and of (ii) data indicative a second involvement between the person and the third party that is a consequence of the person activating an embedded link in the electronic content to a site owned by the third party. In this example, the assessed behavioral influence is responsive to the data indicative of the first involvement, and unresponsive to the data indicative of the second involvement. The process also includes outputting the assessed behavioral influence in a form usable by a process facilitating delivery of a benefit to an owner of the network-available electronic content.

In an alternative embodiment, the process of the program instructions 4220 further includes maintaining informational data corresponding to the assessed influence 4222. In another embodiment, the process of the program instructions further includes providing access to maintained informational data corresponding to the assessed influence 4224. In a further alternative embodiment, the computer-readable signal-bearing medium 4210 includes a computer storage medium 4212. In another alternative embodiment, the computer-readable signal-bearing medium includes a communication medium 4214.

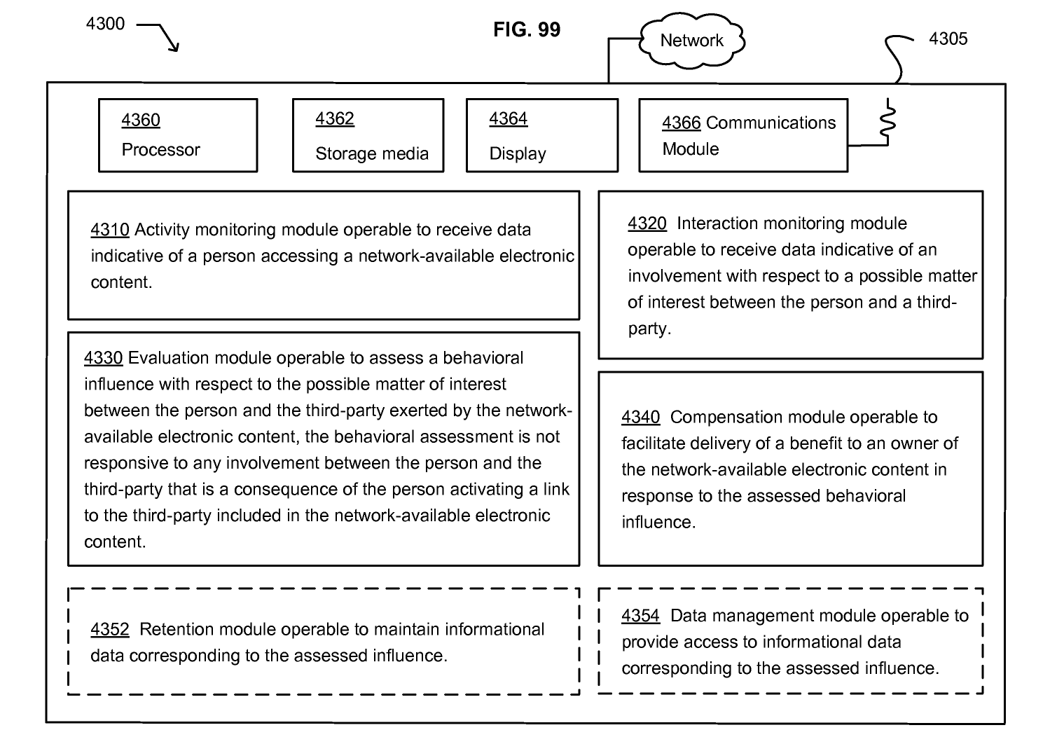

FIG. 99 illustrates an example system 4300. The system includes an activity monitoring module 4310, an interaction monitoring module 4320, an evaluation module 4330, and an compensation module 4340. Any one or more of these modules may be implemented in hardware, software, firmware, or virtually any combination thereof. In an embodiment, at least one of these modules may be included in a computing device 4305.

The activity monitoring module 4310 is operable to receive data indicative of a person accessing a network-available electronic content. The interaction monitoring module 4320 is operable to receive data indicative of an involvement with respect to a possible matter of interest between the person and a third party. The evaluation module 4330 is operable to assess a behavioral influence with respect to the possible matter of interest between the person and the third party exerted by the network-available electronic content. The behavioral assessment is not responsive to any involvement between the person and the third party that is a consequence of the person activating a link to the third party included in the network-available electronic content. The compensation module 4340 is operable to facilitate delivery of a benefit to an owner of the network-available electronic content in response to the assessed behavioral influence.

In an alternative embodiment, the system 4300 further includes a retention module 4352 operable to maintain informational data corresponding to the assessed influence. In another embodiment, the system includes a data management module 4354 operable to provide access to informational data corresponding to the assessed influence. In a further embodiment, the system may include a processor 4360, a storage media 4362, a display 4364, and/or a communications module 4366.

In another alternative embodiment, the computing device 4305 further includes a computing device operable to communicate with a network. In a further embodiment, the computing device operable to communicate with a network includes a computing device responsive to human input, and operable to display human perceivable content and communicate with a network. The computing device responsive to human input may include a user-side computing device. The user-side computing device may include the thin computing device 20 described in conjunction with FIG. 1 and/or the computing device 110 described in conjunction with FIG. 2. In an embodiment, the computing device operable to communicate with a network includes a computing device operable to provide electronic content to a network. The computing device operable to provide electronic content to a network may include the server device 201 described in conjunction with FIG. 3. In another embodiment, the computing device operable to communicate with a network includes an intermediate computing device operable to communicate with a network. In an embodiment, the computing device operable to communicate with a network includes a network intermediary device operable to communicate with a network. In a further embodiment, the computing device operable to communicate with a network includes a computing device under a control of the third party and operable to communicate with a network. In another embodiment, the computing device operable to communicate with a network includes a search engine site. The search engine site may include the search engine site 350 described in conjunction with FIG. 4.

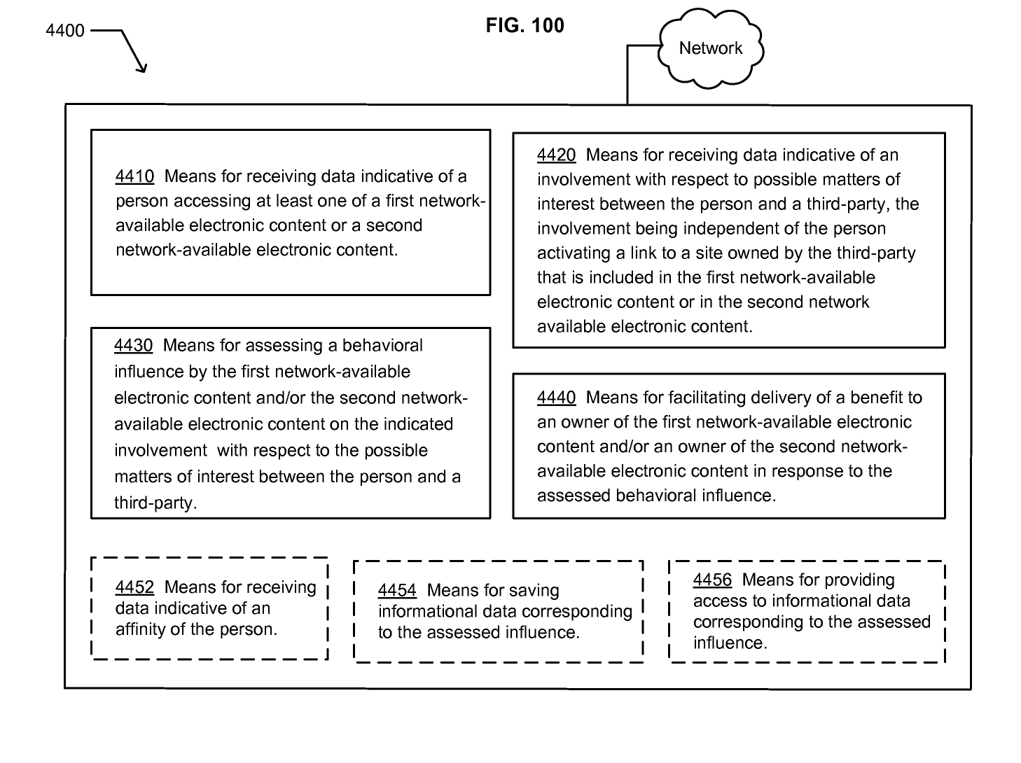

FIG. 100 illustrates an example device 4400. The device includes means 4410 for receiving data indicative of a person accessing at least one of a first network-available electronic content or a second network-available electronic content. The device also includes means 4420 for receiving data indicative of an involvement with respect to possible matters of interest between the person and a third party. The involvement is independent of the person activating a link to a site owned by the third party that is included in the first network-available electronic content or in the second network available electronic content. The device further includes means 4430 for assessing a behavioral influence by the first network-available electronic content and/or the second network-available electronic content on the indicated involvement with respect to the possible matters of interest between the person and a third party. The device also includes means 4440 for facilitating delivery of a benefit to an owner of the first network-available electronic content and/or an owner of the second network-available electronic content in response to the assessed behavioral influence.

In an alternative embodiment, the device 4400 includes means 4452 for receiving data indicative of an affinity of the person. In another embodiment, the device includes means 4454 for saving informational data corresponding to the assessed influence. In a further embodiment, the device includes means 4456 for providing access to informational data corresponding to the assessed influence.

Influencers in a Web 2.0 Environment

Techniques for rewarding and/or determining influencers, and more specifically, to assessing and/or determining an influence of an electronically accessed content on an involvement between an accessor and a third party, are disclosed. It will be appreciated that many specific details of certain implementations are set forth in the following description, and in the accompanying figures to provide a thorough understanding of such implementations. One skilled in the art will understand from the teachings of the present disclosure, however, that the present disclosure may have other possible implementations, and that such other implementations may be practiced with/without some of the details set forth in the following description.

Exemplary Systems and Environments

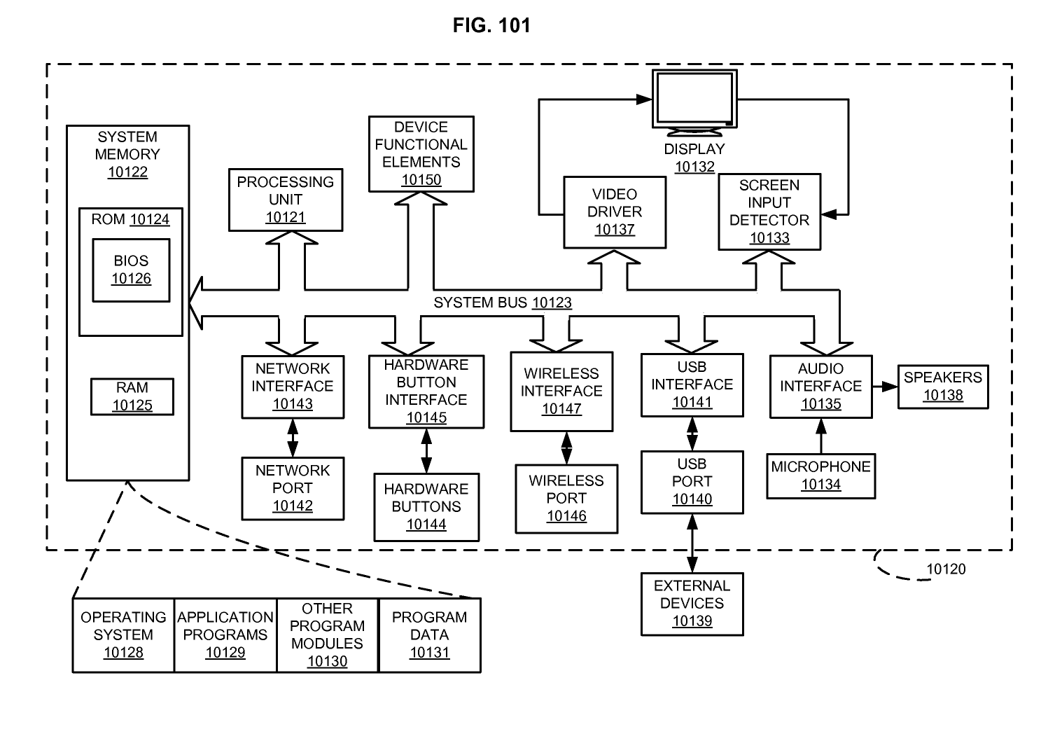

Exemplary systems and environments in which various implementations in accordance with the present disclosure may be implemented are described in this section with reference to FIGS. 101 through 104. It will be appreciated, however, that the following description of exemplary systems and environments is not exhaustive of all possible environments in which the teachings of the present disclosure may be implemented.

For example, FIG. 101 illustrates an exemplary system that includes a thin computing device 10120, which may be included in an electronic device that also includes a device functional element 10150. For example, the electronic device may include any item having electrical and/or electronic components playing a role in a functionality of the item, such as a limited resource computing device, an electronic pen, a handheld electronic writing device, a digital camera, a scanner, an ultrasound device, an x-ray machine, a non-invasive imaging device, a cell phone, a printer, a refrigerator, a car, and an airplane. The thin computing device 10120 includes a processing unit 10121, a system memory 10122, and a system bus 10123 that couples various system components including the system memory 10122 to the processing unit 10121. The system bus 10123 may be any of several types of bus structures including a memory bus or memory controller, a peripheral bus, and a local bus using any of a variety of bus architectures. The system memory includes read-only memory (ROM) 10124 and random access memory (RAM) 10125. A basic input/output system (BIOS) 10126, containing the basic routines that help to transfer information between sub-components within the thin computing device 10120, such as during start-up, is stored in the ROM 10124. A number of program modules may be stored in the ROM 10124 and/or RAM 10125, including an operating system 10128, one or more application programs 10129, other program modules 10130 and program data 10131.

A user may enter commands and information into the computing device 10120 through input devices, such as a number of switches and buttons, illustrated as hardware buttons 10144, connected to the system via a suitable interface 10145. Input devices may further include a touch-sensitive display screen 10132 with suitable input detection circuitry 10133. The output circuitry of the touch-sensitive display 10132 is connected to the system bus 10123 via a video driver 10137. Other input devices may include a microphone 10134 connected through a suitable audio interface 10135, and a physical hardware keyboard (not shown). In addition to the display 10132, the computing device 10120 may include other peripheral output devices, such as at least one speaker 10138.

Other external input or output devices 10139, such as a joystick, game pad, satellite dish, scanner or the like may be connected to the processing unit 10121 through a USB port 10140 and USB port interface 10141, to the system bus 10123. Alternatively, the other external input and output devices 10139 may be connected by other interfaces, such as a parallel port, game port or other port. The computing device 10120 may further include or be capable of connecting to a flash card memory (not shown) through an appropriate connection port (not shown). The computing device 10120 may further include or be capable of connecting with a network through a network port 10142 and network interface 10143, and through wireless port 10146 and corresponding wireless interface 10147 may be provided to facilitate communication with other peripheral devices, including other computers, printers, and so on (not shown). It will be appreciated that the various components and connections shown are exemplary and other components and means of establishing communications links may be used.

The computing device 10120 may be primarily designed to include a user interface. The user interface may include a character, a key-based, and/or another user data input via the touch sensitive display 10132. The user interface may include using a stylus (not shown). Moreover, the user interface is not limited to an actual touch-sensitive panel arranged for directly receiving input, but may alternatively or in addition respond to another input device such as the microphone 10134. For example, spoken words may be received at the microphone 10134 and recognized. Alternatively, the computing device 10120 may be designed to include a user interface having a physical keyboard (not shown).

The device functional elements 10150 are typically application specific and related to a function of the electronic device, and is coupled with the system bus 10123 through an interface (not shown). The functional elements may typically perform a single well-defined task with little or no user configuration or setup, such as a refrigerator keeping food cold, a cell phone connecting with an appropriate tower and transceiving voice or data information, and a camera capturing and saving an image.

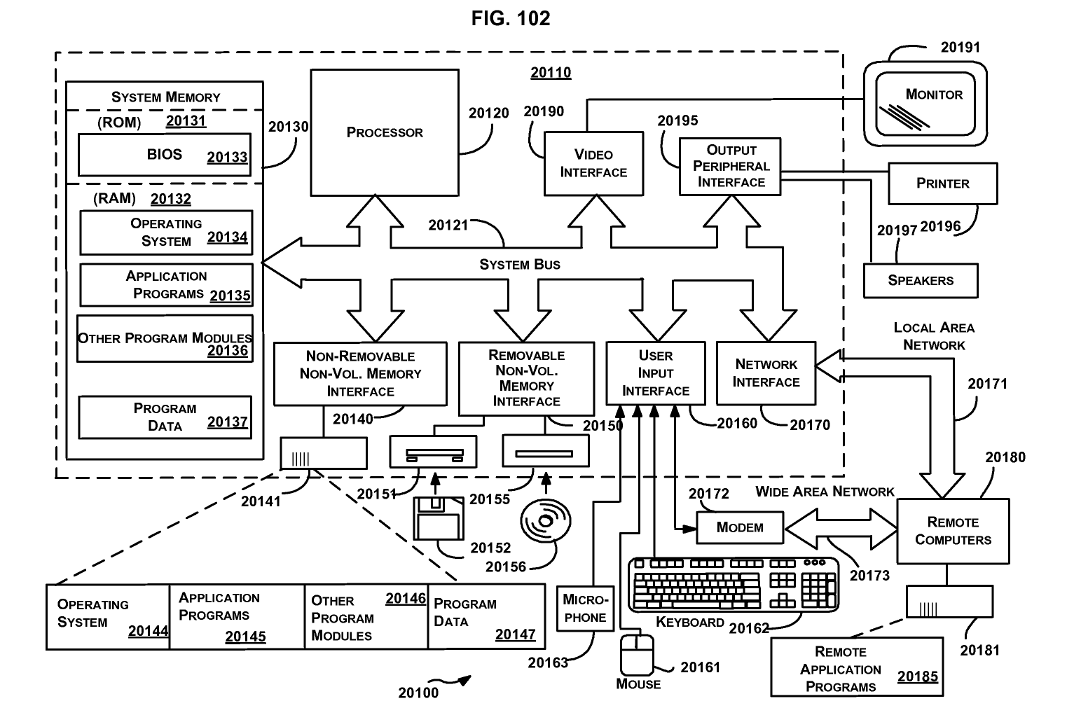

FIG. 102 illustrates an exemplary embodiment of a general-purpose computing system in which embodiments may be implemented, shown as a computing system environment 20100. Components of the computing system environment 20100 may include, but are not limited to, a computing device 20110 having a processing unit 20120, a system memory 20130, and a system bus 20121 that couples various system components including the system memory to the processing unit 20120. The system bus 20121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 20100 typically includes a variety of computer-readable media products. Computer-readable media may include any media that can be accessed by the computing device 20110 and include both volatile and nonvolatile media, removable and non-removable media. By way of example, and not of limitation, computer-readable media may include computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 20110. In a further embodiment, a computer storage media may include a group of computer storage media devices. In another embodiment, a computer storage media may include an information store. In another embodiment, an information store may include a quantum memory, a photonic quantum memory, and/or atomic quantum memory. Combinations of any of the above may also be included within the scope of computer-readable media.

Communications media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media such as a wired network and a direct-wired connection and wireless media such as acoustic, RF, optical, and infrared media.

The system memory 20130 includes computer storage media in the form of volatile and nonvolatile memory such as ROM 20131 and RAM 20132. A RAM may include at least one of a DRAM, an EDO DRAM, a SDRAM, a RDRAM, a VRAM, and/or a DDR DRAM. A basic input/output system (BIOS) 20133, containing the basic routines that help to transfer information between elements within the computing device 20110, such as during start-up, is typically stored in ROM 20131. RAM 20132 typically contains data and program modules that are immediately accessible to or presently being operated on by processing unit 20120. By way of example, and not limitation, FIG. 102 illustrates an operating system 20134, application programs 20135, other program modules 20136, and program data 20137. Often, the operating system 20134 offers services to applications programs 20135 by way of one or more application programming interfaces (APIs) (not shown). Because the operating system 20134 incorporates these services, developers of applications programs 20135 need not redevelop code to use the services. Examples of APIs provided by operating systems such as Microsoft's “WINDOWS” are well known in the art.

The computing device 20110 may also include other removable/non-removable, volatile/nonvolatile computer storage media products. By way of example only, FIG. 102 illustrates a non-removable non-volatile memory interface (hard disk interface) 20140 that reads from and writes for example to non-removable, non-volatile magnetic media. FIG. 102 also illustrates a removable non-volatile memory interface 20150 that, for example, is coupled to a magnetic disk drive 20151 that reads from and writes to a removable, non-volatile magnetic disk 20152, and/or is coupled to an optical disk drive 20155 that reads from and writes to a removable, non-volatile optical disk 20156, such as a CD ROM. Other removable/nonremovable, volatile/non-volatile computer storage media that can be used in the exemplary operating environment include, but are not limited to, magnetic tape cassettes, memory cards, flash memory cards, DVDs, digital video tape, solid state RAM, and solid state ROM. The hard disk drive 20141 is typically connected to the system bus 20121 through a non-removable memory interface, such as the interface 20140, and magnetic disk drive 20151 and optical disk drive 20155 are typically connected to the system bus 20121 by a removable non-volatile memory interface, such as interface 20150.

The drives and their associated computer storage media discussed above and illustrated in FIG. 102 provide storage of computer-readable instructions, data structures, program modules, and other data for the computing device 20110. In FIG. 102, for example, hard disk drive 20141 is illustrated as storing an operating system 20144, application programs 20145, other program modules 20146, and program data 20147. Note that these components can either be the same as or different from the operating system 20134, application programs 20135, other program modules 20136, and program data 20137. The operating system 20144, application programs 20145, other program modules 20146, and program data 20147 are given different numbers here to illustrate that, at a minimum, they are different copies. A user may enter commands and information into the computing device 20110 through input devices such as a microphone 20163, keyboard 20162, and pointing device 20161, commonly referred to as a mouse, trackball, or touch pad. Other input devices (not shown) may include a joystick, game pad, satellite dish, and scanner. These and other input devices are often connected to the processing unit 20120 through a user input interface 20160 that is coupled to the system bus, but may be connected by other interface and bus structures, such as a parallel port, game port, or a universal serial bus (USB). A monitor 20191 or other type of display device is also connected to the system bus 20121 via an interface, such as a video interface 20190. In addition to the monitor, computers may also include other peripheral output devices such as speakers 20197 and printer 20196, which may be connected through an output peripheral interface 20195.

The computing system environment 20100 may operate in a networked environment using logical connections to one or more remote computers, such as a remote computer 20180. The remote computer 20180 may be a personal computer, a server, a router, a network PC, a peer device, or other common network node, and typically includes many or all of the elements described above relative to the computing device 20110, although only a memory storage device 20181 has been illustrated in FIG. 102. The logical connections depicted in FIG. 102 include a local area network (LAN) 20171 and a wide area network (WAN) 20173, but may also include other networks such as a personal area network (PAN) (not shown). Such networking environments are commonplace in offices, enterprise-wide computer networks, intranets, and the Internet.

When used in a LAN networking environment, the computing system environment 20100 is connected to the LAN 20171 through a network interface or adapter 20170. When used in a WAN networking environment, the computing device 20110 typically includes a modem 20172 or other means for establishing communications over the WAN 20173, such as the Internet. The modem 20172, which may be internal or external, may be connected to the system bus 20121 via the user input interface 20160, or via another appropriate mechanism. In a networked environment, program modules depicted relative to the computing device 20110, or portions thereof, may be stored in a remote memory storage device. By way of example, and not limitation, FIG. 102 illustrates remote application programs 20185 as residing on computer storage medium 20181. It will be appreciated that the network connections shown are exemplary and other means of establishing communications link between the computers may be used.

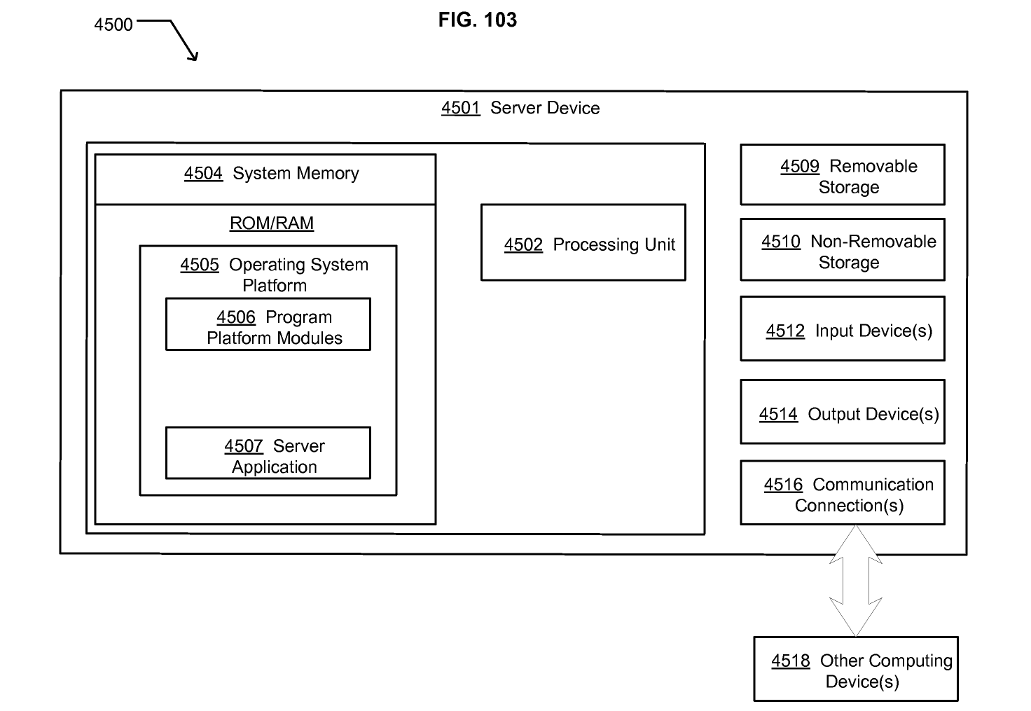

FIG. 103 illustrates an exemplary system 4500 in which embodiments may be implemented. The exemplary system includes a computing system couplable to a network and operable to provide electronic content, such as a server 4501. In an embodiment, the server may include an application server, audio server, database server, fax server, file server, intranet server, mail server, merchant server, modem server, network access server, network server, print server, proxy server, remote access server, telephony server, terminal server, video server, and/or Web server. In another embodiment, the server may include a network intermediary, a network switch, and/or a router. Server functionality may be implemented in software, hardware, firmware, and/or a combination thereof. Server functionality may be provided by a computing device that also provides other functionality. The network may include an electronic network, an optical network, and/or a combination of optical and electronic networks.

In a configuration, the server 4501 typically includes at least one processing unit 4502 and system memory 4504. System memory 4504 typically includes operating system platform 4505 and one or more program modules 4506 running on operating system. In addition to the program modules 4506, a server application 4507 may also be running on the operating system. The server application 4507 may be operable to deliver electronic content and/or files to applications via a protocol, and may include and/or interact with other computing devices, application servers, applications, and application interfaces (APIs) residing in other applications. For example, the server application may include a Web server operable to deliver Web pages and/or electronic content to Web browser applications via HTTP protocols.

The server 4501 may have additional features or functionality. For example, server may also include additional data storage devices (removable and/or non-removable), as illustrated in FIG. 103 by removable storage 4509 and non-removable storage 4510. System memory 4504, removable storage 4509 and non-removable storage 4510 are all examples of computer storage media. The server may include input device(s) 4512 and output device(s) 4514. The server also contains communication connections 4516 that allow the device to communicate with and perform a service associated with a network, including communicating with other servers and/or with other computing device, illustrated as other computing device(s) 4518. Communication connections 4516 are one example of communication media.

FIGS. 101-103 are intended to provide a brief, general description of an illustrative and/or suitable exemplary environments in which embodiments may be implemented. An exemplary system may include the thin computing device 10120 of FIG. 101, the computing system environment 20100 of FIG. 102, and/or the server of FIG. 103. FIGS. 101-103 are examples of a suitable environment and is not intended to suggest any limitation as to the structure, scope of use, or functionality of an embodiment. A particular environment should not be interpreted as having any dependency or requirement relating to any one or combination of components illustrated in an exemplary environment. For example, in certain instances, one or more elements of an environment may be deemed not necessary and omitted. In other instances, one or more other elements may be deemed necessary and added. Further, it will be appreciated that device(s) and/or environment(s) described herein may include numerous electrical, optical, mechanical, and/or digital components that may necessary to operate the device, but are not needed to illustrate the subject matter described herein. As such, some of these electrical, optical, mechanical, and/or digital components may be omitted from the specification for clarity.

In the description that follows, certain embodiments may be described with reference to acts and symbolic representations of operations that are performed by one or more computing devices, such as the computing device 20110 of FIG. 102. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

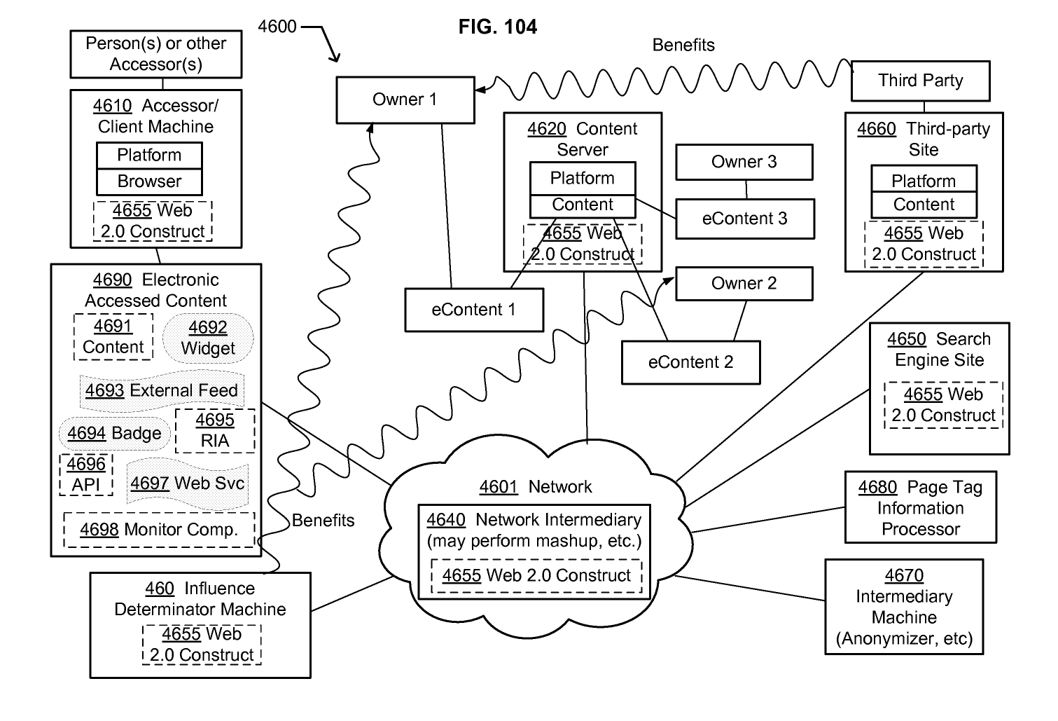

FIG. 104 illustrates an exemplary network environment 4600 in which embodiments may be implemented. The exemplary environment may include one or more networks, illustrated as a network 4601, and one or more client (or accessor) machines, illustrated as client (or accessor_machine 4610. A fabric of the network 4601 may include network intermediaries, illustrated as a network intermediary 4640 running on a platform (not shown). In an embodiment, the client machine includes a computing device used by a human user. In another embodiment, the client machine includes a computing device used by a human user to communicate in a peer-to-peer environment (P2P), and/or to communicate in a cloud-to-cloud environment (C2C). In a further embodiment, the client machine includes a computing device used by a human user to communicate with a server. The client machine may include the thin computing device 10120 illustrated in FIG. 101, and/or the computing device 20110 illustrated in FIG. 102.

The exemplary environment 4600 may also include one or more servers, illustrated as a content server 4620. In an embodiment, the content server is operable to provide electronic content (illustrated as eContent 1 and/or eContent 2 to one or more client machines. In another embodiment, the content server includes the server 4501 illustrated in FIG. 103. In a further embodiment, the content server(s) includes a node in P2P and/or a C2C network. The node may include the thin computing device 10120 illustrated in FIG. 101, and/or the computing device 20110 illustrated in FIG. 102. The exemplary environment 4600 may also include one or more third party sites, illustrated as a third party site 4630. The third party site may include a merchant site, such as amazon.com for books, a manufacturer site, such as subaru.com for automobiles, a religious institution, such as catholic.org and/or hinduism.com, and/or a political site, such as rnc.org and/or democrats.org. The exemplary environment 4600 may also include one or more search engine sites, illustrated as a search engine site 4650. The search engine site may include a general search engine site, such as google.com and/or live.com. In another embodiment, the search engine site may include a topical search site, such as HONMedhunt and/or FindLaw.com.

The exemplary environment 4600 may also include an influence determinator machine 4660, an intermediary machine 4670, and/or a page tag information processor 4680. Each of these machines may be operable to receive data and/or information gathered by at least one of the client machine 4610, the content server 4620, the third party site 4630, and/or the network intermediary 4640, and to produce an output useable in assessing an influence on a person using the client machine by a content of the content server.

As further shown in FIG. 104, one or more components of the network environment 4600 may cooperatively provide an electronic accessed content 4690 that may be accessed by the accessor (or client) machine 4610. In some implementations, the electronic accessed content 4690 may include one or more portions or components. For example, in some implementations, the electronic accessed content 4690 may include a mashup of similar or different portions or components, or a plurality of mashups.

More specifically, with continued reference to FIG. 104, in some implementations, the electronic accessed content 4690 may include one or more of the following components or types: a content 4691 (e.g. text, audio, visual, video, or other suitable content), a widget 4692 (e.g. clock, weather monitor, music provider, news provider, game, entertainment provider, story provider, article provider, stock market tracker, etc.), an external feed 4693 (e.g. clock, weather monitor, music provider, news provider, game, entertainment provider, story provider, article provider, stock market tracker, etc.), a badge 4694 (e.g. animal, brand name, musical group, sports content, humorous content, entertainment content, nationality content, religious content, affinity content, affiliation content, etc.), a Rich Internet Application (RIA) 4695 (e.g. virtual weather provider, virtual experience provider, news provider, designer, entertainment provider, shopping facilitator, analytical facilitator, etc.), an Application Programming Interface (API) 4696 (e.g. file operations, file references, geometry and topology operations, feature operations, projects, drawing and dimensional operations, assembly operations, user interfaces, user preferences, etc.), a web service 4697 (e.g. search service, mapping service, directions service, spelling and grammar services, etc.), and a monitoring component 4698 (e.g. tracking component, access monitor, registration component, etc.). Of course, in alternate implementations, the electronic accessed content 4690 may include any other suitable components or content types.

The network environment 4600 further includes one or more Web 2.0 constructs 4655 which may be located or distributed on one or more components within the environment 4600. For example, in some implementations, a Web 2.0 construct 4655 may be located on the network 4601, the accessor/client machine 4610, the content server 4620, the third party site 4630, the network intermediary 4640, the search engine site 4650, the influence determinator machine 4660, or any other component of the network environment 4600. As used herein, the term “Web 2.0 construct” (or “machine-implemented Web 2.0 construct”) may include a wide variety of constructs implemented in software, hardware, firmware, or combinations thereof. For example, a “Web 2.0 construct” may include a web-based application, a web service, an asynchronous application, an API, an RIA application, an Ajax (Asynchronous JavaScript and XML (Extensible Markup Language)) application, a Flex application, a Flash® application, a Web 2.0 engine, or a mashup that includes one or more of the afore-mentioned constructs.

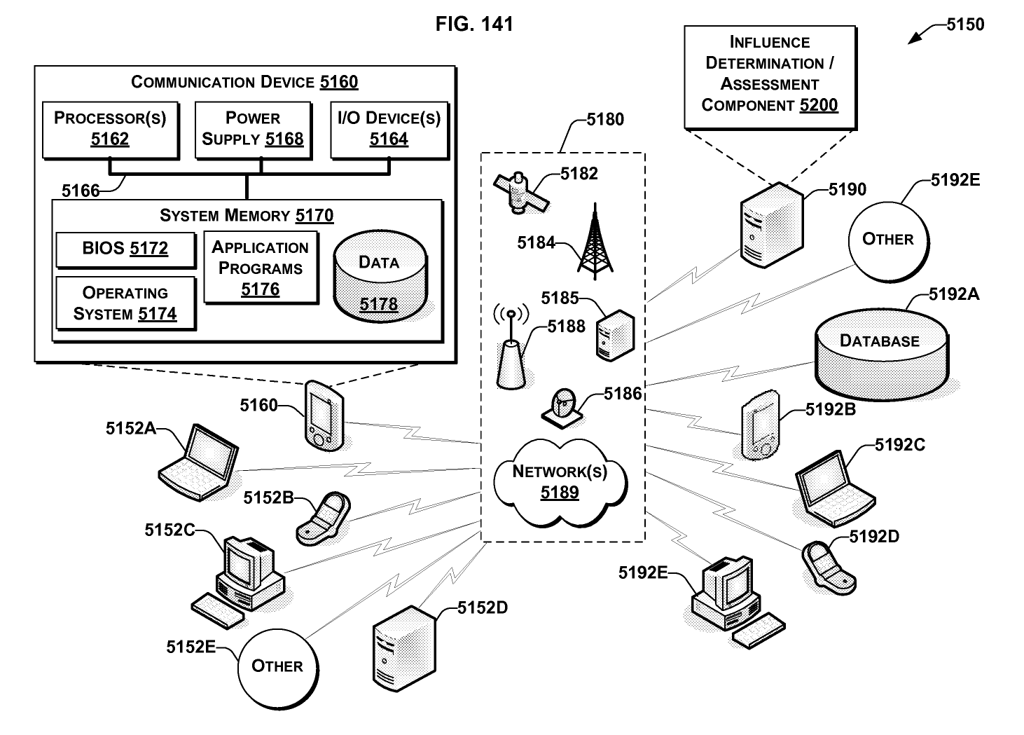

It should be appreciated that the exemplary systems and environments described above with reference to FIGS. 101-104 are merely illustrative of a few of the many possible systems and environments in which the teachings of the present disclosure may be implemented, and that the teachings herein are not limited to the particular systems and environments described above. For example, additional exemplary systems and environments in accordance with the teachings of the present disclosure are described below with respect to FIGS. 141-147.

Additional Exemplary Systems and Environments

Additional aspects of exemplary systems and environments for implementing aspects of methods and processes in accordance with the present disclosure will now be described. For example, FIG. 141 illustrates an exemplary environment 5150 in which further embodiments may be implemented. In this implementation, the environment 5150 includes a communication device 5160 that communicates via a communication infrastructure 5180 with an influence determiner 5190. The influence determiner 5190 includes an influence determination/assessment component 5200 in accordance with the teachings of the present disclosure. In some implementations, the communication device 5160 may bypass the infrastructure 5180 and communicate directly with the influence determiner 5190, or may simply communicate with the infrastructure 5180 itself.

As further shown in FIG. 141, in some implementations, the environment 5150 may include one or more additional communication devices 5152. In will be appreciated that the communication devices 5160, 5152 may be a wide variety of suitable devices. For example, in some implementations, the communication device 5160 (or 5152) may be a hand-held device (860) (e.g. personal data assistant (PDA), global positioning system (GPS), radio, television, audio device, audio-visual device, mobile communicator, signal processor, etc.), a laptop or mobile computer (852A), a cellular telephone (852B), a desktop computer (852C), a server (852D), or any other suitable device (852E) having the desired communication capabilities.

In some implementations, the influence determiner 5190 may provide electronic content for access by the communication devices 5160, 5152. In further implementations, the environment 5150 may include one or more content providers 5192. The content providers 5192 (and the influence determiner 5190) may include a wide variety of suitable devices. For example, in some implementations, the content providers 5192 may include a server (890), a database (892A), a hand-held device (892B) (e.g. personal data assistant (PDA), global positioning system (GPS), radio, television, audio device, audio-visual device, mobile communicator, signal processor, etc.), a laptop or mobile computer (892C), a cellular telephone (892D), a desktop computer (892E), or any other suitable device (892E) having the desired content-providing capabilities.

In some implementations, the infrastructure 5180 may include a variety of suitable components that cooperatively provide a wired or wireless communications functionality. Various exemplary communication components of the infrastructure 5180 are shown in FIG. 141 for illustrative purposes. For example, in some implementations, the infrastructure 5180 may include one or more of the following: a communications satellite 5182, an antenna tower 5184, a computer 5185, a communications dish 5186, a signal carrier 5188, and one or more networks 5189. Alternately, other communications components may be used. In particular implementations, for example, the infrastructure 5180 may include components that make up a Core Network (CN) and/or a UMTS Terrestrial Radio Access Network (UTRAN) of a modern UMTS (Universal Mobile Telecommunication System).

As further illustrated in FIG. 141, in some implementations, the communication device 5160 includes one or more processors 5162 and one or more input/output (I/O) devices 5164 coupled to a system memory 5170 by a bus 5166. Power may be provided to the components of the communication device 5160 via a power supply 5168. The system bus 5166 of the communication device 5160 represents any of the several types of bus structures, including a memory bus or memory controller, a peripheral bus, an accelerated graphics port, and a processor or local bus using any of a variety of bus architectures. The I/O component 5164 may be configured to operatively communicate with one or more external components, such as one or more components of the infrastructure 5180, one or more other communication devices 5152, the influence determiner 5190, one or more content providers 5192, or other communications networks, such a cellular telephone network, a satellite network, an information network (e.g., Internet, intranet, cellular network, cable network, fiber optic network, LAN, WAN, etc.), an infrared or radio wave communication network, or any other suitable network.

The system memory 5170 may include computer-readable media configured to store data and/or program modules for implementing the techniques disclosed herein that are immediately accessible to and/or presently operated on by the processor 5162. For example, the system memory 5170 may store a basic input/output system (BIOS) 5172, an operating system 5174, one or more application programs 5176 (e.g. a web browser, a communications program, etc.), and program data 5178 that can be accessed by the processor 5172 for performing various tasks desired by a user of the communication device 5160. The other communication devices 5152 of the environment 5150 may have an internal structure similar to (or different than) that of the communication device 5160 shown in FIG. 141.

The computer-readable media included in the system memory 5170 can be any available media that can be accessed by the device 5160, including computer storage media and communication media. Computer storage media may include both volatile and nonvolatile, removable and non-removable media implemented in any method or technology for storage of information such as computer-readable instructions, data structures, program modules, or other data. Computer storage media includes, but is not limited to, and random access memory (RAM), read only memory (ROM), electrically erasable programmable ROM (EEPROM), flash memory or other memory technology, compact disk ROM (CD-ROM), digital versatile disks (DVD) or other optical disk storage, magnetic cassettes, magnetic tape, magnetic disk storage or other magnetic storage devices, or any other medium, including paper, punch cards and the like, which can be used to store the desired information and which can be accessed by the communication device 5160.

Similarly, communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF (radio-frequency), infrared and other wireless media. Combinations of any of the above should also be included within the scope of computer readable media.

Generally, program modules executed on the communication devices 5160, 5152, the influence determiner 5190, or the content providers 5192 (FIG. 141) may include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

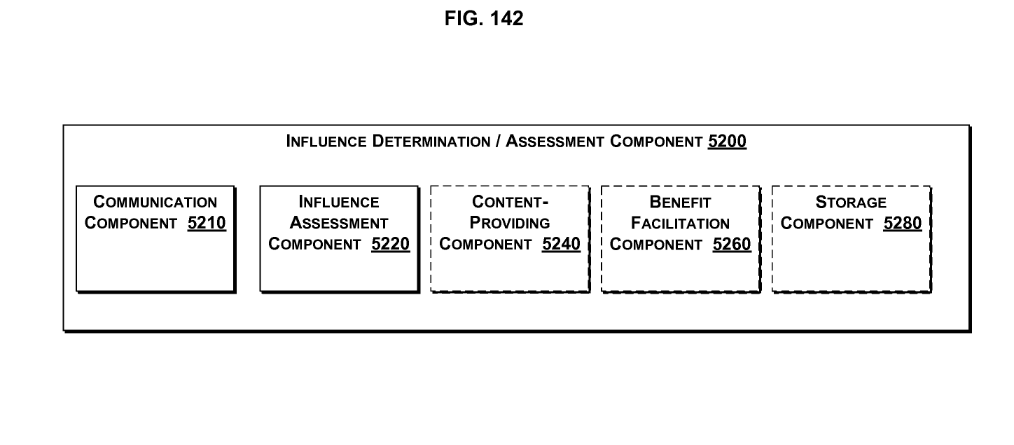

FIG. 142 shows an exemplary implementation of the influence assessment component 5200 of the influence determiner 5190 of FIG. 141. Although the influence determination/assessment component 5200 is depicted as being resident on the influence determiner 5190 in FIG. 141, in some implementations, one or more portions or functionalities of the influence determination/assessment component 5200 may be distributed to other portions of the environment 5150 (e.g. infrastructure 5180, communication devices 5160, 5152, content providers 5192, etc.). More specifically, in further implementations, the influence determination/assessment component 5200 may reside on an electronic device of an accessor, or an electronic device of a provider of electronic content, or on any other suitable component of the environment 850.

As shown in FIG. 142, in some implementations, the influence determination/assessment component 5200 may include a communication component 5210 operatively communicating with an influence deetermination/assessment component 5230. In further implementations, the influence deetermination/assessment component 5200 may also include a content-providing component 5240, a benefit facilitation component 5260, and a storage component 5280. The various components 5210, 5220, 5240, 5260, 5280 of the influence deetermination/assessment component 5200 may operatively communicate using known techniques to accomplish the desired functionalities described herein. In addition, unless otherwise specified, it will be appreciated that the various components 5210, 5220, 5240, 5260, 5280 of the influence deetermination/assessment component 5200 may be implemented using hardware, software, firmware, or combinations thereof.

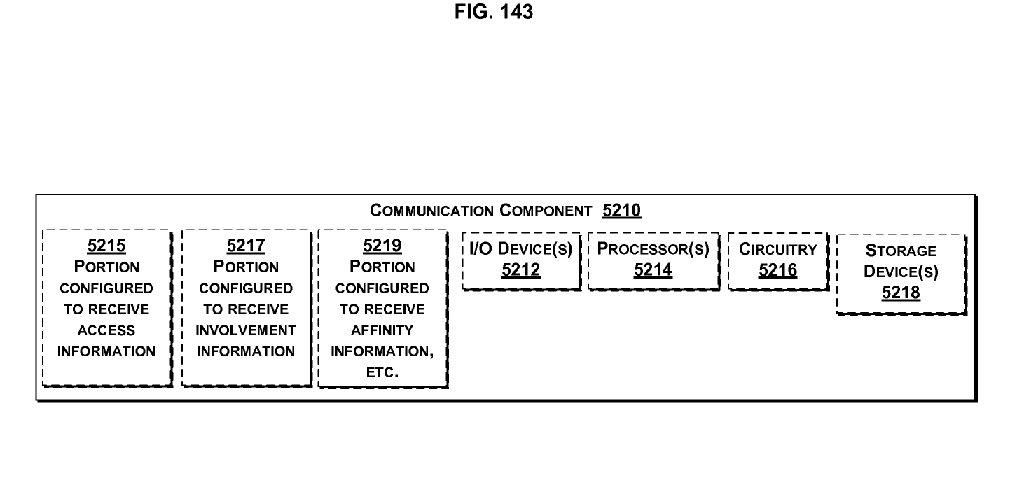

FIG. 143 illustrates an exemplary implementation of the communication component 5210 of FIG. 142. In some implementations, the communication component 5210 may include a portion 5215 configured to receive access information, and a portion 5217 configured to receive involvement information 5217, as described more fully below. In some implementations, the portion 5217 configured to receive involvement information is further configured to receive involvement information using a machine-implemented Web 2.0 construct, as described more fully below. In further implementations, the communication component 5210 may include a portion 5219 configured to receive affinity information, or any other desired information. Further possible implementations and aspects of the communication component 5210 are described more fully below.

As further shown in FIG. 143, the communication component 5210 may also include one or more I/O devices 5212 (e.g. antennas, ports, etc.), processors 5214, circuitry 5216 (e.g. ASICs, signal conditioning, etc.), storage devices 5218, or any other suitable desired sub-components or sub-systems to cooperatively perform the desired functionalities described herein. Although the portions and components of the communication component 5210 are depicted in FIG. 143 as being separate portions and components for the sake of clarity, it should be appreciated that these portions and components are not necessarily separate, and may variously be combined or may have overlapping portions, components, or functionalities.

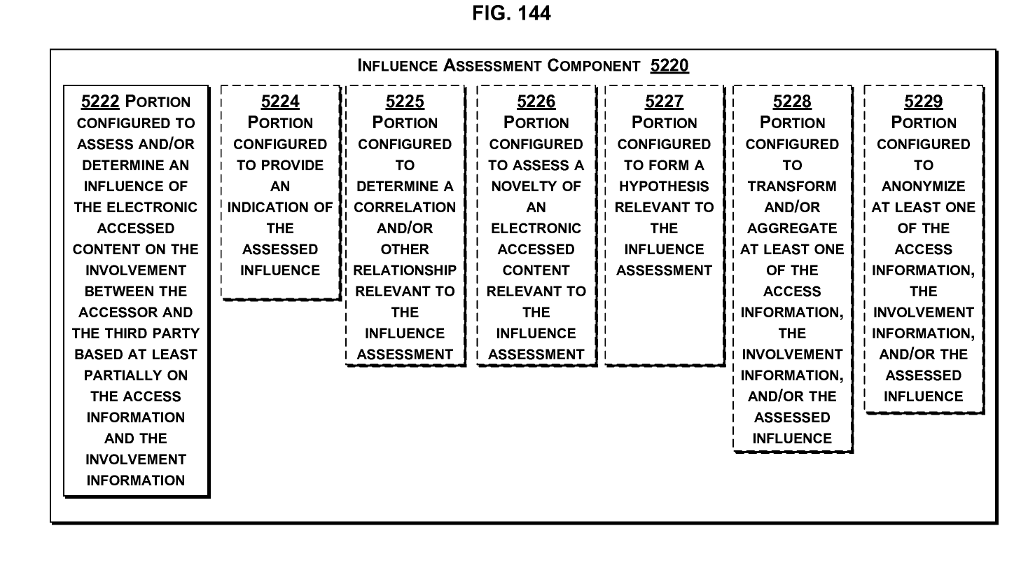

FIG. 144 shows an exemplary implementation of the influence assessment component 5220 of FIG. 142. In some implementations, the influence assessment component 5220 may include a portion 5222 configured to assess and/or determine an influence of the electronic accessed content on the involvement between the accessor and the third party based at least partially on the access information and the involvement information. In further implementations, the influence assessment component 5220 may include a portion 5224 configured to provide an indication of the assessed influence. The influence assessment component 5220 may also include a portion 5225 configured to determine a correlation and/or other relationship relevant to the influence assessment (e.g. a correlation between a communication between a content site and a computing device responsive to a human user input, and a communication between the computing device and a beneficiary site).

In some implementations, the influence assessment component 5220 may include a portion 5226 configured to assess a novelty of an electronic accessed content relevant to the influence assessment. In further implementations, the influence assessment component 5220 may include a portion 5227 configured to form a hypothesis relevant to the influence assessment. Similarly, the influence assessment component 5220 may include a portion 5228 configured to transform and/or aggregate at least one of the access information, the involvement information, and/or the assessed influence. In some implementations, the influence assessment component 5220 may include a portion 5229 configured to anonymize at least one of the access information, the involvement information, and/or the assessed influence. Further possible implementations and aspects of the influence assessment component 5220 are described more fully below.

Although such components are not shown in FIG. 144 for the sake of clarity, in some implementations, the influence assessment component 5220 may also include one or more I/O devices 5212 (e.g. antennas, ports, etc.), processors 5214, circuitry 5216 (e.g. ASICs, signal conditioning, etc.), or storage devices 5218 (see FIG. 143). Again, although the portions and components of the influence assessment component 5220 are depicted in FIG. 144 as being separate portions and components for the sake of clarity, it should be appreciated that these portions and components are not necessarily separate, and may variously be combined or may have overlapping portions, components, or functionalities.

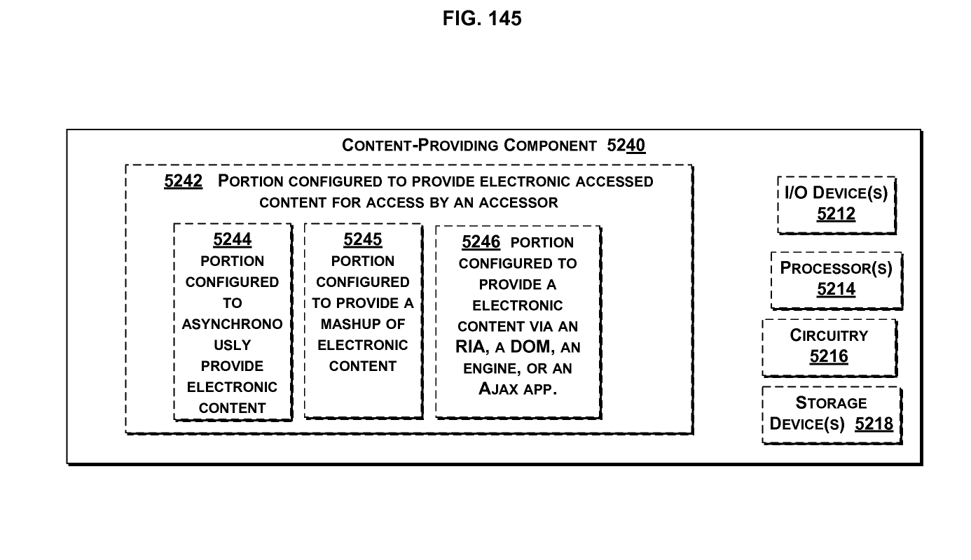

FIG. 145 shows an exemplary implementation of the content-providing component 5240 of FIG. 142. In some implementations, the content-providing component 5240 may include a portion 5242 configured to provide electronic accessed content for access by an accessor. More specifically, in some implementations, the portion 5242 configured to provide electronic accessed content for access by an accessor may include a portion 5244 configured to asynchronously provide electronic content, or a portion 5245 configured to provide a mashup of electronic content, a portion 5246 configured to provide electronic content via a Rich Internet Application (RIA) (e.g. a Flash application, etc.), or a Document Object Model (DOM), or an engine, or an Ajax application, or other portions configured to provide electronic content in a variety of ways, as described more fully below. In addition, further possible implementations and aspects of the content-providing component 5240 are described more fully below.

As shown in FIG. 145, the content-providing component 5240 may also include one or more I/O devices 5212 (e.g. antennas, ports, etc.), processors 5214, circuitry 5216 (e.g. ASICs, signal conditioning, etc.), or storage devices 5218. Again, although the portions and components of the content-providing component 5240 are depicted in FIG. 145 as being separate portions and components for the sake of clarity, it should be appreciated that these portions and components are not necessarily separate, and may variously be combined or may have overlapping portions, components, or functionalities.

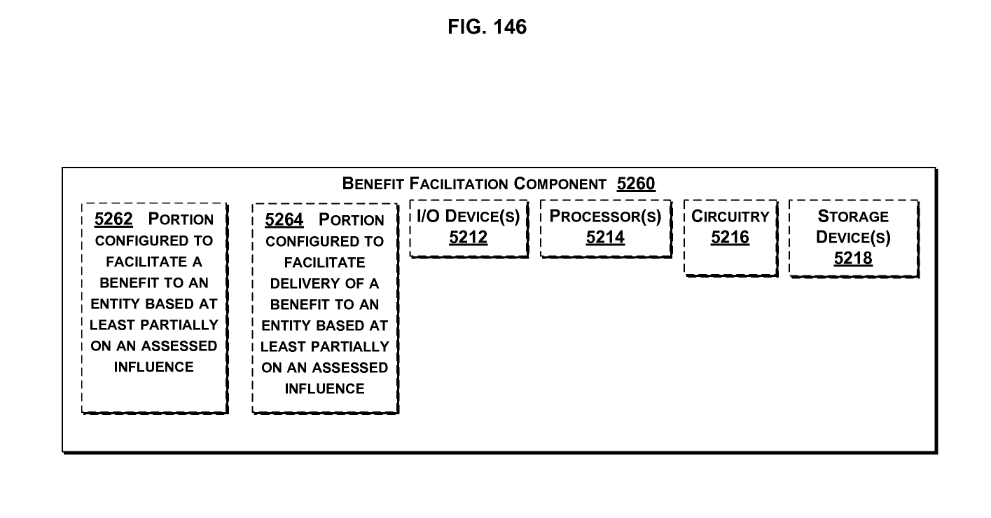

FIG. 146 shows an exemplary implementation of the benefit facilitation component 5260 of FIG. 142. In some implementations, the benefit facilitation component 5260 may include a portion 5262 configured to facilitate a benefit to an entity based at least partially on an assessed influence. In further implementations, the benefit facilitation component 5260 may include a portion 5264 configured to facilitate delivery of a benefit to an entity based at least partially on an assessed influence. In addition, further possible implementations and aspects of the benefit facilitation component 5260 are described more fully below.

As shown in FIG. 146, the benefit facilitation component 5260 may also include one or more I/O devices 5212 (e.g. antennas, ports, etc.), processors 5214, circuitry 5216 (e.g. ASICs, signal conditioning, etc.), or storage devices 5218. Again, although the portions and components of the benefit facilitation component 5260 are depicted in FIG. 146 as being separate portions and components for the sake of clarity, it should be appreciated that these portions and components are not necessarily separate, and may variously be combined or may have overlapping portions, components, or functionalities.

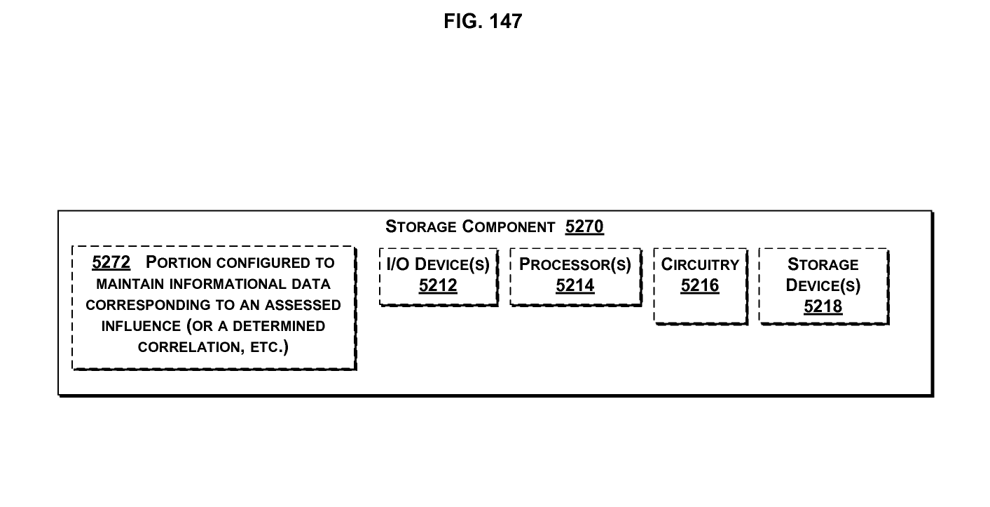

FIG. 147 shows an exemplary implementation of the storage component 5270 of FIG. 142. In some implementations, the storage component 5270 may include a portion 5272 configured to maintain informational data corresponding to the assessed influence, or information relevant to the assessed influence (e.g. a determined correlation, etc.). In addition, further possible implementations and aspects of the storage component 5270 are described more fully below.

As shown in FIG. 147, the storage component 5270 may also include one or more I/O devices 5212 (e.g. antennas, ports, etc.), processors 5214, circuitry 5216 (e.g. ASICs, signal conditioning, etc.), or storage devices 5218. Again, although the portions and components of the storage component 5270 are depicted in FIG. 147 as being separate portions and components for the sake of clarity, it should be appreciated that these portions and components are not necessarily separate, and may variously be combined or may have overlapping portions, components, or functionalities.

It should be appreciated that the exemplary systems and environments described above with reference to FIGS. 101-104 and 141-147 are merely illustrative of a few of the many possible systems and environments in which the teachings of the present disclosure may be implemented, and that the teachings herein are not limited to the particular systems and environments described above.

Exemplary Processes for Rewarding Influencers

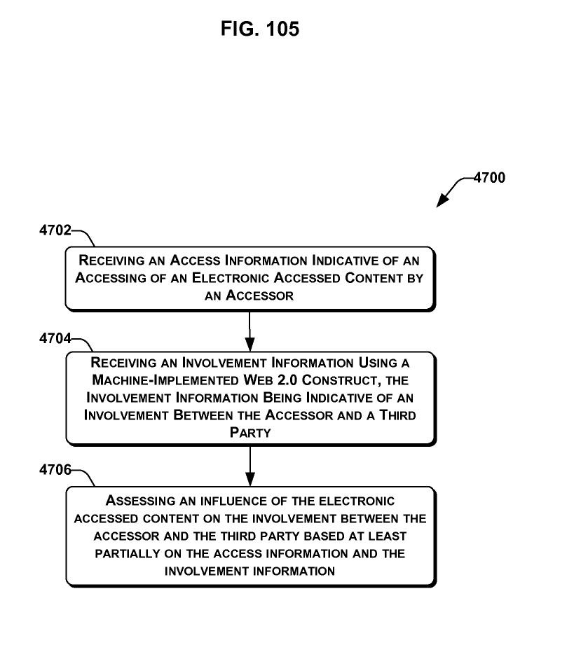

Exemplary processes for rewarding influencers in accordance with the teachings of the present disclosure are described below with reference to FIGS. 105 through 140. It will be appreciated, however, that the following description of exemplary processes is not exhaustive of all possible processes in accordance with the teachings of the present disclosure.

For example, FIG. 105 is a flowchart of method 4700 of assessing an influence of an electronically accessed content in accordance with the present disclosure. More specifically, in this implementation, the method 4700 includes access information indicative of an accessing of an electronic accessed content by an accessor at 4702. For example, in a representative implementation, access information indicative of an accessing of an electronic accessed content by an accessor at 4702 may include receiving data indicating that a web browser associated with a particular consumer has accessed a particular website for a particular duration of time, or that a mobile device (e.g. cellular telephone) has requested a download of a particular podcast of information.

The method 4700 further includes involvement information using a machine-implemented Web 2.0 construct, the involvement information being indicative of an involvement between the accessor and a third party at 4704. In some implementations, the involvement information using a machine-implemented Web 2.0 construct, the involvement information being indicative of an involvement between the accessor and a third party at 4704 may include, for example, receiving data indicating that the above-mentioned consumer conducted a transaction with a particular vendor of goods or services, or that a user of the aforesaid cellular telephone conducted business with a broker. It will be appreciated that a wide variety of machine-implemented Web 2.0 constructs may be used for receiving the involvement information at 4704, including, for example, an Ajax (Asynchronous JavaScript and XML (Extensible Markup Language)) application, an asynchronous application, a Flash® application, a web service, any other suitable Web 2.0 engine (or content or construct), or a mashup that includes one or more of the afore-mentioned constructs.

As further shown in FIG. 105, the method 4700 also includes assess an influence of the electronic accessed content on the involvement between the accessor and the third party based at least partially on the access information and the involvement information at 4706. For example, in a representative implementation, the assess an influence of the electronic accessed content on the involvement between the accessor and the third party based at least partially on the access information and the involvement information at 4706 may include assessing whether the website accessed by the consumer using the browser was the primary reason the consumer purchased the good or service from the vendor, or assessing whether the cell phone user's interaction with the broker was attributable to the podcast that was downloaded by the user. Of course, many other representative scenarios in accordance with the method 4700 may be conceived.

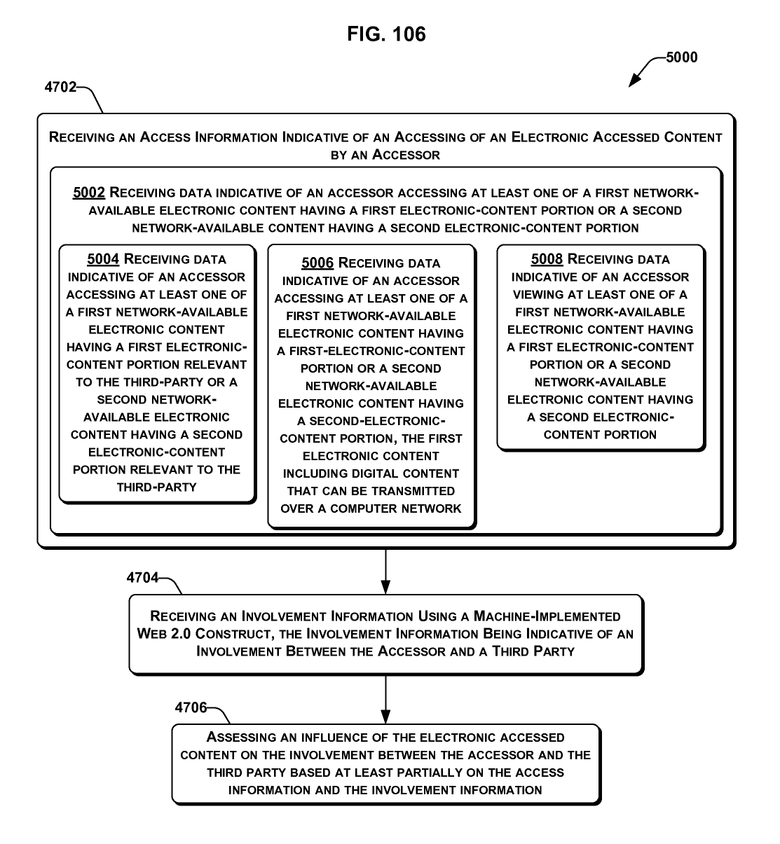

It will be appreciated that receiving the access information at 4702 may occur in a variety of ways. For example, in a method 5000 as shown in FIG. 106, access information indicative of an accessing of an electronic accessed content by an accessor may include data indicative of an accessor accessing at least one of a first network-available electronic content having a first electronic content portion or a second network-available electronic content having a second electronic content portion at 5002 (e.g. receiving data indicative of an accessing of a mashup of a web service-related content and a blog-related content).

More specifically, data indicative of an accessor accessing at least one of a first network-available electronic content having a first electronic content portion or a second network-available electronic content having a second electronic content portion (at 5002) may include data indicative of an accessor accessing at least one of a first network-available electronic content having a first electronic content portion relevant to the third party or a second network-available electronic content having a second electronic content portion relevant to the third party at 5004. For example, data may be received indicative of a consumer accessing a first product-related content comparing a first brand of cameras (Brand A) to a second brand of cameras (Brand B), and also indicative of the consumer assessing a second product-related content comparing the first and second brands of cameras (Brand A and B), the third party being a provider (e.g. manufacturer, wholesaler, retailer, advertiser, etc.) of either the Brand A camera or the Brand B camera.

Similarly, data indicative of an accessor accessing at least one of a first network-available electronic content having a first electronic content portion or a second network-available electronic content having a second electronic content portion (at 5002) may include data indicative of an accessor accessing at least one of a first network-available electronic content having a first electronic content portion or a second network-available electronic content having a second electronic content portion, the first electronic content including digital content that can be transmitted over a computer network at 5006 (e.g. receiving data indicative of a searchbot accessing a first webpage or a second webpage, the first webpage including digitized audio signals that are transmitted over the Internet). In some implementations, data indicative of an accessor accessing at least one of a first network-available electronic content having a first electronic content portion or a second network-available electronic content having a second electronic content portion (at 5002) may include data indicative of an accessor viewing at least one of a first network-available electronic content having a first electronic content portion or a second network-available electronic content having a second electronic content portion at 5008 (e.g. receiving data indicative of a media player viewing a mashup that provides a first viewable podcast and a second viewable podcast).

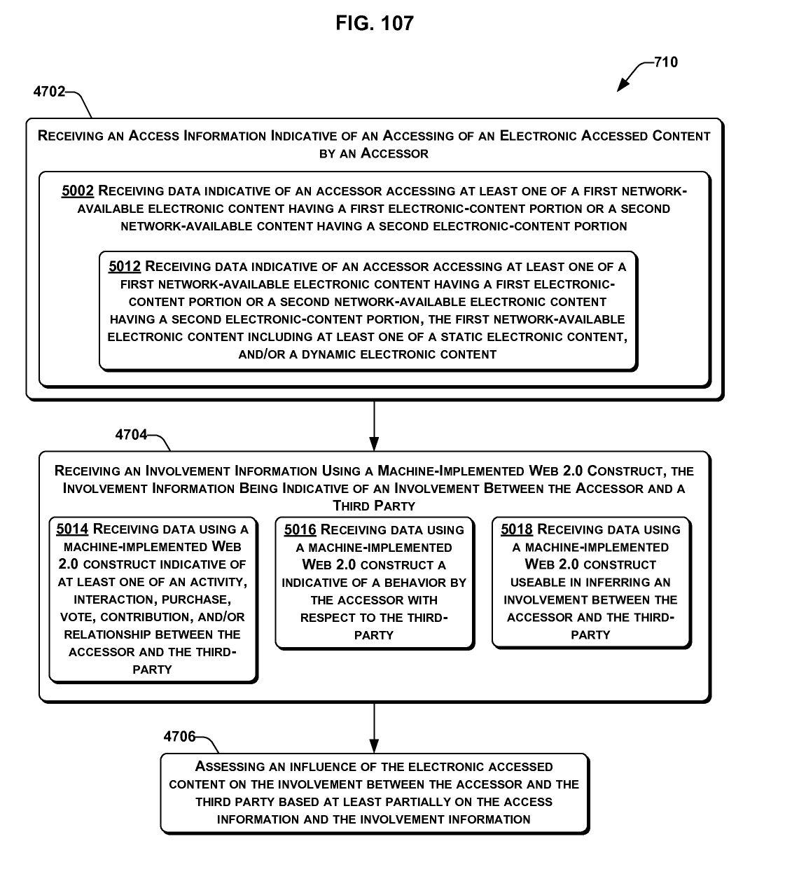

In addition, as depicted by process 5010 shown in FIG. 107, in some implementations, data indicative of an accessor accessing at least one of a first network-available electronic content having a first electronic content portion or a second network-available electronic content having a second electronic content portion (at 5002) may include data indicative of an accessor accessing at least one of a first network-available electronic content having a first electronic content portion or a second network-available electronic content having a second electronic content portion, the first network-available electronic content including at least one of a static electronic content, and/or a dynamic electronic content at 5012 (e.g. receiving data indicative of a browser accessing a webpage that provides a mashup of a sports team's schedule (static content) and an RSS feed of statistics and scores from the games that are or have been occurring throughout the country (dynamic content)).

It will be appreciated that receiving the involvement information at 4704 may be accomplished in a variety of ways. For example, as further shown in FIG. 107, involvement information using a machine-implemented Web 2.0 construct, the involvement information being indicative of an involvement between the accessor and a third party (at 4704) may include data using a machine-implemented Web 2.0 construct indicative of at least one of an activity, interaction, purchase, vote, contribution, and/or relationship between the accessor and the third party at 5014 (e.g. receiving involvement data using an asynchronous application indicative of a purchase-and-sale transaction between a consumer and a vendor). Similarly, involvement information using a machine-implemented Web 2.0 construct, the involvement information being indicative of an involvement between the accessor and a third party (at 4704) may include data using a machine-implemented Web 2.0 construct indicative of a behavior by the accessor with respect to the third party at 5016 (e.g. receiving involvement data using a mashup that indicates that a person recommended the services of an insurance provider to a friend).

In further implementations, involvement information using a machine-implemented Web 2.0 construct, the involvement information being indicative of an involvement between the accessor and a third party (at 4704) may include data using a machine-implemented Web 2.0 construct useable in inferring an involvement between the accessor and the third party at 5018 (e.g. receiving data using an Ajax application that shows a cookie indicative of a consumer transaction was placed by the third party's website on the accessor's device).

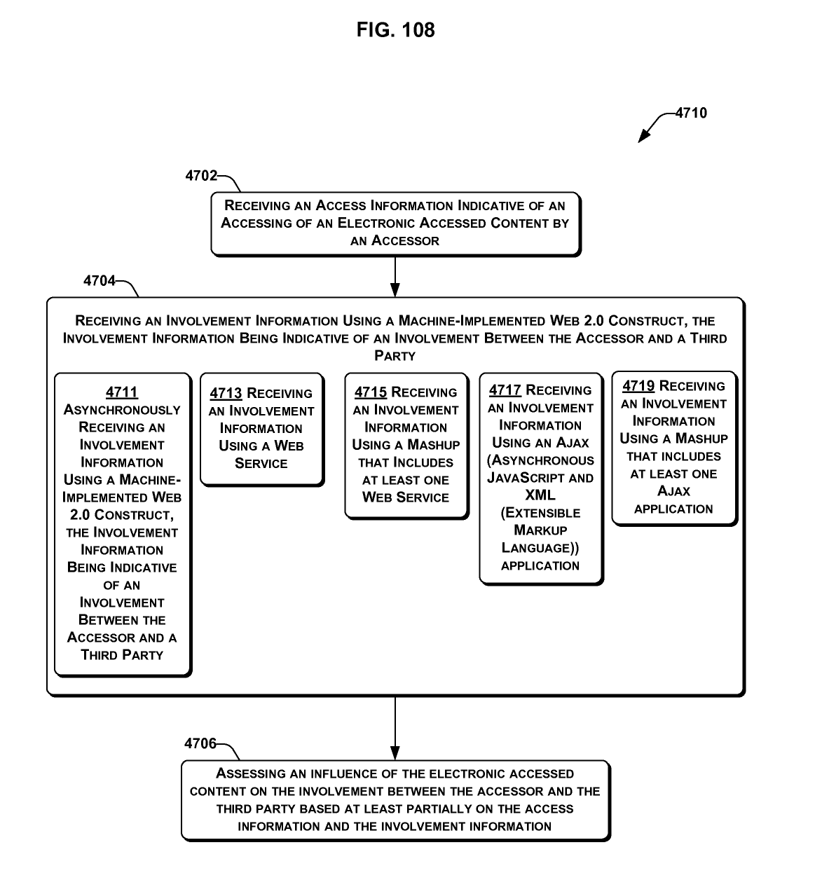

Furthermore, in a method 4710 as shown in FIG. 108, involvement information using a machine-implemented Web 2.0 construct, the involvement information being indicative of an involvement between the accessor and a third party (at 4704) may include asynchronously involvement information using a machine-implemented Web 2.0 construct, the involvement information being indicative of an involvement between the accessor and a third party at 4711 (e.g. using an Ajax application or other asynchronous engine). In some implementations, involvement information using a machine-implemented Web 2.0 construct, the involvement information being indicative of an involvement between the accessor and a third party (at 4704) may include receiving an involvement information using a web service at 4713 (e.g. a web service that performs tracking and reporting of durations of time spent by web browsers accessing websites). Similarly, in some implementations, involvement information using a machine-implemented Web 2.0 construct, the involvement information being indicative of an involvement between the accessor and a third party (at 4704) may include receiving an involvement information using a mashup that includes at least one web service at 4715 (e.g. a mashup that provides both an Internet search service and a web service that performs tracking and reporting of durations of time spent by web browsers accessing websites).

In further implementations, involvement information using a machine-implemented Web 2.0 construct, the involvement information being indicative of an involvement between the accessor and a third party (at 4704) may include receiving an involvement information using an Ajax (Asynchronous JavaScript and XML (Extensible Markup Language)) application at 4717 (e.g. an Ajax application that documents and reports podcasts downloaded to a platform or device). Similarly, in some implementations, involvement information using a machine-implemented Web 2.0 construct, the involvement information being indicative of an involvement between the accessor and a third party (at 4704) may include receiving an involvement information using a mashup that includes at least one Ajax application at 4719 (e.g. a mashup that includes both an offer to sell printed materials and an Ajax application that documents and reports podcasts downloaded to a platform or device).

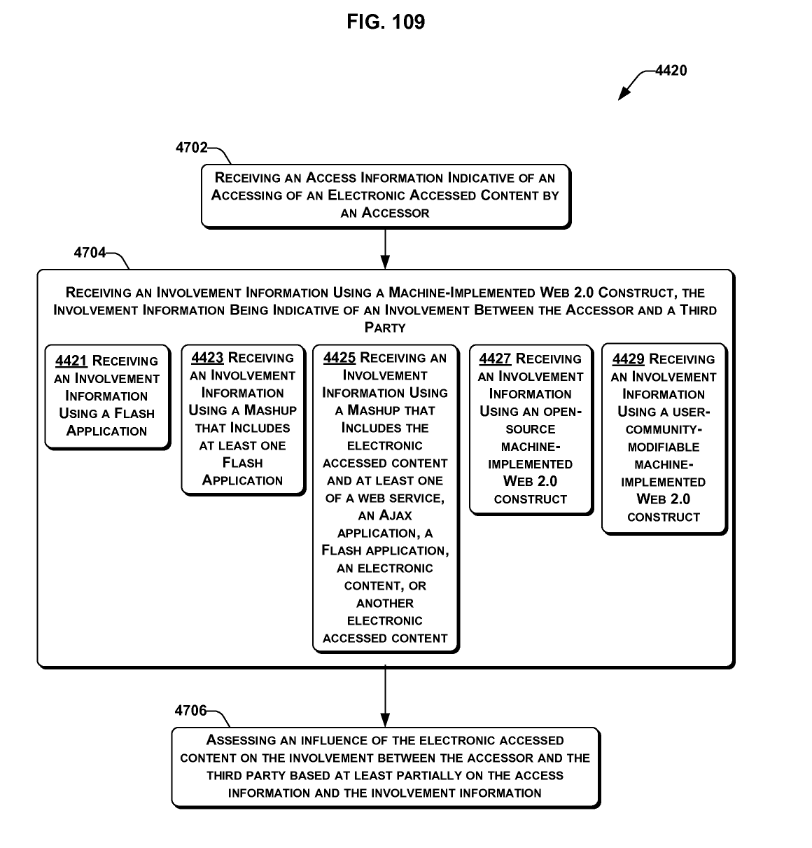

As depicted in the process 4420 shown in FIG. 109, in some implementations, involvement information using a machine-implemented Web 2.0 construct, the involvement information being indicative of an involvement between the accessor and a third party (at 4704) may include receiving an involvement information using a Flash application at 4421 (e.g. a Flash application that provides animation or other enhanced interactive capabilities and that monitors or reports web browser activities). Similarly, in some implementations, involvement information using a machine-implemented Web 2.0 construct, the involvement information being indicative of an involvement between the accessor and a third party (at 4704) may include receiving an involvement information using a mashup that includes at least one Flash application at 4423 (e.g. a mashup that provides audio or visual content to a viewer and a Flash application that provides animation or other enhanced interactive capabilities and that monitors or reports web browser activities).

In further implementations, involvement information using a machine-implemented Web 2.0 construct, the involvement information being indicative of an involvement between the accessor and a third party (at 4704) may include receiving an involvement information using a mashup that include the electronic accessed content and at least one of a web service, an Ajax application, a Flash application, an electronic content, or another electronic accessed content at 4425 (e.g. a mashup that includes a product review and an engine that monitors or reports web browser activities). Similarly, in some implementations, involvement information using a machine-implemented Web 2.0 construct, the involvement information being indicative of an involvement between the accessor and a third party (at 4704) may include receiving an involvement information using an open source machine-implemented Web 2.0 construct at 4427 (e.g. an open-source engine that monitors or reports web browser activities, or an open-source application that documents access time durations). In further implementations, involvement information using a machine-implemented Web 2.0 construct, the involvement information being indicative of an involvement between the accessor and a third party (at 4704) may include receiving an involvement information using a user-community modifiable machine-implemented Web 2.0 construct at 4429 (e.g. a user-community modifiable construct that monitors or reports downloading or browsing activities and time durations).

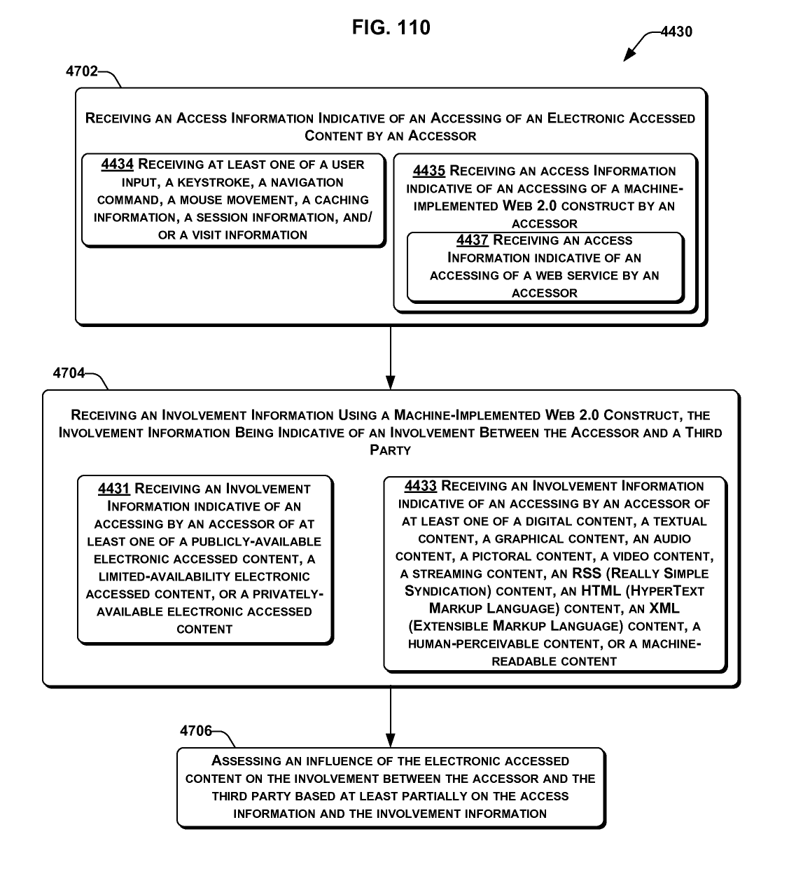

In some implementations, such as a process 4430 shown in FIG. 110, involvement information using a machine-implemented Web 2.0 construct, the involvement information being indicative of an involvement between the accessor and a third party (at 4704) may include access information indicative of an accessing by an accessor of at least one of a publicly-available electronic accessed content, a limited-availability electronic accessed content, or a privately-available electronic accessed content at 4431. For example, the receiving of the access information (at 4704) may include receiving an email message documenting a patron's accessing history of a publicly-available electronic library, a limited-availability electronic library (e.g. available only to registered patrons or pay-per-view patrons), or a privately-available electronic library (e.g. a library owned by a club or corporation).

Similarly, in some implementations, involvement information using a machine-implemented Web 2.0 construct, the involvement information being indicative of an involvement between the accessor and a third party (at 4704) may include access information indicative of an accessing by an accessor of at least one of a digital content, a textual content, a graphical content, an audio content, a pictoral content, a video content, a streaming content, an RSS (Really Simple Syndication) content, an HTML (HyperText Markup Language) content, an XML (Extensible Markup Language) content, a human-perceivable content, or a machine-readable content at 4433 (e.g. receiving electronic signals indicating a user's accessing of graphical content from a news-related service).

As further shown in FIG. 110, in some implementations, access information indicative of an accessing of an electronic accessed content by an accessor (at 4702) may include at least one of a user input, a keystroke, a navigation command, a mouse movement, a caching information, a session information, and/or a visit information at 4434. For example, the at least one of a user input, a keystroke, a navigation command, a mouse movement, a caching information, a session information, and/or a visit information may include information associated with, incidental to, and/or responsive to one or more of user mouse movements, scrolling movements, purchases, operations, visited Websites, visited blogs, page views, page visits, viewing time, repeat visits, page tags, printing a content, click stream, search strings, local search strings, interactions, scrolling, menu activity, corresponding/related to browsing the Internet, cut and past, print history, browsing history, email, cookies, user keystrokes, logged keystrokes along with the window name they are typed, email sent, email received, logged events, logged timeline, Website activity, logged Websites visited, application usage; log of applications run, documents opened, saved documents, files opened, files viewed, cut, cut and paste, scrolling, navigating, and setting a bookmark. In further implementations, the access information may include data indicative of a computing system environment, a local computing system interaction associated with the client-side computing device, a network interaction including bulk content downloaded to form a page, a turning of visibility tags on and off, and/or an interactive environment.

In further implementations, access information indicative of an accessing of an electronic accessed content by an accessor (at 4702) may include access information indicative of an accessing of a machine-implemented Web 2.0 construct by an accessor at 4435 (e.g. receiving information indicating a user's viewing of visual content from a mashup that includes a Web-based information service). More specifically, in some implementations, access information indicative of an accessing of a machine-implemented Web 2.0 construct by an accessor (at 4435) may include access information indicative of an accessing of a web service by an accessor at 4437 (e.g. receiving information indicating a user's viewing of visual content from a Web-based information service).

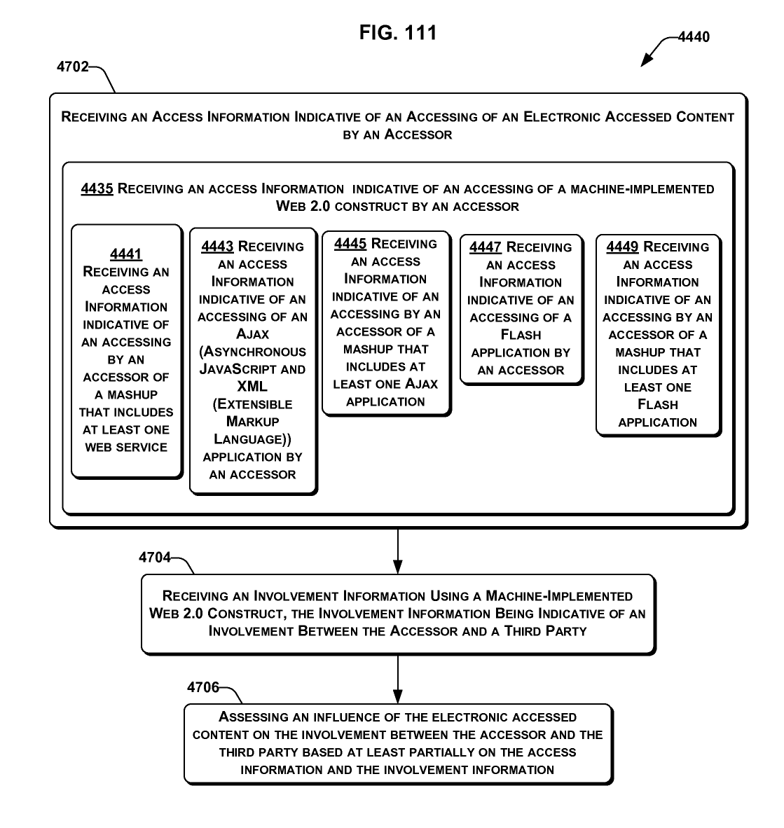

As depicted in a process 4440 shown in FIG. 111, in some implementations, access information indicative of an accessing of a machine-implemented Web 2.0 construct by an accessor (at 4435) may include access information indicative of an accessing by an accessor of a mashup that includes at least one web service at 4441 (e.g. receiving information indicating a mobile device's downloading of audio content from a mashup that includes an RSS service). In further implementations, access information indicative of an accessing of a machine-implemented Web 2.0 construct by an accessor (at 4435) may include access information indicative of an accessing of an Ajax (Asynchronous JavaScript and XML (Extensible Markup Language)) application by an accessor at 4443 (e.g. receiving information indicating a PDA (Personal Data Assistant) access of an Ajax application from a website that provides Internet search services). Similarly, access information indicative of an accessing of a machine-implemented Web 2.0 construct by an accessor (at 4435) may include access information indicative of an accessing by an accessor of a mashup that includes at least one Ajax application at 4445 (e.g. receiving information indicating a PDA (Personal Data Assistant) access of a mashup that includes an Ajax application from a website that provides Internet search services).

As further shown in FIG. 111, in some implementations, access information indicative of an accessing of a machine-implemented Web 2.0 construct by an accessor (at 4435) may include access information indicative of an accessing of a Flash application by an accessor at 4447 (e.g. receiving information indicating a computer access of an animation-related Flash application from a website that offers books or other printed materials for sale). In further implementations, access information indicative of an accessing of a machine-implemented Web 2.0 construct by an accessor (at 4435) may include access information indicative of an accessing by an accessor of a mashup that includes at least one Flash application at 4449 (e.g. receiving information indicating a computer access of a mashup that includes an animation-related Flash application from a website that offers services for sale).

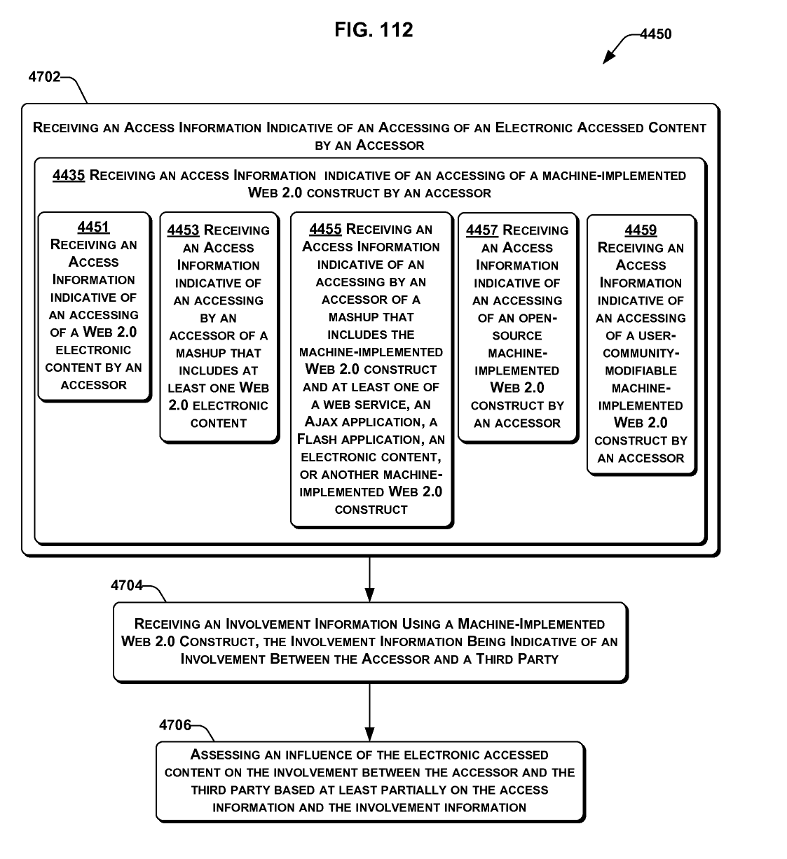

In some implementations, such as a process 4450 shown in FIG. 112, access information indicative of an accessing of a machine-implemented Web 2.0 construct by an accessor (at 4435) may include access information indicative of an accessing of a Web 2.0 electronic content by an accessor at 4451 (e.g. receiving a report indicating an accessing of an electronic article by a potential consumer). In further implementations, access information indicative of an accessing of a machine-implemented Web 2.0 construct by an accessor (at 4435) may include access information indicative of an accessing by an accessor of a mashup that includes at least one Web 2.0 electronic content at 4453 (e.g. receiving a report indicating an accessing by a potential consumer of a mashup from a provider of advertising that includes an electronic article). Similarly, access information indicative of an accessing of a machine-implemented Web 2.0 construct by an accessor (at 4435) may include access information indicative of an accessing by an accessor of a mashup that includes the machine-implemented Web 2.0 construct and at least one of a web service, an Ajax application, a Flash application, an electronic content, or another machine-implemented Web 2.0 construct at 4455 (e.g. receiving documentation indicating an accessing by a potential consumer of a mashup from a provider of advertising that includes an Ajax application and a web service that facilitates an RIA (Rich Internet Application)).

As further shown in FIG. 112, access information indicative of an accessing of a machine-implemented Web 2.0 construct by an accessor (at 4435) may include access information indicative of an accessing of an open-source machine-implemented Web 2.0 construct by an accessor at 4457 (e.g. receiving information indicating an accessing by a browser of an open-source Ajax application). In still other implementations, access information indicative of an accessing of a machine-implemented Web 2.0 construct by an accessor (at 4435) may include access information indicative of an accessing of a user-community-modifiable machine-implemented Web 2.0 construct by an accessor at 4459 (e.g. receiving information indicating an accessing by a device of a user-community-modifiable asynchronous interface engine).

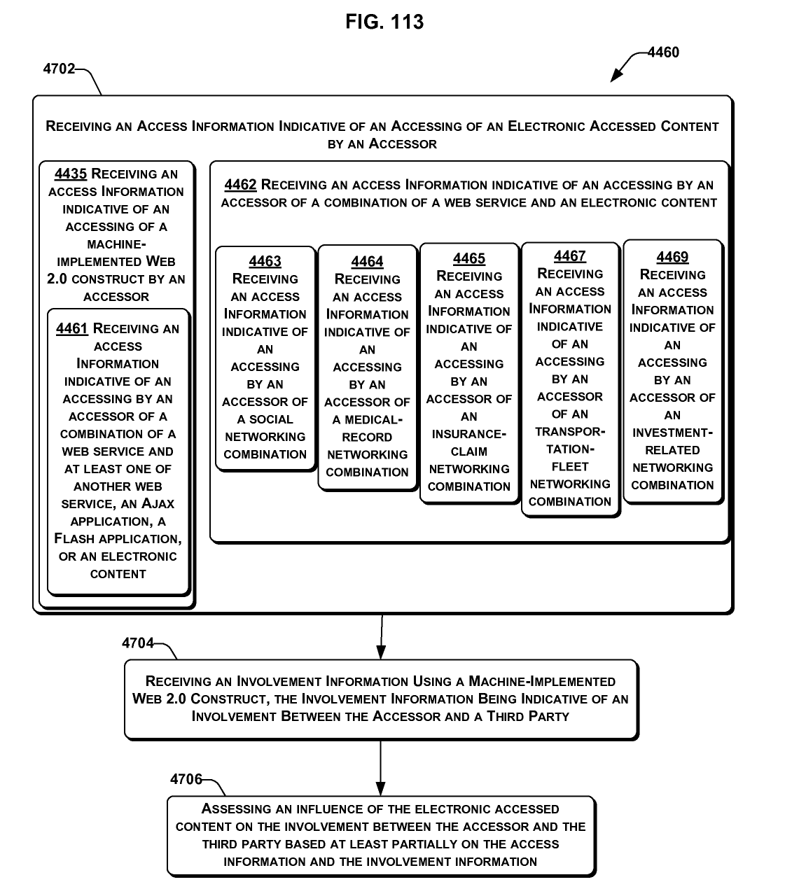

With reference now to FIG. 113, in a process 4460, access information indicative of an accessing of a machine-implemented Web 2.0 construct by an accessor (at 4435) may include access information indicative of an accessing by an accessor of a combination of a web service and at least one of another web service, an Ajax application, a Flash application, or an electronic content at 4461 (e.g. receiving information indicating an accessing by a potential consumer of a combination of a Flash application that shows animation of a product in operation). Similarly, in some implementations, access information indicative of an accessing of a machine-implemented Web 2.0 construct by an accessor (at 4435) may include access information indicative of an accessing by an accessor of a combination of a web service and an electronic content at 4462 (e.g. receiving information indicating an accessing by a potential consumer of a combination of a consumer-advocacy service and an article regarding particular products or services).

It will be appreciated that access information indicative of an accessing by an accessor of a combination of a web service and an electronic content (at 4462) may include numerous particular implementations. For example, as further shown in FIG. 113, in some implementations, access information indicative of an accessing by an accessor of a combination of a web service and an electronic content (at 4462) may include access information indicative of an accessing by an accessor of a social networking combination at 4463 (e.g. receiving information indicating an accessing by an individual of an Ajax application in combination with content related to potential dating partners). Similarly, in some implementations, access information indicative of an accessing by an accessor of a combination of a web service and an electronic content (at 4462) may include access information indicative of an accessing by an accessor of a medical-record networking combination at 4464 (e.g. receiving information indicating an accessing by an nurse of an asynchronous engine in combination with electronic information relating to patient medical history).

In further implementations, access information indicative of an accessing by an accessor of a combination of a web service and an electronic content (at 4462) may include access information indicative of an accessing by an accessor of an insurance-claim networking combination at 4465 (e.g. receiving information indicating an accessing by a claims adjustor of an application in combination with electronic information relating to vehicle repairs). Similarly, access information indicative of an accessing by an accessor of a combination of a web service and an electronic content (at 4462) may include access information indicative of an accessing by an accessor of a transportation-fleet networking combination at 4467 (e.g. receiving information indicating an accessing by a planner of an application in combination with electronic information relating to aircraft availability). In further implementations, access information indicative of an accessing by an accessor of a combination of a web service and an electronic content (at 4462) may include access information indicative of an accessing by an accessor of an investment-related networking combination at 4469 (e.g. receiving information indicating an accessing by a broker of a web service in combination with electronic information relating to stock prices).

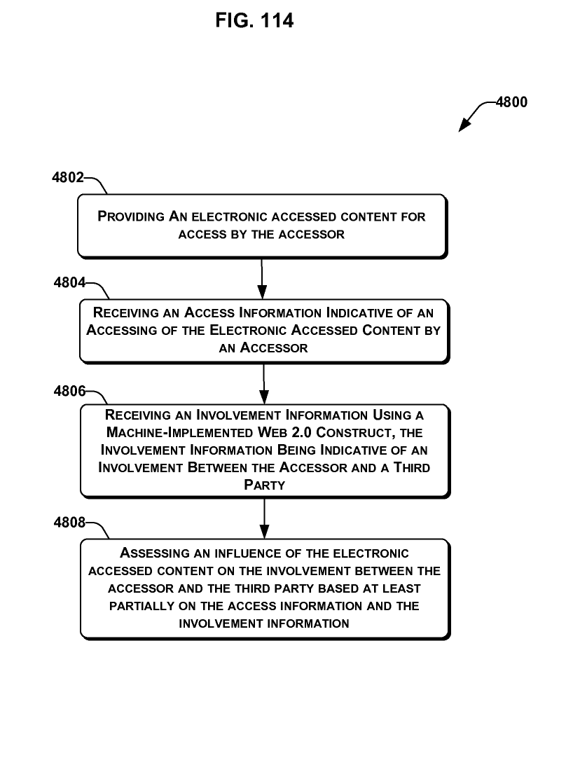

FIG. 114 is a flowchart of method 4800 in accordance with another implementation of the present disclosure. In this implementation, the method 4800 includes electronic accessed content for access by the accessor at 4802 (e.g. operating a server that hosts the electronic accessed content, or offering a web service, or providing access to an electronic library), access information indicative of an accessing of an electronic accessed content by an accessor at 4804 (e.g. receiving data packets indicating an accessing of the electronic accessed content), involvement information using a machine-implemented Web 2.0 construct, the involvement information being indicative of an involvement between the accessor and a third party at 4806 (e.g. receiving information signals via a mashup that includes an Ajax application), and assess an influence of the electronic accessed content on the involvement between the accessor and the third party based at least partially on the access information and the involvement information at 4808 (e.g. assessing an influence of the electronic accessed content on a purchase-and-sale transaction between and consumer and a vendor).

In some implementations, the electronic accessed content for access by the accessor at 4802 may be performed by the same entity that performs the involvement information using a machine-implemented Web 2.0 construct, the involvement information being indicative of an involvement between the accessor and a third party at 4806. For example, in some implementations, an entity that provides the electronic accessed content for access by the accessor and that receives involvement information using a machine-implemented Web 2.0 construct may include an online retailer, an online search provider, an information broker, an advertiser, a web service provider, or any other suitable entity.

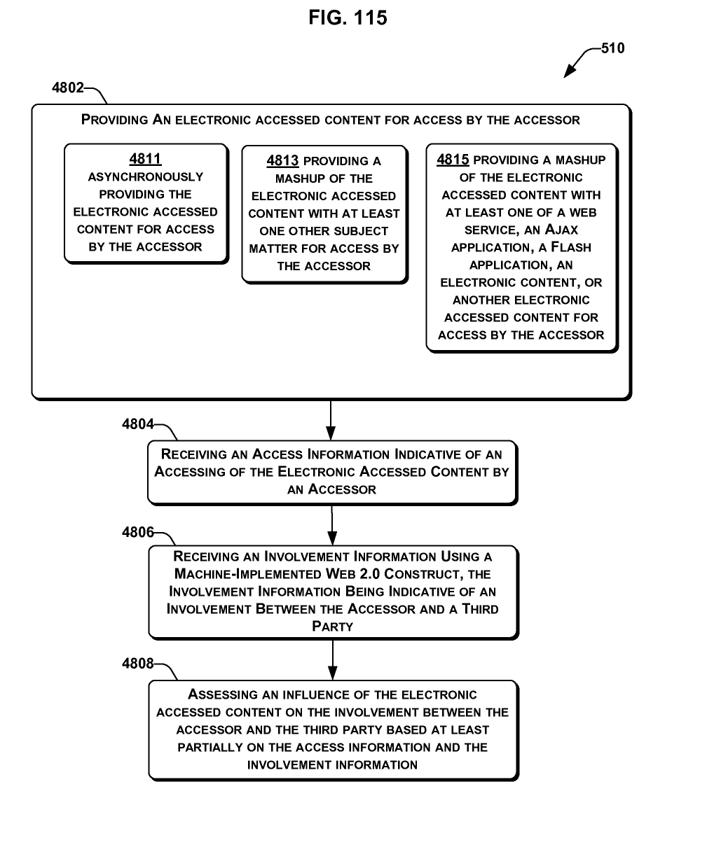

It will be appreciated that electronic accessed content for access by the accessor at 4802 may be accomplished in a variety of ways. For example, in a method 4810 as shown in FIG. 115, electronic accessed content for access by the accessor (at 4802) includes asynchronously electronic accessed content for access by the accessor at 4811 (e.g. providing the electronic accessed content using an asynchronous engine). Similarly, in some implementations, electronic accessed content for access by the accessor (at 4802) may include a mashup of the electronic accessed content with at least one other subject matter for access by the accessor at 4813 (e.g. providing a technical brochure mashed up with an HTML article). In further implementations, electronic accessed content for access by the accessor (at 4802) may include a mashup of the electronic accessed content with at least one of a web service, an Ajax application, a Flash application, an electronic content, or another electronic accessed content for access by the accessor at 4815 (e.g. providing a technical brochure mashed up with an RSS service).

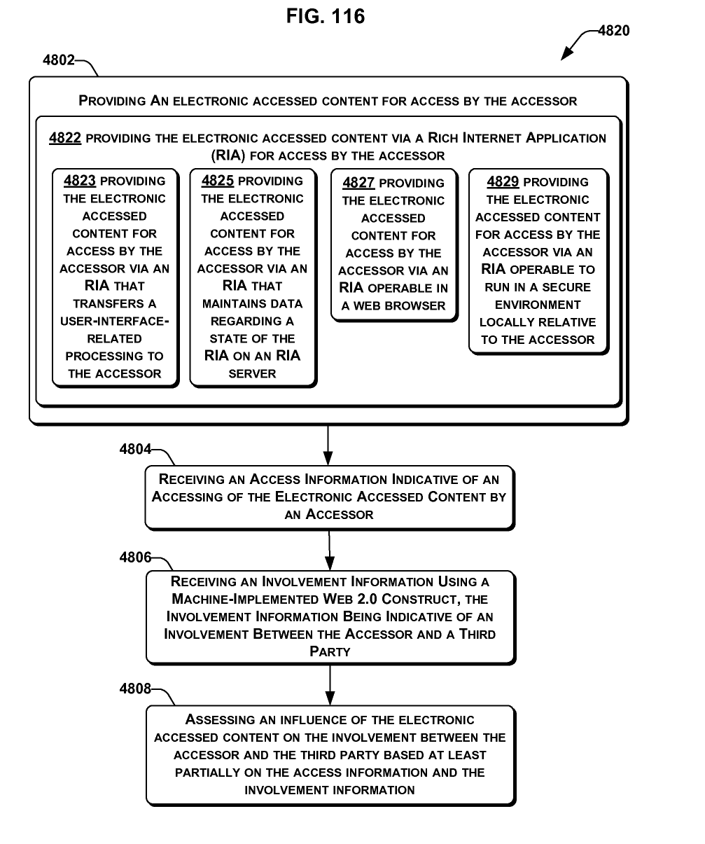

In further implementations, such as a process 4820 shown in FIG. 116, electronic accessed content for access by the accessor (at 4802) may include electronic accessed content via a Rich Internet Application (RIA) for access by the accessor at 4822 (e.g. providing an editorial content using an interactive Flash application). More specifically, in some implementations, electronic accessed content via a Rich Internet Application (RIA) for access by the accessor (at 4822) may include electronic accessed content for access by the accessor via an RIA that transfers a user-interface-related processing to the accessor at 4823 (e.g. providing an editorial content using an interactive Flash application loaded onto a viewer's device that handles interface-related processing). Similarly, in some implementations, electronic accessed content via a Rich Internet Application (RIA) for access by the accessor (at 4822) may include electronic accessed content for access by the accessor via an RIA that maintains data regarding a state of the RIA on an RIA server at 4825 (e.g. providing an editorial content using an interactive Flash application on a server that hosts the Flash application and maintains state data thereon).

In further implementations, electronic accessed content via a Rich Internet Application (RIA) for access by the accessor (at 4822) may include electronic accessed content for access by the accessor via an RIA operable in a web browser at 4827 (e.g. providing an editorial content using an interactive Flash application operable in Microsoft's Internet Explorer®). Similarly, in some implementations, electronic accessed content via a Rich Internet Application (RIA) for access by the accessor (at 4822) may include electronic accessed content for access by the accessor via an RIA operable to run in a secure environment locally relative to the accessor at 4829 (e.g. providing an editorial content using a Mocha application operable in to run in a “sandbox” environment on a mobile device).

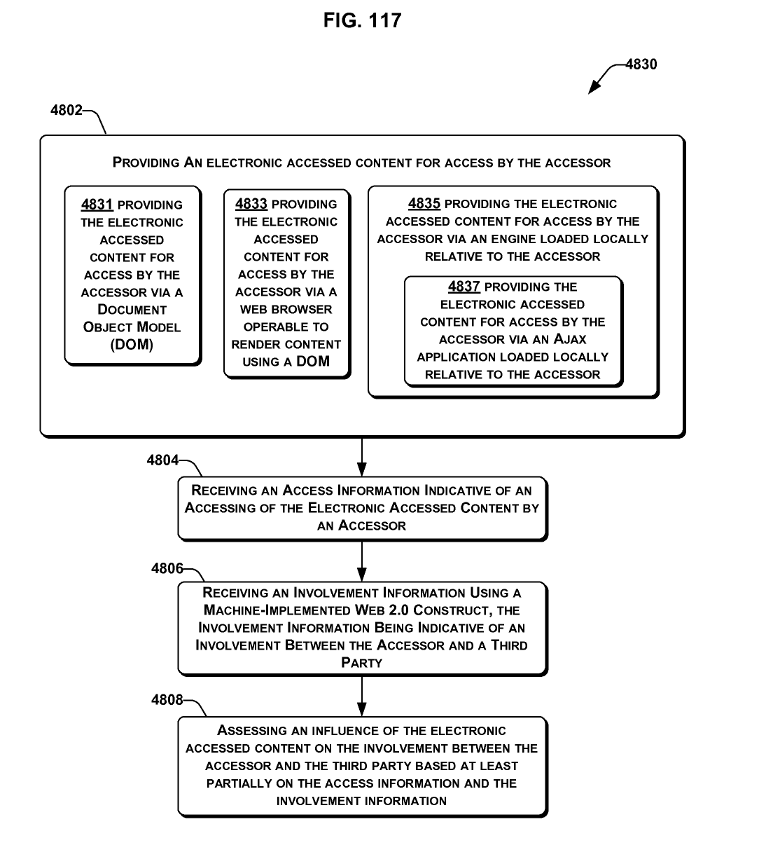

As shown in FIG. 117, in further implementations (e.g. process 4830), electronic accessed content for access by the accessor (at 4802) may include may include electronic accessed content for access by the accessor via a Document Object Model (DOM) at 4831 (e.g. providing an audio packet using a DOM-based Ajax application). In other implementations, electronic accessed content for access by the accessor (at 4802) may include electronic accessed content for access by the accessor via a web browser operable to render content using a DOM at 4833 (e.g. providing a video stream using a DOM-renderable version of Google's Chrome® browser).

Similarly, in some implementations, electronic accessed content for access by the accessor (at 4802) may include electronic accessed content for access by an accessor via an engine loaded locally relative to the accessor at 4835 (e.g. providing an mpeg file using an asynchronous engine loaded on a viewer's mobile device). More specifically, in particular implementations, electronic accessed content for access by an accessor via an engine loaded locally relative to the accessor (at 4835) may include via an Ajax application loaded locally relative to the accessor at 4837 (e.g. providing an mpeg file using an Ajax-based engine loaded on a viewer's mobile device).

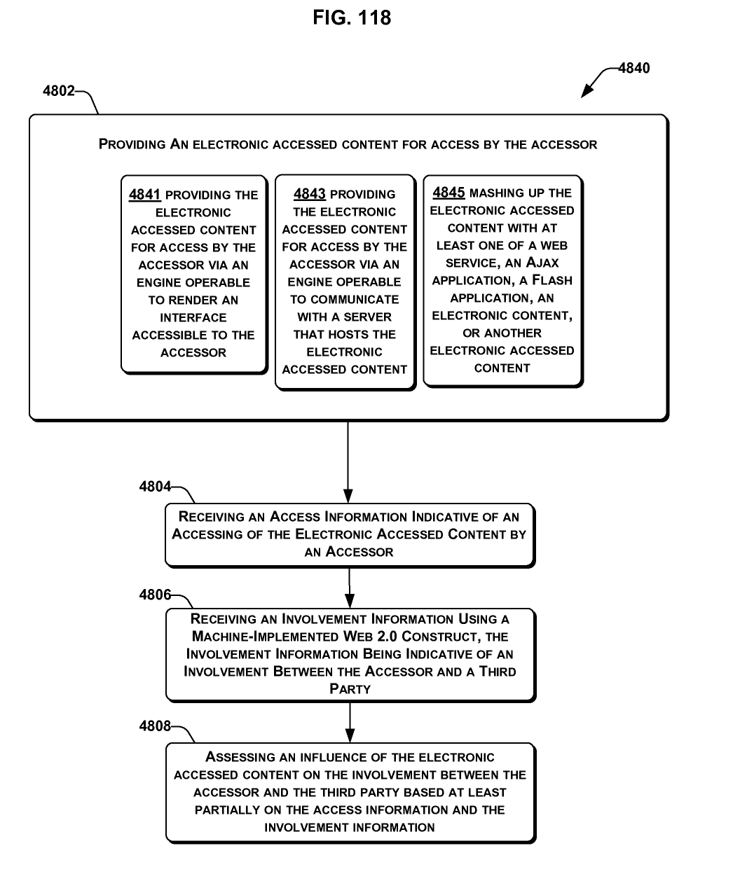

As shown in FIG. 118, in further implementations (e.g. a process 4840), electronic accessed content for access by the accessor (at 4802) may include via an engine operable to render an interface accessible to the accessor at 4841 (e.g. providing an electronic communication using an application that performs menu-related functions). Similarly, electronic accessed content for access by the accessor (at 4802) may include via an engine operable to communicate with a server that hosts the electronic accessed content at 4843 (e.g. providing an electronic communication using an application that performs content-fetching functions). In other implementations, electronic accessed content for access by the accessor (at 4802) may include up the electronic accessed content with at least one of a web service, an Ajax application, a Flash application, an electronic content, or another electronic accessed content at 4845 (e.g. mashing up an electronic communication with an advertising service).

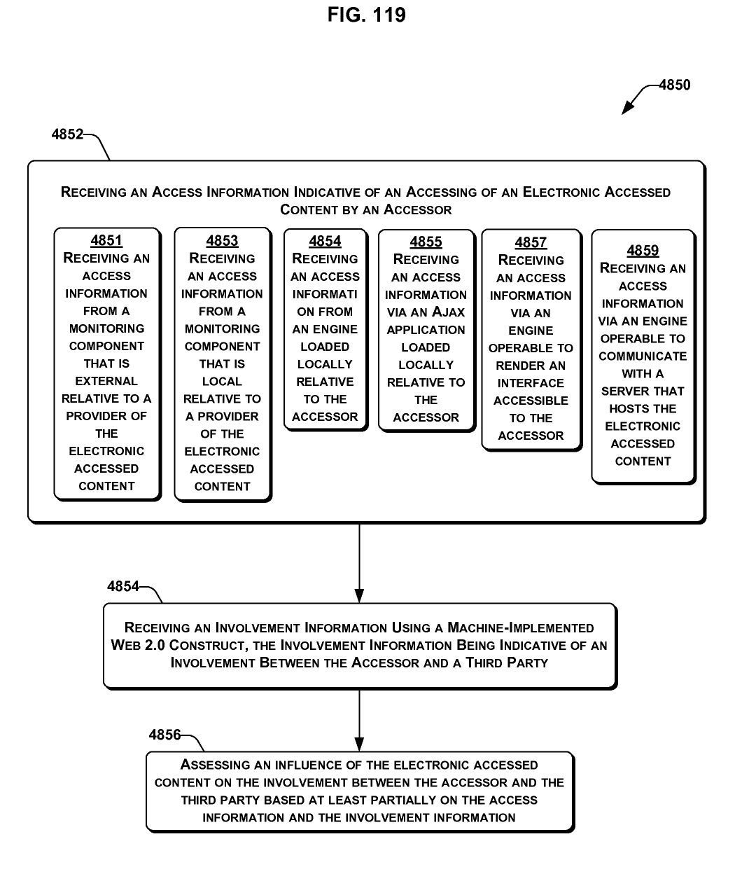

In still other implementations, such as process 4850 shown in FIG. 119, access information indicative of an accessing of an electronic accessed content by an accessor (at 4802) may include access information from a monitoring component that is external relative to a provider of the electronic accessed content at 4851 (e.g. receiving a signal from a tracking cookie installed on the accessor's device). Similarly, access information indicative of an accessing of an electronic accessed content by an accessor (at 4802) access information from a monitoring component that is local relative to a provider of the electronic accessed content at 4853 (e.g. receiving a signal from an inwardly-looking application installed on a server that hosts the electronic accessed content).

In further implementations, electronic accessed content for access by the accessor (at 4802) may include access information from an engine loaded locally relative to the accessor at 4854 (e.g. receiving data from an Applet installed on a laptop of the accessor). In addition, electronic accessed content for access by the accessor (at 4802) may include access information via an Ajax application loaded locally relative to the accessor at 4855 (e.g. receiving data from an Ajax application installed on a computing device of the accessor). Similarly, electronic accessed content for access by the accessor (at 4802) may include access information via an engine operable to render an interface accessible to the accessor at 4857 (e.g. receiving information from an interface-rendering Ajax application installed on a computing device of the accessor). In still other implementations, electronic accessed content for access by the accessor (at 4802) may include access information via an engine operable to communicate with a server that hosts the electronic accessed content at 4859 (e.g. receiving information from a content-rendering Applet installed on a computing device of the accessor).

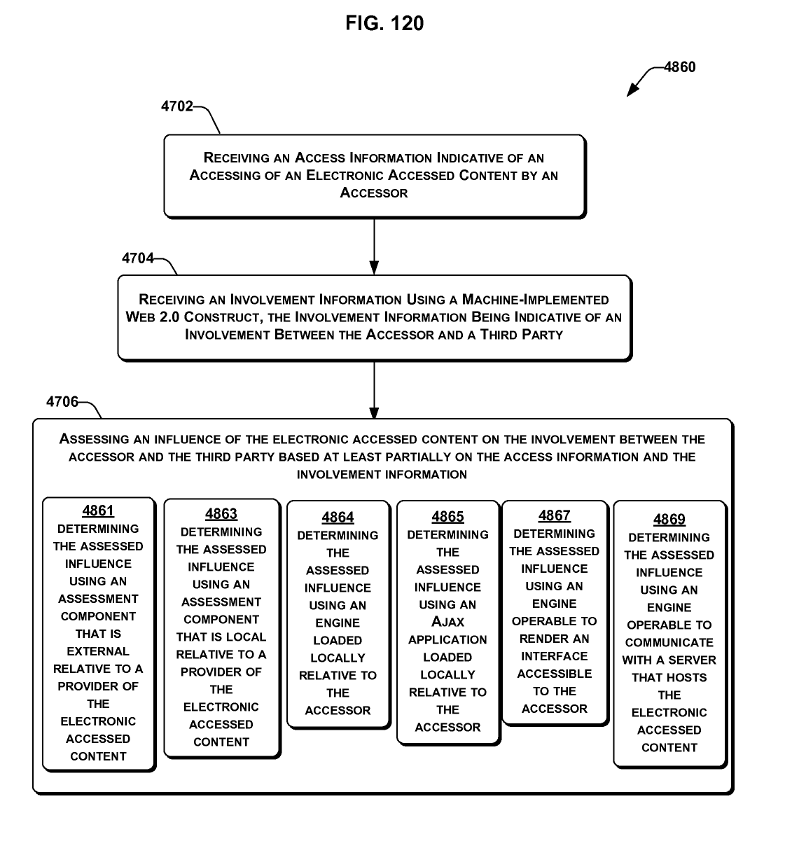

Referring now to FIG. 120, it may be noted that assess an influence of the electronic accessed content on the involvement between the accessor and the third party based at least partially on the access information and the involvement information (at 4706) may be performed in a variety of suitable ways. For example, in some implementation, such as a process 4860, assess an influence of the electronic accessed content on the involvement between the accessor and the third party based at least partially on the access information and the involvement information (at 4706) may include determine the assessed influence using an assessment component that is external relative to a provider of the electronic accessed content at 4861 (e.g. determining the assessed influence using software operated by a third party on a third party computing device). Similarly, in some implementations, assess an influence of the electronic accessed content on the involvement between the accessor and the third party based at least partially on the access information and the involvement information (at 4706) may include determine the assessed influence using an assessment component that is local relative to a provider of the electronic accessed content at 4863 (e.g. determining the assessed influence using software operating on the computing device of the accessor).

In still other implementations, assess an influence of the electronic accessed content on the involvement between the accessor and the third party based at least partially on the access information and the involvement information (at 4706) may include determine the assessed influence using an engine loaded locally relative to the accessor at 4864 (e.g. determining the assessed influence using an asynchronously-operating application operating on a mobile device of the accessor). Similarly, assess an influence of the electronic accessed content on the involvement between the accessor and the third party based at least partially on the access information and the involvement information (at 4706) may include determine the assessed influence using an Ajax application loaded locally relative to the accessor at 4865 (e.g. determining the assessed influence using an Ajax application operating on a mobile device of the accessor). In further implementations, assess an influence of the electronic accessed content on the involvement between the accessor and the third party based at least partially on the access information and the involvement information (at 4706) may include determine the assessed influence using an engine operable to render an interface accessible to the accessor at 4867 (e.g. determining the assessed influence using an interface-rendering Applet). And in still other implementations, assess an influence of the electronic accessed content on the involvement between the accessor and the third party based at least partially on the access information and the involvement information (at 4706) may include determine the assessed influence using an engine operable to communicate with a server that hosts the electronic accessed content at 4869 (e.g. determining the assessed influence using a content-fetching Applet).

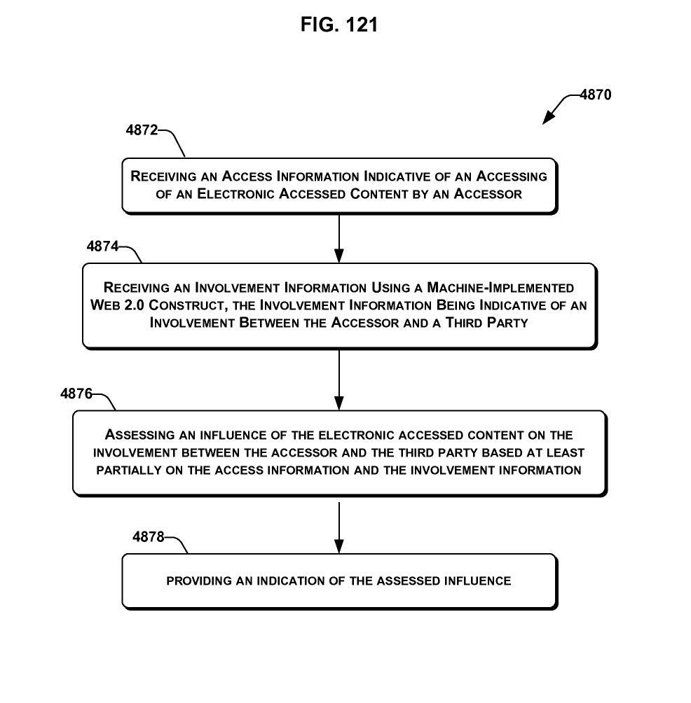

FIG. 121 is a flowchart of method 4870 in accordance with another implementation of the present disclosure. In this implementation, the method 4870 includes access information indicative of an accessing of an electronic accessed content by an accessor at 4872 (e.g. receiving data indicating a period of access of a movie-review article by a potential movie-goer), involvement information using a machine-implemented Web 2.0 construct, the involvement information being indicative of an involvement between the accessor and a third party at 4874 (e.g. receiving ticket-purchase information via a web service regarding the movie-goer's purchase of a ticket from a theater), assess an influence of the electronic accessed content on the involvement between the accessor and the third party based at least partially on the access information and the involvement information at 4876 (e.g. assigning an influence level of the movie-review article to the movie-goer's ticket purchase), and provide an indication of the assessed influence at 4878 (e.g. notifying the theater of the influence level of the movie-review article).

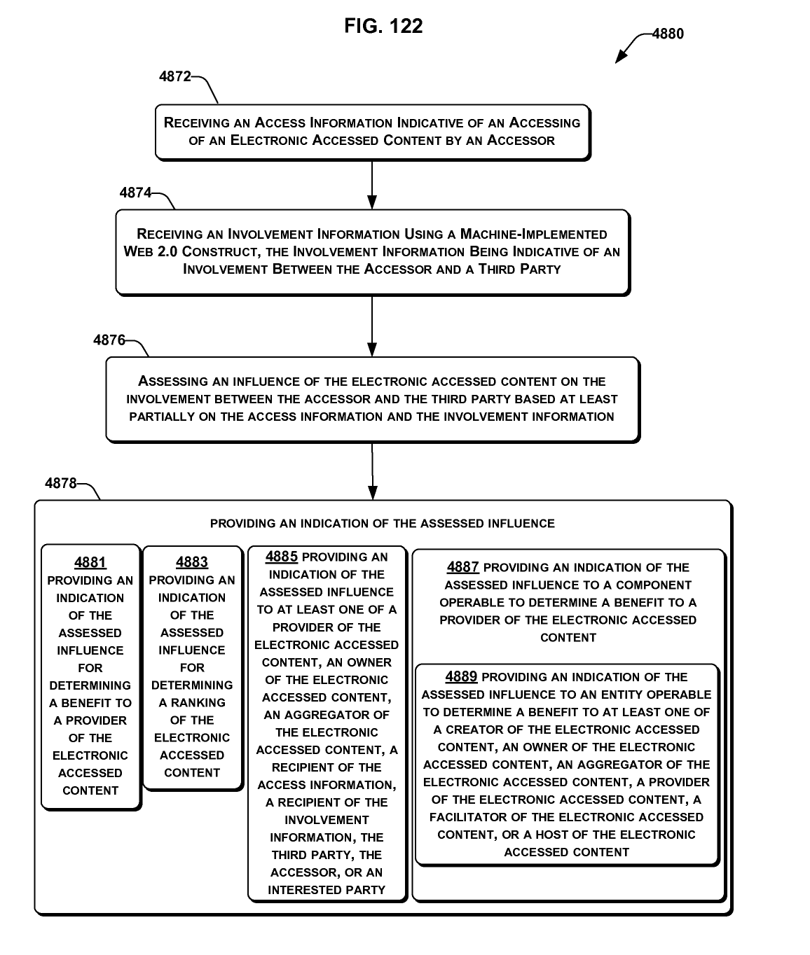

It will be appreciated that provide an indication of the assessed influence at 4878 may be accomplished in a variety of ways. For example, in a process 4880 shown in FIG. 122, provide an indication of the assessed influence (at 4878) may include influence assessment component configured to provide an indication of the assessed influence for determining a benefit to a provider of the electronic accessed content at 4881 (e.g. notifying the theater of the influence level from which the theater may decide to provide free passes to an author of the movie-review article). In some implementations, provide an indication of the assessed influence (at 4878) may include for determining a ranking of the electronic accessed content at 4883 (e.g. notifying the theater of the influence level from which the theater may decide whether to cite the movie-review article in a future press release). Similarly, provide an indication of the assessed influence (at 4878) may include to at least one of a provider of the electronic accessed content, an owner of the electronic accessed content, an aggregator of the electronic accessed content, a recipient of the access information, a recipient of the involvement information, the third party, the accessor, or an interested party at 4885 (e.g. notifying an electronic news-provider of the influence level of the movie-review article).

As further shown in FIG. 122, in some implementations, provide an indication of the assessed influence (at 4878) includes to a component operable to determine a benefit to a provider of the electronic accessed content at 4887 (e.g. notifying a software application of the influence level from which the software application may decide to provide free passes to an author of the movie-review article). It will be appreciated that to a component operable to determine a benefit to a provider of the electronic accessed content at 4887 may be accomplished in a variety of suitable ways. For example, in some implementations, to a component operable to determine a benefit to a provider of the electronic accessed content (at 4887) may include to an entity operable to determine a benefit to at least one of a creator of the electronic accessed content, an owner of the electronic accessed content, an aggregator of the electronic accessed content, a provider of the electronic accessed content, a facilitator of the electronic accessed content, or a host of the electronic accessed content at 4889 (e.g. notifying a software application of the influence level from which the software application may decide to provide free passes to an electronic-news service that provided the movie-review article).

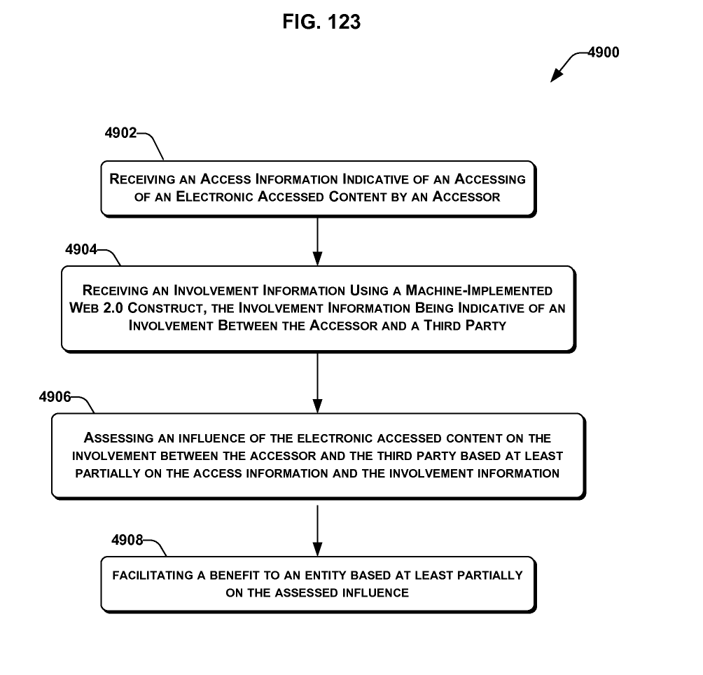

FIG. 123 is a flowchart of method 4900 in accordance with another implementation of the present disclosure. In this implementation, the method 4900 includes access information indicative of an accessing of an electronic accessed content by an accessor at 4902 (e.g. receiving information indicating that an electronic news article was scanned by a webcrawler program), involvement information using a machine-implemented Web 2.0 construct, the involvement information being indicative of an involvement between the accessor and a third party at 4904 (e.g. receiving involvement data indicative that the webcrawler program provided information regarding the news article, such as a copy of the news article, a ranking of the news article, etc., to an information broker), assess an influence of the electronic accessed content on the involvement between the accessor and the third party based at least partially on the access information and the involvement information at 4906 (e.g. assessing an influence of the news article on the involvement between the webcrawler and the information broker, based on, for example, the webcrawler's ranking of the news article, or the information broker's subsequent usage of the news article, etc.), and facilitate a benefit to an entity based at least partially on the assessed influence at 4908 (e.g. providing compensation to a provider of the news article based on the assessed influence).

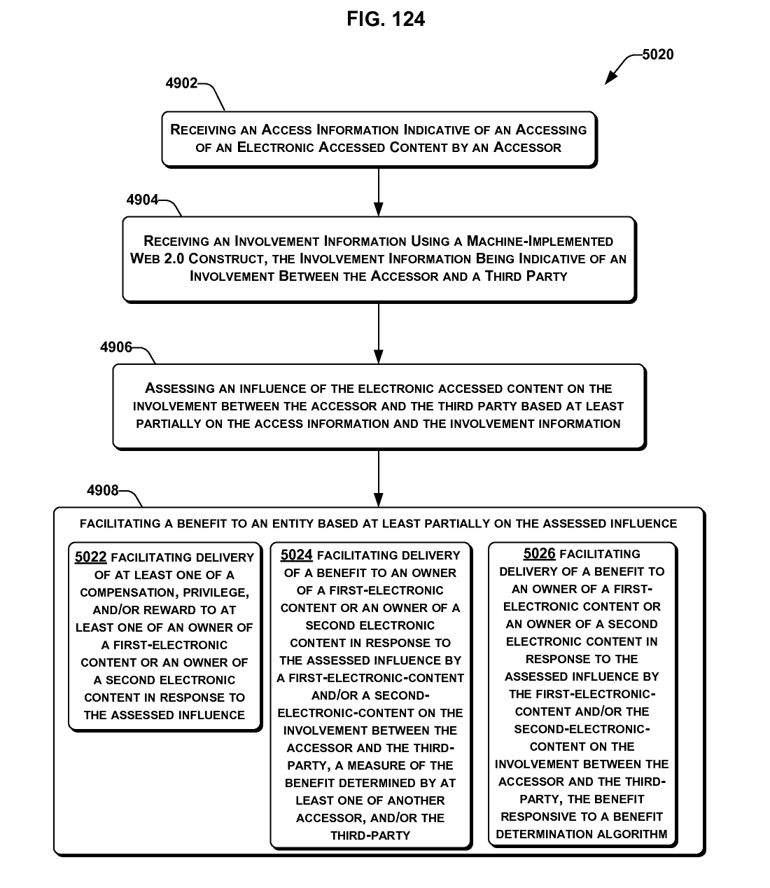

It will be appreciated that facilitate a benefit to an entity based at least partially on the assessed influence at 4908 may be accomplished in a variety of ways. For example, in a process 5020 shown in FIG. 124, facilitate a benefit to an entity based at least partially on the assessed influence (at 4908) may include delivery of at least one of a compensation, privilege, and/or reward to at least one of an owner of a first electronic content or an owner of a second electronic content in response to the assessed influence at 5022 (e.g. recommending a credit for future goods or services be provided to an owner of the first electronic content based on an assessed influence that exceeds a predetermined threshold). Similarly, facilitate a benefit to an entity based at least partially on the assessed influence (at 4908) may include delivery of a benefit to an owner of a first electronic content or an owner of a second electronic content in response to the assessed influence by a first electronic content and/or a second electronic content on the involvement between the accessor and the third party, a measure of the benefit determined by at least one of another accessor, and/or the third party at 5024 (e.g. offering a service provided by an information broker at a reduced rate to an owner of a news article based on an assessed influence of the news article, the information broker determining that the reduced rate is 75% of a normal rate for the service). In further implementations, facilitate a benefit to an entity based at least partially on the assessed influence (at 4908) may include delivery of a benefit to an owner of a first electronic content or an owner of a second electronic content in response to the assessed influence by the first electronic content and/or the second electronic content on the involvement between the accessor and the third party, the benefit responsive to a benefit determination algorithm at 5026 (e.g. providing a discount on flights of a particular airline to an owner of a travel agency based on a weighting formula that determines the amount of flights booked by the travel agency on the particular airline in comparison with the total amount of flights booked by all travel agencies).

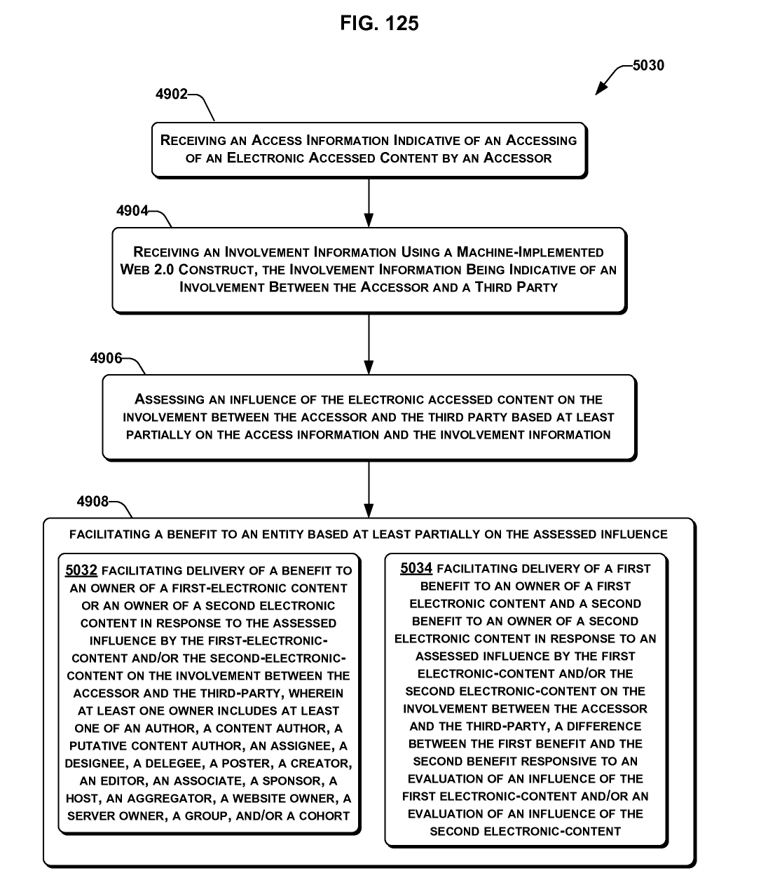

In addition, as depicted by a process 5030 shown in FIG. 125, facilitate a benefit to an entity based at least partially on the assessed influence (at 4908) may include delivery of a benefit to an owner of a first electronic content or an owner of a second electronic content in response to the assessed influence by the first electronic content and/or the second electronic content on the involvement between the accessor and the third party, wherein at least one owner includes at least one of an author, a content author, a putative content author, an assignee, a designee, a delegee, a poster, a creator, an editor, an associate, a sponsor, a host, an aggregator, a website owner, a server owner, a group, and/or a cohort at 5032 (e.g. transferring funds into a bank account of an organizer of a webcast event by an advertiser based on a determination that a viewer of a mashup of the webcast event and an advertisement influenced a purchase by the viewer of the advertiser's goods). In some implementations, facilitate a benefit to an entity based at least partially on the assessed influence (at 4908) may include delivery of a first benefit to an owner of a first electronic content and a second benefit to an owner of a second electronic content in response to an assessed influence by the first electronic content and/or the second electronic content on the involvement between the accessor and the third party, a difference between the first benefit and the second benefit responsive to an evaluation of an influence of the first electronic content and/or an evaluation of an influence of the second electronic content at 5034 (e.g. providing a relatively smaller rate reduction on goods to a first author of a consumer report providing a moderately-positive endorsement of a product, and a relatively larger rate reduction on goods to a second author of a consumer report providing a highly-positive endorsement of the product, the difference between the larger and smaller rate reductions being based on an evaluation of the relative influence of the consumer reports by the first and second authors).

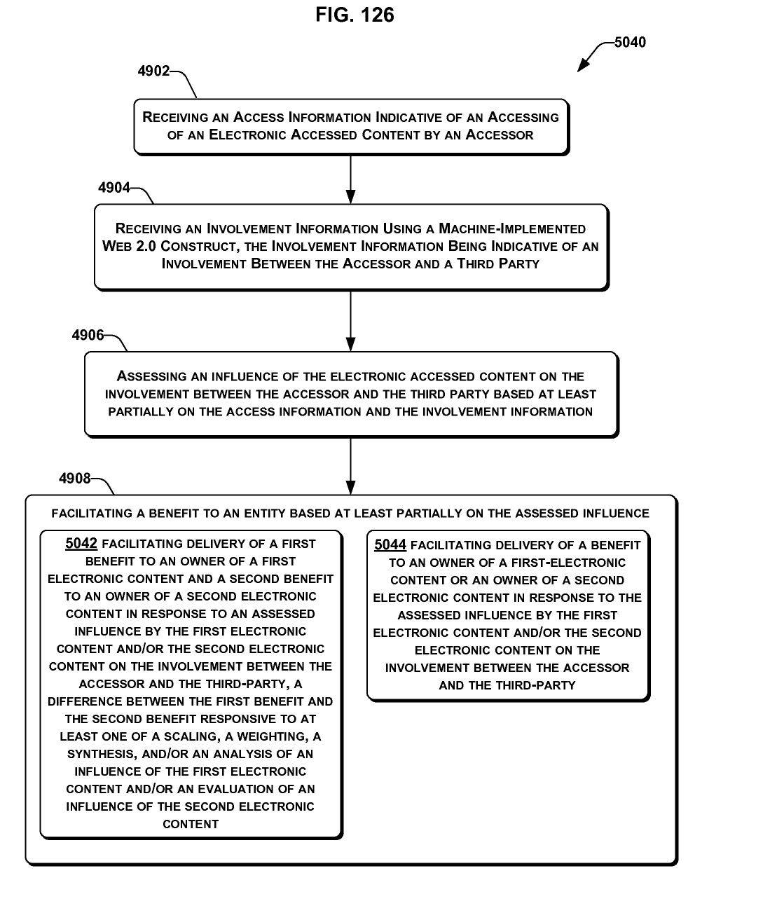

As shown in a process 5040 illustrated in FIG. 126, in some implementations, facilitate a benefit to an entity based at least partially on the assessed influence (at 4908) may include delivery of a first benefit to an owner of a first electronic content and a second benefit to an owner of a second electronic content in response to an assessed influence by the first electronic content and/or the second electronic content on the involvement between the accessor and the third party, a difference between the first benefit and the second benefit responsive to at least one of a scaling, a weighting, a synthesis, and/or an analysis of an influence of the first electronic content and/or an evaluation of an influence of the second electronic content at 5042 (e.g. sending first and second compensations to first and second content providers, respectively, a difference between the first and second compensations being based on relative percentages of gross sales attributable to influences by the first and second contents). Similarly, in some implementations, facilitate a benefit to an entity based at least partially on the assessed influence (at 4908) may include delivery of a benefit to an owner of a first electronic content or an owner of a second electronic content in response to the assessed influence by the first electronic content and/or the second electronic content on the involvement between the accessor and the third party at 5044 (e.g. sending a percentage of profit to a provider of a map-generating service by a real estate agency that provides a mashup of real estate listings combined with the map-generating service to potential buyers based on an assessed influence of the map-generating service on actual sales of real estate to actual buyers).

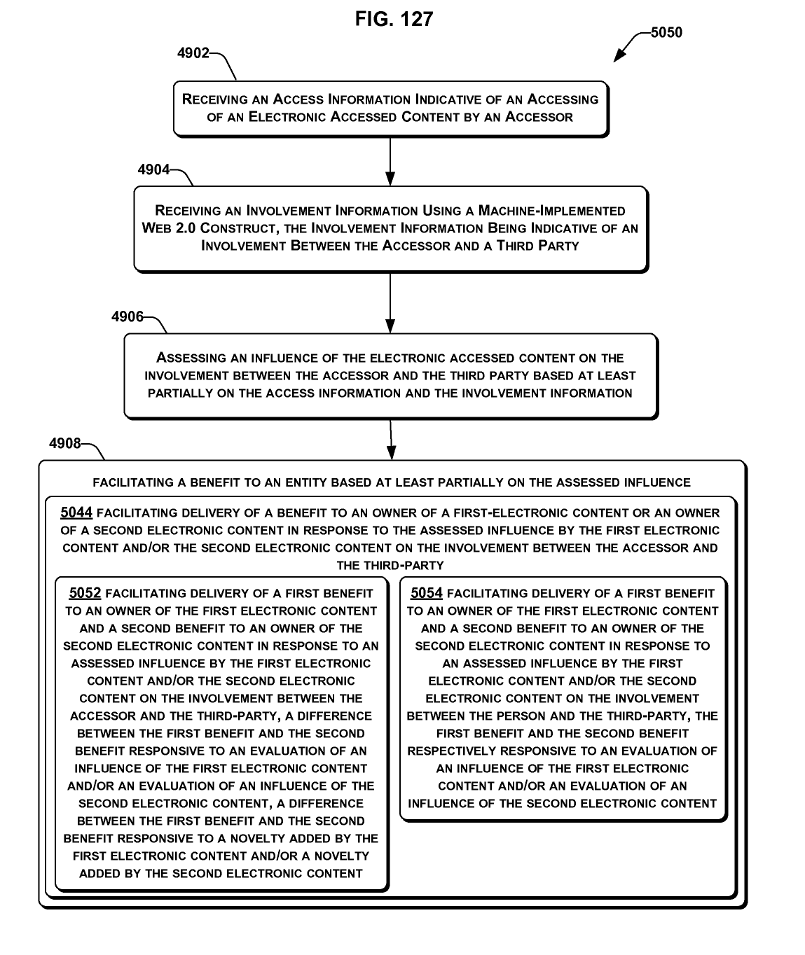

More specifically, as illustrated by a process 5050 shown in FIG. 127, in some implementations, delivery of a benefit to an owner of a first electronic content or an owner of a second electronic content in response to the assessed influence by the first electronic content and/or the second electronic content on the involvement between the accessor and the third party (at 5044) may include delivery of a first benefit to an owner of the first electronic content and a second benefit to an owner of the second electronic content in response to an assessed influence by the first electronic content and/or the second electronic content on the involvement between the accessor and the third party, a difference between the first benefit and the second benefit responsive to an evaluation of an influence of the first electronic content and/or an evaluation of an influence of the second electronic content, a difference between the first benefit and the second benefit responsive to a novelty added by the first electronic content and/or a novelty added by the second electronic content at 5052 (e.g. providing first and second compensations to first and second authors of scientific content based on evaluations of the respective influences of the scientific contents provided by the first and second authors on sales of scientific equipment, the influence evaluations being responsive to relative amounts of novel contributions to a particular scientific field provided by the first and second authors, respectively). Similarly, delivery of a benefit to an owner of a first electronic content or an owner of a second electronic content in response to the assessed influence by the first electronic content and/or the second electronic content on the involvement between the accessor and the third party (at 5044) may include delivery of a first benefit to an owner of the first electronic content and a second benefit to an owner of the second electronic content in response to an assessed influence by the first electronic content and/or the second electronic content on the involvement between the person and the third party, the first benefit and the second benefit respectively responsive to an evaluation of an influence of the first electronic content and/or an evaluation of an influence of the second electronic content at 5054 (e.g. providing first and second compensations to first and second authors of astronomy-related content based on first and second evaluations of the respective influences of the astronomy-related contents provided by the first and second authors on sales of astronomy-related literature).

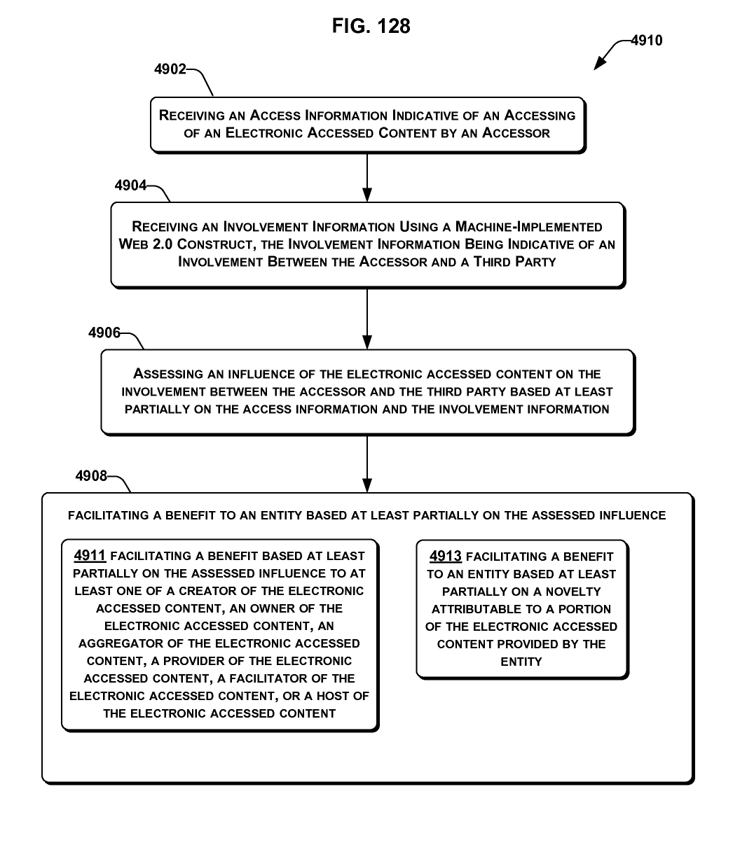

Similarly, in a process 4910 shown in FIG. 128, facilitate a benefit to an entity based at least partially on the assessed influence (at 4908) may include a benefit based at least partially on the assessed influence to at least one of a creator of the electronic accessed content, an owner of the electronic accessed content, an aggregator of the electronic accessed content, a provider of the electronic accessed content, a facilitator of the electronic accessed content, or a host of the electronic accessed content at 4911 (e.g. providing a quantity of free web services to an online search provider that facilitates access to electronic accessed content based on an assessment of the influence of the electronic accessed content on an accessor's useage of the web service). Similarly, in some implementations, facilitate a benefit to an entity based at least partially on the assessed influence (at 4908) may include a benefit to an entity based at least partially on a novelty attributable to a portion of the electronic accessed content provided by the entity at 4913 (e.g. facilitating a compensation to an aggregator of movie reviews based on a novelty of the content provided by the aggregator).

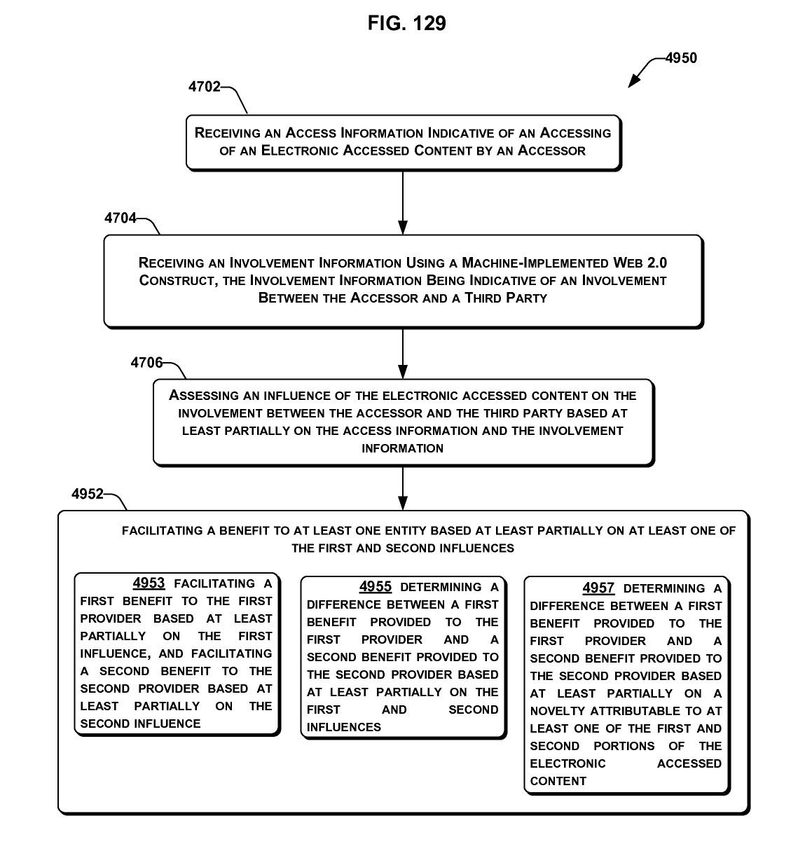

FIG. 129 is a flowchart of process 4950 in accordance with another implementation of the present disclosure. In this implementation, the process 4950 includes access information indicative of an accessing of an electronic accessed content by an accessor at 4702 (e.g. receiving a browsing history showing a “hit” on a home improvement website by a browser), involvement information using a machine-implemented Web 2.0 construct, the involvement information being indicative of an involvement between the accessor and a third party at 4704 (e.g. receiving order information indicative of an order of home improvement supplies by the browser from a supply seller), assess an influence of the electronic accessed content on the involvement between the accessor and the third party based at least partially on the access information and the involvement information at 4706 (e.g. assessing an influence of the website on the order of home improvement supplies based at least partially on the browsing history and the order information), and a benefit to at least one entity based at least partially on at least one of a first influence attributable to a first portion of the electronic accessed content and a second influence attributable to a second portion of the electronic accessed content at 4952 (e.g. calculating a quantum of compensation to an owner of the website based on a first influence attributable to an advertisement portion of the website and a second influence attributable to an instructional “how-to” portion of the website).

As shown in FIG. 129, in some implementations, a benefit to at least one entity based at least partially on at least one of a first influence attributable to a first portion of the electronic accessed content and a second influence attributable to a second portion of the electronic accessed content (at 4952) may include a first benefit to a first provider of a first portion of the electronic accessed content based at least partially on a first influence and a second benefit to a second provider of a second portion of the electronic accessed content based at least partially on a second influence at 4953 (e.g. calculating a first quantum of compensation to an advertiser based on a first influence attributable to an advertisement portion of a website and calculating a second quantum of compensation to an author based on a second influence attributable to an instructional “how-to” portion of the website). In further implementations, a benefit to at least one entity based at least partially on at least one of a first influence attributable to a first portion of the electronic accessed content and a second influence attributable to a second portion of the electronic accessed content (at 4952) may include a difference between a first benefit provided to a first provider of a first portion of the electronic accessed content and a second benefit provided to a second provider of a second portion of the electronic accessed content based at least partially on the first and second influences at 4955 (e.g. calculating a difference between a first quantum of compensation provided to an advertiser and a second quantum of compensation to an author of an instructional “how-to” portion of the website based at least partially on the first and second influences). In still other implementations, a benefit to at least one entity based at least partially on at least one of a first influence attributable to a first portion of the electronic accessed content and a second influence attributable to a second portion of the electronic accessed content (at 4952) may include a difference between a first benefit provided to a first provider of a first portion of the electronic accessed content and a second benefit provided to a second provider of a second portion of the electronic accessed content based at least partially on a novelty attributable to at least one of the first and second portions of the electronic accessed content at 4957 (e.g. calculating a difference between a first quantum of compensation provided to an advertiser and a second quantum of compensation to an author of an instructional “how-to” portion of the website based at least partially on a novelty attributable to the advertisement portion and the “how-to” portion of the website).

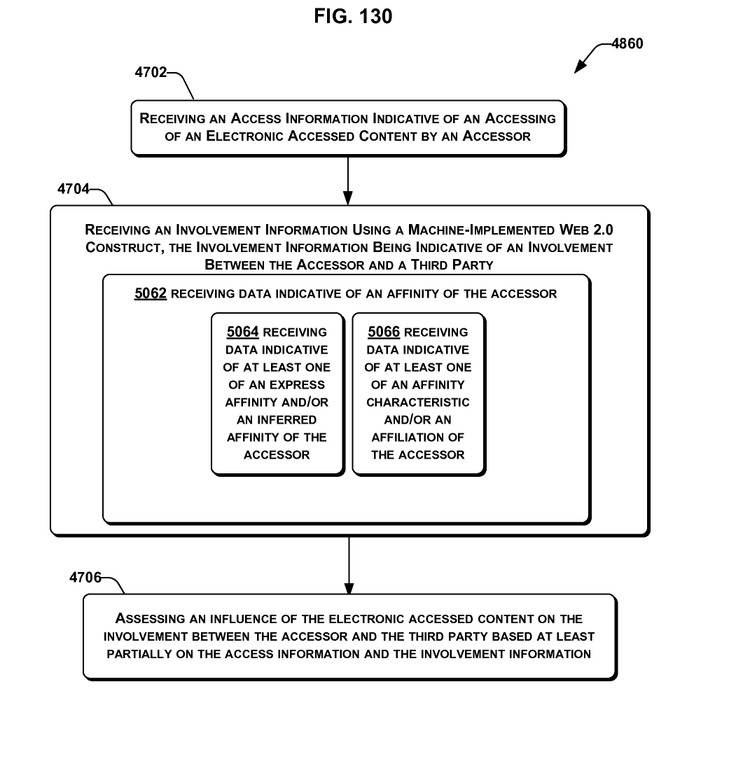

With reference to FIG. 130, in some implementations, such as a process 5060, involvement information using a machine-implemented Web 2.0 construct, the involvement information being indicative of an involvement between the accessor and a third party (at 4704) may include data indicative of an affinity of the accessor at 5062 (e.g. receiving data indicating that the accessor prefers to purchase products manufactured in the United States). More specifically, data indicative of an affinity of the accessor (at 5062) may include data indicative of at least one of an express affinity and/or an inferred affinity of the accessor at 5064 (e.g. receiving data indicative of a consumer's track record of purchasing products promoted by females over competing products promoted by males). In further implementations, data indicative of an affinity of the accessor (at 5062) may include data indicative of at least one of an affinity characteristic and/or an affiliation of the accessor at 5066 (e.g. receiving data indicative of a listener's membership on an organizing committee of the Earshot Jazz Festival in Seattle).

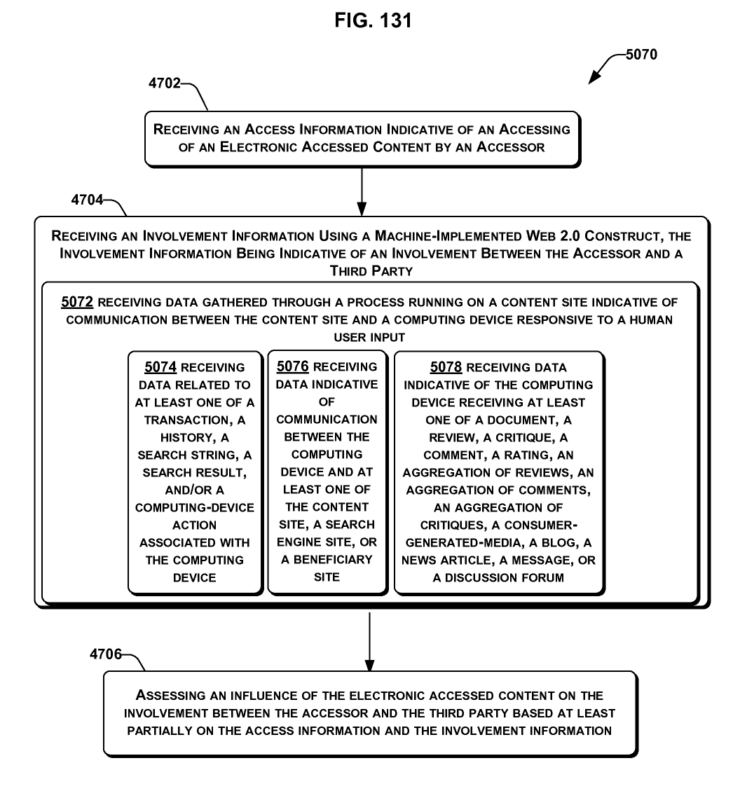

As illustrated by a process 5070 shown in FIG. 131, in some implementations, involvement information using a machine-implemented Web 2.0 construct, the involvement information being indicative of an involvement between the accessor and a third party (at 4704) may include data gathered through a process running on a content site indicative of communication between the content site and a computing device responsive to a human user input at 5072 (e.g. receiving download records from a monitoring component operating on a site that provides ringtones regarding ringtones downloaded from the site to a person's mobile communication device). More specifically, data gathered through a process running on a content site indicative of communication between the content site and a computing device responsive to a human user input (at 5072) may include data related to at least one of a transaction, a history, a search string, a search result, and/or a computing-device action associated with the computing device at 5074 (e.g. receiving records from a monitoring component operating on an online driving-directions site showing that directions were downloaded from the site to a person's mobile communication device). In some implementations, data gathered through a process running on a content site indicative of communication between the content site and a computing device responsive to a human user input (at 5072) may include data indicative of communication between the computing device and at least one of the content site, a search engine site, or a beneficiary site at 5076 (e.g. receiving records from a monitoring component operating on an online search engine site showing search strings entered on the search engine site by a person's computing device). Similarly, data gathered through a process running on a content site indicative of communication between the content site and a computing device responsive to a human user input (at 5072) may include data indicative of the computing device receiving at least one of a document, a review, a critique, a comment, a rating, an aggregation of reviews, an aggregation of comments, an aggregation of critiques, a consumer-generated-media, a blog, a news article, a message, or a discussion forum at 5078 (e.g. receiving records from a monitoring component operating on an online news site showing download histories of reviews and articles downloaded from the site to a person's personal data assistant).

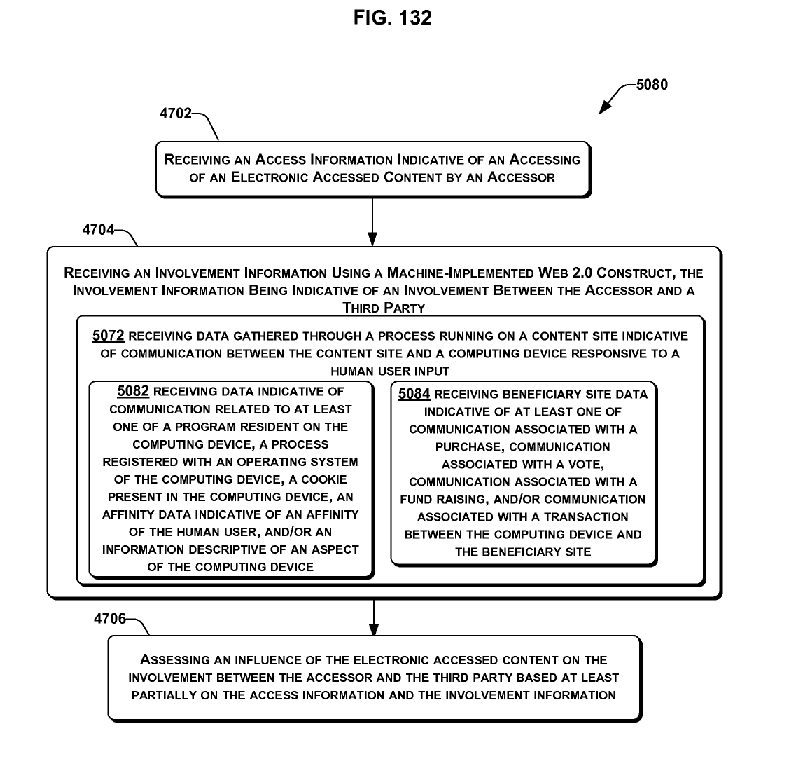

In further implementations, such as a process 5080 shown in FIG. 132, data gathered through a process running on a content site indicative of communication between the content site and a computing device responsive to a human user input (at 5072) may include data indicative of communication related to at least one of a program resident on the computing device, a process registered with an operating system of the computing device, a cookie present in the computing device, an affinity data indicative of an affinity of the human user, and/or an information descriptive of an aspect of the computing device at 5082 (e.g. receiving records from a monitoring component operating on an online driving-directions site showing that directions were downloaded from the site to a navigational program residing on a person's mobile communication device). In some implementations, data gathered through a process running on a content site indicative of communication between the content site and a computing device responsive to a human user input (at 5072) may include beneficiary site data indicative of at least one of communication associated with a purchase, communication associated with a vote, communication associated with a fund raising, and/or communication associated with a transaction between the computing device and the beneficiary site at 5084 (e.g. receiving contribution records from a radio station, such as a publicly-funded radio station, indicative of a donation associated provided from the computing device to the radio station).

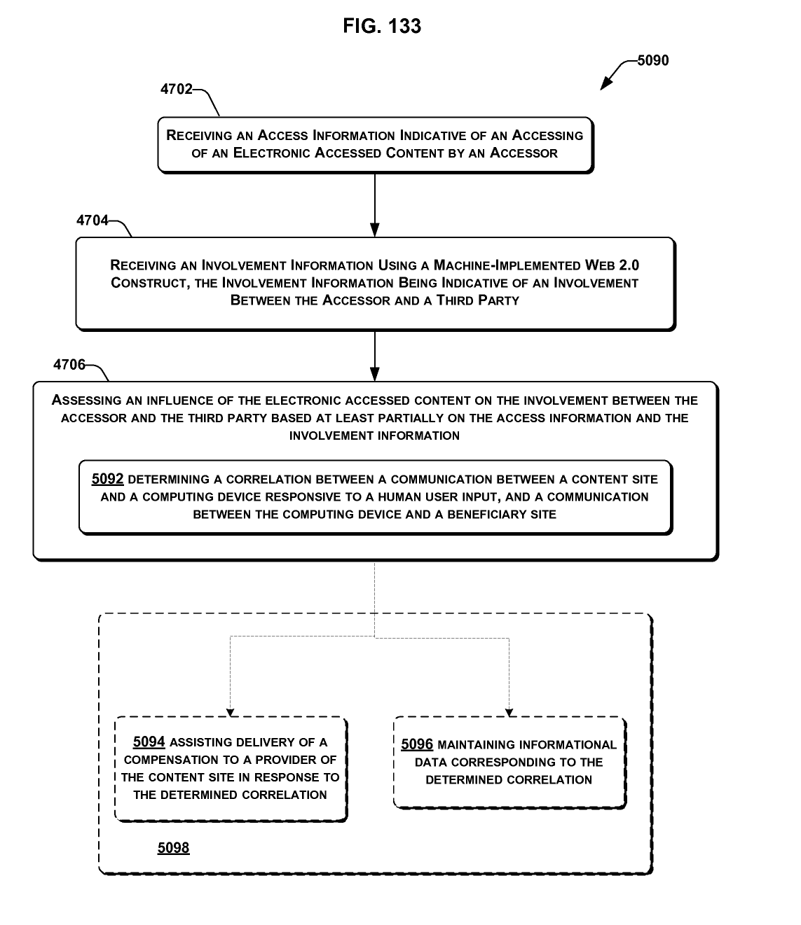

As shown in FIG. 133, in some implementations such as a process 5090, assess an influence of the electronic accessed content on the involvement between the accessor and the third party based at least partially on the access information and the involvement information (at 4706) may include a correlation between a communication between a content site and a computing device responsive to a human user input, and a communication between the computing device and a beneficiary site at 5092 (e.g. determining a high-probability correlation between a consumer viewing a product review on a site of an information broker and the consumer's subsequent purchase of the product and an on-line retail site). In some implementations, the process 5090 may further include delivery of a compensation to a provider of the content site in response to the determined correlation at 5094 (e.g. performing an online deposit to a bank account of an owner of electronic assessed content based on a high-probability correlation), or informational data corresponding to the determined correlation at 5096 (e.g. storing data regarding purchase-and-sale transaction correlations in a memory), or both at 5098.

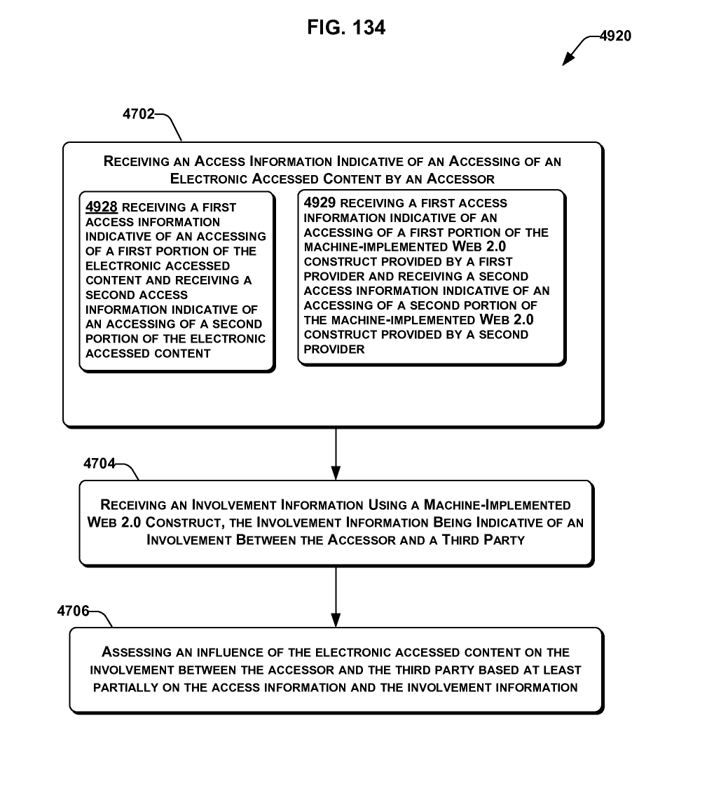

It may be noted that access information indicative of an accessing of an electronic accessed content by an accessor (at 4702 of FIG. 105) may occur in other ways. For example, in some implementations, such as a process 4920 shown in FIG. 134, access information indicative of an accessing of an electronic accessed content by an accessor (at 4702) may include a first access information indicative of an accessing of a first portion of the electronic accessed content and a second access information indicative of an accessing of a second portion of the electronic accessed content at 4928 (e.g. receiving first data indicative of an accessing of a first product review of an aggregation of product reviews and receiving a second data indicative of an accessing of a second product review of the aggregation of product reviews). Similarly, in some implementations, access information indicative of an accessing of an electronic accessed content by an accessor (at 4702) may include a first access information indicative of an accessing of a first portion of a machine-implemented Web 2.0 construct provided by a first provider and a second access information indicative of an accessing of a second portion of the machine-implemented Web 2.0 construct provided by a second provider at 4929 (e.g. receiving first data indicative of an accessing of a web service portion of a mashup of content, and receiving second data indicative of an accessing of a Flash application portion of the mashup of content).

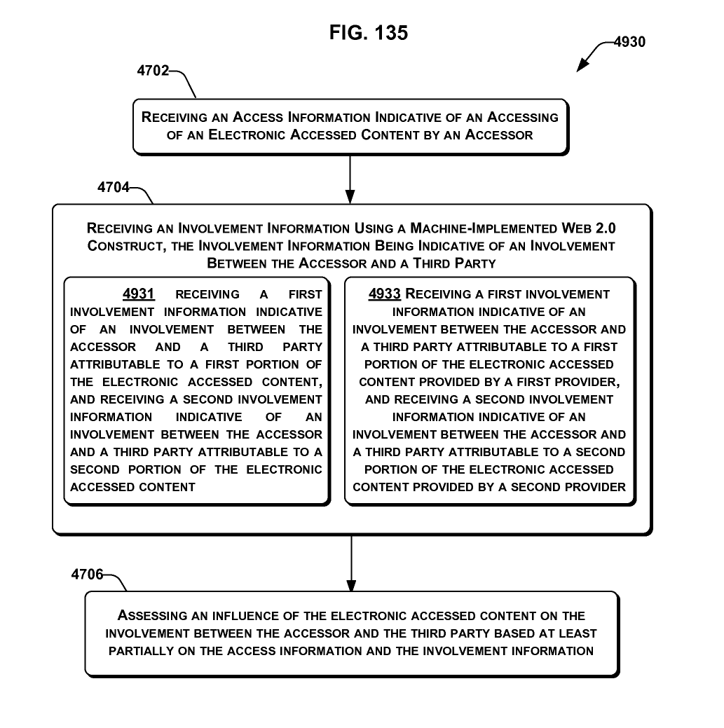

Similarly, involvement information using a machine-implemented Web 2.0 construct, the involvement information being indicative of an involvement between the accessor and a third party (at 4704 of FIG. 105) may be accomplished in a variety of additional ways. For example, in some implementations, such as a process 4930 shown in FIG. 135, involvement information using a machine-implemented Web 2.0 construct, the involvement information being indicative of an involvement between the accessor and a third party (at 4704) may include a first involvement information indicative of an involvement between the accessor and a third party attributable to a first portion of the electronic accessed content and a second involvement information indicative of an involvement between the accessor and a third party attributable to a second portion of the electronic accessed content at 4931 (e.g. receiving first data indicative of a first period spent by a consumer shopping at an online retail facility attributable to a first article from an aggregation of product-related articles, and receiving second data indicative of a second period spent by the consumer shopping at the online retail facility attributable to a second article from the aggregation). Similarly, in further implementations involvement information using a machine-implemented Web 2.0 construct, the involvement information being indicative of an involvement between the accessor and a third party (at 4704) may include a first involvement information indicative of an involvement between the accessor and a third party attributable to a first portion of the electronic accessed content provided by a first provider and a second involvement information indicative of an involvement between the accessor and a third party attributable to a second portion of the electronic accessed content provided by a second provider at 4933 (e.g. receiving first data indicative of a first surfing period spent by a potential soldier surfing information on goarmy.com attributable to a first promotional piece of an aggregation of pieces provided by a former soldier, and receiving second data indicative indicative of a second surfing period spent by the potential soldier attributable to a second promotional piece of the aggregation provided by a current soldier).

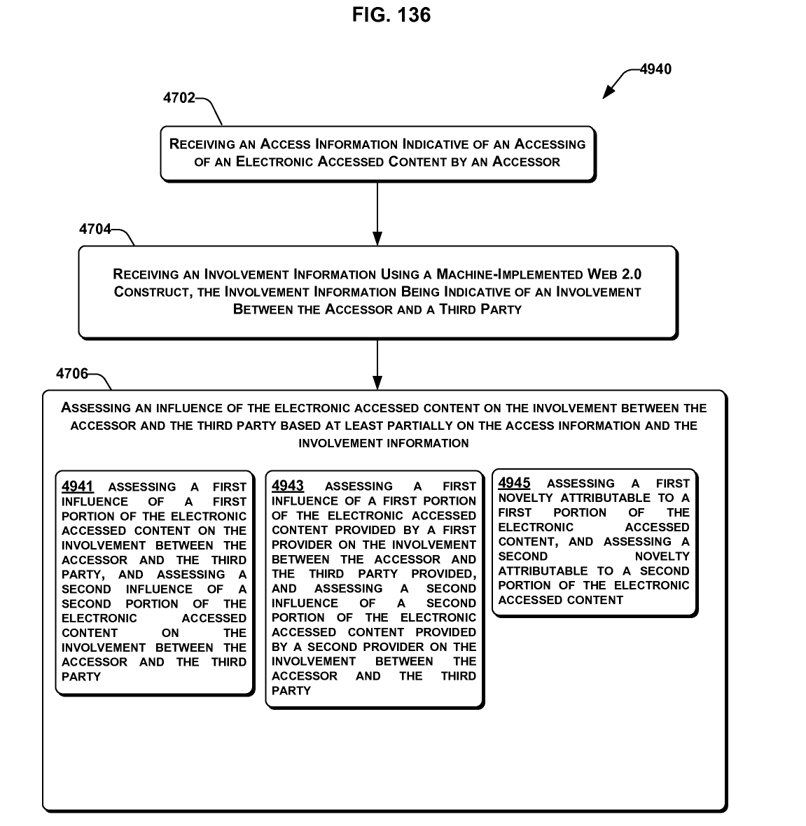

In still other implementations, assess an influence of the electronic accessed content on the involvement between the accessor and the third party based at least partially on the access information and the involvement information (e.g., at 4706) may be accomplished in a variety of ways. For example, in some implementations, such as a process 4940 shown in FIG. 136, assess an influence of the electronic accessed content on the involvement between the accessor and the third party based at least partially on the access information and the involvement information (at 4706) may include a first influence of a first portion of the electronic accessed content on the involvement between the accessor and the third party and a second influence of a second portion of the electronic accessed content on the involvement between the accessor and the third party at 4941 (e.g. assessing a first influence of a first product review from a consumer e-magazine on an automobile purchase between a buyer and a dealership and assessing a second influence of a second product review from the consumer e-magazine on the automobile purchase). In further implementations, assess an influence of the electronic accessed content on the involvement between the accessor and the third party based at least partially on the access information and the involvement information (at 4706) may include a first influence of a first portion of the electronic accessed content provided by a first provider on the involvement between the accessor and the third party provided and a second influence of a second portion of the electronic accessed content provided by a second provider on the involvement between the accessor and the third party at 4943 (e.g. assessing a first influence of a first product review from a consumer e-magazine provided by a consumer watchdog group on an automobile purchase between a buyer and a dealership and assessing a second influence of a second product review from the consumer e-magazine provided by an automotive test group on the automobile purchase). Similarly, assess an influence of the electronic accessed content on the involvement between the accessor and the third party based at least partially on the access information and the involvement information (at 4706) may include a first novelty attributable to a first portion of the electronic accessed content and a second novelty attributable to a second portion of the electronic accessed content at 4945 (e.g. assessing a first novelty attributable to a first product review from a consumer e-magazine and assessing a second novelty attributable to a second product review from the consumer e-magazine).

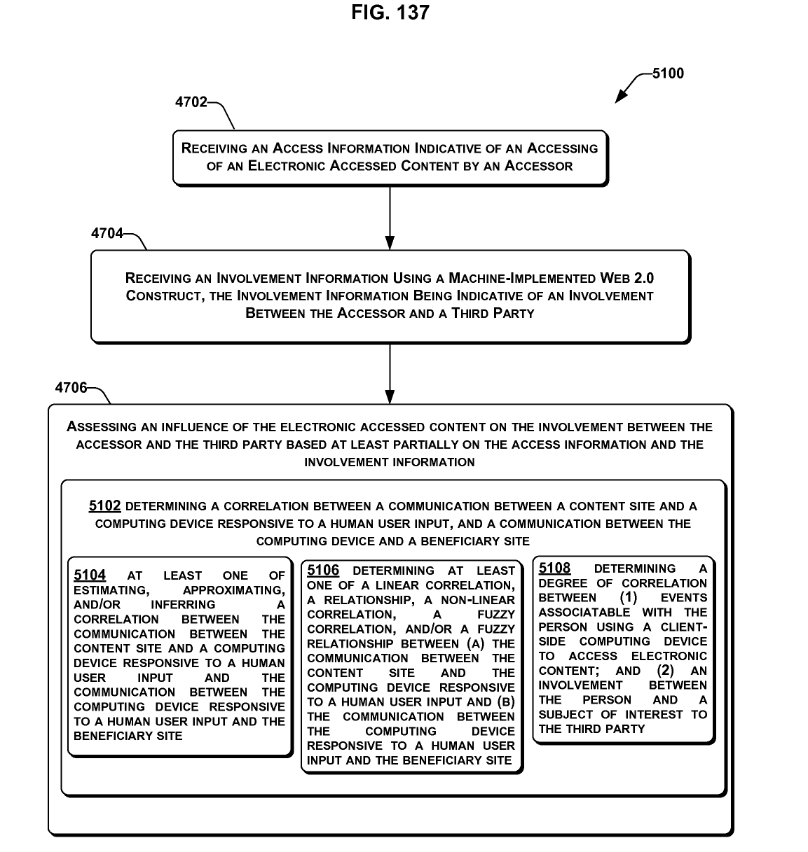

As illustrated in FIG. 137, in some implementations (e.g. process 5100), assess an influence of the electronic accessed content on the involvement between the accessor and the third party based at least partially on the access information and the involvement information (at 4706) may include determine a correlation between a communication between a content site and a computing device responsive to a human user input, and a communication between the computing device and a beneficiary site at 5102 (e.g. determining that a download regarding rental products from a server to a handheld device is correlated to a rental of the rental product from a rental provider). More specifically, in some implementations, determine a correlation between a communication between a content site and a computing device responsive to a human user input, and a communication between the computing device and a beneficiary site (at 5102) may include at least one of estimate, approximate, and/or infer a correlation between the communication between the content site and a computing device responsive to a human user input and the communication between the computing device responsive to a human user input and the beneficiary site at 5104 (e.g. inferring that an upload regarding the attributes of product A from a server to a handheld device is correlated to a purchase of product A from a retailer).

Similarly, determine a correlation between a communication between a content site and a computing device responsive to a human user input, and a communication between the computing device and a beneficiary site (at 5102) may include determine at least one of a linear correlation, a relationship, a non-linear correlation, a fuzzy correlation, and/or a fuzzy relationship between (a) the communication between the content site and the computing device responsive to a human user input and (b) the communication between the computing device responsive to a human user input and the beneficiary site at 5106 (e.g. determining that a length of time spent by the accessor browsing a content regarding the attributes of product A is linearly related to a purchase of product A by the accessor from a retailer). In further implementations, determine a correlation between a communication between a content site and a computing device responsive to a human user input, and a communication between the computing device and a beneficiary site (at 5102) may include determine a degree of correlation between (1) events associatable with the person using a client-side computing device to access electronic content; and (2) an involvement between the person and a subject of interest to the third party at 5108 (e.g. determining a strong correlation between an accessor's browsing of content regarding the attributes of service X and the accessor's subsequent purchase of service Y from a service retailer).

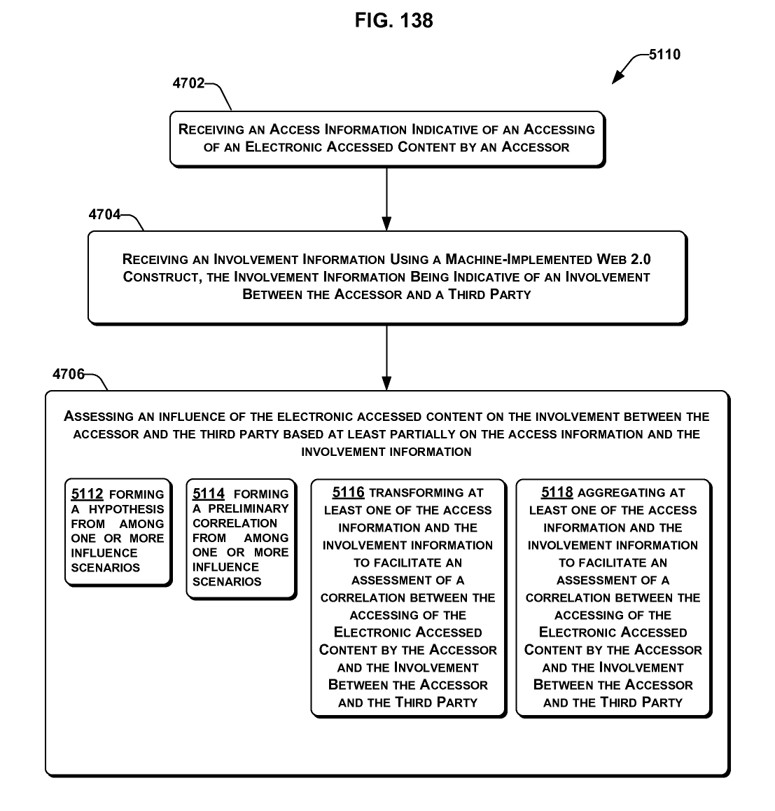

In still other implementations, such as a process 5110 shown in FIG. 138, assess an influence of the electronic accessed content on the involvement between the accessor and the third party based at least partially on the access information and the involvement information (at 4706) may include form a hypothesis from among one or more influence scenarios at 5112 (e.g. forming a hypothesis that the accessor was strongly influenced from among several possible influence levels). Similarly, assess an influence of the electronic accessed content on the involvement between the accessor and the third party based at least partially on the access information and the involvement information (at 4706) may include a first influence of a first electronic accessed content provided by a first provider based at least partially on the first access information at 5114 (e.g. deciding that the accessor's involvement is strongly correlated with the involvement from among several possible correlation levels).

In other implementations, assess an influence of the electronic accessed content on the involvement between the accessor and the third party based at least partially on the access information and the involvement information (at 4706) may include transform at least one of the access information and the involvement information to facilitate an assessment of a correlation between the accessing of the electronic accessed content by the accessor and the involvement between the accessor and the third party at 5116 (e.g. filtering outlying instances of the access information and the involvement information to improve the correlation assessment between the accessing and the involvement). Further, assess an influence of the electronic accessed content on the involvement between the accessor and the third party based at least partially on the access information and the involvement information (at 4706) may include aggregate at least one of the access information and the involvement information to facilitate an assessment of a correlation between the accessing of the electronic accessed content by the accessor and the involvement between the accessor and the third party at 5118 (e.g. compiling historical data regarding the access information and the involvement information to improve the correlation assessment between the accessing and the involvement).

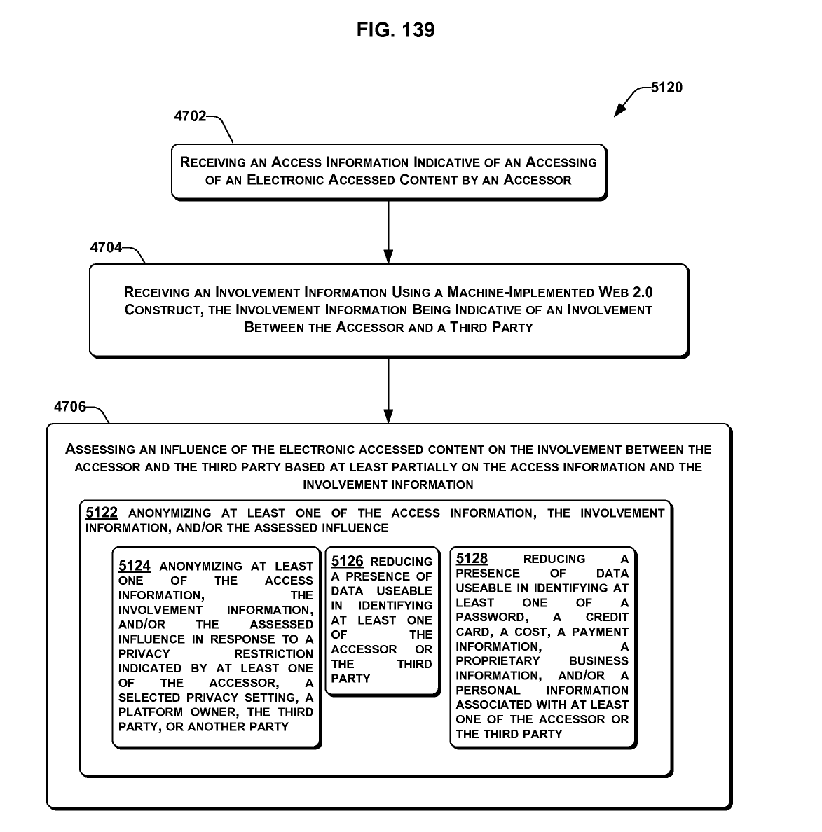

In some implementations, such as a process 5120 shown in FIG. 139, assess an influence of the electronic accessed content on the involvement between the accessor and the third party based at least partially on the access information and the involvement information (at 4706) may include anonymize at least one of the access information, the involvement information, and/or the assessed influence at 5122 (e.g. deleting identifying information regarding an identity of the accessor from the access information and the involvement information). More specifically, anonymize at least one of the access information, the involvement information, and/or the assessed influence (at 5122) may include anonymize at least one of the access information, the involvement information, and/or the assessed influence in response to a privacy restriction indicated by at least one of the accessor, a selected privacy setting, a platform owner, the third party, or another party at 5124 (e.g. deleting identifying information regarding an identity of the accessor from the access information and the involvement information in accordance with a privacy policy election by the accessor).

In other implementations, anonymize at least one of the access information, the involvement information, and/or the assessed influence (at 5122) may include reduce a presence of data useable in identifying at least one of the accessor or the third party at 5126 (e.g. generalizing identity information regarding the accessor to a general type of accessor, and generalizing identity information regarding the third party to a general type of third party, from the access information and the involvement information). In further implementations, anonymize at least one of the access information, the involvement information, and/or the assessed influence (at 5122) may include reduce a presence of data useable in identifying at least one of a password, a credit card, a cost, a payment information, a proprietary business information, and/or a personal information associated with at least one of the accessor or the third party at 5128 (e.g. redacting information regarding details of a consumer transaction between the accessor and the third party from the access information and the involvement information).

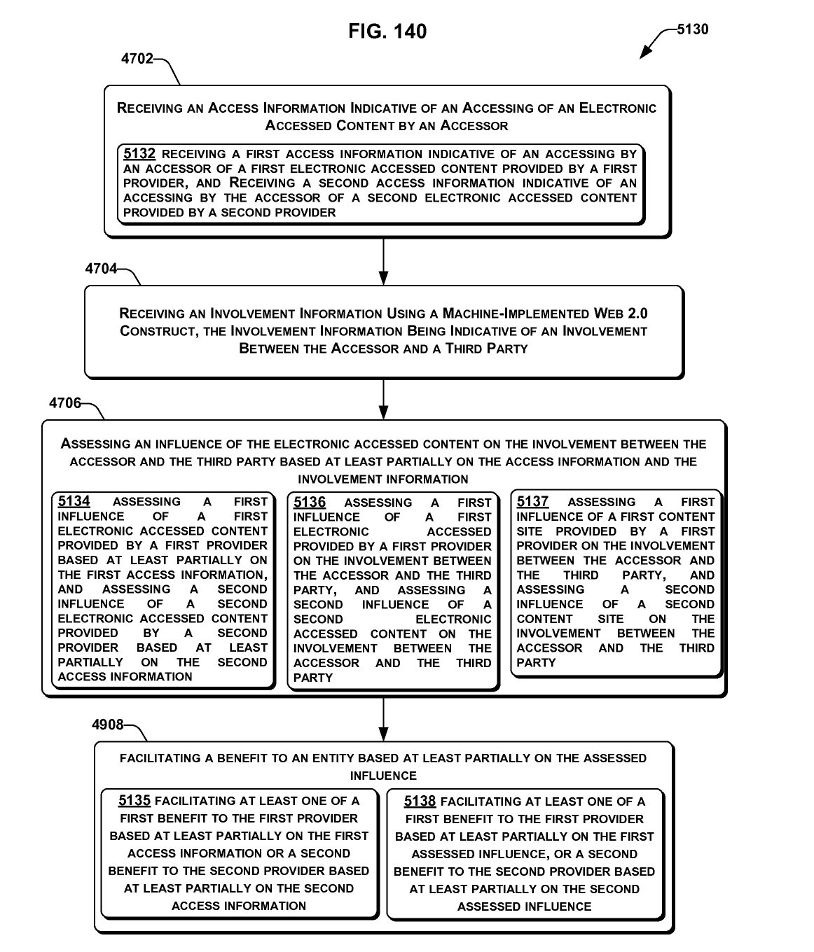

In yet another implementation, a process 5130 shown in FIG. 140 may include access information indicative of an accessing of an electronic accessed content by an accessor at 4702 (e.g. receiving “hit,” access time, or “cursor hovering” information associated with an accessor), involvement information using a machine-implemented Web 2.0 construct, the involvement information being indicative of an involvement between the accessor and a third party at 4704 (e.g. receiving information indicating a commercial transaction between a consumer and a provider), assess an influence of the electronic accessed content on the involvement between the accessor and the third party based at least partially on the access information and the involvement information at 4706 (e.g. assessing that the accessed content had a moderate influence on the commercial transaction between a consumer and a provider), and facilitate a benefit to an entity based at least partially on the assessed influence at 4908 (e.g. adding points to an account of a provider of the accessed content commensurate with the moderate influence).

More specifically, in some implementations, access information indicative of an accessing of an electronic accessed content by an accessor (at 4702) may include a first access information indicative of an accessing by an accessor of a first electronic accessed content provided by a first provider and a second access information indicative of an accessing by the accessor of a second electronic accessed content provided by a second provider at 5132. Similarly, assess an influence of the electronic accessed content on the involvement between the accessor and the third party based at least partially on the access information and the involvement information (at 4706) may include a first influence of a first electronic accessed content provided by a first provider based at least partially on the first access information and a second influence of a second electronic accessed content provided by a second provider based at least partially on the second access information at 5134. And in some implementations, facilitate a benefit to an entity based at least partially on the assessed influence (at 4908) may include at least one of a first benefit to the first provider based at least partially on the first access information, or a second benefit to the second provider based at least partially on the second access information at 5134.

As further shown in FIG. 140, in other implementations, assess an influence of the electronic accessed content on the involvement between the accessor and the third party based at least partially on the access information and the involvement information (at 4706) may include a first influence of a first electronic accessed content provided by a first provider on the involvement between the accessor and the third party and a second influence of a second electronic accessed content provided by a second provider on the involvement between the accessor and the third party at 5136. Similarly, in some implementations, assess an influence of the electronic accessed content on the involvement between the accessor and the third party based at least partially on the access information and the involvement information (at 4706) may include a first influence of a first content site provided by a first provider on the involvement between the accessor and the third party and a second influence of a second content site provided by a second provider on the involvement between the accessor and the third party at 5137. In addition, facilitate a benefit to an entity based at least partially on the assessed influence at 4908 may include delivery of at least one of a first benefit to the first provider based at least partially on the first assessed influence, or a second benefit to the second provider based at least partially on the second assessed influence at 5138.

Exemplary Processes for Determining Influencers

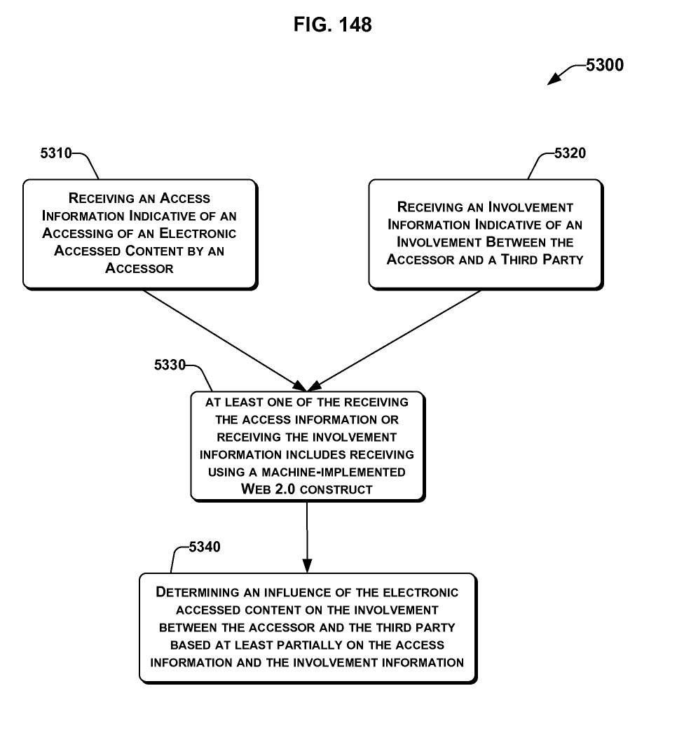

Exemplary processes for determining influencers in accordance with the teachings of the present disclosure are described below with reference to FIGS. 148 through 157. It will be appreciated, however, that the following description of exemplary processes is not exhaustive of all possible processes in accordance with the teachings of the present disclosure.

To provide an improved understanding of various aspects described below, a few representative embodiments of methods in accordance with the present disclosure will be described. For example, consider a simple scenario involving a consumer that is pondering whether to purchase a gadget. There are several different competing suppliers from which the consumer may purchase different models of the gadget. During a pre-purchase shopping period, the consumer visits several different websites, accessing electronic content on each website that discusses various aspects of the different models available from the different competing suppliers. Among the several factors involved in the consumer's decision (e.g. cost, performance, size, weight, appearance, reputation, etc.), there may be a particular factor that is of relatively-higher importance to this particular consumer. Assume for the purpose of this scenario that the particular factor that is most important to this consumer is the size of the gadget. During the consumer's shopping period, which may take place over an extended period of time (e.g. days, weeks, months, etc.), one particular site may provide electronic content that provides a useful comparison of the various sizes of the different models of the gadget that are available from the various different suppliers (e.g. sizeeasy.com), compelling or enabling the consumer to make a decision. The consumer may then purchase a particular model of the gadget from a particular supplier.

Embodiments of processes and systems in accordance with the teachings of the present disclosure may advantageously determine an influence of one or more of the various electronic contents accessed by the consumer on the consumer's ultimate decision to purchase a particular product from a particular supplier. In the representative scenario described above, the site that provided the comparison of the various sizes of the different models of the gadget was the most influential on this particular consumer's purchase decision. In at least some embodiments, a process in accordance with the present disclosure may provide a way to associate the consumer's accessing of the various electronic content during the shopping period with the consumer's ultimate purchase decision, including determining an influence of one or more of the various electronic contents on the consumer's purchase. In still other embodiments, the provider of the most influential electronic content may receive a benefit, such as from the supplier from whom the consumer purchased the gadget.

Various ways of associating the consumer's accessing of the various electronic content during the shopping period with the consumer's ultimate purchase decision have been conceived and are described more fully below. For example, in at least some embodiments, a process may analyze a consumer's behavior before and after accessing a site's electronic content, and make assumptions about relative influence of the electronic content based on the analysis. In a particular embodiment, for example, an analysis may determine that the consumer made a purchase immediately (e.g. within 48 hours) after accessing an electronic content that recommended a product. In other embodiments, an analysis may determine that the consumer terminated shopping activities after accessing an electronic content, followed by a registration of a new product following a period of time (e.g. days, weeks, months, etc.).

The analysis of the consumer's behavior before accessing a site's electronic content and after visiting the site's electronic content may be performed in a variety of ways. For example, in some embodiments, the analysis may be performed by an entity that analyzes the consumer's behavior. In other embodiments, a component (e.g. software, hardware, firmware, or combinations thereof) may be provided on an electronic device of the consumer that analyzes the consumer's behavior. The component and/or the entity may analyze publicly-available information or privately-available information (or both) to determine an influence of an electronic content on the consumer's purchase decision. For example, in some embodiments, analyzing the consumer's behavior may include an analysis of a consumer's internet browsing history, cache history, electronic mail history, credit card history, bank account history, electronic notes, and/or other suitable publicly or privately-available information. An analysis component may search through such information sources for strings, key words, phrases, data, or any other suitable indicia.

Although a process may analyze privately-available information, it will be appreciated that such privately-available information need not be publicly revealed as a result of such analyses. For example, in at least some embodiments, although a process analyzes a consumer's privately-available information the process need not record, transmit, or reveal such information to any other entities in order to determine an influence of one or more of the various electronic contents on the consumer's purchase. More specifically, in at least some embodiments, a process may reveal a final determination (e.g. conclusion, hypothesis, etc.) about an influence of an electronic content on the consumer's purchase without revealing any privately-available information used in formulating the determination (e.g. the accessed content from website x was the most influential in the consumer's decision to purchase the gadget from the supplier).

Of course, a variety of other ways of associating the consumer's accessing of electronic content with the consumer's ultimate purchase decision may be conceived in accordance with the teachings of the present disclosure. In some embodiments, the consumer may be queried as to the various websites visited and requested to provide direct input on the influence of such websites on the consumer's decision. For example, consider another simple scenario in which a consumer visits several websites during the course of shopping for a service or product (e.g. a camera). The consumer's browsing activity during a pre-purchase period may be tracked, and following a purchase, the consumer may be presented with a list of the sites visited by the consumer and queried about the relative influence of the sites. For example, the consumer may be presented with a list of thumbnails of sites visited during the pre-purchase period, and may be asked to rank them in order of influence (e.g. “here are the thumbnails of sites you visited, which was most helpful to you?”). In some embodiments, the consumer may be queried at the time of sale of a product or service via a supplier's (or a third party's) website. Alternately, the query for user input may occur in a non-online setting, such as at a brick-and-mortar retail outlet or point-of-sale, or other suitable non-online procedure (e.g. follow-up mailing, telephone poll, etc.). In some embodiments, the user may be presented with a multiple choice menu that enables the user to provide a ranking of the relative influence (e.g. most positive, positive, neutral, negative, most negative, etc.) of each site visited. It will be appreciated that information on negative results may be of interest to product suppliers in order to provide improvements to products or services offered.

In yet another representative scenario, a vendor or provider of a product or service may develop one or more various models for automated determination of an influence of an electronic content on a consumer's decision. In at least some implementations, an influence determination component may be located on an electronic platform (e.g. computer, cell phone, personal data assistant, etc.) that may perform the desired influence determinations.

For example, in some embodiments, a model for automated influence determination may include one or more classes of sites that contain electronic content that may be relevant to an accessor's decision to purchase (or not to purchase) a product or service. By analyzing an access history of the accessor, an automated model may determine that a particular site or a particular electronic content was accessed by the accessor prior to the purchase, and may assume a relative influence of the particular site or the particular electronic content based on a weighting formula or other suitable means. In some implementations, for example, it may be known (or assumed) that content from a first source (e.g. a technical column in the New York Times) is more influential (e.g. based on relative numbers of readers, polling data, statistics, etc.) than content from a second source (e.g. an advertisement on craigslist.com). It will be appreciated that in some implementations, the accessor's history of accessing information may be obtained from information contained on the accessor's electronic device (e.g. computer, cell phone, personal data assistant, etc.), or alternately, may be received from the various sites visited by the accessor (e.g. when visited by accessor, number of times visited by accessor, duration of visit(s), clicks made, contents accessed, etc.). An automated model may then apply logic to such information to determine the relative influence of the accessed content(s) on the accessor's decision.

In at least some implementations, a supplier of an electronic platform (e.g. computer, cell phone, personal data assistant, etc.) may include some type of logic or component into the electronic platform that is configured to perform the desired influence determinations. Alternately, such influence determinations may reside within a supplier's site or that of a third party.

In another aspect, the sites or electronic contents accessed by the accessor may leave data or information behind on the accessor's electronic device that is detectable by an analysis component to assist in the subsequent influence determination. For example, in some implementations, a packet of information (e.g. a cookie) may be stored on the accessor's electronic device that provides access information of interest in the influence determination (e.g. when visited by accessor, number of times visited by accessor, duration of visit(s), clicks made, contents accessed, etc.). Alternately, a signature of an accessed site may be left by an accessed site, such as by particular numerical values (e.g. unique size values, dimensional values, ratings, capabilities, etc.), terms, words, phrases or other indicia contained within the information accessed by the accessor which may remain on the accessor's electronic device.

In a particular implementation, an analysis component may determine an influence of a particular electronic content based on a discernable pattern over time. For example, in some implementations, an analysis component may assume that a most-recently-acquired electronic content was the most influential to a purchaser's decision. Alternately, an analysis component may analyze an electronic document that was developed during the purchaser's shopping period, and may search for patterns that indicate a relative influence of a particular electronic content or site (e.g. differences in a note-taking document before/after visiting a site, evolution of such a note-taking document to determine where each piece comes from to determine influence, determination of a first accessed site or content that caused the accessor to include the identity of the particular product purchased into the note-taking document as being the most influential, etc.).

Additional embodiments and aspects of processes and systems in accordance with the present disclosure will now be described with reference to the accompanying figures. For example, FIG. 148 is a flowchart of method 5300 of an influence determination method in accordance with at least some embodiments of the present disclosure. More specifically, in this implementation, the method 5300 includes receiving an access information indicative of an accessing of an electronic accessed content by an accessor at 5310, and receiving an involvement information indicative of an involvement between the accessor and a third party at 5320. In this implementation, at least one of receiving the access information or receiving the involvement information includes receiving using a machine-implemented Web 2.0 construct (at 5330). In addition, the method 5300 includes determining a determined influence of the electronic accessed content on the involvement between the accessor and the third party based at least partially on the access information and the involvement information at 5340.

For example, in some implementations, receiving an access information indicative of an accessing of an electronic accessed content by an accessor at 5310 may include receiving data indicating that a web browser associated with a particular consumer has accessed a particular website for a particular duration of time, or that a mobile device (e.g. cellular telephone) has requested a download of a particular podcast of information. In another representative example, data may be received indicative of a consumer accessing a first product-related content comparing a first brand of cameras (Brand A) to a second brand of cameras (Brand B), and also indicative of the consumer assessing a second product-related content comparing the first and second brands of cameras (Brand A and B), the third party being a provider (e.g. manufacturer, wholesaler, retailer, advertiser, etc.) of either the Brand A camera or the Brand B camera.

Similarly, in at least some implementations, the receiving an involvement information indicative of an involvement between the accessor and a third party at 5320 may include, for example, receiving data indicating that the above-mentioned consumer conducted a transaction with a particular vendor of goods or services, or that a user of the aforesaid cellular telephone conducted business with a broker. For example, in some implementations, receiving an involvement information indicative of an involvement between the accessor and a third party at 5320 may include receiving data indicating that a web browser associated with a particular consumer has transacted a purchase from a product provider, or that a mobile device (e.g. cellular telephone) has transacted a purchase from a service provider. In another representative example, data may be received indicative of a consumer ordering a first product from a retailer (e.g. Brand A cameras), or receiving a purchase confirmation (e.g. via a text message on a cellular telephone).

It will be appreciated that a wide variety of machine-implemented Web 2.0 constructs may be used for at least one of receiving the access information or receiving the involvement information includes receiving using a machine-implemented Web 2.0 construct at 5330, including, for example, an Ajax (Asynchronous JavaScript and XML (Extensible Markup Language)) application, an asynchronous application, a Flash application, a web service, any other suitable Web 2.0 engine (or content or construct), or a mashup that includes one or more of the afore-mentioned constructs.

It will be appreciated that the access information or the involvement information may take many suitable forms. For example, such information may include at least one of a user input, a keystroke, a navigation command, a mouse movement, a caching information, a session information, and/or a visit information may include information associated with, incidental to, and/or responsive to one or more of user mouse movements, scrolling movements, purchases, operations, visited Websites, visited blogs, page views, page visits, viewing time, repeat visits, page tags, printing a content, click stream, search strings, local search strings, interactions, scrolling, menu activity, corresponding/related to browsing the Internet, cut and past, print history, browsing history, email, cookies, user keystrokes, logged keystrokes along with the window name they are typed, email sent, email received, logged events, logged timeline, Website activity, logged Websites visited, application usage; log of applications run, documents opened, saved documents, files opened, files viewed, cut, cut and paste, scrolling, navigating, and setting a bookmark. In further implementations, the access information may include data indicative of a computing system environment, a local computing system interaction associated with the client-side computing device, a network interaction including bulk content downloaded to form a page, a turning of visibility tags on and off, and/or an interactive environment.

As mentioned above, in some implementations, the determining a determined influence of the electronic accessed content on the involvement between the accessor and the third party based at least partially on the access information and the involvement information at 5340 may include determining whether the website accessed by the consumer using the browser was the primary reason the consumer purchased the good or service from the vendor, or determining whether the cell phone user's eventual purchase was attributable to a podcast that was downloaded by the user.

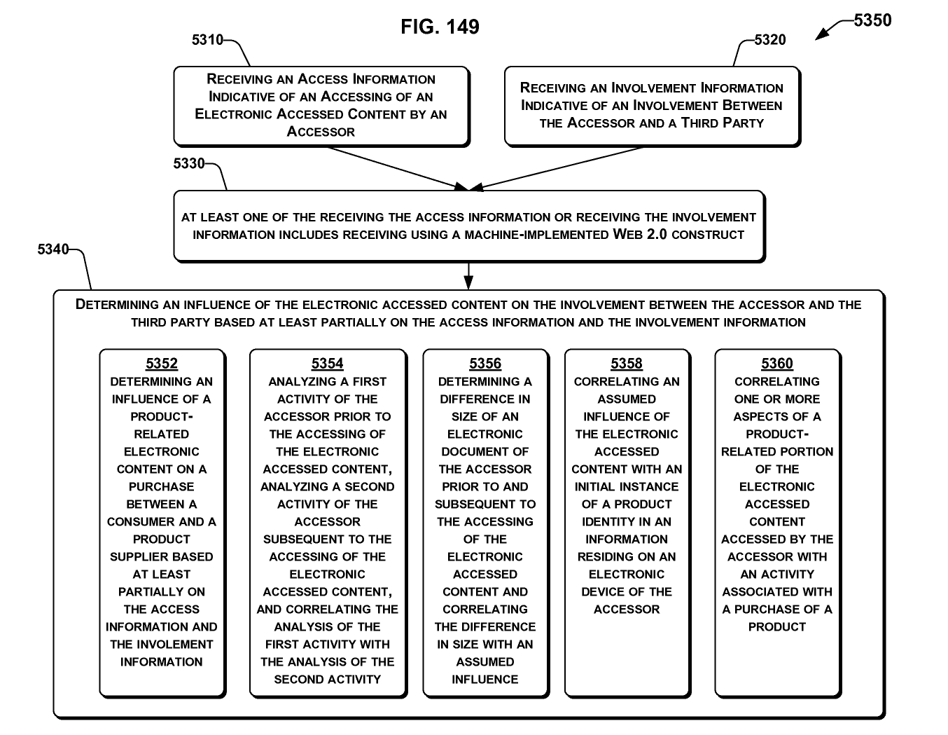

It will be appreciated that determining a determined influence of the electronic accessed content on the involvement between the accessor and the third party based at least partially on the access information and the involvement information at 5340 may occur in a variety of ways. For example, in a method 5350 as shown in FIG. 149, determining a determined influence of the electronic accessed content on the involvement between the accessor and the third party based at least partially on the access information and the involvement information at 5340 may include determining an influence of a product-related electronic content on a purchase between a consumer and a product supplier based at least partially on the access information and the involvement information at 5352 (e.g. determining that a last-accessed website that promoted a particular product was the most influential in the purchaser's decision to purchase the product). Similarly, determining a determined influence of the electronic accessed content on the involvement between the accessor and the third party based at least partially on the access information and the involvement information at 5340 may include analyzing a first activity of the accessor prior to the accessing of the electronic accessed content, analyzing a second activity of the accessor subsequent to the accessing of the electronic accessed content, and correlating the analysis of the first activity with the analysis of the second activity at 5354 (e.g. analyzing a first length of time spent accessing a first website, analyzing a second length of time spent accessing a second website, and correlating the first and second lengths of time).

In further embodiments, determining a determined influence of the electronic accessed content on the involvement between the accessor and the third party based at least partially on the access information and the involvement information at 5340 may include determining a difference in size of an electronic document of the accessor prior to and subsequent to the accessing of the electronic accessed content and correlating the difference in size with an assumed influence at 5356. For example, in some embodiments, a size of a note-taking document related to an accessor's eventual purchase may be reviewed after the accessor has accessed a first website and a second website, and the relative growth of the note-taking document after each of the first and second websites may be assumed to be directly proportional to the influence of each website, respectively.

In further embodiments, determining a determined influence of the electronic accessed content on the involvement between the accessor and the third party based at least partially on the access information and the involvement information at 5340 may include correlating an assumed influence of the electronic accessed content with an initial instance of a product identity in an information residing on an electronic device of the accessor at 5358. For example, in some embodiments, an electronic content containing a first mention or appearance of a product eventually purchased by an accessor may be assumed to be the most influential in the accessor's purchase decision. Similarly, the first mention or appearance of a product may be determined from a note-taking document, a cache memory, a browsing history, or any other suitable information source.

Similarly, in further embodiments, determining a determined influence of the electronic accessed content on the involvement between the accessor and the third party based at least partially on the access information and the involvement information at 5340 may include correlating one or more aspects of a product-related portion of the electronic accessed content accessed by the accessor with an activity associated with a purchase of a product at 5360 (e.g. correlating electronic signals indicating a user's accessing of graphical content related to a product, and an eventual registration of a newly-purchased product from a supplier).

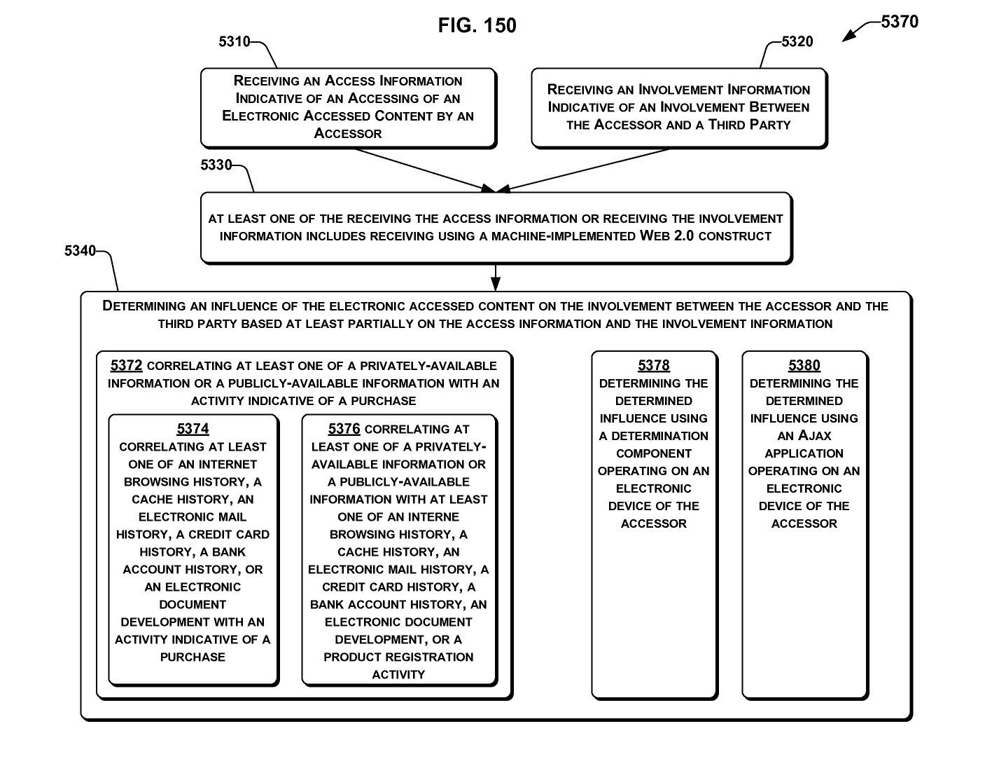

As shown in FIG. 150, in further embodiments, determining a determined influence of the electronic accessed content on the involvement between the accessor and the third party based at least partially on the access information and the involvement information at 5340 may include correlating at least one of a privately-available information or a publicly-available information with an activity indicative of a purchase at 5372 (e.g. correlating a cookie or other evidence of browsing history with a credit card purchase record). For example, in some implementations, correlating at least one of a privately-available information or a publicly-available information with an activity indicative of a purchase at 5372 may include correlating at least one of an internet browsing history, a cache history, an electronic mail history, a credit card history, a bank account history, or an electronic document development with an activity indicative of a purchase at 5374 (e.g. correlating a browsing history of a last-visited website with an email purchase confirmation).

Similarly, in further embodiments, correlating at least one of a privately-available information or a publicly-available information with an activity indicative of a purchase at 5372 may include correlating at least one of a privately-available information or a publicly-available information with at least one of an interne browsing history, a cache history, an electronic mail history, a credit card history, a bank account history, an electronic document development, or a product registration activity at 5376 (e.g. correlating a browsing history of a last-visited website with an electronic purchase record shown in a bank statement).

In further embodiments, determining a determined influence of the electronic accessed content on the involvement between the accessor and the third party based at least partially on the access information and the involvement information at 5340 may include determining the determined influence using a determination component operating on an electronic device of the accessor at 5378 (e.g. determining the determined influence using an influence determination software package operating on the purchaser's laptop computer).

Similarly, in further embodiments, determining a determined influence of the electronic accessed content on the involvement between the accessor and the third party based at least partially on the access information and the involvement information at 5340 may include determining the determined influence using an Ajax application operating on an electronic device of the accessor at 5380 (e.g. determining the determined influence using an Ajax component operating on the purchaser's personal data assistant).

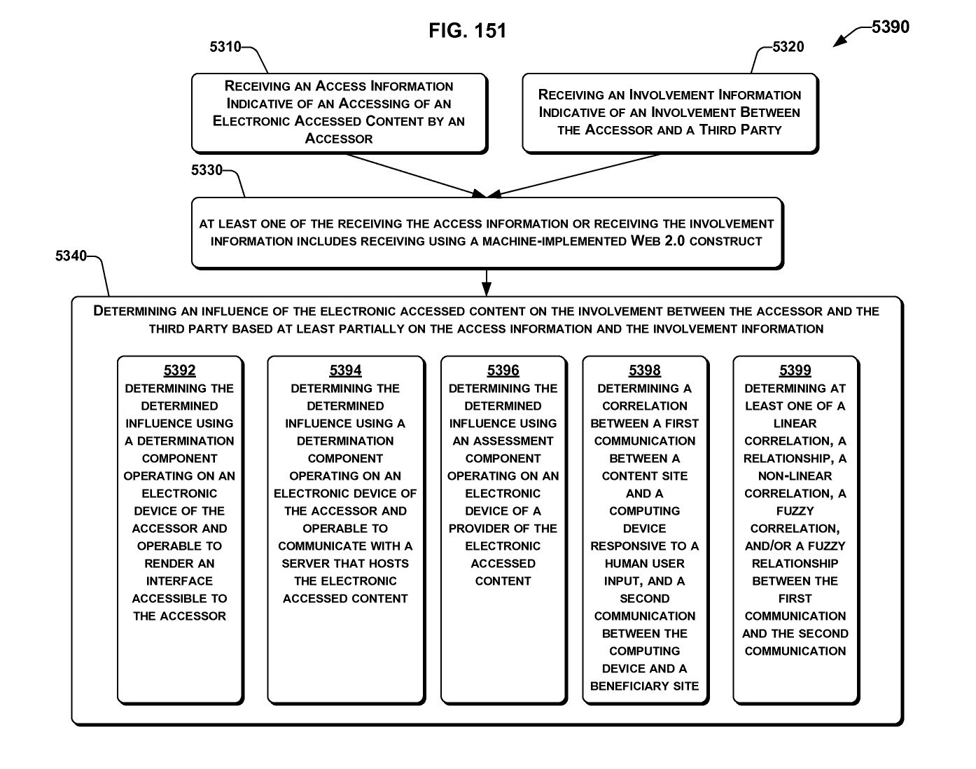

As shown in FIG. 151, in further embodiments, determining a determined influence of the electronic accessed content on the involvement between the accessor and the third party based at least partially on the access information and the involvement information at 5340 may include determining the determined influence using a determination component operating on an electronic device of the accessor and operable to render an interface accessible to the accessor at 5392 (e.g. determining the determined influence using a software component that detects a purchase by the accessor and provides a display requesting the purchaser's input on the electronic content that influenced the purchase).

In further embodiments, determining a determined influence of the electronic accessed content on the involvement between the accessor and the third party based at least partially on the access information and the involvement information at 5340 may include determining the determined influence using a determination component operating on an electronic device of the accessor and operable to communicate with a server that hosts the electronic accessed content at 5394 (e.g. determining the determined influence using a software component that detects a purchase by the accessor and transmits information related to the purchase to one or more servers that hosted electronic content accessed by the purchaser prior to the purchase).

In further embodiments, determining a determined influence of the electronic accessed content on the involvement between the accessor and the third party based at least partially on the access information and the involvement information at 5340 may include determining the determined influence using an assessment component operating on an electronic device of a provider of the electronic accessed content at 5396 (e.g. determining the determined influence using an influence determination software package operating on the server that provided the content related to the purchased product).

In further embodiments, determining a determined influence of the electronic accessed content on the involvement between the accessor and the third party based at least partially on the access information and the involvement information at 5340 may include determining a correlation between a first communication between a content site and a computing device responsive to a human user input, and a second communication between the computing device and a beneficiary site at 5398 (e.g. determining a correlation between an amount of information “clicked on” or reviewed by the accessor related to a product purchased by the accessor and a Paypal order confirmation message indicating a purchase of the product).

In further embodiments, determining a determined influence of the electronic accessed content on the involvement between the accessor and the third party based at least partially on the access information and the involvement information at 5340 may include determining at least one of a linear correlation, a relationship, a non-linear correlation, a fuzzy correlation, and/or a fuzzy relationship between the first communication and the second communication at 5399 (e.g. determining a determined influence assuming a direct relationship between a volume of electronic content accessed by a purchaser and a presumed influence level of the electronic content).

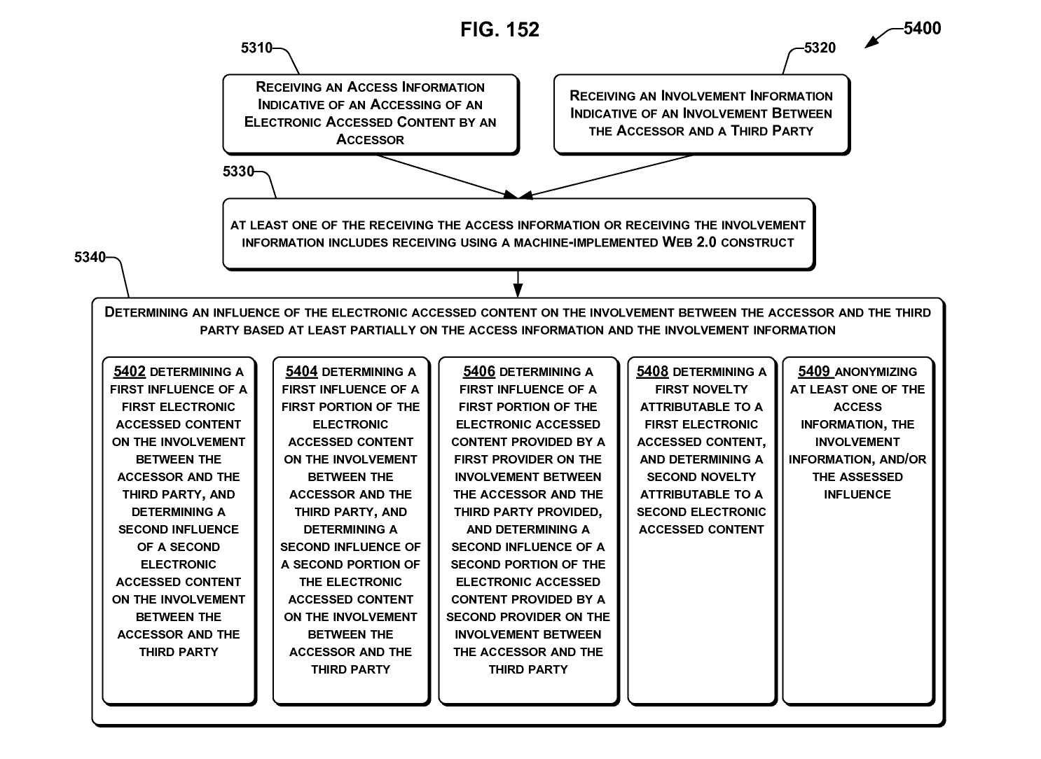

As shown in FIG. 152, in further embodiments, determining a determined influence of the electronic accessed content on the involvement between the accessor and the third party based at least partially on the access information and the involvement information at 5340 may include determining a first influence of a first electronic accessed content on the involvement between the accessor and the third party, and determining a second influence of a second electronic accessed content on the involvement between the accessor and the third party at 5402 (e.g. determining a first influence based on a first time period spent by an accessor accessing a first electronic content provided by a marketer, and a second influence based on a second time period spent by the accessor accessing a second electronic content provided by the marketer).

In further embodiments, determining a determined influence of the electronic accessed content on the involvement between the accessor and the third party based at least partially on the access information and the involvement information at 5340 may include determining a first influence of a first portion of the electronic accessed content on the involvement between the accessor and the third party, and determining a second influence of a second portion of the electronic accessed content on the involvement between the accessor and the third party at 5404 (e.g. determining a first influence of a first product review article provided by a marketer and reviewed by a purchaser, and a second influence based on a second product review article provided by the marketer and reviewed by the purchaser).

In further embodiments, determining a determined influence of the electronic accessed content on the involvement between the accessor and the third party based at least partially on the access information and the involvement information at 5340 may include determining a first influence of a first portion of the electronic accessed content provided by a first provider on the involvement between the accessor and the third party provided, and determining a second influence of a second portion of the electronic accessed content provided by a second provider on the involvement between the accessor and the third party at 5406 (e.g. determining a first influence of an endorsement of a first service by a first spokesperson, and determining a second influence of another endorsement of a second service by a second spokesperson, where an accessor eventually purchases at least one of the first or second services).

In further embodiments, determining a determined influence of the electronic accessed content on the involvement between the accessor and the third party based at least partially on the access information and the involvement information at 5340 may include determining a first novelty attributable to a first electronic accessed content, and determining a second novelty attributable to a second electronic accessed content at 5408 (e.g. determining a first influence of a first commentator's viewpoint and determining a second influence of a second commentator's viewpoint, where an accessor eventually submits a purchase order consistent with either the first viewpoint or the second viewpoint).

In still further embodiments, determining a determined influence of the electronic accessed content on the involvement between the accessor and the third party based at least partially on the access information and the involvement information at 5340 may include anonymizing at least one of the access information, the involvement information, and/or the assessed influence at 5409 (e.g. removing any information that may be used to identify an accessor/purchaser from information provided to a determination component operating on a server of a provider of an electronic content).

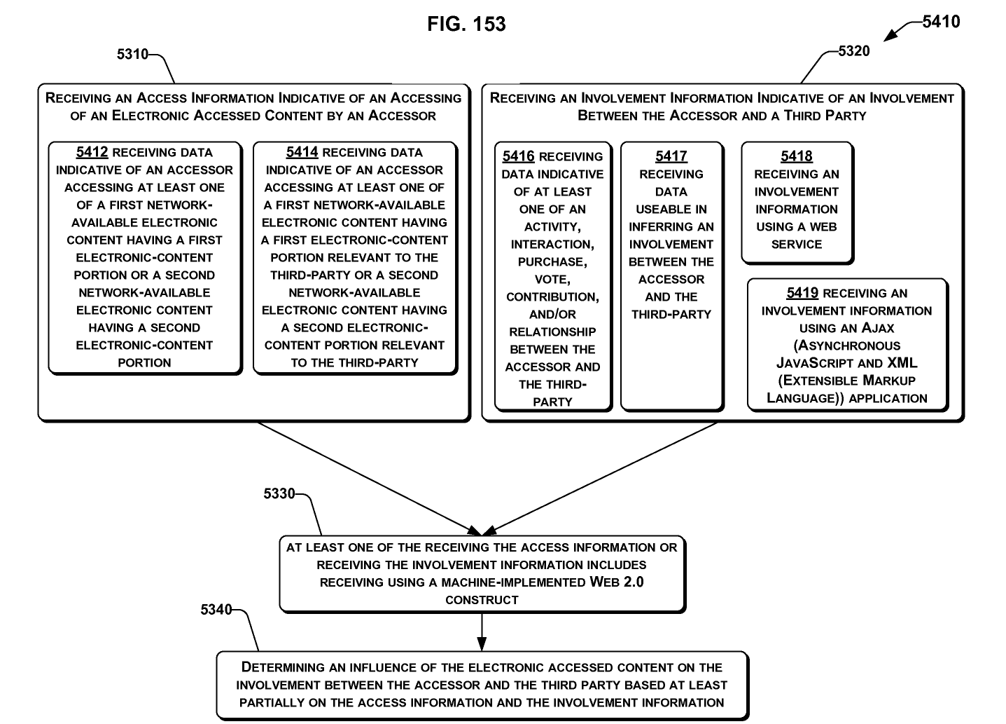

It will be appreciated that receiving an access information indicative of an accessing of an electronic accessed content by an accessor at 5310 may occur in a variety of ways. For example, in a method 5410 as shown in FIG. 153, receiving an access information indicative of an accessing of an electronic accessed content by an accessor at 5310 may include receiving data indicative of an accessor accessing at least one of a first network-available electronic content having a first electronic-content portion or a second network-available electronic content having a second electronic-content portion at 5412 (e.g. receiving data indicative of a media player viewing a mashup that provides a first viewable podcast and a second viewable podcast).

In further embodiments, receiving an access information indicative of an accessing of an electronic accessed content by an accessor at 5310 may include receiving data indicative of an accessor accessing at least one of a first network-available electronic content having a first electronic-content portion relevant to the third-party or a second network-available electronic content having a second electronic-content portion relevant to the third-party at 5414 (e.g. receiving data indicative that an accessor accessed a first article for a first time period and a second article for a second time period, receiving data indicative that an accessor recorded a first quantity of notes while reviewing a first article and a second quantity of notes while reviewing a second article).

Similarly, it will be appreciated that receiving an involvement information indicative of an involvement between the accessor and a third party at 5320 may occur in a variety of ways. For example, with continued reference to FIG. 153, in some embodiments, receiving an involvement information indicative of an involvement between the accessor and a third party at 5320 may include receiving data indicative of at least one of an activity, interaction, purchase, vote, contribution, and/or relationship between the accessor and the third-party at 5416.

In further embodiments, receiving an involvement information indicative of an involvement between the accessor and a third party at 5320 may include receiving data useable in inferring an involvement between the accessor and the third-party at 5417 (e.g. receiving a cookie placed by the third-party's website on the accessor's device indicative of a consumer transaction). Similarly, in further embodiments, receiving an involvement information indicative of an involvement between the accessor and a third party at 5320 may include receiving an involvement information using a web service at 5418 (e.g. receiving a report from a web service that performs tracking and reporting of durations of time spent by web browsers accessing websites). In still further embodiments, receiving an involvement information indicative of an involvement between the accessor and a third party at 5320 may include receiving an involvement information using an Ajax (Asynchronous JavaScript and XML (Extensible Markup Language)) application at 5419 (e.g. receiving a report using an Ajax application that documents and reports podcasts downloaded to a platform or device).

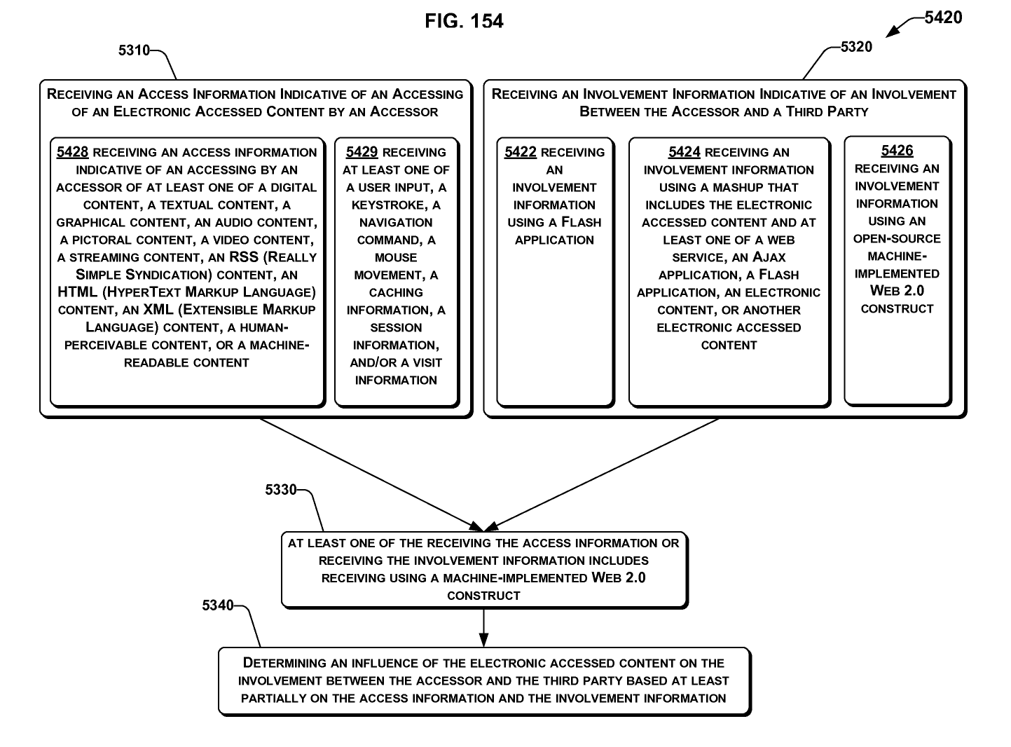

As shown in FIG. 154, in some embodiments, receiving an involvement information indicative of an involvement between the accessor and a third party at 5320 may include receiving an involvement information using a Flash application at 5422 (e.g. receiving a report from a Flash application that provides enhanced interactive capabilities and also monitors web browsing activities). Similarly, in further embodiments, receiving an involvement information indicative of an involvement between the accessor and a third party at 5320 may include receiving an involvement information using a mashup that includes the electronic accessed content and at least one of a web service, an Ajax application, a Flash application, an electronic content, or another electronic accessed content at 5424 (e.g. receiving a purchase confirmation message from a mashup that provides audio or visual content to a viewer and a Flash application that provides animation and that reports online purchasing activities).

In further embodiments, receiving an involvement information indicative of an involvement between the accessor and a third party at 5320 may include receiving an involvement information using an open-source machine-implemented Web 2.0 construct at 5426 (e.g. receiving a feed of information from an open-source engine that monitors web browsing activities, or an open-source application that documents access time durations). More specifically, in further embodiments, receiving an access information indicative of an accessing of an electronic accessed content by an accessor at 5310 may include receiving an access information indicative of an accessing by an accessor of at least one of a digital content, a textual content, a graphical content, an audio content, a pictoral content, a video content, a streaming content, an RSS (Really Simple Syndication) content, an HTML (HyperText Markup Language) content, an XML (Extensible Markup Language) content, a human-perceivable content, or a machine-readable content at 5428. Similarly, in further embodiments, receiving an access information indicative of an accessing of an electronic accessed content by an accessor at 5310 may include receiving at least one of a user input, a keystroke, a navigation command, a mouse movement, a caching information, a session information, and/or a visit information at 5429.

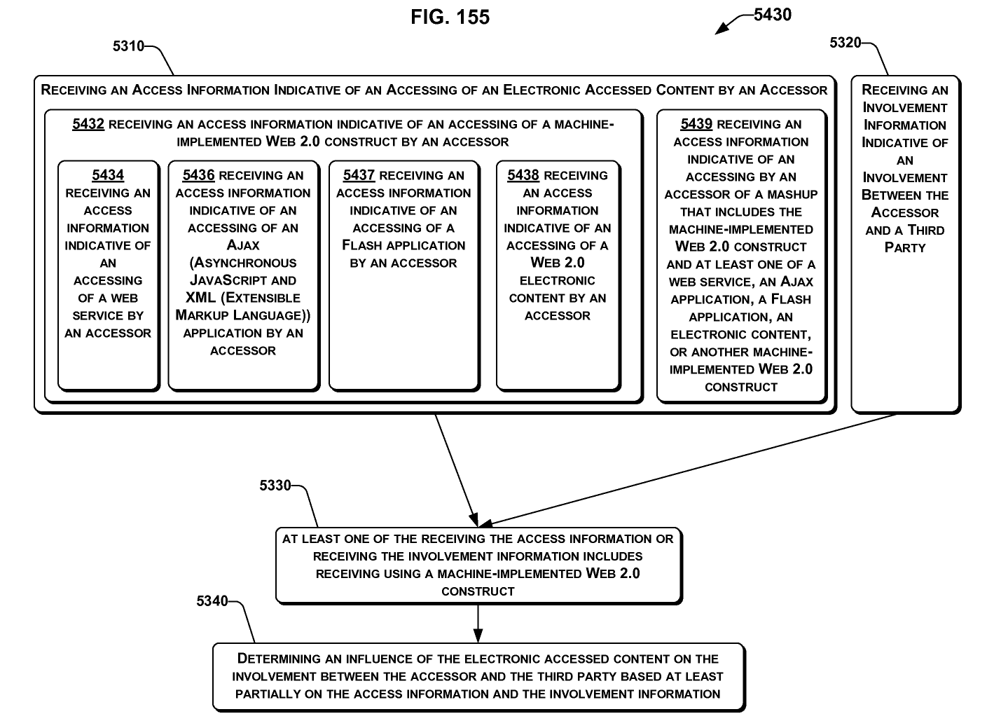

As shown in FIG. 155, in some embodiments, receiving an access information indicative of an accessing of an electronic accessed content by an accessor at 5310 may include receiving an access information indicative of an accessing of a machine-implemented Web 2.0 construct by an accessor at 5432 (e.g. receiving a summary indicating a user's shopping activity including viewing of visual content from a mashup that includes a Web-based information service). In further embodiments, receiving an access information indicative of an accessing of an electronic accessed content by an accessor at 5310 may include receiving an access information indicative of an accessing of a web service by an accessor at 5434 (e.g. receiving information indicating a user's viewing of product-related information from an RSS feed of consumer-oriented information from a Web-based information service).

Similarly, in further embodiments, receiving an access information indicative of an accessing of an electronic accessed content by an accessor at 5310 may include receiving an access information indicative of an accessing of an Ajax (Asynchronous JavaScript and XML (Extensible Markup Language)) application by an accessor at 5436 (e.g. receiving information indicating a PDA (Personal Data Assistant) access of an Ajax application from a website that provides Internet search services). In still further embodiments, receiving an access information indicative of an accessing of an electronic accessed content by an accessor at 5310 may include receiving an access information indicative of an accessing of a Flash application by an accessor at 5437 (e.g. receiving information indicating a computer access of a Flash application that provides animation of aspects of a product from a retailer).

In further embodiments, receiving an access information indicative of an accessing of an electronic accessed content by an accessor at 5310 may include receiving an access information indicative of an accessing of a Web 2.0 electronic content by an accessor at 5438 (e.g. receiving information indicating a computer access of a mashup that includes an animation-related Flash application from a website that offers services for sale). Similarly, in further embodiments, receiving an access information indicative of an accessing of an electronic accessed content by an accessor at 5310 may include receiving an access information indicative of an accessing by an accessor of a mashup that includes the machine-implemented Web 2.0 construct and at least one of a web service, an Ajax application, a Flash application, an electronic content, or another machine-implemented Web 2.0 construct at 5439.

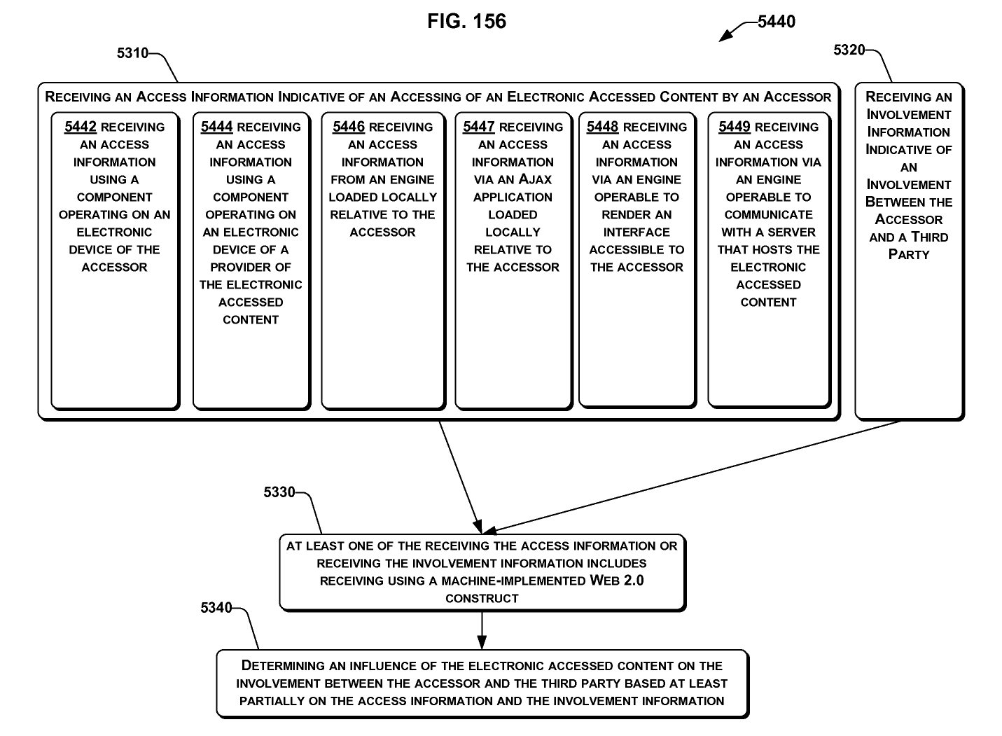

As shown in FIG. 156, in some embodiments, receiving an access information indicative of an accessing of an electronic accessed content by an accessor at 5310 may include receiving an access information using a component operating on an electronic device of the accessor at 5442 (e.g. receiving an access report using an asynchronous engine loaded on an accessor's mobile device). In further embodiments, receiving an access information indicative of an accessing of an electronic accessed content by an accessor at 5310 may include receiving an access information using a component operating on an electronic device of a provider of the electronic accessed content at 5444 (e.g. receiving an access report using a software package loaded on a server that hosts an accessed electronic content).

Similarly, in further embodiments, receiving an access information indicative of an accessing of an electronic accessed content by an accessor at 5310 may include receiving an access information from an engine loaded locally relative to the accessor at 5446. (e.g. receiving an access report using a software package loaded on an accessor's laptop). In further embodiments, receiving an access information indicative of an accessing of an electronic accessed content by an accessor at 5310 may include receiving an access information via an Ajax application loaded locally relative to the accessor at 5447 (e.g. receiving a report including sites visited and duration of visits using an Ajax package loaded on an accessor's cell phone).

In further embodiments, receiving an access information indicative of an accessing of an electronic accessed content by an accessor at 5310 may include receiving an access information via an engine operable to render an interface accessible to the accessor at 5448 (e.g. receiving a browsing summary using a component that presents a menu for user-provided influence input). Similarly, in further embodiments, receiving an access information indicative of an accessing of an electronic accessed content by an accessor at 5310 may include receiving an access information via an engine operable to communicate with a server that hosts the electronic accessed content at 5449 (e.g. receiving a periodic browsing report from a software component that transmits the periodic browsing report to one or more servers that host product-related information).

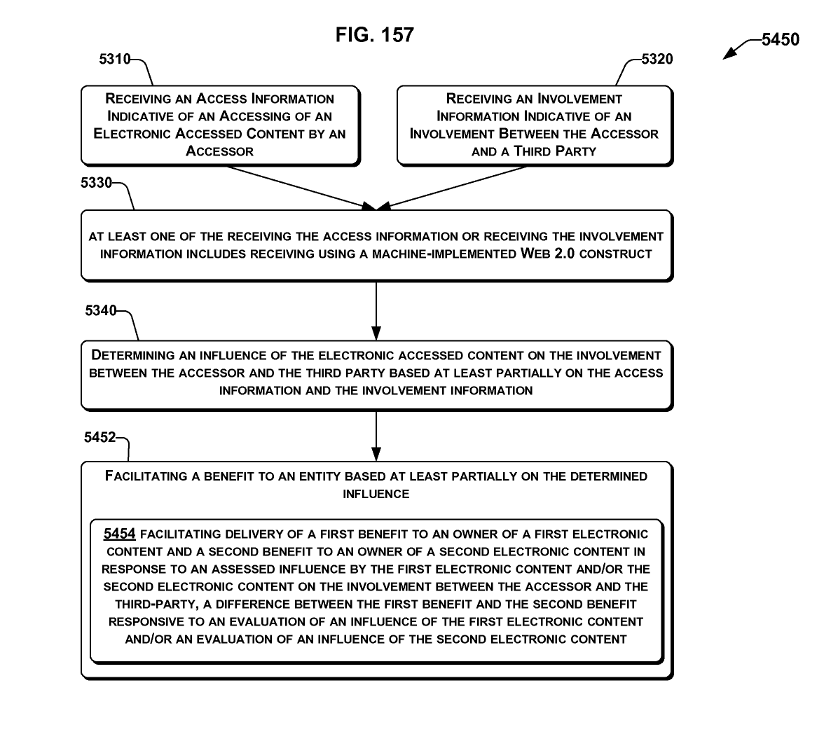

Additional embodiments and aspects of processes and systems in accordance with the present disclosure are depicted in FIG. 157, which shows a flowchart of a method 5450 that includes receiving an access information indicative of an accessing of an electronic accessed content by an accessor at 5310, receiving an involvement information indicative of an involvement between the accessor and a third party at 5320, wherein at least one of receiving the access information or receiving the involvement information includes receiving using a machine-implemented Web 2.0 construct at 5330, and determining a determined influence of the electronic accessed content on the involvement between the accessor and the third party based at least partially on the access information and the involvement information at 5340. The method 5450 further includes facilitating a benefit to an entity based at least partially on the determined influence at 5452 (e.g. providing compensation to a provider of a product-review article based on a determined influence of the article, authorizing a credit for future goods or services to an owner of an electronic content based on a determined influence that exceeds a predetermined threshold, providing a discount on airline flights based on a determined influence of a favorable travel recommendation).

It will be appreciated that the facilitating a benefit to an entity based at least partially on the determined influence at 5452 may be implemented in a variety of ways. For example, in some embodiments, facilitating a benefit to an entity based at least partially on the determined influence at 5452 may include facilitating delivery of a first benefit to an owner of a first electronic content and a second benefit to an owner of a second electronic content in response to an assessed influence by the first electronic content and/or the second electronic content on the involvement between the accessor and the third-party, a difference between the first benefit and the second benefit responsive to an evaluation of an influence of the first electronic content and/or an evaluation of an influence of the second electronic content at 5454 (e.g. providing a relatively smaller rate reduction on goods to a first author of a consumer report providing a moderately-positive endorsement of a product, and a relatively larger rate reduction on goods to a second author of a consumer report providing a highly-positive endorsement of the product, the difference between the larger and smaller rate reductions being based on an evaluation of the relative influence of the consumer reports by the first and second authors).

It should be appreciated that the processes and methods described above with reference to FIGS. 148-157 are merely illustrative of a few of the many possible processes and methods in which the teachings of the present disclosure may be implemented, and that the teachings herein are not limited to the particular processes and methods described above.

It should be appreciated that the particular embodiments of systems and processes described herein are merely possible implementations of the present disclosure, and that the present disclosure is not limited to the particular implementations described herein and shown in the accompanying figures. For example, in alternate implementations, certain acts need not be performed in the order described, and may be modified, and/or may be omitted entirely, depending on the circumstances. Moreover, in various implementations, the acts described may be implemented by a computer, controller, processor, programmable device, or any other suitable device, and may be based on instructions stored on one or more computer-readable media or otherwise stored or programmed into such devices. In the event that computer-readable media are used, the computer-readable media can be any available media that can be accessed by a device to implement the instructions stored thereon.

Various methods, systems, and techniques may be described and implemented in the general context of computer-executable instructions, such as program modules, executed by one or more processors or other devices. Generally, program modules include routines, programs, objects, components, data structures, etc. that perform particular tasks or implement particular abstract data types. Typically, the functionality of the program modules may be combined or distributed as desired in various alternate embodiments. In addition, embodiments of these methods, systems, and techniques may be stored on or transmitted across some form of computer readable media.

It may also be appreciated that there may be little distinction between hardware and software implementations of aspects of systems and methods disclosed herein. The use of hardware or software may generally be a design choice representing cost vs. efficiency tradeoffs, however, in certain contexts the choice between hardware and software can become significant. Those having skill in the art will appreciate that there are various vehicles by which processes, systems, and technologies described herein can be effected (e.g., hardware, software, firmware, or combinations thereof), and that a preferred vehicle may vary depending upon the context in which the processes, systems, and technologies are deployed. For example, if an implementer determines that speed and accuracy are paramount, the implementer may opt for a mainly hardware and/or firmware vehicle. Alternatively, if flexibility is paramount, the implementer may opt for a mainly software implementation. In still other implementations, the implementer may opt for some combination of hardware, software, and/or firmware. Hence, there are several possible vehicles by which the processes and/or devices and/or other technologies described herein may be effected, and which may be desired over another may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use standard engineering practices to integrate such described devices and/or processes into workable systems having the described functionality. That is, at least a portion of the devices and/or processes described herein can be developed into a workable system via a reasonable amount of experimentation.

The herein described aspects and drawings illustrate different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” (or “operatively connected,” or “operatively coupled”) to each other to achieve the desired functionality, and any two components capable of being so associated can also be viewed as being “operably couplable” (or “operatively couplable”) to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that some aspects of the embodiments disclosed herein can be implemented in standard integrated circuits, and also as one or more computer programs running on one or more computers, and also as one or more software programs running on one or more processors, and also as firmware, as well as virtually any combination thereof. It will be further understood that designing the circuitry and/or writing the code for the software and/or firmware could be accomplished by a person skilled in the art in light of the teachings and explanations of this disclosure.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. For example, in some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

As a further example of “open” terms in the present specification and claims, it will be understood that usage of a language construction “A or B” is generally interpreted as a non-exclusive “open term” meaning. A alone, B alone, and/or A and B together.

Although various features have been described in considerable detail with reference to certain preferred embodiments, other embodiments are possible. Therefore, the spirit or scope of the appended claims should not be limited to the description of the embodiments contained herein.

1-993. (canceled)

994. A machine, comprising:
circuitry for receiving at least some data indicative of at least one person accessing at least some network-available electronic content;
circuitry for receiving at least some data indicative of at least one involvement between the at least one person and at least one third party; and
circuitry for facilitating delivery of at least one benefit to at least one entity associated with the at least some network-available electronic content in response to at least one assessed influence by the at least some network-available electronic content on the at least one involvement between the at least one person and the at least one third party.

995. The machine of claim 994, wherein circuitry for receiving at least some data indicative of at least one person accessing at least some network-available electronic content comprises:
circuitry for receiving at least some data indicative of at least one person accessing at least some network-available electronic content including at least one electronic content portion relevant to the at least one third party.

996. The machine of claim 994, wherein circuitry for receiving at least some data indicative of at least one person accessing at least some network-available electronic content comprises:
circuitry for receiving at least some data indicative of at least one visitor accessing at least some network-available electronic content including at least one electronic content portion.

997. The machine of claim 994, wherein circuitry for receiving at least some data indicative of at least one person accessing at least some network-available electronic content comprises:
circuitry for receiving at least some data indicative of at least one person accessing at least some network-available electronic content including at least one electronic content portion, the at least one electronic content portion including at least some digital content capable of being transmitted over at least one computer network.

998. The machine of claim 994, wherein circuitry for receiving at least some data indicative of at least one person accessing at least some network-available electronic content comprises:
circuitry for receiving at least some data indicative of at least one person encountering at least some network-available electronic content including at least one electronic content portion.

999. The machine of claim 994, wherein circuitry for receiving at least some data indicative of at least one person accessing at least some network-available electronic content comprises:
circuitry for receiving at least some data indicative of at least one person viewing at least some network-available electronic content including at least one electronic content portion.

1000. The machine of claim 994, wherein circuitry for receiving at least some data indicative of at least one person accessing at least some network-available electronic content comprises:
circuitry for receiving at least some data indicative of at least one person accessing at least some network-available electronic content including at least one electronic content portion, the at least some network-available electronic content including at least one of at least some publicly-available electronic content, at least some limited-availability electronic content, or at least some privately-available electronic content.

1001. The machine of claim 994, wherein circuitry for receiving at least some data indicative of at least one person accessing at least some network-available electronic content comprises:
circuitry for receiving at least some data indicative of at least one person accessing at least some network-available electronic content including at least one electronic content portion, the at least some network-available electronic content including at least one of at least some static electronic content or at least some dynamic electronic content.

1002. The machine of claim 994, wherein circuitry for receiving at least some data indicative of at least one person accessing at least some network-available electronic content comprises:
circuitry for receiving at least some data indicative of at least one person accessing at least some network-available electronic content including at least one electronic content portion, the at least some network-available electronic content including at least one of at least some static digital content or at least some dynamic digital content.

1003. The machine of claim 994, wherein circuitry for receiving at least some data indicative of at least one person accessing at least some network-available electronic content comprises:
circuitry for receiving at least some data indicative of at least one person accessing at least some network-available electronic content including at least one electronic content portion, the at least some network-available electronic content including at least one of at least some human-perceivable content, at least some textual content, at least some visual content, at least some audio content, at least some music content, or at least some graphic content.

1004. The machine of claim 994, wherein circuitry for receiving at least some data indicative of at least one person accessing at least some network-available electronic content comprises:
circuitry for receiving at least some data indicative of at least one person accessing at least some network-available electronic content including at least one electronic content portion, the at least some network-available electronic content including one or more of at least one electronic document, at least one electronic work, at least some electronically-stored information, at least one Web document, at least one email, or at least one instant message.

1005. The machine of claim 994, wherein circuitry for receiving at least some data indicative of at least one involvement between the at least one person and at least one third party comprises:
circuitry for receiving at least some data indicative of one or more of at least one activity, at least one interaction, at least one purchase, at least one vote, at least one contribution, or at least one relationship between the at least one person and the at least one third party.

1006. The machine of claim 994, wherein circuitry for receiving at least some data indicative of at least one involvement between the at least one person and at least one third party comprises:
circuitry for receiving at least some data indicative of at least some behavior by the at least one person with respect to the at least one third party.

1007. The machine of claim 994, wherein circuitry for receiving at least some data indicative of at least one involvement between the at least one person and at least one third party comprises:
circuitry for receiving at least some data indicative useable in inferring at least one involvement between the at least one person and the at least one third party.

1008. The machine of claim 994, wherein circuitry for facilitating delivery of at least one benefit to at least one entity associated with the at least some network-available electronic content in response to at least one assessed influence by the at least some network-available electronic content on the at least one involvement between the at least one person and the at least one third party comprises:
circuitry for facilitating delivery of one or more of at least some compensation, at least one privilege, or at least one reward to at least one entity associated with the at least some network-available electronic content in response to at least one assessed influence by the at least some network-available electronic content on the at least one involvement between the at least one person and the at least one third party.

1009. The machine of claim 994, wherein circuitry for facilitating delivery of at least one benefit to at least one entity associated with the at least some network-available electronic content in response to at least one assessed influence by the at least some network-available electronic content on the at least one involvement between the at least one person and the at least one third party comprises:
circuitry for facilitating delivery of at least one benefit to at least one entity associated with the at least some network-available electronic content in response to at least one assessed influence by the at least some network-available electronic content on the at least one involvement between the at least one person and the at least one third party, including at least circuitry for determining at least one measure of the at least one benefit by one or more of at least one other person or the at least one third party.

1010. The machine of claim 994, wherein circuitry for facilitating delivery of at least one benefit to at least one entity associated with the at least some network-available electronic content in response to at least one assessed influence by the at least some network-available electronic content on the at least one involvement between the at least one person and the at least one third party comprises:
circuitry for facilitating delivery of at least one benefit to at least one entity associated with the at least some network-available electronic content in response to at least one assessed influence by the at least some network-available electronic content on the at least one involvement between the at least one person and the at least one third party, including at least circuitry for determining the at least one benefit responsive to at least one benefit determination algorithm.

1011. The machine of claim 994, wherein circuitry for facilitating delivery of at least one benefit to at least one entity associated with the at least some network-available electronic content in response to at least one assessed influence by the at least some network-available electronic content on the at least one involvement between the at least one person and the at least one third party comprises:
circuitry for facilitating delivery of at least one benefit to at least one entity associated with the at least some network-available electronic content in response to at least one assessed influence by the at least some network-available electronic content on the at least one involvement between the at least one person and the at least one third party, wherein the at least one entity includes one or more of at least one author, at least one content author, at least one putative content author, at least one assignee, at least one designee, at least one delegee, at least one poster, at least one creator, at least one editor, at least one associate, at least one sponsor, at least one host, at least one aggregator, at least one website owner, at least one server owner, at least one group, or at least one cohort.

1012. The machine of claim 994, wherein circuitry for facilitating delivery of at least one benefit to at least one entity associated with the at least some network-available electronic content in response to at least one assessed influence by the at least some network-available electronic content on the at least one involvement between the at least one person and the at least one third party comprises:
circuitry for facilitating delivery of at least one benefit to at least one entity associated with the at least some network-available electronic content in response to at least one assessed influence with respect to at least one subject of interest to the at least one third party by the at least some network-available electronic content on the at least one involvement between the at least one person and the at least one third party.

1013. The machine of claim 994, wherein circuitry for facilitating delivery of at least one benefit to at least one entity associated with the at least some network-available electronic content in response to at least one assessed influence by the at least some network-available electronic content on the at least one involvement between the at least one person and the at least one third party comprises:
circuitry for facilitating delivery of at least one benefit to at least one entity associated with the at least some network-available electronic content in response to at least one assessed influence trend by the at least some network-available electronic content on the at least one involvement between the at least one person and the at least one third party.

1014. The machine of claim 994, wherein circuitry for facilitating delivery of at least one benefit to at least one entity associated with the at least some network-available electronic content in response to at least one assessed influence by the at least some network-available electronic content on the at least one involvement between the at least one person and the at least one third party comprises:
circuitry for facilitating delivery of at least one benefit to at least one entity associated with the at least some network-available electronic content in response to at least one assessed influence on at least some behavior of the at least one person by the at least some network-available electronic content.

1015. The machine of claim 994, further comprising:
circuitry for receiving at least some data indicative of at least one affinity of the at least one person.

1016. The machine of claim 1015, wherein circuitry for receiving at least some data indicative of at least one affinity of the at least one person comprises:
circuitry for receiving at least some data indicative of one or more of at least one express affinity or at least one inferred affinity of the at least one person.

1017. The machine of claim 1015, wherein circuitry for receiving at least some data indicative of at least one affinity of the at least one person comprises:
circuitry for receiving at least some data indicative of one or more of at least one affinity characteristic or at least one affiliation of the at least one person.

1018. The machine of claim 994, further comprising:
circuitry for maintaining at least some informational data corresponding to the at least one assessed influence.

1019. The machine of claim 994, further comprising:
circuitry for providing at least partial access to at least some informational data corresponding to the at least one assessed influence.

1020. An article of manufacture, comprising:
means for receiving at least some data indicative of at least one person accessing at least some network-available electronic content;
means for receiving at least some data indicative of at least one involvement between the at least one person and at least one third party; and
means for facilitating delivery of at least one benefit to at least one entity associated with the at least some network-available electronic content in response to at least one assessed influence by the at least some network-available electronic content on the at least one involvement between the at least one person and the at least one third party.

1021. A machine, comprising:
one or more application specific integrated circuits configured for receiving at least some data indicative of at least one person accessing at least some network-available electronic content;
one or more application specific integrated circuits configured for receiving at least some data indicative of at least one involvement between the at least one person and at least one third party; and
one or more application specific integrated circuits configured for facilitating delivery of at least one benefit to at least one entity associated with the at least some network-available electronic content in response to at least one assessed influence by the at least some network-available electronic content on the at least one involvement between the at least one person and the at least one third party.
